(19) United States
(12) Patent Application Publication
(10) Pub. No.: US 2014/0122487 A1
(43) Pub. Date: May 1, 2014

(54) Food Supply Chain Automation Farm Testing System And Method

(71) Applicant: ELWHA LLC, Bellevue, WA (US)

(72) Inventors: Edward K.Y. Jung, Bellevue, WA (US); Royce A. Levien, Lexington, MA (US); Mark A. Malamud, Seattle, WA (US)

(73) Assignee: ELWHA LLC, Bellevue, WA (US)

(21) Appl. No.: 13/668,977

(22) Filed: Nov. 5, 2012

Related U.S. Application Data
(63) Continuation-in-part of application No. 13/663,137, filed on Oct. 29, 2012.
Application No. 13/663,137 is a continuation of application No. 13/663,095, filed on Oct. 29, 2012.

(51) Int. Cl. G06F 17/30

(52) U.S. Cl. CPC G06F 17/30598
USPC 707/737

(57) ABSTRACT

A computationally implemented system and method that is designed to, but is not limited to: electronically storing farming related test information generated through testing of one or more test samples of one or more first farming related items involved in farming related creation of one or more first biologically based substances; and electronically storing symbolic information recorded as being correlated with one or more tags, said one or more tags recorded as being at least temporarily in vicinity of one or more second farming related items involved in farming related creation of one or more second biologically based substances. In addition to the foregoing, other method aspects are described in the claims, drawings, and text forming a part of the present disclosure.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/663,137, entitled Food Supply Chain Automation Farm Tracking System And Method, naming Edward K. Y. Jung, Royce A. Levien, and Mark A. Malamud as inventors, filed Oct. 29, 2012 with attorney docket no. 0712-003-002-000001, which is currently co-pending or is an application of which a currently co-pending application is entitled to the benefit of the filing date, and which is a continuation of U.S. patent application Ser. No. 13/663,095, Food Supply Chain Automation Farm Tracking System And Method, naming Edward K. Y. Jung, Royce A. Levien, and Mark A. Malamud as inventors, filed Oct. 29, 2012 with attorney docket no. 0712-003-002-000000.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a computationally-implemented method includes, but is not limited to electronically storing farming related test information generated through testing of one or more test samples of one or more first farming related items involved in farming related creation of one or more first biologically based substances; and electronically storing symbolic information recorded as being correlated with and as being correlated with one or more tags, said one or more tags recorded as being at least temporarily in vicinity of one or more second farming related items involved in farming related creation of one or more second biologically based substances. In addition to the foregoing, other method aspects are described in the claims, drawings, and text forming a part of the disclosure set forth herein.

In one or more various aspects, related machines, compositions of matter, or manufactures of systems may include, but are not limited to, circuitry and/or programming for effecting the herein-referenced method aspects; the circuitry and/or programming can be virtually any combination of hardware, software, and/or firmware configured to effect the herein-referenced method aspects depending upon the design choices of the system designer (limited to patentable subject matter under 35 USC 101).

A computationally-implemented system includes, but is not limited to: means for electronically storing farming related test information generated through testing of one or more test samples of one or more first farming related items involved in farming related creation of one or more first biologically based substances; and means for electronically storing symbolic information recorded as being correlated with and as being correlated with one or more tags, said one or more tags recorded as being at least temporarily in vicinity of one or more second farming related items involved in farming related creation of one or more second biologically based substances. In addition to the foregoing, other system aspects are described in the claims, drawings, and text forming a part of the disclosure set forth herein.

A computationally-implemented system includes, but is not limited to a storing test info electrical circuitry arrangement for electronically storing farming related test information generated through testing of one or more test samples of one or more first farming related items involved in farming related creation of one or more first biologically based substances; and a storing symbolic info electrical circuitry arrangement for electronically storing symbolic information recorded as being correlated with and as being correlated with one or more tags, said one or more tags recorded as being at least temporarily in vicinity of one or more second farming related items involved in farming related creation of one or more second biologically based substances. In addition to the foregoing, other system aspects are described in the claims, drawings, and text forming a part of the disclosure set forth herein.

A system includes, but is not limited to a storing test info module configured to operate in accordance with electronically storing farming related test information generated through testing of one or more test samples of one or more first farming related items involved in farming related creation of one or more first biologically based substances; and a storing symbolic info module configured to operate in accordance with electronically storing symbolic information recorded as being correlated with and as being correlated with one or more tags, said one or more tags recorded as being at least temporarily in vicinity of one or more second farming related items involved in farming related creation of one or more second biologically based substances. In addition to the foregoing, other system aspects are described in the claims, drawings, and text forming a part of the disclosure set forth herein.

An article of manufacture including one or more non-transitory signal-bearing storage medium bearing one or more instructions for electronically storing farming related test information generated through testing of one or more test samples of one or more first farming related items involved in farming related creation of one or more first biologically based substances; and one or more instructions for electronically storing symbolic information recorded as being correlated with and as being correlated with one or more tags, said one or more tags recorded as being at least temporarily in vicinity of one or more second farming related items involved in farming related creation of one or more second biologically based substances. In addition to the foregoing, other computer program product aspects are described in the claims, drawings, and text forming a part of the disclosure set forth herein.

A system including one or more computing devices; and one or more instructions when executed on the one or more computing devices cause the one or more computing devices to perform electronically storing farming related test information generated through testing of one or more test samples of one or more first farming related items involved in farming related creation of one or more first biologically based substances; and electronically storing symbolic information recorded as being correlated with and as being correlated with one or more tags, said one or more tags recorded as being at least temporarily in vicinity of one or more second farming related items involved in farming related creation of one or more second biologically based substances. In addition to the foregoing, other computer program product aspects are described in the claims, drawings, and text forming a part of the disclosure set forth herein.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of is an example of farming related ingestible materials production testing system that may provide context, for instance, in introducing one or more processes and/or devices described herein

FIG. 1 is a schematic view depicting farm-test co. info hub aspects as related with a farming related ingestible materials production testing system.

FIG. 2 is a schematic view depicting farm-tracking aspects as related with the farming related ingestible materials production testing system.

FIG. 3 is a schematic view depicting farm-track co. info hub aspects as related with the farming related ingestible materials production testing system.

FIG. 4 is a schematic view depicting farm-tracking aspects as related with the farming related ingestible materials production testing system.

FIG. 5 is a schematic view depicting shipping aspects as related with the farming related ingestible materials production testing system.

FIG. 6 is a schematic view depicting grocery test and track co. info hub aspects as related with the farming related ingestible materials production testing system.

FIG. 7 is a schematic view depicting grocery tracking aspects as related with the farming related ingestible materials production testing system.

FIG. 8 is a schematic view depicting home-test and track co. info hub aspects as related with the farming related ingestible materials production testing system.

FIG. 9 is a schematic view depicting home tracking aspects as related with the farming related ingestible materials production testing system.

FIG. 10 is a schematic view depicting restaurant-test and track co. info hub aspects as related with the farming related ingestible materials production testing system.

FIG. 11 is a schematic view depicting restaurant tracking aspects as related with the farming related ingestible materials production testing system.

FIG. 12 is a block diagram depicting an exemplary implementation of the farming related ingestible materials production testing system 10 of FIG. 1 including exemplary subsystems.

FIG. 13 is a block diagram depicting a control and information processing subsystem s100 of an exemplary implementation of the farming related ingestible materials production testing system 10 of FIG. 1.

FIG. 14 is a block diagram depicting an information storage subsystem s200 of an exemplary implementation of the farming related ingestible materials production testing system 10 of FIG. 1.

FIG. 15 is a block diagram depicting an information user interface subsystem s300 of an exemplary implementation of the farming related ingestible materials production testing system 10 of FIG. 1.

FIG. 16 is a block diagram depicting a sensing subsystem s400 of an exemplary implementation of the farming related ingestible materials production testing system 10 of FIG. 1.

FIG. 17 is a block diagram depicting an electronic communication subsystem s500 of an exemplary implementation of the farming related ingestible materials production testing system 10 of FIG. 1.

FIG. 18 is a block diagram depicting a power subsystem s600 of an exemplary implementation of the farming related ingestible materials production testing system 10 of FIG. 1.

FIG. 19 is a block diagram depicting a material processing subsystem s700 of an exemplary implementation of the farming related ingestible materials production testing system 10 of FIG. 1.

FIG. 20 is a block diagram depicting a preparation subsystem s800 of an exemplary implementation of the farming related ingestible materials production testing system 10 of FIG. 1.

FIG. 21 is a block diagram depicting one or more exemplary electrical circuitry arrangements of the farming related ingestible materials production testing system 10 of FIG. 1.

FIG. 22 is a block diagram depicting one or more exemplary electrical circuitry arrangements of the farming related ingestible materials production testing system 10 of FIG. 1.

FIG. 23 is a block diagram depicting one or more exemplary electrical circuitry arrangements of the farming related ingestible materials production testing system 10 of FIG. 1.

FIG. 24 is a block diagram depicting one or more exemplary electrical circuitry arrangements of the farming related ingestible materials production testing system 10 of FIG. 1.

FIG. 25 is a block diagram depicting one or more exemplary electrical circuitry arrangements of the farming related ingestible materials production testing system 10 of FIG. 1.

FIG. 26 is a block diagram depicting one or more exemplary electrical circuitry arrangements of the farming related ingestible materials production testing system 10 of FIG. 1.

FIG. 27 is a block diagram depicting one or more exemplary electrical circuitry arrangements of the farming related ingestible materials production testing system 10 of FIG. 1.

FIG. 28 is a block diagram depicting one or more exemplary instructions of the information storage subsystem s200 of the farming related ingestible materials production testing system 10 of FIG. 1.

FIG. 29 is a block diagram depicting one or more exemplary instructions of the information storage subsystem s200 of the farming related ingestible materials production testing system 10 of FIG. 1.

FIG. 30 is a block diagram depicting one or more exemplary instructions of the information storage subsystem s200 of the farming related ingestible materials production testing system 10 of FIG. 1.

FIG. 31 is a block diagram depicting one or more exemplary instructions of the information storage subsystem s200 of the farming related ingestible materials production testing system 10 of FIG. 1.

FIG. 32 is a block diagram depicting one or more exemplary instructions of the information storage subsystem s200 of the farming related ingestible materials production testing system 10 of FIG. 1.

FIG. 33 is a block diagram depicting one or more exemplary instructions of the information storage subsystem s200 of the farming related ingestible materials production testing system 10 of FIG. 1.

FIG. 34 is a block diagram depicting one or more exemplary instructions of the information storage subsystem s200 of the farming related ingestible materials production testing system 10 of FIG. 1.

FIG. 35 is a block diagram depicting one or more exemplary modules of the farming related ingestible materials production testing system 10 of FIG. 1.

FIG. 36 is a block diagram depicting one or more exemplary modules of the farming related ingestible materials production testing system 10 of FIG. 1.

FIG. 37 is a block diagram depicting one or more exemplary modules of the farming related ingestible materials production testing system 10 of FIG. 1.

FIG. 38 is a block diagram depicting one or more exemplary modules of the farming related ingestible materials production testing system 10 of FIG. 1.

FIG. 39 is a block diagram depicting one or more exemplary modules of the farming related ingestible materials production testing system 10 of FIG. 1.

FIG. 40 is a block diagram depicting one or more exemplary modules of the farming related ingestible materials production testing system 10 of FIG. 1.

FIG. 41 is a block diagram depicting one or more exemplary modules of the farming related ingestible materials production testing system 10 of FIG. 1.

FIG. 42 is a high-level flowchart illustrating an operational flow o10 representing exemplary operations related to electronically storing farming related test information generated through testing of one or more test samples of one or more first farming related items involved in farming related creation of one or more first biologically based substances, and electronically storing symbolic information recorded as being correlated with and as being correlated with one or more tags, said one or more tags recorded as being at least temporarily in vicinity of one or more second farming related items involved in farming related creation of one or more second biologically based substances at least associated with the depicted exemplary implementations of the system.

FIG. 43 is a high-level flowchart including exemplary implementations of operation o11 of FIG. 42.

FIG. 44 is a high-level flowchart including exemplary implementations of operation o11 of FIG. 42.

FIG. 45 is a high-level flowchart including exemplary implementations of operation o11 of FIG. 42.

FIG. 46 is a high-level flowchart including exemplary implementations of operation o11 of FIG. 42.

FIG. 47 is a high-level flowchart including exemplary implementations of operation o11 of FIG. 42.

FIG. 48 is a high-level flowchart including exemplary implementations of operation o11 of FIG. 42.

FIG. 49 is a high-level flowchart including exemplary implementations of operation o11 of FIG. 42.

FIG. 50 is a high-level flowchart including exemplary implementations of operation o11 of FIG. 42.

FIG. 51 is a high-level flowchart including exemplary implementations of operation o11 of FIG. 42.

FIG. 52 is a high-level flowchart including exemplary implementations of operation o11 of FIG. 42.

FIG. 53 is a high-level flowchart including exemplary implementations of operation o11 of FIG. 42.

FIG. 54 is a high-level flowchart including exemplary implementations of operation o11 of FIG. 42.

FIG. 55 is a high-level flowchart including exemplary implementations of operation o11 of FIG. 42.

FIG. 56 is a high-level flowchart including exemplary implementations of operation o11 of FIG. 42.

FIG. 57 is a high-level flowchart including exemplary implementations of operation o11 of FIG. 42.

FIG. 58 is a high-level flowchart including exemplary implementations of operation o11 of FIG. 42.

FIG. 59 is a high-level flowchart including exemplary implementations of operation o11 of FIG. 42.

FIG. 60 is a high-level flowchart including exemplary implementations of operation o11 of FIG. 42.

FIG. 61 is a high-level flowchart including exemplary implementations of operation o11 of FIG. 42.

FIG. 62 is a high-level flowchart including exemplary implementations of operation o11 of FIG. 42.

FIG. 63 is a high-level flowchart including exemplary implementations of operation o11 of FIG. 42.

FIG. 64 is a high-level flowchart including exemplary implementations of operation o11 of FIG. 42.

FIG. 65 is a high-level flowchart including exemplary implementations of operation o11 of FIG. 42.

FIG. 66 is a high-level flowchart including exemplary implementations of operation o11 of FIG. 42.

FIG. 67 is a high-level flowchart including exemplary implementations of operation o11 of FIG. 42.

FIG. 68 is a high-level flowchart including exemplary implementations of operation o11 of FIG. 42.

FIG. 69 is a high-level flowchart including exemplary implementations of operation o11 of FIG. 42.

FIG. 70 is a high-level flowchart including exemplary implementations of operation o12 of FIG. 42.

FIG. 71 is a high-level flowchart including exemplary implementations of operation o12 of FIG. 42.

FIG. 72 is a high-level flowchart including exemplary implementations of operation o12 of FIG. 42.

FIG. 73 is a high-level flowchart including exemplary implementations of operation o12 of FIG. 42.

FIG. 74 is a high-level flowchart including exemplary implementations of operation o12 of FIG. 42.

FIG. 75 is a high-level flowchart including exemplary implementations of operation o12 of FIG. 42.

FIG. 76 is a high-level flowchart including exemplary implementations of operation o12 of FIG. 42.

FIG. 77 is a high-level flowchart including exemplary implementations of operation o12 of FIG. 42.

FIG. 78 is a high-level flowchart including exemplary implementations of operation o12 of FIG. 42.

FIG. 79 is a high-level flowchart including exemplary implementations of operation o12 of FIG. 42.

FIG. 80 is a high-level flowchart including exemplary implementations of operation o12 of FIG. 42.

FIG. 81 is a high-level flowchart including exemplary implementations of operation o12 of FIG. 42.

FIG. 82 is a high-level flowchart including exemplary implementations of operation o12 of FIG. 42.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Generally, both commercial and consumer interests are becoming more concerned regarding origins of their food and other ingestible materials. Thus, tracking and testing systems to provide in depth information concerning provenance and other data associated with food and other ingestible materials including farming related production and other handling and processing can also be of interest.

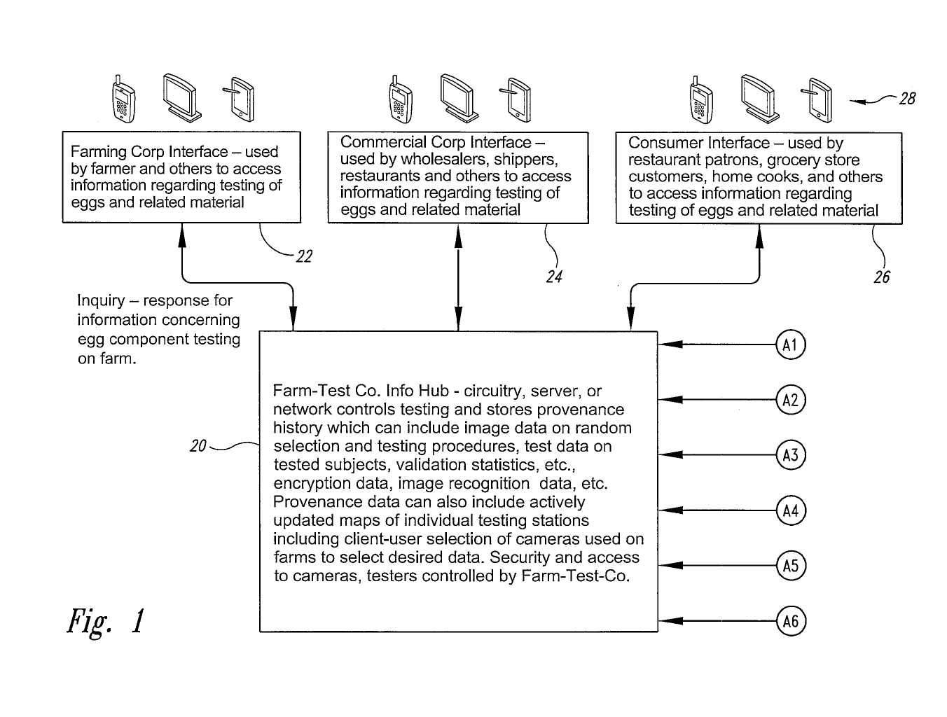

With reference now to the Figures, FIGS. 1-11 depict a schematic diagram of an environment(s) and/or an implementation(s) of technologies described herein. FIGS. 1-11 depict that including physical flows generally including indications as such by use of dashed arrows, the physical flows including that involving handling, testing, worker behavior, animal behavior, and other involvement of items, which can include feed, chicken, egg, carton, containers, transit, grocery store, receiving of containers, unpacking of cartons, shelving of cartons, shopping for cartons, in-store transit of cartons, purchase of carton, transit of carton to home, receiving carton at home, storage of carton at home, removal of egg and preparation of such, etc. Other physical flows are depicted to include transit of container to restaurant, receiving, unpacking, storage, etc. of container at restaurant, unpacking of egg and preparation of in dish, serving and purchasing of dish containing egg, etc. Physical flows are depicted to include testing of grain, chicken, egg, or other items.

FIGS. 1-11 depict that including information flows generally including indications as such by use of solid arrows, the information flows including image data sent from various imaging devices to information hubs, the image data including imaging of various stages of the physical flows. Information flows depicted also include inquiry-responses, initiating of devices, financial data, testing, etc. The information hubs are depicted to include those directed to information flows involving information obtained at farm, transit, restaurant, grocery, home or other locations. The information hubs are depicted to include interchange of information between each other. The information hubs are depicted to communicate with various interfaces to allow for communication therebetween by farming, commercial, restaurant, consumer and other interests. Information in information hubs can allow for research and other activities including determinations of compliance, noncompliance or s made during one or more physical flows. The examples depicted in FIGS. 1-11 are for illustrative purposes but are not intended to limit aspects to only these examples. Rather they serve to exemplify how data on food provenance and other ingestible material and other sorts of source data can be acquired through various tracking and testing for retrieval and inquiry through such as interfaces shown.

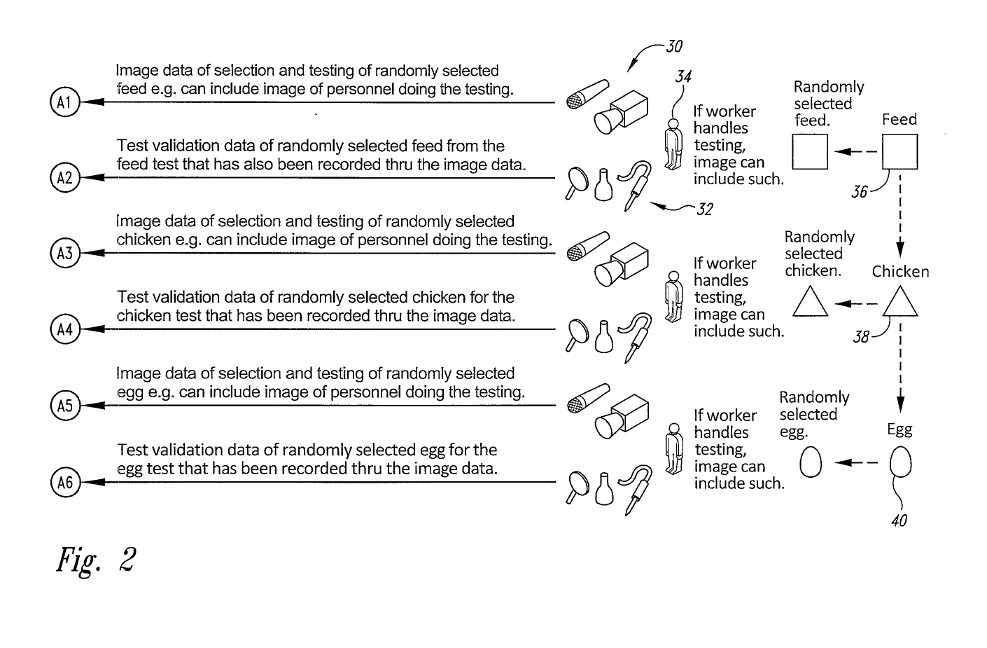

In particular, as shown in FIG. 1, interfaces 22, 24, and 26 are used to interact with Farm-Test Co. Info Hub 20 containing various information related to test of production factors and other items concerning one or more farming related production factors or other items. As shown in FIG. 2, production factors or ingestible material such as feed 36, chicken 38, and egg 40 can be monitored and tested through various sensors 30, 32 further described herein. Behavior of workers 34 can also be monitored.

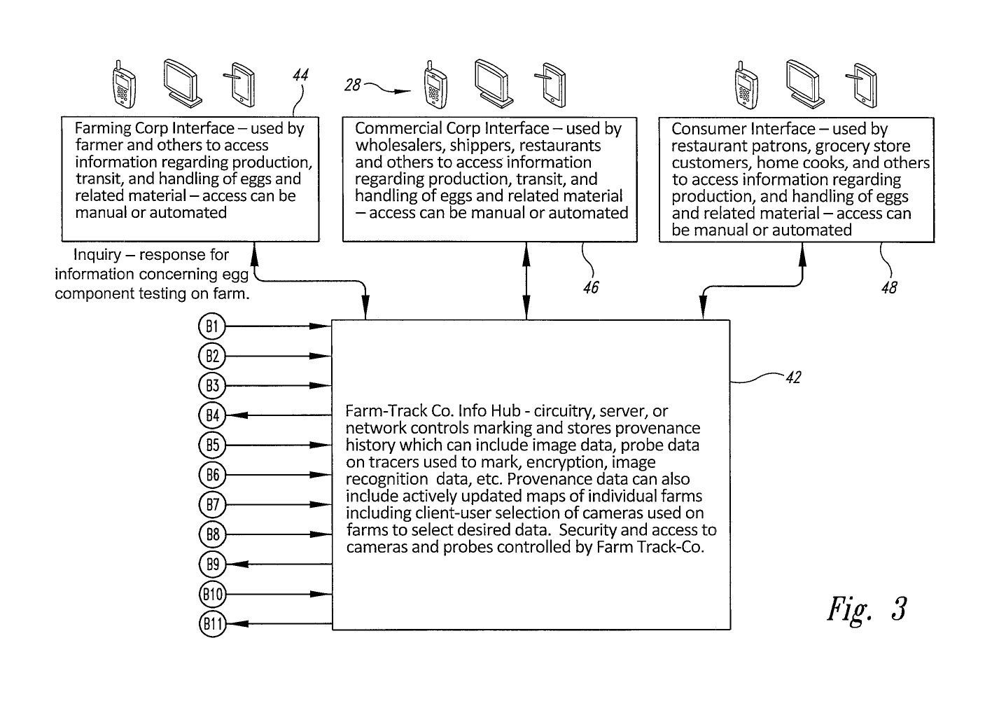

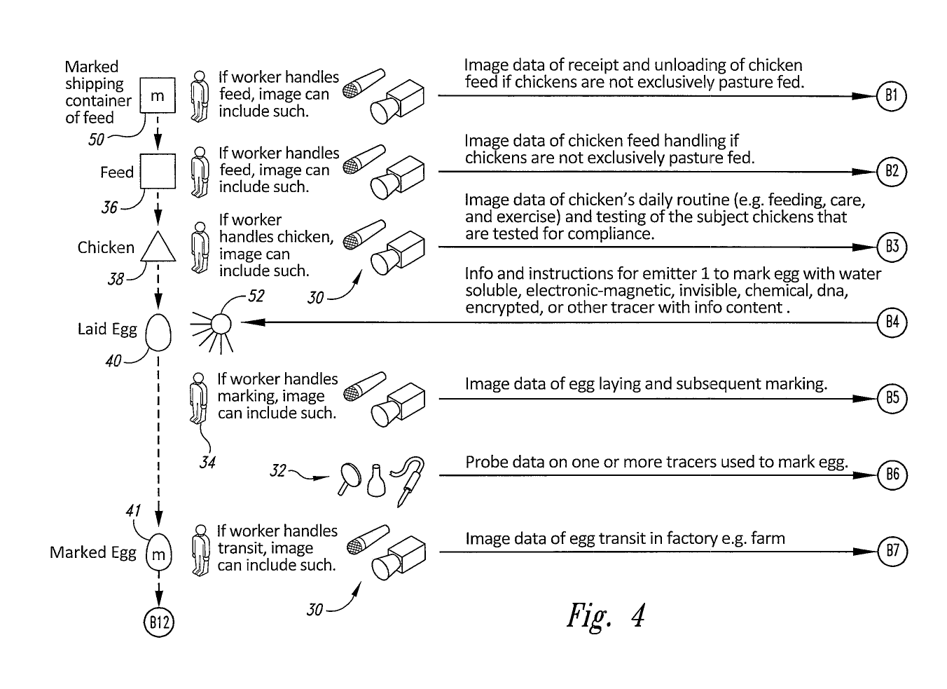

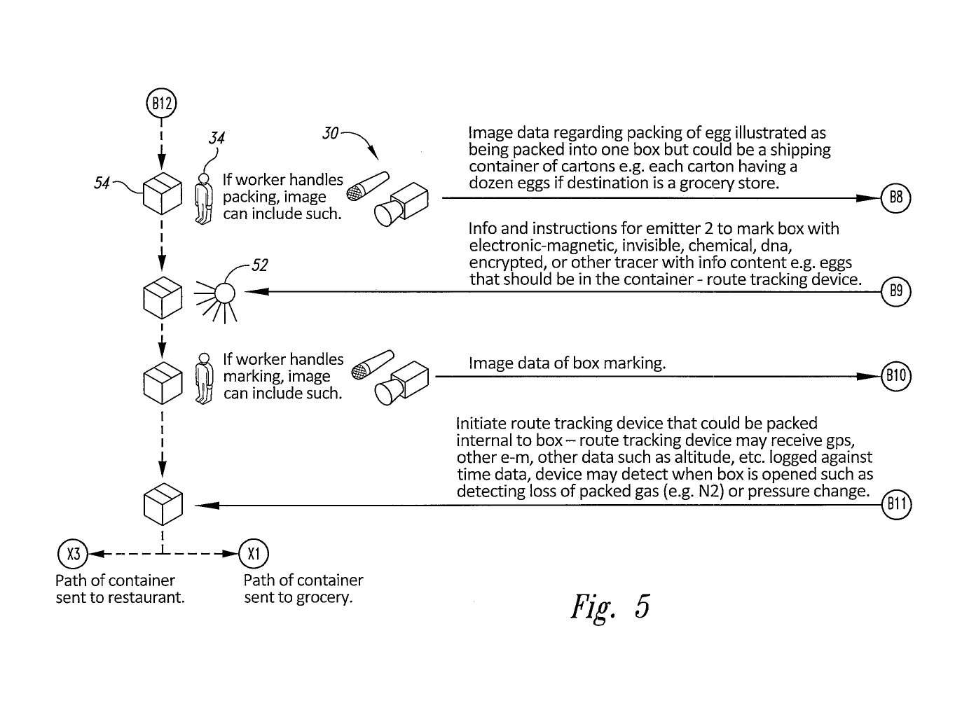

As shown in FIG. 3, interfaces 44, 46, and 48 are used to interact with Farm-Track Co. Info Hub 42 containing various information related to monitoring of production factors and other items concerning one or more farming related production factors or other items. As ingestible material is produced such as egg 40 later becoming marked egg 41 is packed, all such activity involved with such can also be monitored as shown in FIG. 4. The monitoring can be associated with tracers or other labels or marks and also identifiers or other identification information. These associations can be used to access monitoring or testing information through use of tracers and associated identifiers. The tracers can be located at least momentarily in proximity to ingestible material or other production factors to assist in accessing monitoring or testing information. Packing of ingestible material into shipping containers 54 such as shown in FIG. 5 can also be subject to monitoring and labeling of containers through emitters 52.

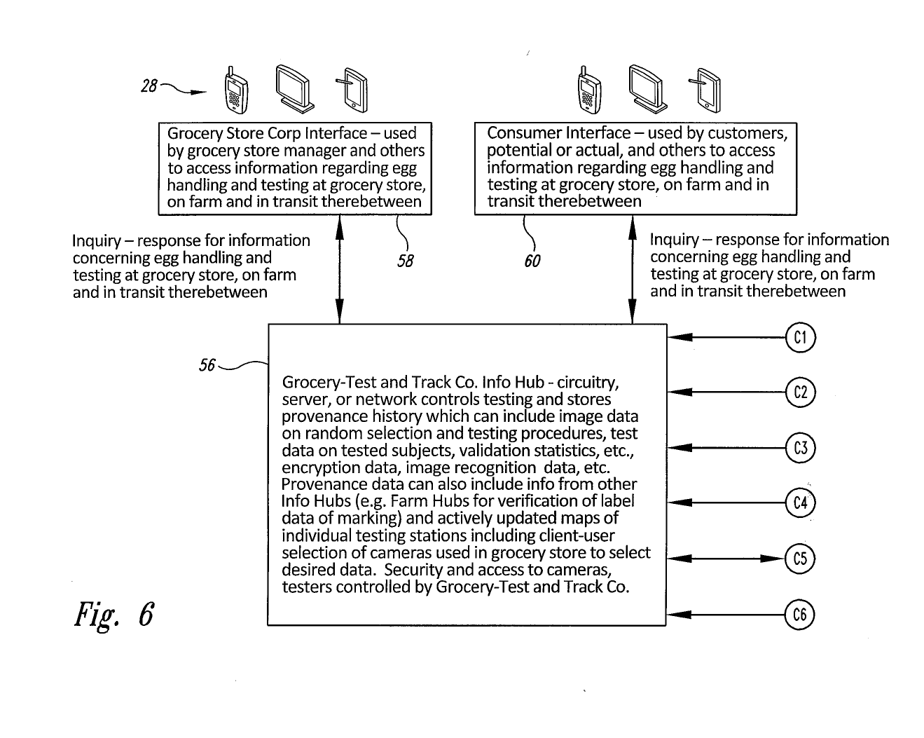

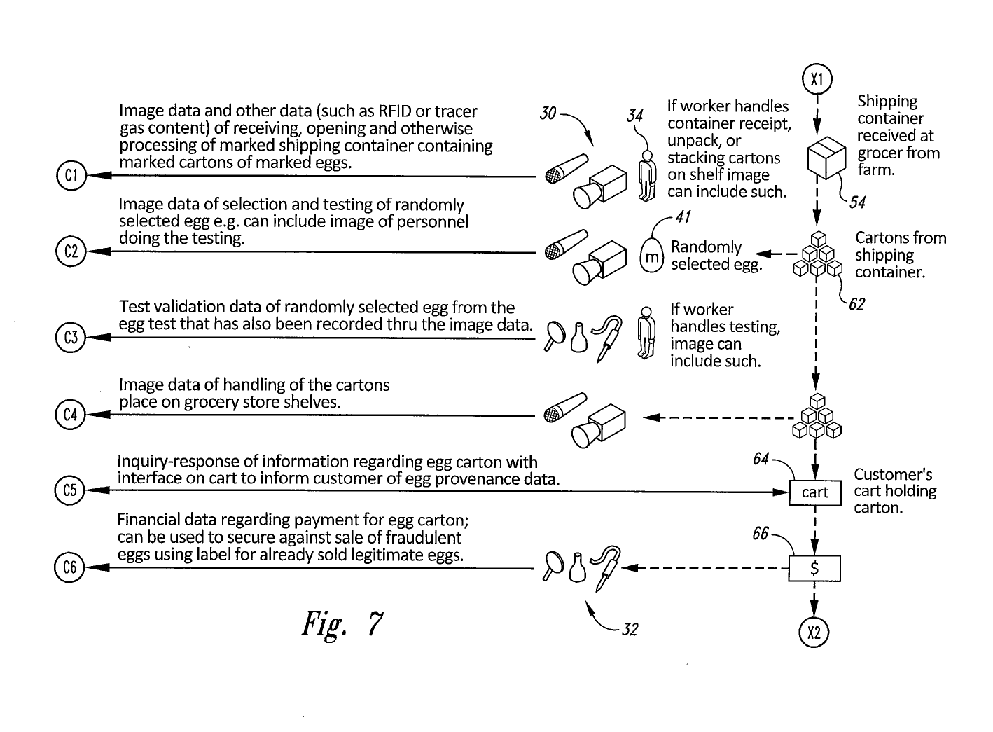

Further monitoring and testing can be performed at commercial locations with information stored on other information hubs such as grocery-test and track co info hub 56 as shown in FIG. 6. Monitoring of grocery activities, such as unpacking cartons 62, use of customer shopping carts 64, and purchase activity 66 shown in FIG. 7, can also be performed.

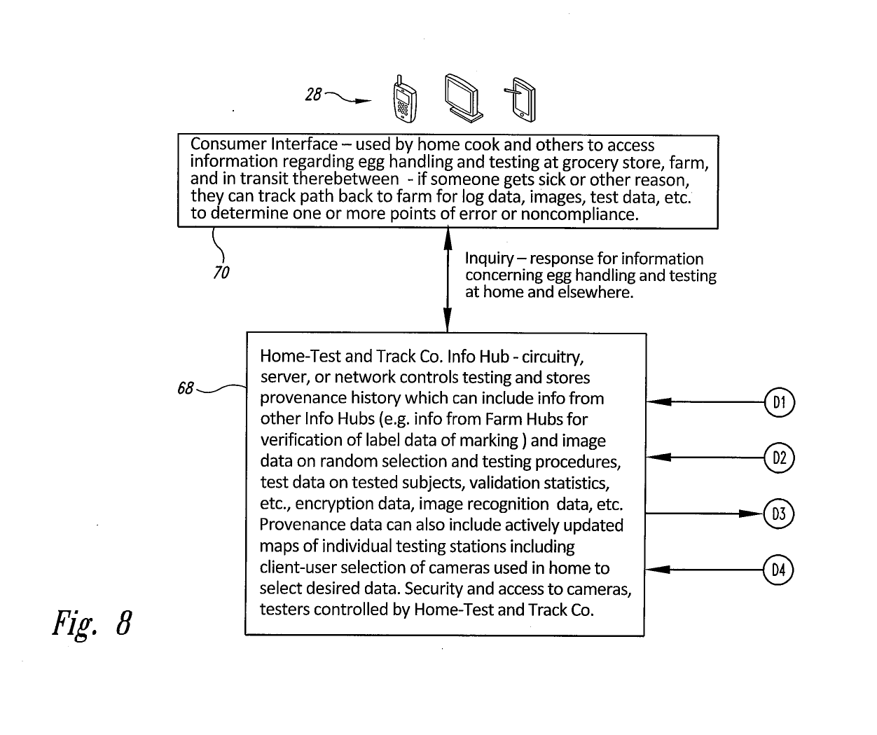

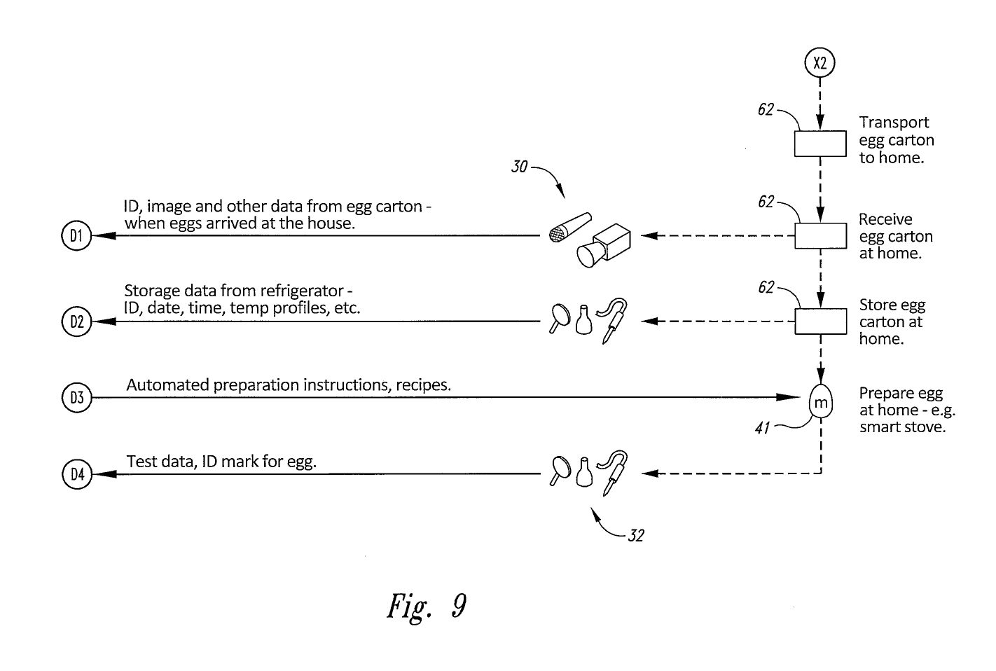

Monitoring, testing and accessing of data can be accomplished at home as well as depicted in FIG. 8 through use of a home-test track co. info hub 68 and consumer interfaces 28. Further illustrative home activities that can be monitored are shown in FIG. 9 to include transporting, receiving, storing and preparing ingestible material.

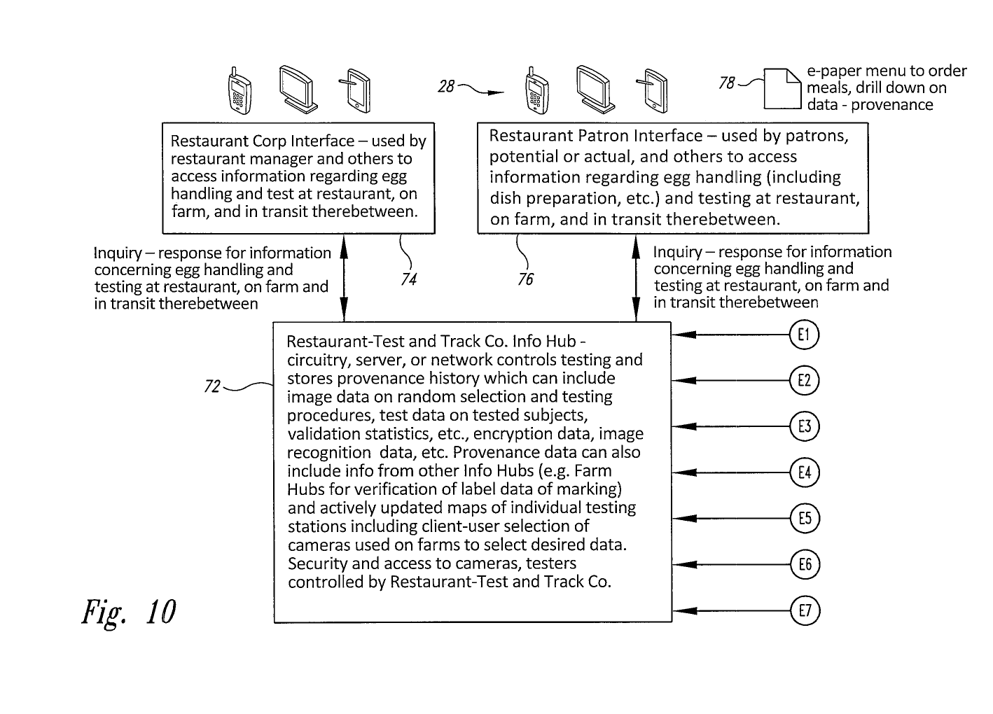

Other commercial venues for monitoring and testing can include restaurants as illustrated in FIG. 10 to include restaurant-test and track co. info hub 72 that can be used for storage and access of provenance data and also monitoring data of activities conducted at a restaurant. This data can be access by both restaurant personnel and restaurant patrons such as through interfaces 74, 76, and 78 to include menuing systems for the patrons.

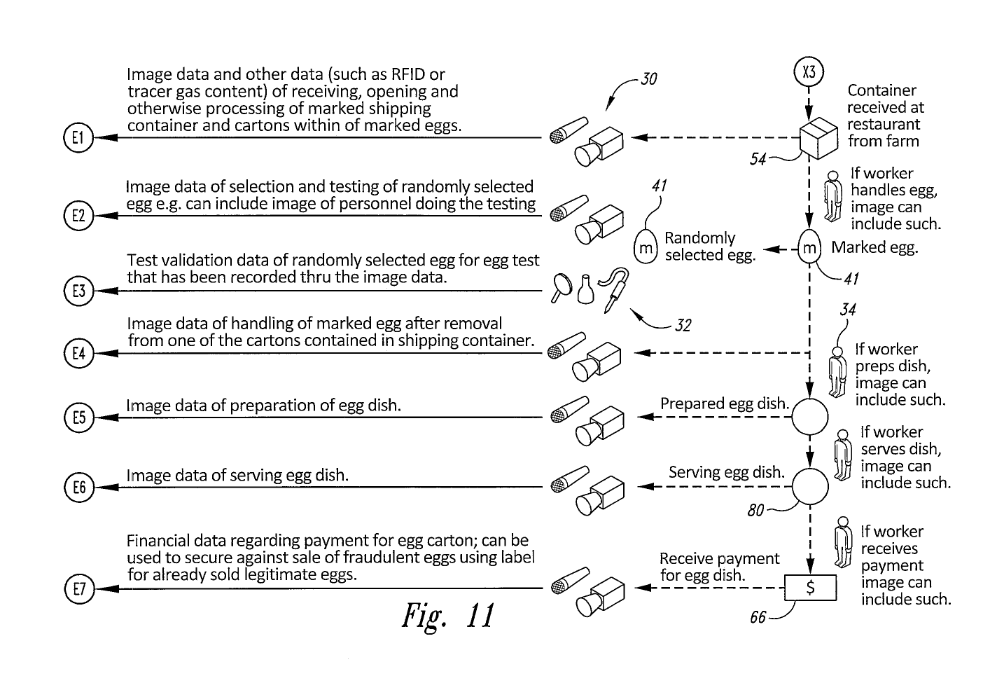

Activities conducted in a restaurant including those depicted in FIG. 11 such as receiving, handling, preparing, serving 80, and transacting payment can be included in monitoring and testing aspects to be stored on the restaurant-test and track co info hub 72 or elsewhere.

Various aspects embodied and illustrated through FIGS. 1-11 can be enumerated below and are provided to provide examples but are not intended to be limiting.

Food Supply Chain Automation
1. Feed (e.g. grain) Farm Track Information Hub
   a. receive fertilizer track and test hub information
   b. receive fertilizer container tracer information or fertilizer tracer information
   c. verify fertilizer container tracer information or fertilizer tracer information with fertilizer track hub information
   d. receive internal fertilizer container tracker information
   e. verify internal fertilizer container tracker information with fertilizer track hub information
   f. receive local fertilizer container handling audio-video and sensor information
   g. scan local fertilizer container handling audio-video and sensor information for error or noncompliance
   h. receive accounting information of production factor use for local fertilizer container handling
   i. correlate local fertilizer container handling audio-video and sensor information with accounting information of production factor use for local fertilizer container handling
   j. associate local fertilizer container handling audio-video and sensor information with fertilizer tracer information
   k. receive local fertilizer handling audio-video and sensor information
   l. scan local fertilizer handling audio-video and sensor information for error or noncompliance
   m. receive accounting information of production factor use for local fertilizer handling
   n. correlate local fertilizer behavior and handling audio-video and sensor information with accounting information of production factor use for local fertilizer handling
   o. associate local fertilizer handling audio-video and sensor information with animal tracer information
   p. receive local feed (grain) handling audio-video and sensor information
   q. associate local feed handling audio-video and sensor information with feed container tracer information or feed tracer information
   r. receive local grain field handling audio-video and sensor information
   s. scan local grain field handling audio-video and sensor information for error or noncompliance
   t. receive accounting information of production factor use for local grain field handling
   u. correlate local grain field handling audio-video and sensor information with accounting information of production factor use for local fertilizer handling
   v. associate local grain field handling audio-video and sensor information with animal tracer information
2. Animal (e.g. chicken) Farm Track and Test Information Hub
   a. receive feed track hub information
   b. receive feed container tracer information or feed tracer information
   c. verify feed container tracer information or feed tracer information with feed track hub information
   d. receive internal feed container tracker information
   e. verify internal feed container tracker information with feed track hub information
   f. receive local feed handling audio-video and sensor information
   g. associate local feed handling audio-video and sensor information with chicken tracer information
   h. scan local feed handling audio-video and sensor information for error or noncompliance
   i. receive accounting information of production factor use for local feed handling
   j. correlate local feed handling audio-video and sensor information with accounting information of production factor use for local feed handling
   k. send alert to initiate feed sample test event
   l. receive feed test sample tracer information
   m. verify feed test sample tracer information with egg track hub information
   n. receive feed test sample handling audio-video and sensor information
   o. associate feed test sample handing audio-video and sensor information with chicken tracer information
   p. scan feed test sample handling audio-video and sensor information for error or noncompliance
   q. receive accounting information of production factor use for feed test sample handling
   r. correlate feed test sample handling audio-video and sensor information with accounting information of production factor use for feed test sample handling
   s. receive test results for feed test sample
   t. associate test results for feed test sample with feed test sample tracer information
   u. update feed (grain) farm track information hub re butchered chicken portion test sample testing
   v. receive local chicken behavior and handling audio-video and sensor information
   w. associate local chicken behavior and handling audio-video and sensor information with chicken tracer information
   x. scan local chicken behavior and handling audio-video and sensor information for error or noncompliance
   y. receive accounting information of production factor use for local chicken behavior and handling
   z. correlate local chicken behavior and handling audio-video and sensor information with accounting information of production factor use for local chicken behavior and handling
   aa. send alert to initiate chicken sample test event
   bb. receive chicken test sample tracer information
   cc. verify chicken test sample tracer information with egg track hub information
   dd. receive chicken test sample handling audio-video and sensor information
   ee. associate chicken test sample handing audio-video and sensor information with chicken tracer information
   ff. scan chicken test sample handling audio-video and sensor information for error or noncompliance
   gg. receive accounting information of production factor use for chicken test sample handling
   hh. correlate chicken test sample handling audio-video and sensor information with accounting information of production factor use for chicken test sample handling
   ii. receive test results for chicken test sample
   jj. associate test results for chicken test sample with chicken test sample tracer information
   kk. update feed (grain) farm track information hub re chicken test sample testing
   ll. scan chicken behavior and handling audio-video and sensor information to determine egg was laid
   mm. instruct emitter to mark laid egg with egg tracer(s) upon determining egg was laid
   nn. receive local egg marking audio-video and sensor information
   oo. scan local egg marking audio-video and sensor information for error or noncompliance
   pp. receive accounting information of production factor use for local egg marking
   qq. correlate local egg marking audio-video and sensor information with accounting information of production factor use for local egg marking
   rr. associate audio-video and sensor information of egg marking with egg tracer information
   ss. associate egg tracer information with tracer information of chicken that laid egg
   tt. receive local egg handling audio-video and sensor information
   uu. scan local egg handling audio-video and sensor information for error or noncompliance
   vv. receive accounting information of production factor use for local egg handling correlate local egg handling audio-video and sensor information with accounting information of production factor use for local egg handling associate local egg handling audio-video and sensor information with egg tracer information
   ww. send alert to initiate egg sample test event
   xx. receive egg test sample tracer information
   yy. verify egg test sample tracer information with egg track hub information
   zz. receive egg test sample handling audio-video and sensor information
   aaa. associate egg test sample handing audio-video and sensor information with chicken tracer information
   bbb. scan egg test sample handling audio-video and sensor information for error or noncompliance
   ccc. receive accounting information of production factor use for egg test sample handling
   ddd. correlate egg test sample handling audio-video and sensor information with accounting information of production factor use for egg test sample handling
   eee. receive test results for egg test sample
   fff. associate test results for egg test sample with egg test sample tracer information
   ggg. update feed (grain) farm track information hub re egg test sample testing
   hhh. receive local egg hatching into hatched chicken audio-video and sensor information
   iii. scan local egg hatching into hatched audio-video and sensor information for error or noncompliance
   jjj. receive accounting information of production factor use for local egg hatching into hatched chicken
   kkk. correlate local egg hatching audio-video and sensor information with accounting information of production factor use for local egg hatching into hatched chicken
   lll. associate local egg hatching into hatched chicken audio-video and sensor information with egg tracer information
   mmm. send alert to initiate hatched chicken sample test event
   nnn. receive hatched chicken test sample tracer information
   ooo. verify hatched chicken test sample tracer information with egg track hub information
   ppp. receive hatched chicken test sample handling audio-video and sensor information
   qqq. associate hatched chicken test sample handing audio-video and sensor information with chicken tracer information
   rrr. scan hatched chicken test sample handling audio-video and sensor information for error or noncompliance
   sss. receive accounting information of production factor use for hatched chicken test sample handling
   ttt. correlate hatched chicken test sample handling audio-video and sensor information with accounting information of production factor use for hatched chicken test sample handling
   uuu. receive test results for hatched chicken test sample
   vvv. associate test results for hatched chicken test sample with hatched chicken test sample tracer information
   www. update feed (grain) farm track information hub re hatched chicken test sample testing
   xxx. instruct emitter to mark local hatched chicken with hatched chicken tracer(s)
   yyy. receive local hatched chicken marking audio-video and sensor information
   zzz. scan local hatched chicken marking audio-video and sensor information for error or noncompliance
   aaaa. receive accounting information of production factor use for local hatched chicken marking
   bbbb. correlate local hatched chicken marking audio-video and sensor information with accounting information of production factor use for local hatched chicken marking
   cccc. associate local hatched chicken audio-video and sensor information with local hatched chicken tracer information
   dddd. receive local hatched chicken behavior audio-video and sensor information
   eeee. scan local hatched chicken behavior audio-video and sensor information for error or noncompliance
   ffff. receive accounting information of production factor use for local hatched chicken behavior
   gggg. correlate local hatched chicken behavior audio-video and sensor information with accounting information of production factor use for local hatched chicken behavior
   hhhh. associate local hatched chicken behavior audio-video and sensor information with local hatched chicken tracer information
   iiii. send alert to initiate hatched chicken sample test event
   jjjj. receive hatched chicken test sample tracer information
   kkkk. verify hatched chicken test sample tracer information with egg track hub information
   llll. receive hatched chicken test sample handling audio-video and sensor information
   mmmm. associate hatched chicken test sample handing audio-video and sensor information with chicken tracer information
   nnnn. scan hatched chicken test sample handling audio-video and sensor information for error or noncompliance
   oooo. receive accounting information of production factor use for hatched chicken test sample handling
   pppp. correlate hatched chicken test sample handling audio-video and sensor information with accounting information of production factor use for hatched chicken test sample handling
   qqqq. receive test results for hatched chicken test sample
   rrrr. associate test results for hatched chicken test sample with hatched chicken test sample tracer information
   ssss. update feed (grain) farm track information hub re hatched chicken test sample testing
   tttt. scan handling and behavior of local hatched chicken to determine when slaughter of local hatched chicken occurs
   uuuu. scan handling of slaughter of local hatched chicken for error or non-compliance
   vvvv. receive accounting information of production factor use for slaughter of local hatched chicken
   wwww. correlate slaughter of local hatched chicken behavior audio-video and sensor information with accounting information of production factor use for slaughter of local hatched chicken
   xxxx. associate slaughter of local hatched chicken audio-video and sensor information with local hatched chicken tracer information
   yyyy. scan handling and behavior of local hatched chicken to determine when butcher of local hatched chicken occurs
   zzzz. scan handling of butcher of local hatched chicken for error or non-compliance
   aaaaa. receive accounting information of production factor use for butcher of local hatched chicken
   bbbbb. correlate butcher of local hatched chicken audio-video and sensor information with accounting information of production factor use for butcher of local hatched chicken
   ccccc. associate butcher of local hatched chicken audio-video and sensor information with local hatched chicken tracer
   ddddd. instruct emitter to mark each portion of butchered chicken with chicken portion tracer(s)
   eeeee. receive butchered chicken portion marking audio-video and sensor information
   fffff. scan butchered chicken portion marking audio-video and sensor information for error or noncompliance
   ggggg. receive accounting information of production factor use for butchered chicken portion marking
   hhhhh. correlate butchered chicken portion marking audio-video and sensor information with accounting information of production factor use for butchered chicken portion marking
   iiiii. associate butchered chicken portion marking audio-video and sensor information with butchered chicken portion tracer information
   jjjjj. send alert to initiate butchered chicken portion sample test event
   kkkkk. receive butchered chicken portion test sample tracer information
   lllll. verify butchered chicken portion test sample tracer information with egg track hub information
   mmmmm. receive butchered chicken portion test sample handling audio-video and sensor information
   nnnnn. associate butchered chicken portion test sample handing audio-video and sensor information with chicken tracer information
   ooooo. scan butchered chicken portion test sample handling audio-video and sensor information for error or noncompliance
   ppppp. receive accounting information of production factor use for butchered chicken portion test sample handling
   qqqqq. correlate butchered chicken portion test sample handling audio-video and sensor information with accounting information of production factor use for butchered chicken portion test sample handling
   rrrrr. receive test results for butchered chicken portion test sample
   sssss. associate test results for butchered chicken portion test sample with butchered chicken portion test sample tracer information
   ttttt. update feed (grain) farm track information hub re butchered chicken portion test sample testing
   uuuuu. receive local packing butchered chicken portion into butchered chicken portion carton audio-video and sensor information
   vvvvv. scan local packing butchered chicken portion into butchered chicken portion carton handling audio-video and sensor information for error or noncompliance
   wwwww. receive accounting information of production factor use for local packing butchered chicken portion into butchered chicken portion carton
   xxxxx. correlate local packing butchered chicken portion into butchered chicken portion carton handling audio-video and sensor information with accounting information of production factor use for local packing butchered chicken portion into butchered chicken portion carton
   yyyyy. associate local packing butchered chicken portion into butchered chicken portion carton audio-video and sensor information with butchered chicken portion tracer information
   zzzzz. instruct emitter to mark butchered chicken portion carton with butchered chicken portion carton tracer(s)
   aaaaaa. receive local butchered chicken portion carton marking audio-video and sensor information
   bbbbbb. scan local butchered chicken portion carton marking audio-video and sensor information for error or noncompliance
   cccccc. receive accounting information of production factor use for local butchered chicken portion carton marking
   dddddd. correlate local butchered chicken portion carton marking audio-video and sensor information with accounting information of production factor use for local butchered chicken portion carton marking
   eeeeee. associate butchered chicken portion carton marking audio-video and sensor information with butchered chicken portion carton tracer information
   ffffff. receive local packing butchered chicken portion carton into carton container audio-video and sensor information
   gggggg. scan local packing butchered chicken portion carton into carton container audio-video and sensor information for error or noncompliance
   hhhhhh. receive accounting information of production factor use for local packing butchered chicken portion carton into carton container
   iiiiii. correlate local packing butchered chicken portion carton into carton container audio-video and sensor information with accounting information of production factor use for local packing butchered chicken portion carton into carton container
   jjjjjj. associate local packing butchered chicken portion carton into carton container audio-video and sensor information with carton container tracer information
   kkkkkk. instruct emitter to mark carton container with carton container tracer(s)
   llllll. receive local carton container marking audio-video and sensor information
   mmmmmm. scan local carton container marking audio-video and sensor information for error or noncompliance
   nnnnnn. receive accounting information of production factor use for local carton container marking
   oooooo. correlate local carton container marking audio-video and sensor information with accounting information of production factor use for local carton container marking
   pppppp. associate local carton container marking audio-video and sensor information with carton container tracer information
3. Egg Farm Track Information Hub
   a. receive feed track hub information
   b. receive feed container tracer information or feed tracer information
   c. verify feed container tracer information or feed tracer information with feed track hub information
   d. receive internal feed container tracker information
   e. verify internal feed container tracker information with feed track hub information
   f. receive local feed handling audio-video and sensor information
   g. associate local feed handling audio-video and sensor information with chicken tracer information
   h. scan local feed handling audio-video and sensor information for error or noncompliance
   i. receive accounting information of production factor use for local feed handling
   j. correlate local feed handling audio-video and sensor information with accounting information of production factor use for local feed handling
   k. receive chicken track hub information
   l. receive chicken container tracer information or chicken tracer information
   m. verify chicken container tracer information or chicken tracer information with chicken track hub information
   n. receive internal chicken container tracker information
   o. verify internal chicken container tracker information with chicken track hub information
   p. receive local chicken behavior and handling audio-video and sensor information
   q. associate local chicken behavior and handling audio-video and sensor information with chicken tracer information
   r. scan local chicken behavior and handling audio-video and sensor information for error or noncompliance
   s. receive accounting information of production factor use for local chicken behavior and handling
   t. correlate local chicken behavior and handling audio-video and sensor information with accounting information of production factor use for local chicken behavior and handling
   u. scan chicken behavior and handling audio-video and sensor information to determine egg was laid
   v. instruct emitter to mark laid egg with egg tracer(s) upon determining egg was laid
   w. receive local egg marking audio-video and sensor information
   x. scan local egg marking audio-video and sensor information for error or noncompliance
   y. receive accounting information of production factor use for local egg marking
   z. correlate local egg marking audio-video and sensor information with accounting information of production factor use for local egg marking
   aa. associate audio-video and sensor information of egg marking with egg tracer information
   bb. associate egg tracer information with tracer information of chicken that laid egg
   cc. receive local egg handling (includes marking) audio-video and sensor information
   dd. scan local egg handling audio-video and sensor information for error or noncompliance
   ee. receive accounting information of production factor use for local egg handling
   ff. correlate local egg handling audio-video and sensor information with accounting information of production factor use for local egg handling
   gg. associate local egg handling audio-video and sensor information with egg tracer information
   hh. receive local packing egg into egg carton audio-video and sensor information
   ii. scan local packing egg into egg carton handling audio-video and sensor information for error or noncompliance
   jj. receive accounting information of production factor use for local packing egg into egg carton
   kk. correlate local packing egg into egg carton handling audio-video and sensor information with accounting information of production factor use for local packing egg into egg carton
   ll. associate local packing egg into egg carton audio-video and sensor information with egg tracer information
   mm. instruct emitter to mark egg carton with egg carton tracer(s)
   nn. receive local egg carton marking audio-video and sensor information
   oo. scan local egg carton marking audio-video and sensor information for error or noncompliance
   pp. receive accounting information of production factor use for local egg carton marking
   qq. correlate local egg carton marking audio-video and sensor information with accounting information of production factor use for local egg carton marking
   rr. associate egg carton marking audio-video and sensor information with egg carton tracer information
   ss. receive local egg carton handling audio-video and sensor handling information
   tt. scan local egg carton handling audio-video and sensor information for error or noncompliance
   uu. receive accounting information of production factor use for local egg carton handling
   vv. correlate local egg carton handling audio-video and sensor information with accounting information of production factor use for local egg carton handling
   ww. associate local egg carton handling audio-video and sensor information with egg carton tracer information
   xx. associate carton tracer information with egg tracer information
   yy. receive local packing egg carton into carton container audio-video and sensor information
   zz. scan local packing egg carton into carton container audio-video and sensor information for error or noncompliance
   aaa. receive accounting information of production factor use for local packing egg carton into carton container
   bbb. correlate local packing egg carton into carton container audio-video and sensor information with accounting information of production factor use for local packing egg carton into carton container
   ccc. associate local packing egg carton into carton container audio-video and sensor information with carton container tracer information
   ddd. instruct emitter to mark carton container with carton container tracer(s)
   eee. receive local carton container marking audio-video and sensor information
   fff. scan local carton container marking audio-video and sensor information for error or noncompliance
   ggg. receive accounting information of production factor use for local carton container marking
   hhh. correlate local carton container marking audio-video and sensor information with accounting information of production factor use for local carton container marking
   iii. associate local carton container marking audio-video and sensor information with carton container tracer information
   jjj. receive local carton container handling audio-video and sensor information
   kkk. scan local carton container handling audio-video and sensor information for error or noncompliance
   lll. receive accounting information of production factor use for local carton container handling
   mmm. correlate local carton container handling audio-video and sensor information with accounting information of production factor use for local carton container handling
   nnn. associate carton container handling audio-video and sensor information with carton container tracer information
   ooo. associate carton container tracer information with egg carton tracer information
   ppp. initiate tracker placed internally in carton container during packing thereof
   qqq. receive egg test hub information
4. Egg Farm Test Information Hub
   a. receive egg track hub information
   b. send alert to initiate local feed sample test event
   c. receive local feed test sample tracer information
   d. verify local feed test sample tracer information with egg track hub information
   e. receive local feed test sample handling audio-video and sensor information
   f. associate local feed test sample handing audio-video and sensor information with local feed test sample tracer information
   g. scan local feed test sample handling audio-video and sensor information for error or noncompliance
   h. receive accounting information of production factor use for local feed test sample handling
   i. correlate local feed test sample handling audio-video and sensor information with accounting information of production factor use for local feed test sample handling
   j. receive test results for local feed test sample
   k. associate test results for local feed test sample with local feed test sample tracer information
   l. update egg farm track information hub re local feed test sample testing
   m. update chicken farm track information hub re local feed test sample testing
   n. update feed (grain) farm track information hub re local feed test sample testing
   o. send alert to initiate local chicken sample test event
   p. receive local chicken test sample tracer information
   q. verify local chicken test sample tracer information with egg track hub information
   r. receive local chicken test sample handling audio-video and sensor information
   s. associate local chicken test sample handing audio-video and sensor information with chicken tracer information
   t. scan local chicken test sample handling audio-video and sensor information for error or noncompliance
   u. receive accounting information of production factor use for local chicken test sample handling
   v. correlate local chicken test sample handling audio-video and sensor information with accounting information of production factor use for local chicken test sample handling
   w. receive test results for local chicken test sample
   x. associate test results for local chicken test sample with local chicken test sample tracer information
   y. update egg farm track information hub re local chicken test sample testing
   z. update chicken farm track information hub re local chicken test sample testing
   aa. update feed (grain) farm track information hub re local chicken test sample testing
   bb. receive local egg test sample tracer information
   cc. verify local egg test sample tracer information with egg track hub information
   dd. receive local egg test sample handling audio-video and sensor information
   ee. associate local egg test sample handing audio-video and sensor information with egg tracer information
   ff. scan local egg test sample handling audio-video and sensor information for error or noncompliance
   gg. receive accounting information of production factor use for local egg test sample handling
   hh. correlate local egg test sample handling audio-video and sensor information with accounting information of production factor use for local egg test sample handling
   ii. receive test results for local egg test sample
   jj. associate test results for local egg test sample with local egg test sample tracer information
   kk. update egg farm track information hub re local egg test sample testing
   ll. update chicken farm track information hub re local egg test sample testing
   mm. update feed (grain) farm track information hub re local egg test sample testing
5. Restaurant Test and Track Information Hub
   a. receive egg farm track hub information
   b. receive egg farm test hub information
   c. receive carton container tracer information
   d. verify carton container tracer information with egg track hub information
   e. receive internal carton container tracker information
   f. verify internal carton container tracker information with egg track hub information
   g. receive local carton container handling audio-video and sensor information
   h. scan local carton container handling audio-video and sensor information for error or noncompliance
   i. receive accounting information of production factor use for local carton container handling
   j. correlate local carton container handling audio-video and sensor information with accounting information of production factor use for local carton container handling
   k. associate local handling of carton container audio-video and sensor information with carton container tracer information
   l. receive local egg carton handling audio-video and sensor information
   m. scan local egg carton handling audio-video and sensor information for error or noncompliance
   n. receive accounting information of production factor use for local egg carton handling
   o. correlate local egg carton handling audio-video and sensor information with accounting information of production factor use for local egg carton handling
   p. associate local egg carton handling audio-video and sensor information with egg carton tracer information
   q. receive local egg handling audio-video and sensor information
   r. scan local egg handling audio-video and sensor information for error or noncompliance
   s. receive accounting information of production factor use for local egg handling
   t. correlate local egg handling audio-video and sensor information with accounting information of production factor use for local egg handling
   u. associate local egg handling audio-video and sensor information with egg tracer information
   v. send alert to initiate local egg sample test event
   w. receive local egg test sample tracer information
   x. verify local egg test sample tracer information with egg track hub information
   y. receive local egg test sample handling audio-video and sensor information
   z. associate local egg test sample handing audio-video and sensor information with egg tracer information
   aa. scan local egg test sample handling audio-video and sensor information for error or noncompliance
   bb. receive accounting information of production factor use for local egg test sample handling
   cc. correlate local egg test sample handling audio-video and sensor information with accounting information of production factor use for local egg test sample handling
   dd. receive test results for local egg test sample
   ee. associate test results for local egg test sample with local egg test sample tracer information
   ff. update egg farm track information hub re local egg test sample testing
   gg. update chicken farm track information hub re local egg test sample testing
   hh. update feed (grain) farm track information hub re local egg test sample testing
   ii. receive local egg dish preparation audio-video and sensor information
   jj. scan local egg dish preparation audio-video and sensor information for error or noncompliance
   kk. receive accounting information of production factor use for local egg dish preparation
   ll. correlate local egg dish preparation audio-video and sensor information with accounting information of production factor use for local egg dish preparation
   mm. associate local egg dish preparation audio-video and sensor information with egg tracer information
   nn. receive local egg dish serving audio-video and sensor information
   oo. scan local egg dish serving audio-video and sensor information for error or noncompliance
   pp. receive accounting information of production factor use for local egg dish serving
   qq. correlate local egg dish serving audio-video and sensor information with accounting information of production factor use for local egg dish serving
   rr. associate local egg dish serving audio-video and sensor information with egg tracer information
   ss. receive local egg dish payment audio-video and sensor information
   tt. scan local egg dish payment audio-video and sensor information for error or noncompliance
   uu. receive accounting information of production factor use for local egg dish payment
   vv. correlate local egg dish payment audio-video and sensor information with accounting information of production factor use for local egg dish payment
   ww. associate local egg dish payment audio-video and sensor information with egg tracer information
6. Grocery Test and Track Information Hub
   a. receive egg farm track hub information
   b. receive egg farm test hub information
   c. receive carton container tracer information
   d. verify carton container tracer information with egg track hub information
   e. receive internal carton container tracker information
   f. verify internal carton container tracker information with egg track hub information
   g. receive local carton container handling audio-video and sensor information
   h. scan local carton container handling audio-video and sensor information for error or noncompliance
   i. receive accounting information of production factor use for local carton container handling
   j. correlate local carton container handling audio-video and sensor information with accounting information of production factor use for local carton container handling
   k. associate local handling of carton container audio-video and sensor information with carton container tracer information
   l. receive local egg carton handling audio-video and sensor information
   m. scan local egg carton handling audio-video and sensor information for error or noncompliance
   n. receive accounting information of production factor use for local egg carton handling
   o. correlate local egg carton handling audio-video and sensor information with accounting information of production factor use for local egg carton handling
   p. associate local egg carton handling audio-video and sensor information with egg carton tracer information
   q. send alert to initiate local egg sample test event
   r. receive local egg test sample tracer information
   s. verify local egg test sample tracer information with egg track hub information
   t. receive local egg test sample handling audio-video and sensor information
   u. associate local egg test sample handing audio-video and sensor information with egg tracer information
   v. scan local egg test sample handling audio-video and sensor information for error or noncompliance
   w. receive accounting information of production factor use for local egg test sample handling
   x. correlate local egg test sample handling audio-video and sensor information with accounting information of production factor use for local egg test sample handling
   y. receive test results for local egg test sample
   z. associate test results for local egg test sample with local egg test sample tracer information
   aa. update egg farm track information hub re local egg test sample testing
   bb. update chicken farm track information hub re local egg test sample testing
   cc. update feed (grain) farm track information hub re local egg test sample testing
   dd. receive local egg carton payment audio-video and sensor information
   ee. scan local egg carton payment audio-video and sensor information for error or noncompliance
   ff. receive accounting information of production factor use for local egg carton payment
   gg. correlate local egg carton payment audio-video and sensor information with accounting information of production factor use for local egg carton payment
   hh. associate local egg carton payment audio-video and sensor information with egg carton tracer information
7. Home Test and Track Information Hub
   a. receive grocery test and track hub information
   b. receive egg carton tracer information
   c. verify egg carton tracer information with egg track hub information
   d. receive internal carton container tracker information
   e. verify internal carton container tracker information with egg track hub information
   f. receive local egg carton handling audio-video and sensor information
   g. scan local egg carton handling audio-video and sensor information for error or noncompliance
   h. receive accounting information of production factor use for local egg carton handling
   i. correlate local egg carton handling audio-video and sensor information with accounting information of production factor use for local egg carton handling
   j. associate local egg carton handling audio-video and sensor information with egg carton tracer information
   k. receive local egg handling audio-video and sensor information
   l. scan local egg handling audio-video and sensor information for error or noncompliance
   m. receive accounting information of production factor use for local egg handling
   n. correlate local egg handling audio-video and sensor information with accounting information of production factor use for local egg handling
   o. associate local egg handling audio-video and sensor information with egg tracer information
   p. send alert to initiate local egg sample test event
   q. receive local egg test sample tracer information
   r. verify local egg test sample tracer information with egg track hub information
   s. receive local egg test sample handling audio-video and sensor information
   t. associate local egg test sample handing audio-video and sensor information with egg tracer information
   u. scan local egg test sample handling audio-video and sensor information for error or noncompliance
   v. receive accounting information of production factor use for local egg test sample handling
   w. correlate local egg test sample handling audio-video and sensor information with accounting information of production factor use for local egg test sample handling
   x. receive test results for local egg test sample
   y. associate test results for local egg test sample with local egg test sample tracer information
   z. update grocery track information hub re local egg test sample testing
   aa. update egg farm track information hub re local egg test sample testing
   bb. update chicken farm track information hub re local egg test sample testing
   cc. update feed (grain) farm track information hub re local egg test sample testing
   dd. receive local egg dish preparation audio-video and sensor information
   ee. scan local egg dish preparation audio-video and sensor information for error or noncompliance
   ff. receive accounting information of production factor use for local egg dish preparation
   gg. correlate local egg dish preparation audio-video and sensor information with accounting information of production factor use for local egg dish preparation
   hh. associate local egg dish preparation audio-video and sensor information with egg tracer information
   ii. receive local egg dish serving audio-video and sensor information
   jj. scan local egg dish serving audio-video and sensor information for error or noncompliance
   kk. receive accounting information of production factor use for local egg dish serving
   ll. correlate local egg dish serving audio-video and sensor information with accounting information of production factor use for local egg dish serving
   mm. associate local egg dish serving audio-video and sensor information with egg tracer information

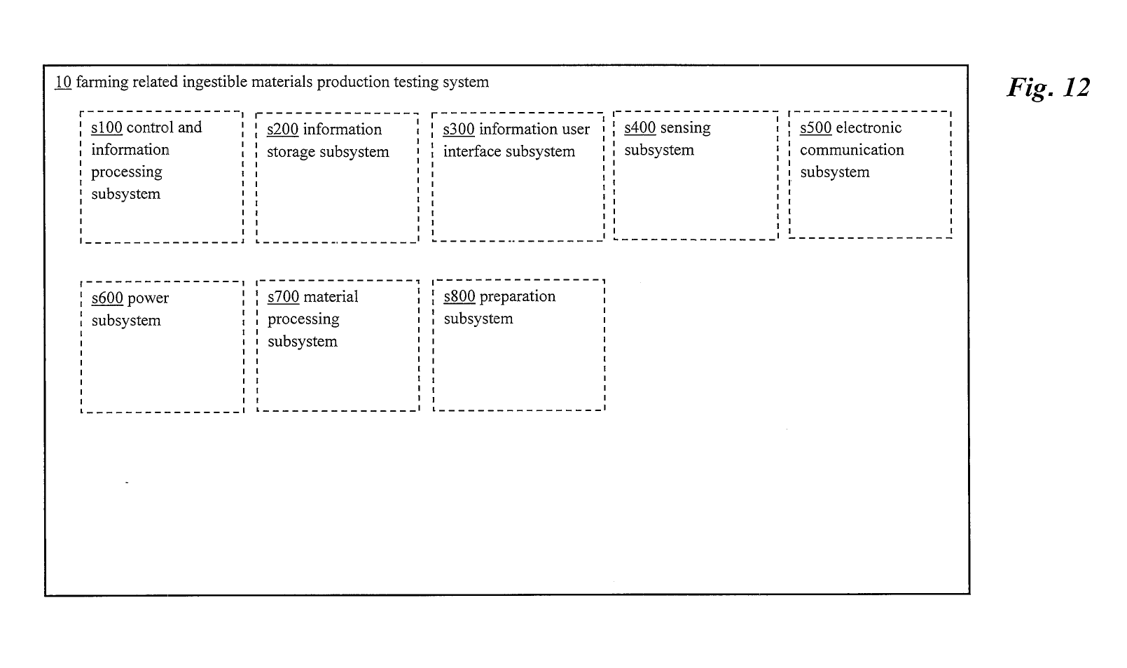

An exemplary version of the farming related ingestible materials production testing system 10 is shown in FIG. 12 to optionally include various subsystems such as control and information processing subsystem s100, information storage subsystem s200, information user interface subsystem s300, sensing subsystem s400, electronic communication subsystem s500, power subsystem s600, material processing subsystem s700, and preparation subsystem s800.

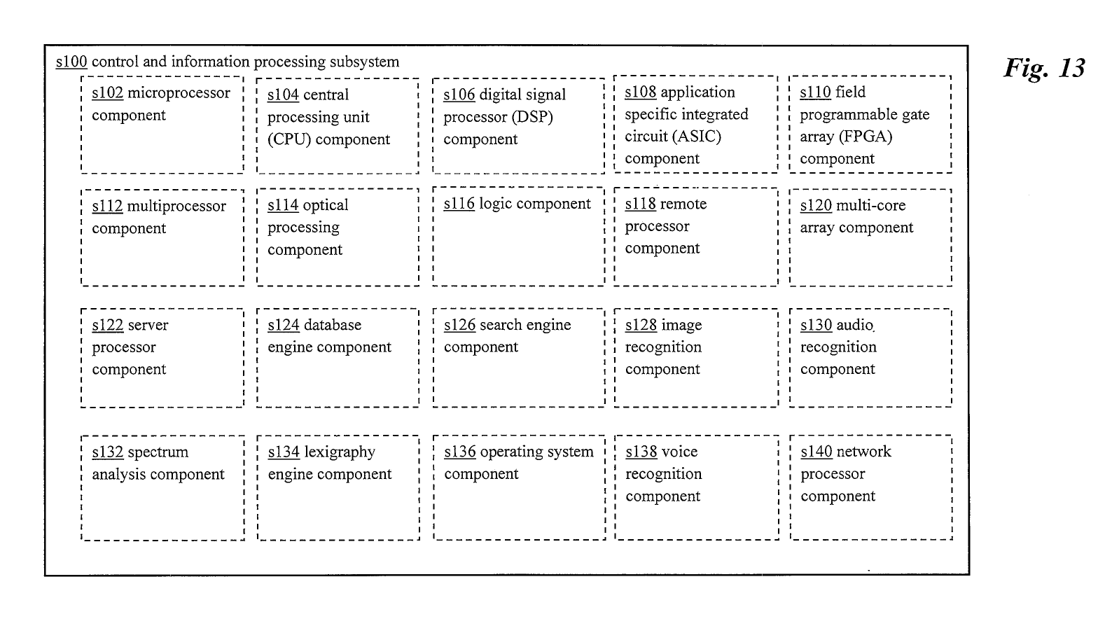

An exemplary implementation of the control and information processing subsystem s100 is shown in FIG. 13 to optionally include various components such as microprocessor component s102, central processing unit (CPU) component s104, digital signal processor (DSP) component s106, application specific integrated circuit (ASIC) component s108, field programmable gate array (FPGA) component s110, multiprocessor component s112, optical processing component s114, logic component s116, remote processor component s118, multi-core array component s120, server processor component s122, database engine component s124, search engine component s126, image recognition component s128, audio recognition component s130, spectrum analysis component s132, lexigraphy engine component s134, operating system component s136, voice recognition component s138, and network processor component s140.

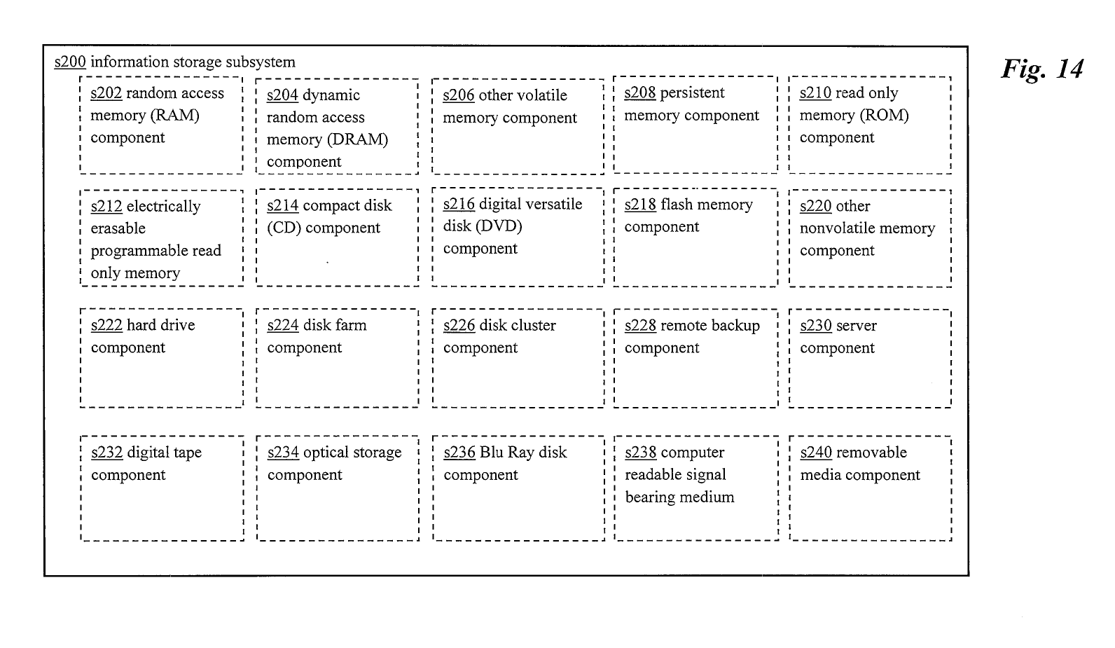

An exemplary implementation of the information storage subsystem s200 is shown in FIG. 14 to optionally include various components such as random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, Blu Ray disk component s236, computer readable signal bearing medium s238, and removable media component s240.

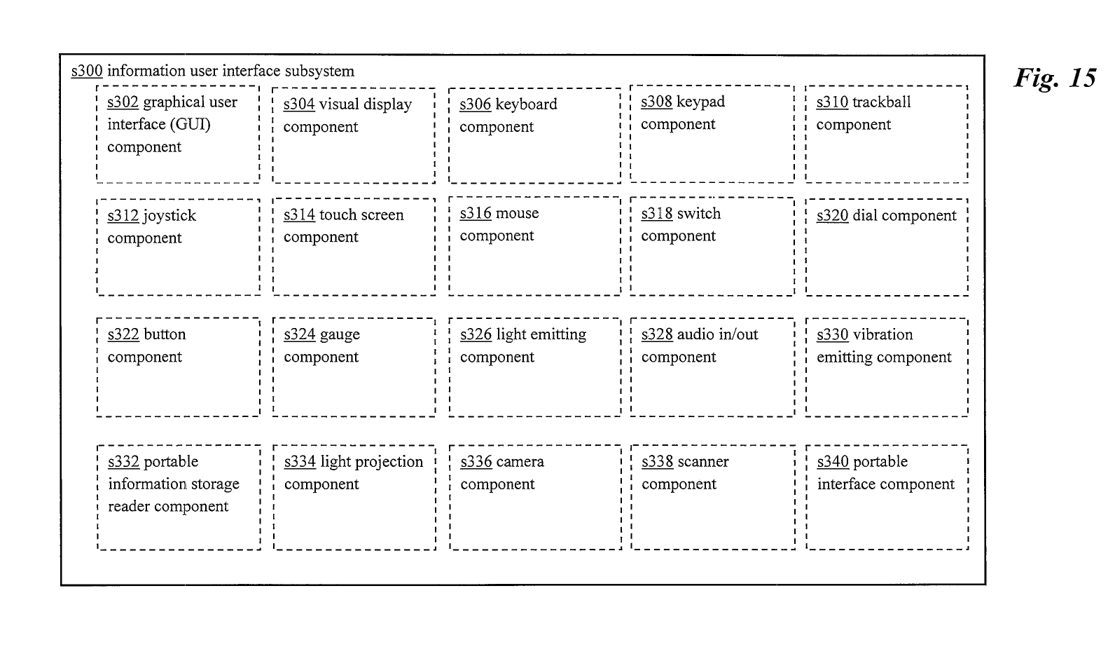

An exemplary implementation of the information user interface subsystem s300 is shown in FIG. 15 to optionally include various components such as graphical user interface (GUI) component s302, visual display component s304, keyboard component s306, keypad component s308, trackball component s310, joystick component s312, touch screen component s314, mouse component s316, switch component s318, dial component s320, button component s322, gauge component s324, light emitting component s326, audio in/out component s328, vibration emitting component s330, portable information storage reader component s332, light projection component s334, camera component s336, scanner component s338, and portable interface component s340.

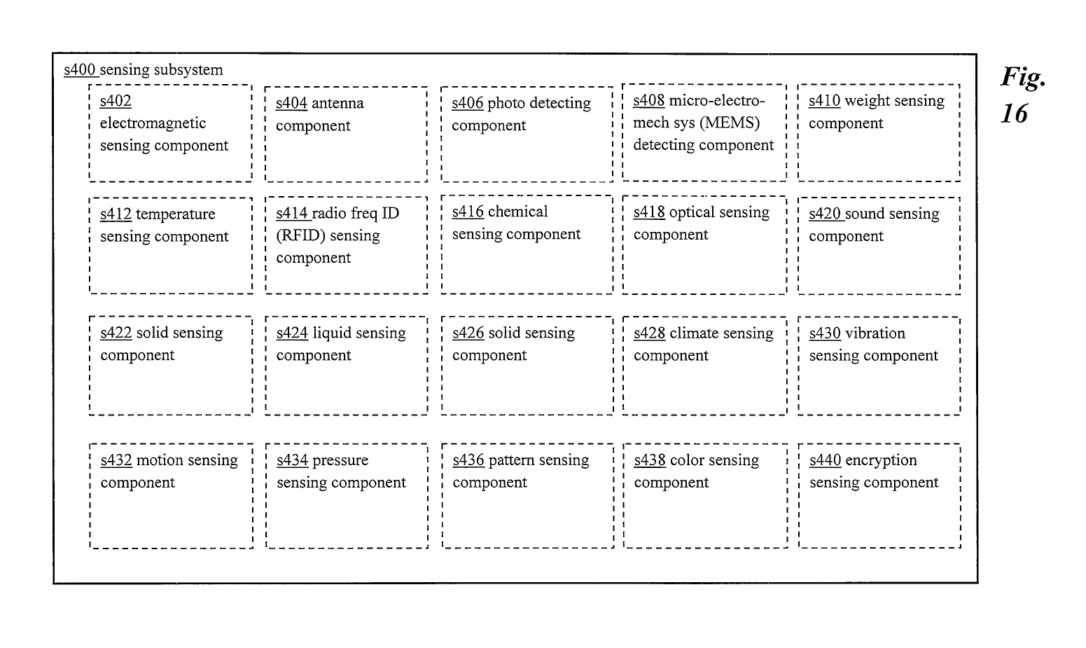

An exemplary implementation of the sensing subsystem s400 is shown in FIG. 16 to optionally include various components such as electromagnetic sensing component s402, antenna component s404, photo detecting component s406, micro-electro-mech sys (MEMS) detecting component s408, weight sensing component s410, temperature sensing component s412, radio freq ID (RFID) sensing component s414, chemical sensing component s416, optical sensing component s418, sound sensing component s420, solid sensing component s422, liquid sensing component s424, solid sensing component s426, climate sensing component s428, vibration sensing component s430, motion sensing component s432, pressure sensing component s434, pattern sensing component s436, color sensing component s438, and encryption sensing component s440.

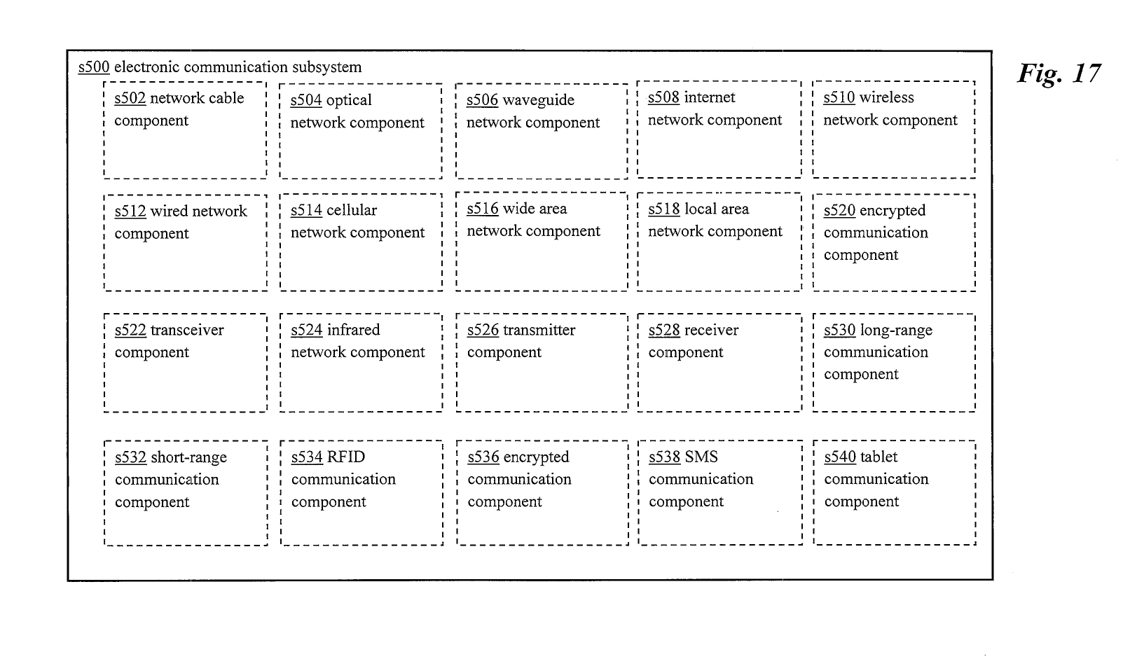

An exemplary implementation of the electronic communication subsystem s500 is shown in FIG. 17 to optionally include various components such as network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, receiver component s528, receiver component s528, long-range communication component s530, short-range communication component s532, RFID communication component s534, encrypted communication component s536, SMS communication component s538, and tablet communication component s540.

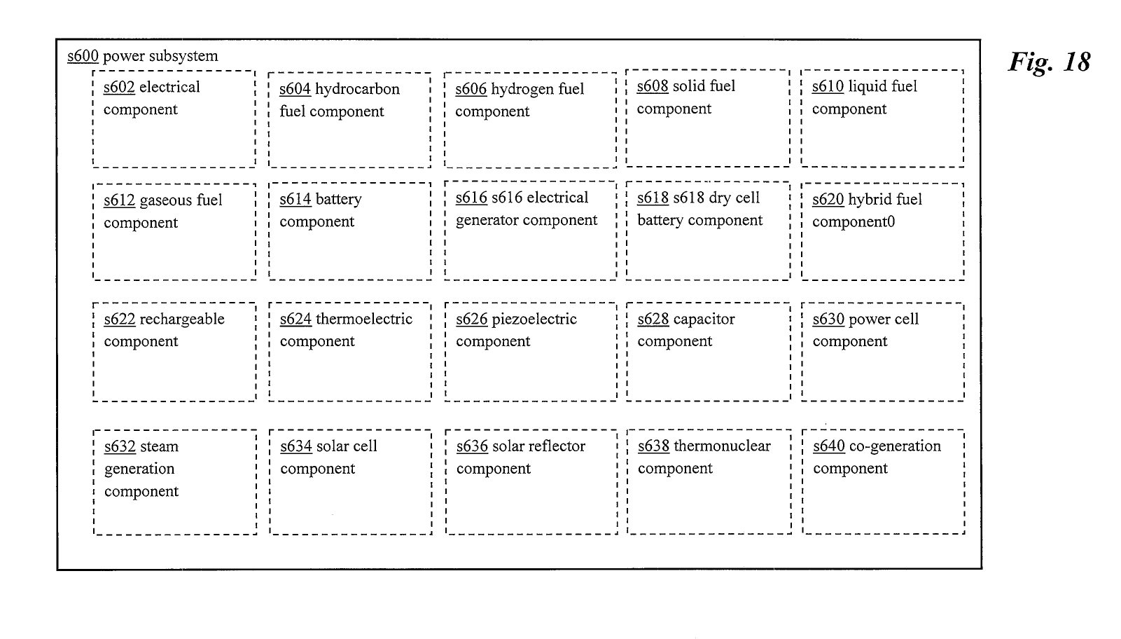

An exemplary implementation of the power subsystem s600 is shown in FIG. 18 to optionally include various components such as electrical component s602, hydrocarbon fuel component s604, hydrogen fuel component s606, solid fuel component s608, liquid fuel component s610, gaseous fuel component s612, battery component s614, battery component s622, battery component s624, battery component s626, battery component s628, power cell component s630, steam generation component s632, solar cell component s634, solar reflector component s636, thermonuclear component s638, and co-generation component s640.

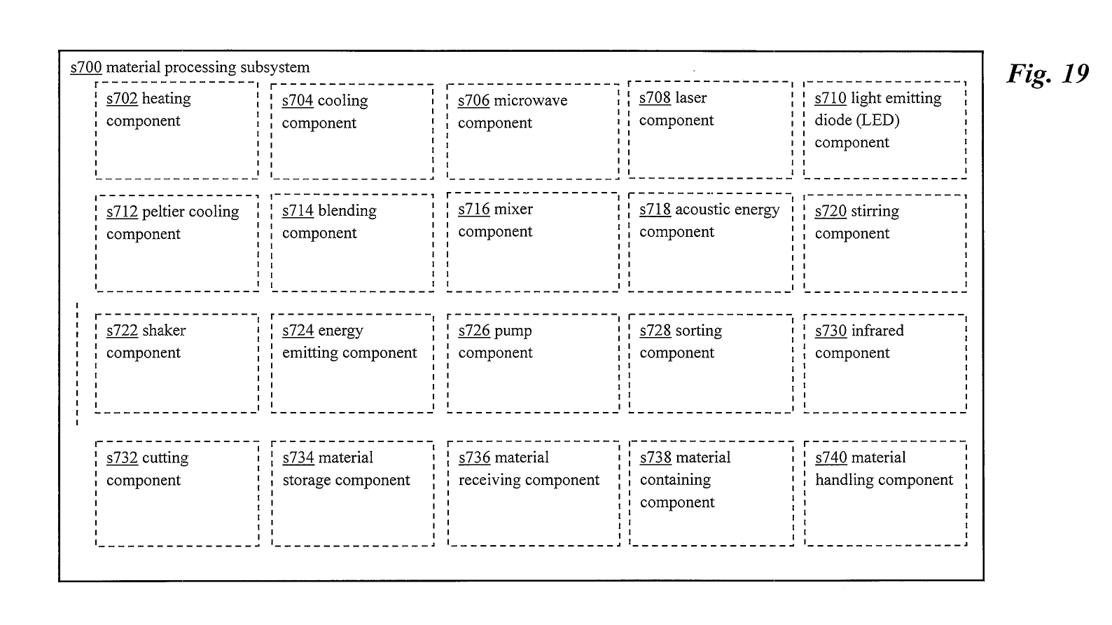

An exemplary implementation of the material processing subsystem s700 is shown in FIG. 19 to optionally include various components such as heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, material receiving component s736, material containing component s738, and material handling component s740.

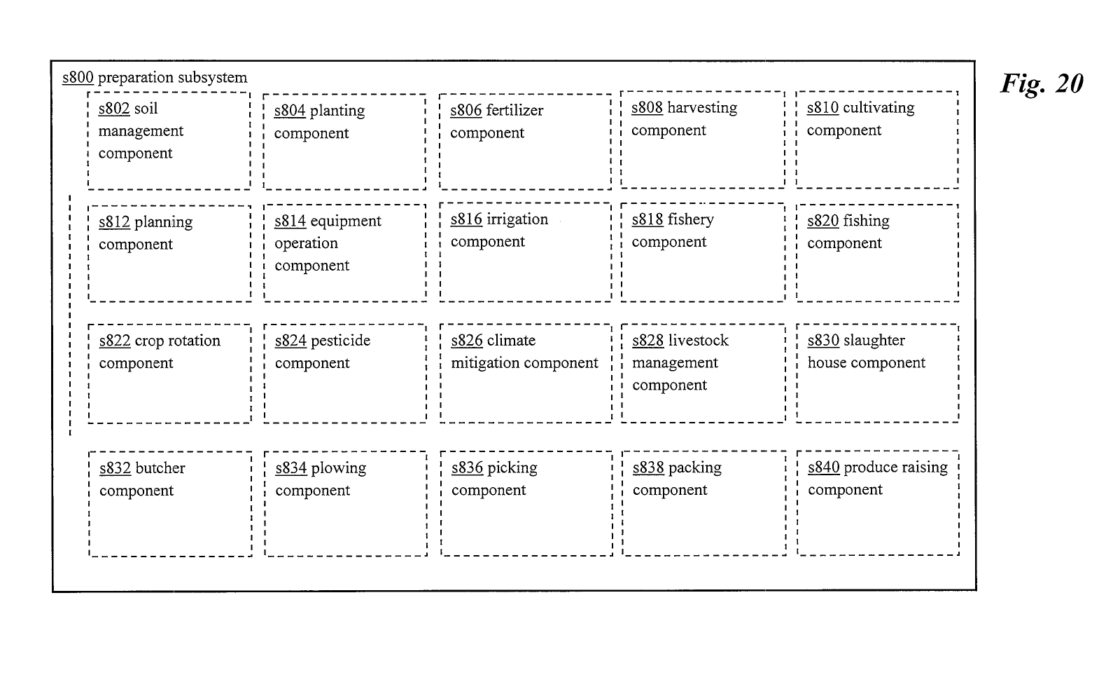

An exemplary implementation of the preparation subsystem s800 is shown in FIG. 20 to optionally include various components such as soil management component s802, planting component s804, fertilizer component s806, harvesting component s808, cultivating component s810, planning component s812, equipment operation component s814, irrigation component s816, fishery component s818, fishing component s820, crop rotation component s822, pesticide component s824, climate mitigation component s826, livestock management component s828, slaughter house component s830, butcher component s832, plowing component s834, picking component s836, packing component s838, and produce raising component s840.

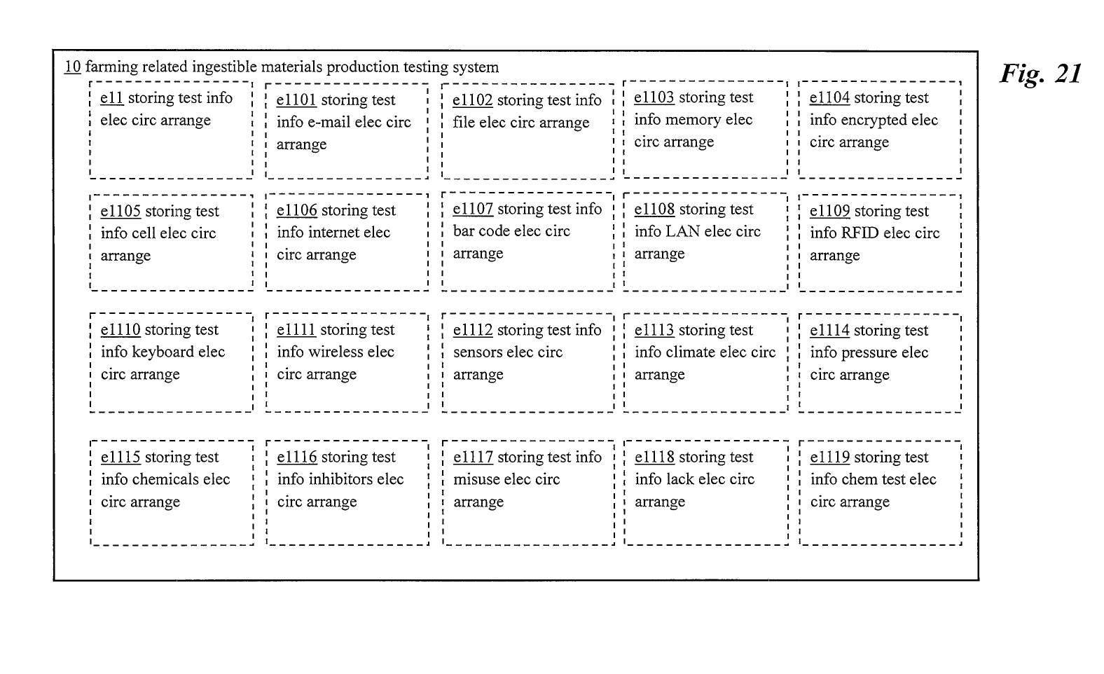

Implementations involve different combinations (otherwise known as “electrical circuitry arrangements”) of components from the subsystems of the farming related ingestible materials production testing system 10. Exemplary depictions of some of these electrical circuitry arrangements are shown in FIG. 21 to include storing test info electrical circuitry arrangement e11, storing test info e-mail electrical circuitry arrangement e1101, storing test info file electrical circuitry arrangement e1102, storing test info memory electrical circuitry arrangement e1103, storing test info encrypted electrical circuitry arrangement e1104, storing test info cell electrical circuitry arrangement e1105, storing test info internet electrical circuitry arrangement e1106, storing test info bar code electrical circuitry arrangement e1107, storing test info LAN electrical circuitry arrangement e1108, storing test info RFID electrical circuitry arrangement e1109, storing test info keyboard electrical circuitry arrangement e1110, storing test info wireless electrical circuitry arrangement e1111, storing test info sensors electrical circuitry arrangement e1112, storing test info climate electrical circuitry arrangement e1113, storing test info pressure electrical circuitry arrangement e1114, storing test info chemicals electrical circuitry arrangement e1115, storing test info inhibitors electrical circuitry arrangement e1116, storing test info misuse electrical circuitry arrangement e1117, storing test info lack electrical circuitry arrangement e1118, and storing test info chem test electrical circuitry arrangement e1119.

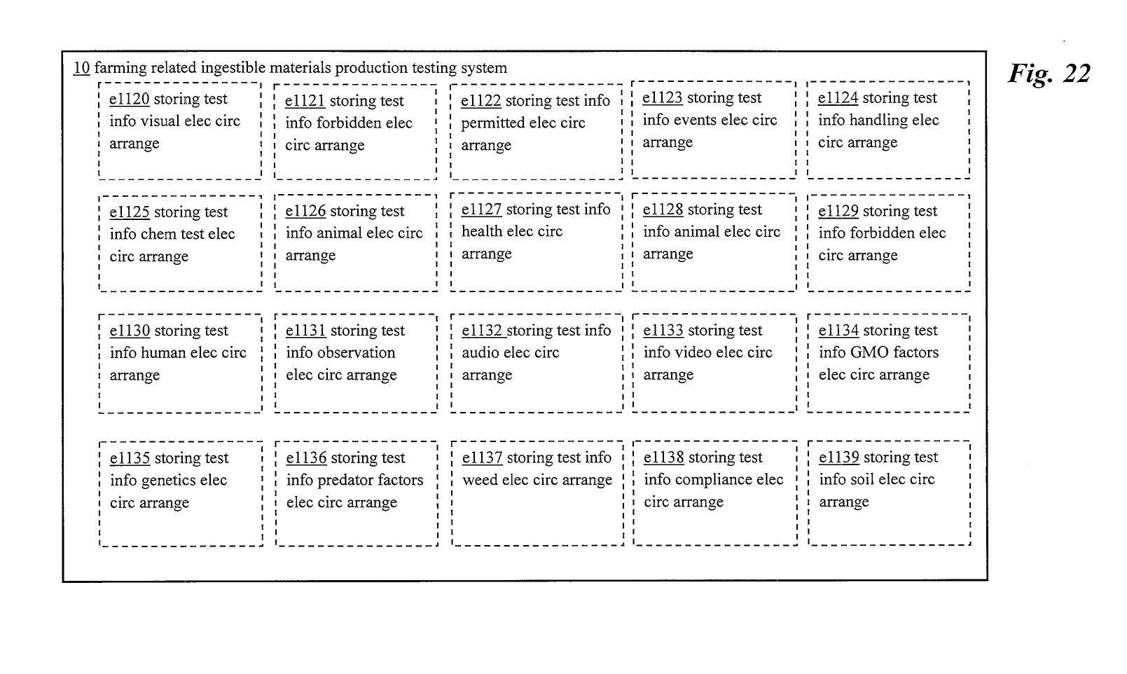

Some of these electrical circuitry arrangements are depicted in FIG. 22 to include storing test info visual electrical circuitry arrangement e1120, storing test info forbidden electrical circuitry arrangement e1121, storing test info permitted electrical circuitry arrangement e1122, storing test info events electrical circuitry arrangement e1123, storing test info handling electrical circuitry arrangement e1124, storing test info chem test electrical circuitry arrangement e1125, storing test info animal electrical circuitry arrangement e1126, storing test info health electrical circuitry arrangement e1127, storing test info animal electrical circuitry arrangement e1128, storing test info forbidden electrical circuitry arrangement e1129, storing test info human electrical circuitry arrangement e1130, storing test info observation electrical circuitry arrangement e113, storing test info audio electrical circuitry arrangement e1132, storing test info video electrical circuitry arrangement e1133, storing test info GMO factors electrical circuitry arrangement e1134, storing test info genetics electrical circuitry arrangement e1135, storing test info predator factors electrical circuitry arrangement e1136, storing test info weed electrical circuitry arrangement e1137, storing test info compliance electrical circuitry arrangement e1138, and storing test info soil electrical circuitry arrangement e1139.

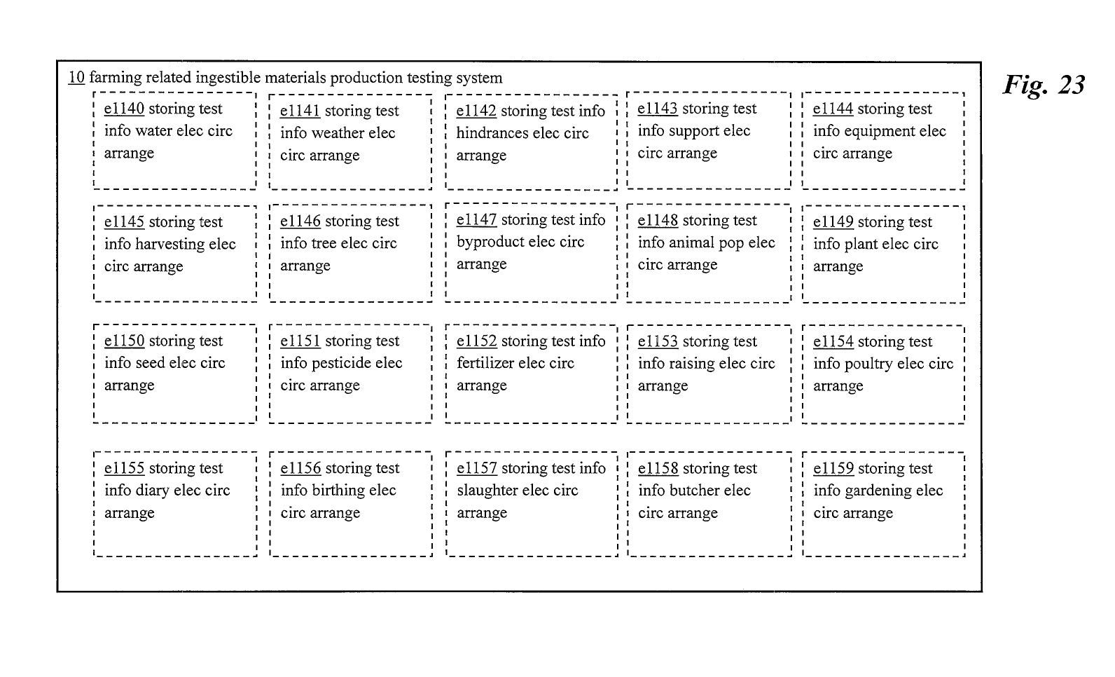

Some of these electrical circuitry arrangements are depicted in FIG. 23 to include storing test info water electrical circuitry arrangement e1140, storing test info weather electrical circuitry arrangement e1141, storing test info hindrances electrical circuitry arrangement e1142, storing test info support electrical circuitry arrangement e1143, storing test info equipment electrical circuitry arrangement e1144, storing test info harvesting electrical circuitry arrangement e1145, storing test info tree electrical circuitry arrangement e1146, storing test info byproduct electrical circuitry arrangement e1147, storing test info animal pop electrical circuitry arrangement e1148, storing test info plant electrical circuitry arrangement e1149, storing test info seed electrical circuitry arrangement e1150, storing test info pesticide electrical circuitry arrangement e1151, storing test info fertilizer electrical circuitry arrangement e1152, storing test info raising electrical circuitry arrangement e1153, storing test info poultry electrical circuitry arrangement e1154, storing test info diary electrical circuitry arrangement e1155, storing test info birthing electrical circuitry arrangement e1156, storing test info slaughter electrical circuitry arrangement e1157, storing test info butcher electrical circuitry arrangement e1158, and storing test info gardening electrical circuitry arrangement e1159.

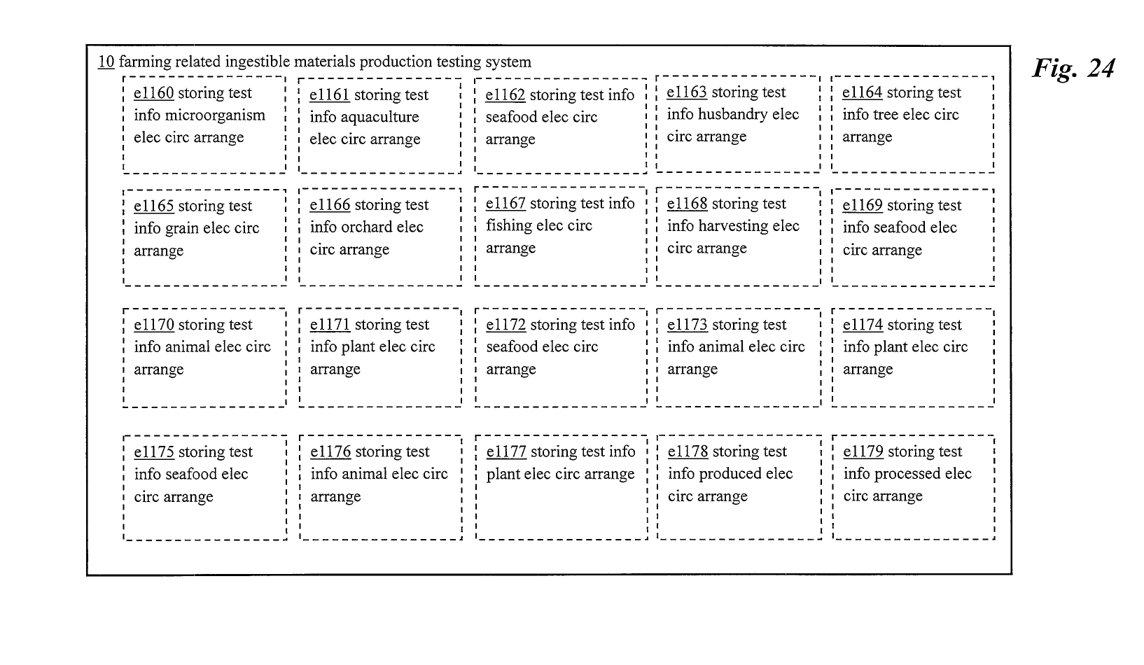

Some of these electrical circuitry arrangements are depicted in FIG. 24 to include storing test info microorganism electrical circuitry arrangement e1160, storing test info aquaculture electrical circuitry arrangement e1161, storing test info seafood electrical circuitry arrangement e1162, storing test info husbandry electrical circuitry arrangement e1163, storing test info tree electrical circuitry arrangement e1164, storing test info grain electrical circuitry arrangement e1165, and storing test info orchard electrical circuitry arrangement e1166, storing test info fishing electrical circuitry arrangement e1167, storing test info harvesting electrical circuitry arrangement e1168, storing test info seafood electrical circuitry arrangement e1169, storing test info animal electrical circuitry arrangement e1170, storing test info plant electrical circuitry arrangement e1171, storing test info seafood electrical circuitry arrangement e1172, storing test info animal electrical circuitry arrangement e1173, storing test info plant electrical circuitry arrangement e1174, storing test info seafood electrical circuitry arrangement e1175, storing test info animal electrical circuitry arrangement e1176, storing test info plant electrical circuitry arrangement e1177, storing test info produced electrical circuitry arrangement e1178, and storing test info processed electrical circuitry arrangement e1179.

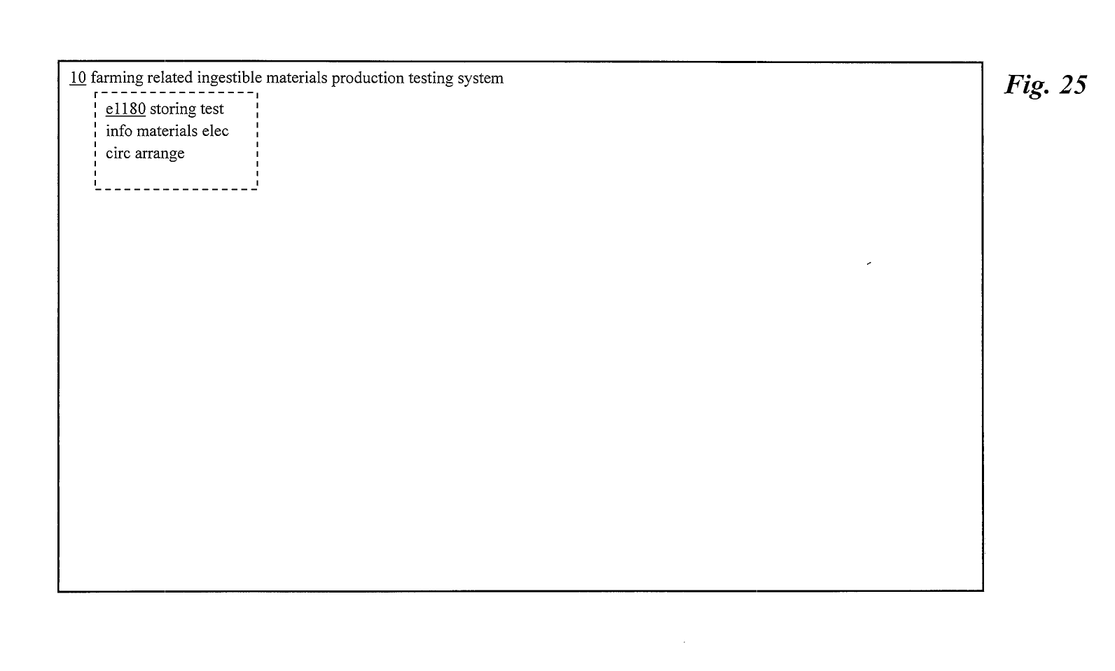

Some of these electrical circuitry arrangements are depicted in FIG. 25 to include storing test info materials electrical circuitry arrangement e1180.

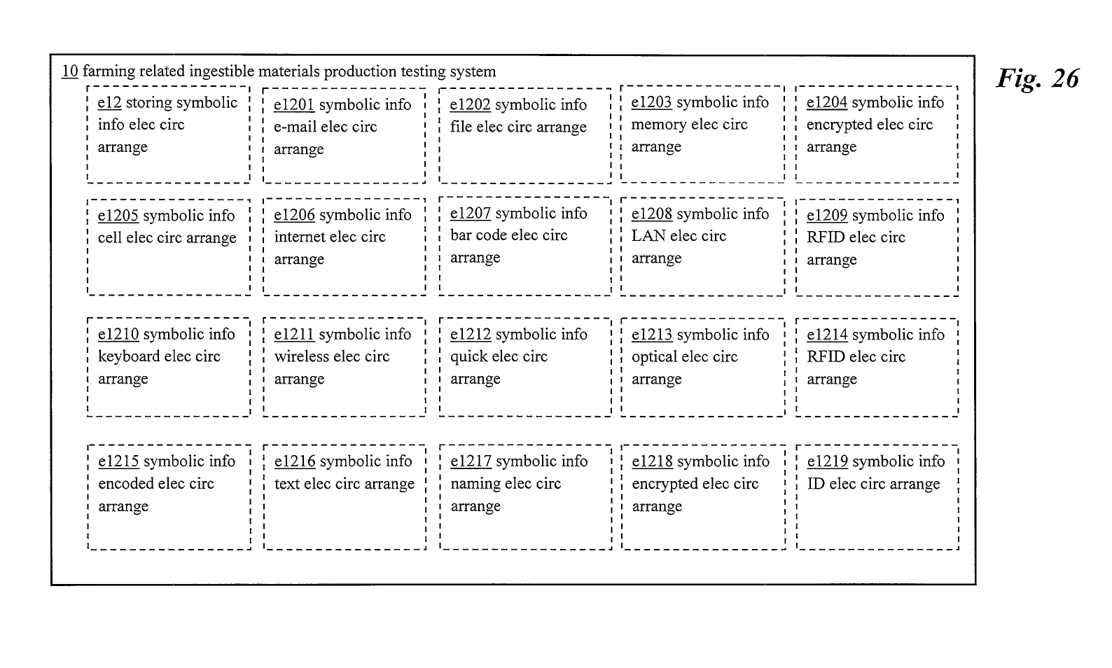

Some of these electrical circuitry arrangements are depicted in FIG. 26 to include storing symbolic info electrical circuitry arrangement e12, symbolic info e-mail electrical circuitry arrangement e1201, symbolic info file electrical circuitry arrangement e1202, symbolic info memory electrical circuitry arrangement e1203, symbolic info encrypted electrical circuitry arrangement e1204, symbolic info cell electrical circuitry arrangement e1205, symbolic info internet electrical circuitry arrangement e1206, symbolic info bar code electrical circuitry arrangement e1207, symbolic info LAN electrical circuitry arrangement e1208, symbolic info RFID electrical circuitry arrangement e1209, symbolic info keyboard electrical circuitry arrangement e1210, symbolic info wireless electrical circuitry arrangement e1211, and symbolic info quick electrical circuitry arrangement e1212, symbolic info optical electrical circuitry arrangement e1213, symbolic info RFID electrical circuitry arrangement e1214, symbolic info encoded electrical circuitry arrangement e1215, symbolic info text electrical circuitry arrangement e1216, symbolic info naming electrical circuitry arrangement e1217, symbolic info encrypted electrical circuitry arrangement e1218, and symbolic info ID electrical circuitry arrangement e1219.

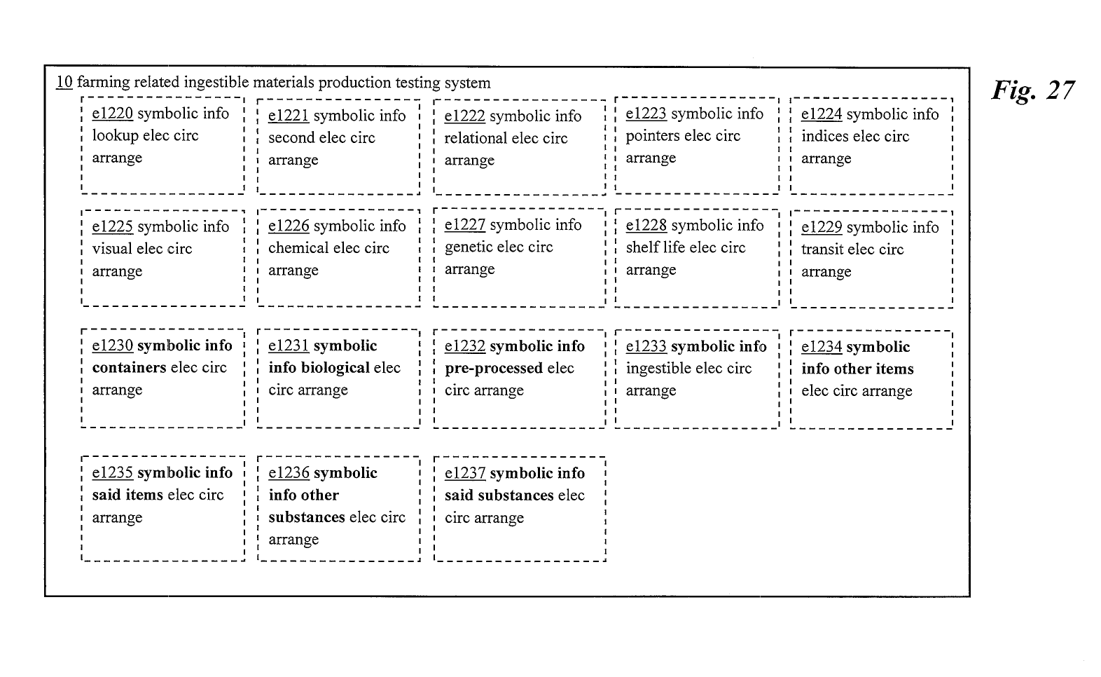

Some of these electrical circuitry arrangements are depicted in FIG. 27 to include symbolic info lookup electrical circuitry arrangement e1220, symbolic info second electrical circuitry arrangement e1221, symbolic info relational electrical circuitry arrangement e1222, symbolic info pointers electrical circuitry arrangement e1223, symbolic info indices electrical circuitry arrangement e1224, symbolic info visual electrical circuitry arrangement e1225, symbolic info chemical electrical circuitry arrangement e1226, symbolic info genetic electrical circuitry arrangement e1227, symbolic info shelf life electrical circuitry arrangement e1228, symbolic info transit electrical circuitry arrangement e1229, symbolic info other items electrical circuitry arrangement e1234, symbolic info biological electrical circuitry arrangement e1231, symbolic info pre-processed electrical circuitry arrangement e1232, symbolic info ingestible electrical circuitry arrangement e1233, symbolic info other items electrical circuitry arrangement e1234, symbolic info said items electrical circuitry arrangement e1235, symbolic info other substances electrical circuitry arrangement e1236, and symbolic info said substances electrical circuitry arrangement e1237.

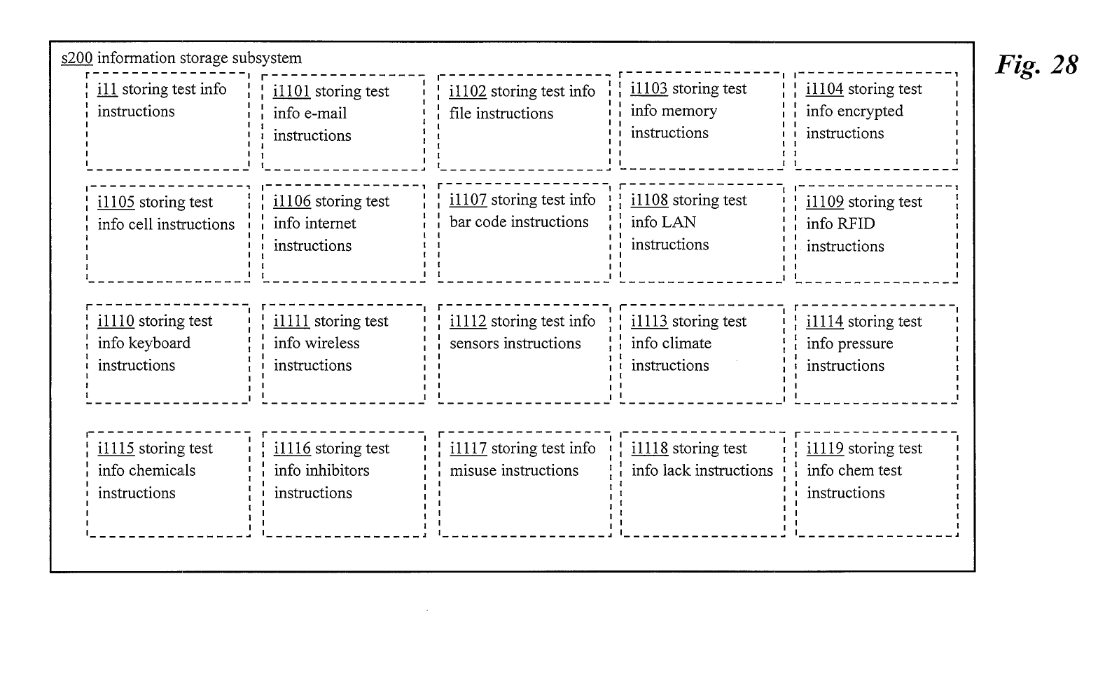

In implementations one or more instructions are stored and/or otherwise borne in various subsystems, components, and/or accessories of the farming related ingestible materials production testing system 10 such as being borne in a non-transitory signal bearing medium of information storage subsystem s200. One or more exemplary instructions depicted in FIG. 28 as being borne in an exemplary version of a non-transitory signal bearing medium of information storage subsystem s200 include one or more storing test info instructions ill, one or more storing test info e-mail instructions i1101, one or more storing test info file instructions i1102, one or more storing test info memory instructions i1103, one or more storing test info encrypted instructions i1104, one or more storing test info cell instructions i1105, one or more storing test info internet instructions i1106, one or more storing test info bar code instructions i1107, one or more storing test info LAN instructions i1108, one or more storing test info RFID instructions i1109, one or more storing test info keyboard instructions i1110, one or more storing test info wireless instructions i1111, one or more storing test info sensors instructions i1112, one or more storing test info climate instructions i1113, one or more storing test info pressure instructions i1114, one or more storing test info chemicals instructions i1115, one or more storing test info inhibitors instructions i1116, one or more storing test info misuse instructions i1117, one or more storing test info lack instructions i1118, and one or more storing test info chem test instructions i1119.

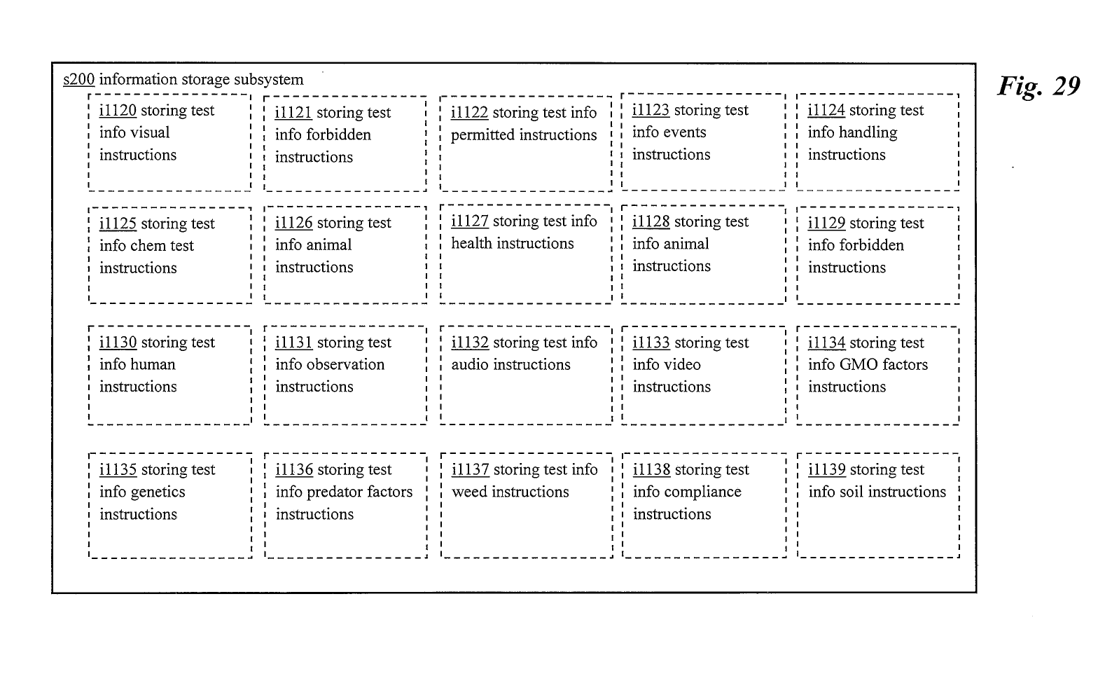

One or more exemplary instructions depicted in FIG. 29 as being borne in an exemplary version of a non-transitory signal bearing medium of information storage subsystem s200 include one or more storing test info visual instructions i1120, one or more storing test info forbidden instructions i1121, one or more storing test info permitted instructions i1122, one or more storing test info events instructions i1123, one or more storing test info handling instructions i1124, one or more storing test info chem test instructions i1125, one or more storing test info animal instructions i1126, one or more storing test info health instructions i1127, one or more storing test info animal instructions i1128, one or more storing test info forbidden instructions i1129, one or more storing test info human instructions i1130, one or more storing test info observation instructions i1131, one or more storing test info audio instructions i1132, one or more storing test info video instructions i1133, one or more storing test info GMO factors instructions i1134, one or more storing test info genetics instructions i1135, one or more storing test info predator factors instructions i1136, one or more storing test info weed instructions i1137, one or more storing test info compliance instructions i1138, and one or more storing test info soil instructions i1139.

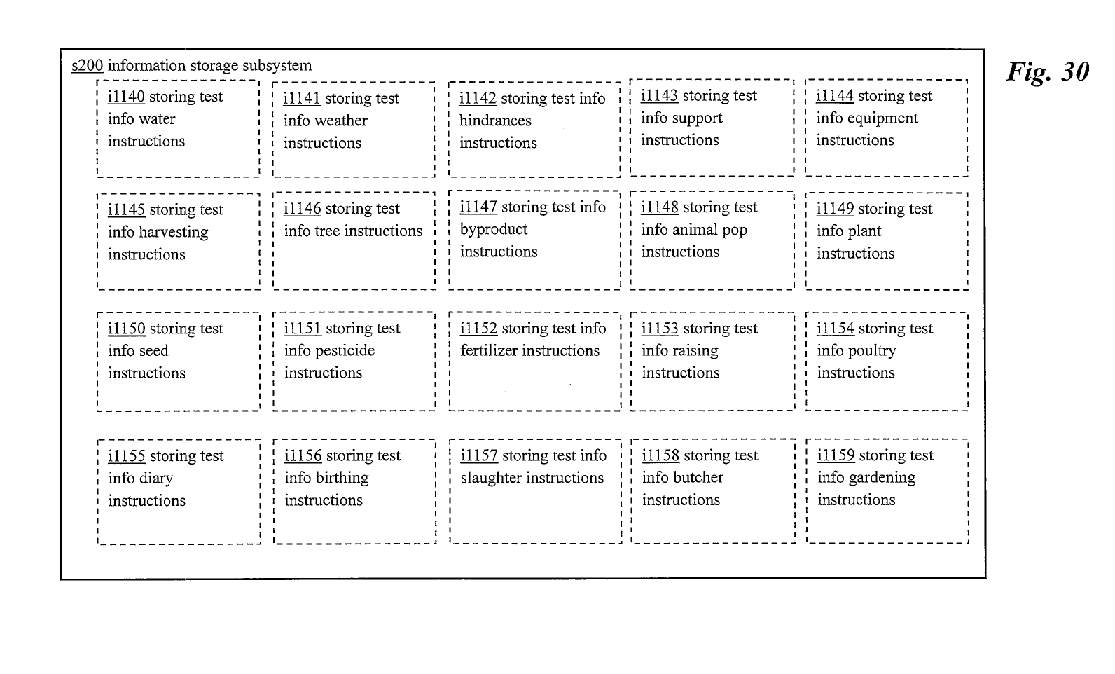

One or more exemplary instructions depicted in FIG. 30 as being borne in an exemplary version of a non-transitory signal bearing medium of information storage subsystem s200 include one or more storing test info water instructions i1140, one or more storing test info weather instructions i1141, one or more storing test info hindrances instructions i1142, one or more storing test info support instructions i1143, one or more storing test info equipment instructions i1144, one or more storing test info harvesting instructions i1145, one or more storing test info tree instructions i1146, one or more storing test info byproduct instructions i1147, one or more storing test info animal pop instructions i1148, one or more storing test info plant instructions i1149, one or more storing test info seed instructions i1150, one or more storing test info pesticide instructions i1151, one or more storing test info fertilizer instructions i1152, one or more storing test info raising instructions i1153, one or more storing test info poultry instructions i1154, one or more storing test info diary instructions i1155, one or more storing test info birthing instructions i1156, one or more storing test info slaughter instructions i1157, one or more storing test info butcher instructions i1158, and one or more storing test info gardening instructions i1159.

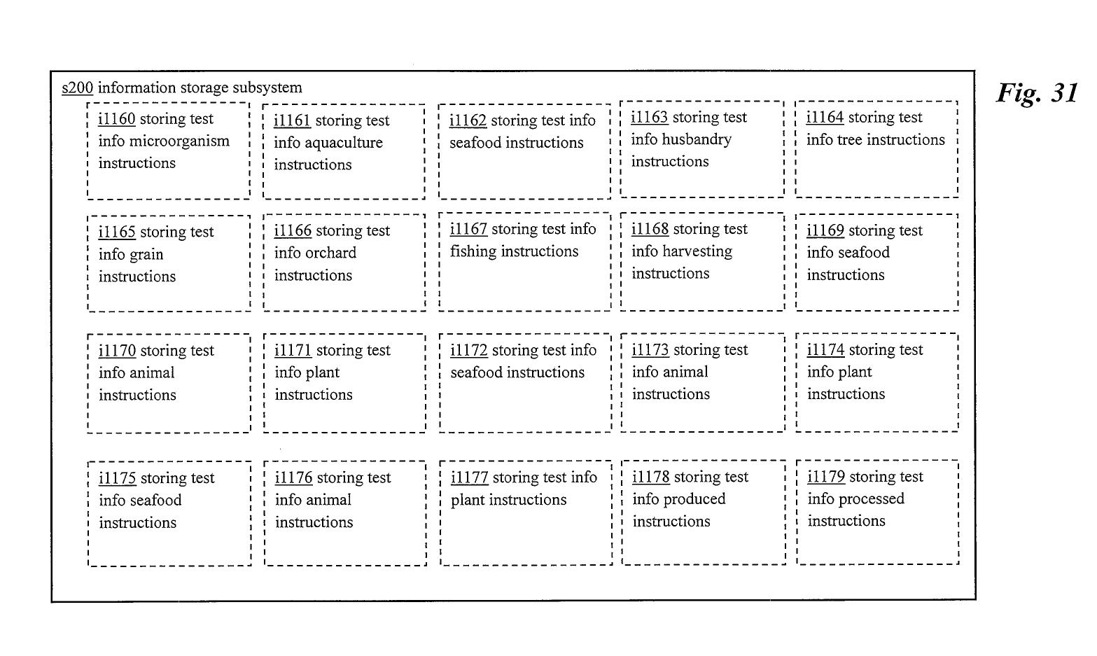

One or more exemplary instructions depicted in FIG. 31 as being borne in an exemplary version of a non-transitory signal bearing medium of information storage subsystem s200 include one or more storing test info microorganism instructions i1160, one or more storing test info aquaculture instructions i1161, one or more storing test info seafood instructions i1162, one or more storing test info husbandry instructions i1163, one or more storing test info tree instructions i1164, one or more storing test info grain instructions i1165, and one or more storing test info orchard instructions i1166, one or more storing test info fishing instructions i1167, one or more storing test info harvesting instructions i1168, one or more storing test info seafood instructions i1169, one or more storing test info animal instructions i1170, one or more storing test info plant instructions i1171, one or more storing test info seafood instructions i1172, one or more storing test info animal instructions i1173, one or more storing test info plant instructions i1174, one or more storing test info seafood instructions i1175, one or more storing test info animal instructions i1176, one or more storing test info plant instructions i1177, one or more storing test info produced instructions i1178, and one or more storing test info processed instructions i1179.

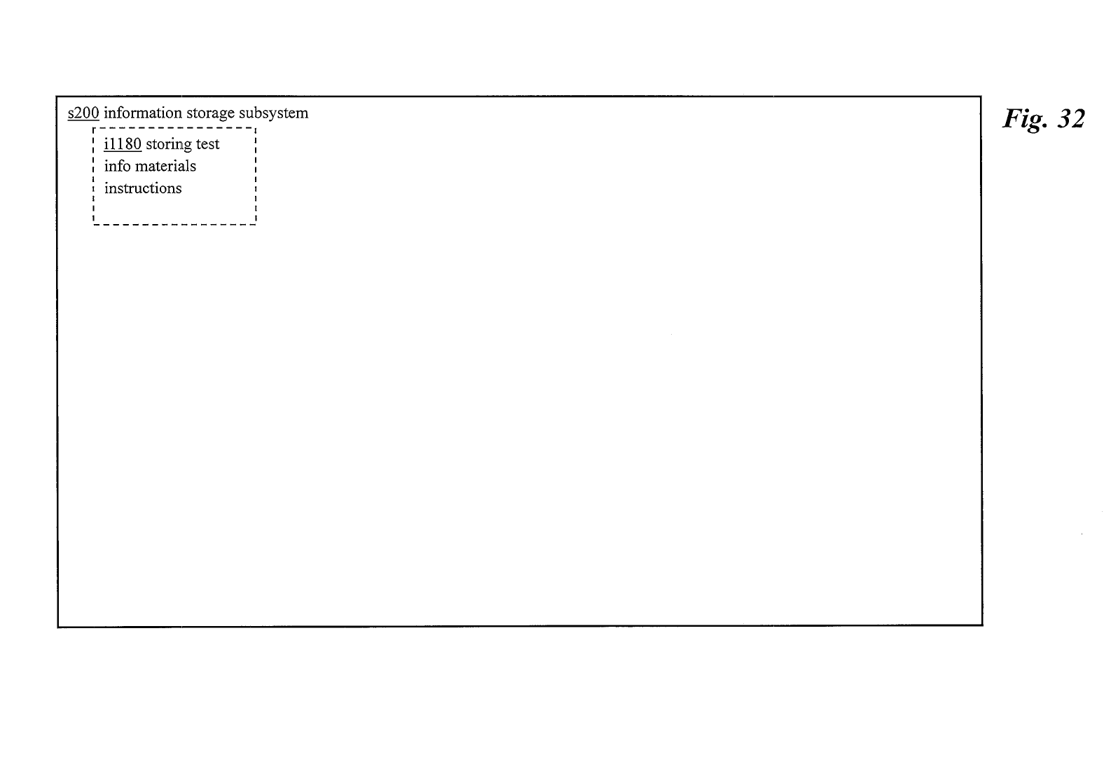

One or more exemplary instructions depicted in FIG. 32 as being borne in an exemplary version of a non-transitory signal bearing medium of information storage subsystem s200 include one or more storing test info materials instructions i1180.

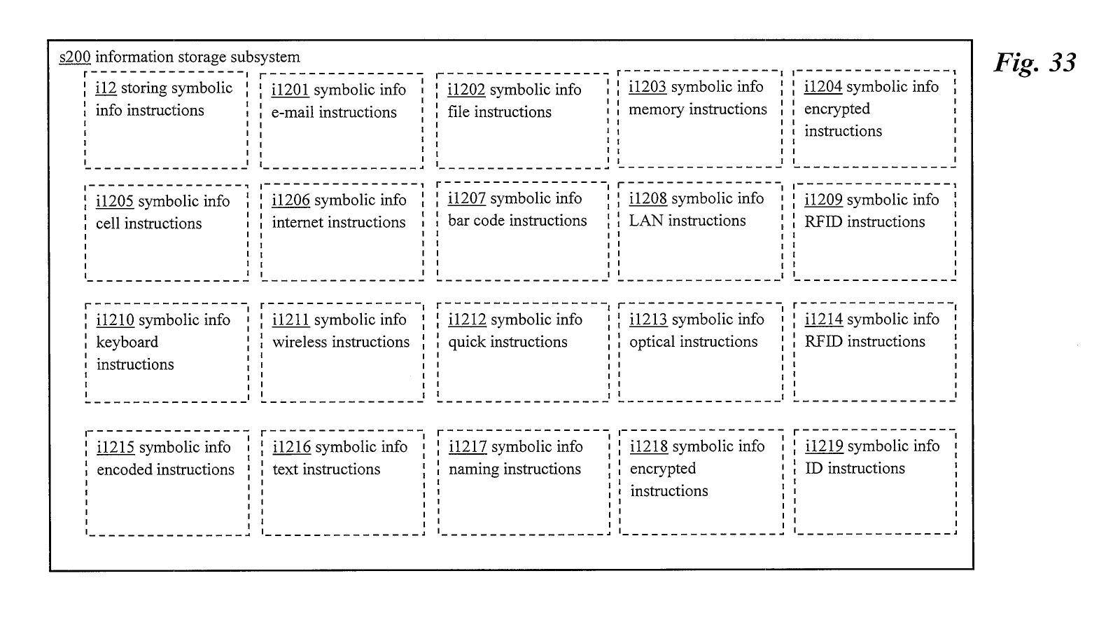

One or more exemplary instructions depicted in FIG. 33 as being borne in an exemplary version of a non-transitory signal bearing medium of information storage subsystem s200 include one or more storing symbolic info instructions i12, one or more symbolic info e-mail instructions i1201, one or more symbolic info file instructions i1202, one or more symbolic info memory instructions i1203, one or more symbolic info encrypted instructions i1204, one or more symbolic info cell instructions i1205, one or more symbolic info internet instructions i1206, one or more symbolic info bar code instructions i1207, one or more symbolic info LAN instructions i1208, one or more symbolic info RFID instructions i1209, one or more symbolic info keyboard instructions i1210, one or more symbolic info wireless instructions i1211, one or more symbolic info quick instructions i1212, one or more symbolic info optical instructions i1213, one or more symbolic info RFID instructions i1214, one or more symbolic info encoded instructions i1215, one or more symbolic info text instructions i1216, one or more symbolic info naming instructions i1217, one or more symbolic info encrypted instructions i1218, and one or more symbolic info ID instructions i1219.

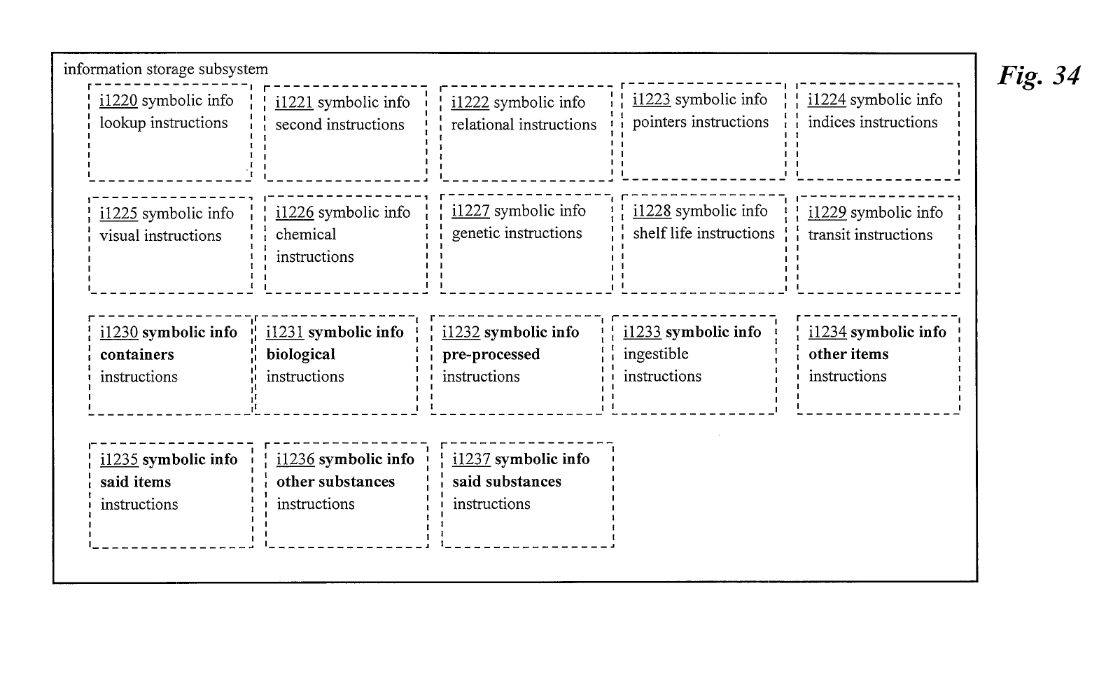

One or more exemplary instructions depicted in FIG. 34 as being borne in an exemplary version of a non-transitory signal bearing medium of information storage subsystem s200 include one or more symbolic info lookup instructions i1220, one or more symbolic info second instructions i1221, one or more symbolic info relational instructions i1222, one or more symbolic info pointers instructions i1223, one or more symbolic info indices instructions i1224, one or more symbolic info visual instructions i1225, one or more symbolic info chemical instructions i1226, one or more symbolic info genetic instructions i1227, one or more symbolic info shelf life instructions i1228, one or more symbolic info transit instructions i1229, one or more symbolic info other items instructions i1234, one or more symbolic info biological instructions i1231, one or more symbolic info pre-processed instructions i1232, one or more symbolic info ingestible instructions i1233, one or more symbolic info other items instructions i1234, one or more symbolic info said items instructions i1235, one or more symbolic info other substances instructions i1236, and one or more symbolic info said substances instructions i1237.

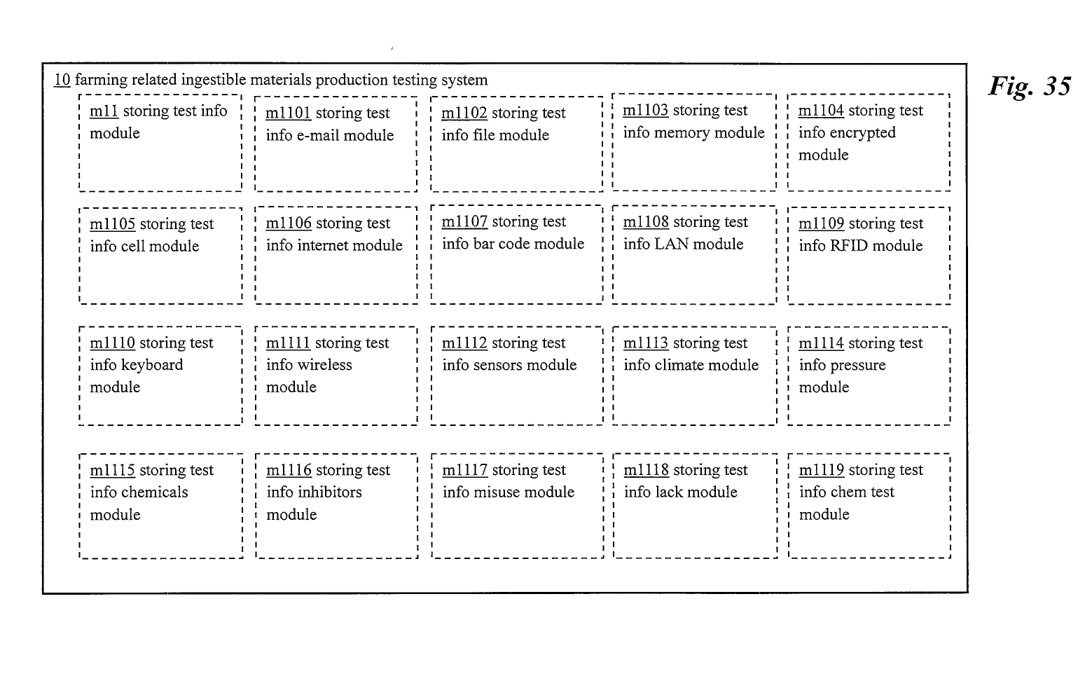

Implementations of modules involve different combinations (limited to patentable subject matter under 35 U.S.C. 101) of one or more aspects from one or more of the electrical circuitry arrangements and/or one or more aspects from one or more of the instructions of the farming related ingestible materials production testing system 10. Exemplary depictions of some of these modules are shown in FIG. 35 to include storing test info module m11, storing test info e-mail module m1101, storing test info file module m1102, storing test info memory module m1103, storing test info encrypted module m1104, storing test info cell module m1105, storing test info internet module m1106, storing test info bar code module m1107, storing test info LAN module m1108, storing test info RFID module m1109, storing test info keyboard module m1110, storing test info wireless module m1111, storing test info sensors module m1112, storing test info climate module m1113, storing test info pressure module m1114, storing test info chemicals module m1115, storing test info inhibitors module m1116, storing test info misuse module m1117, storing test info lack module m1118, and storing test info chem test module m1119.

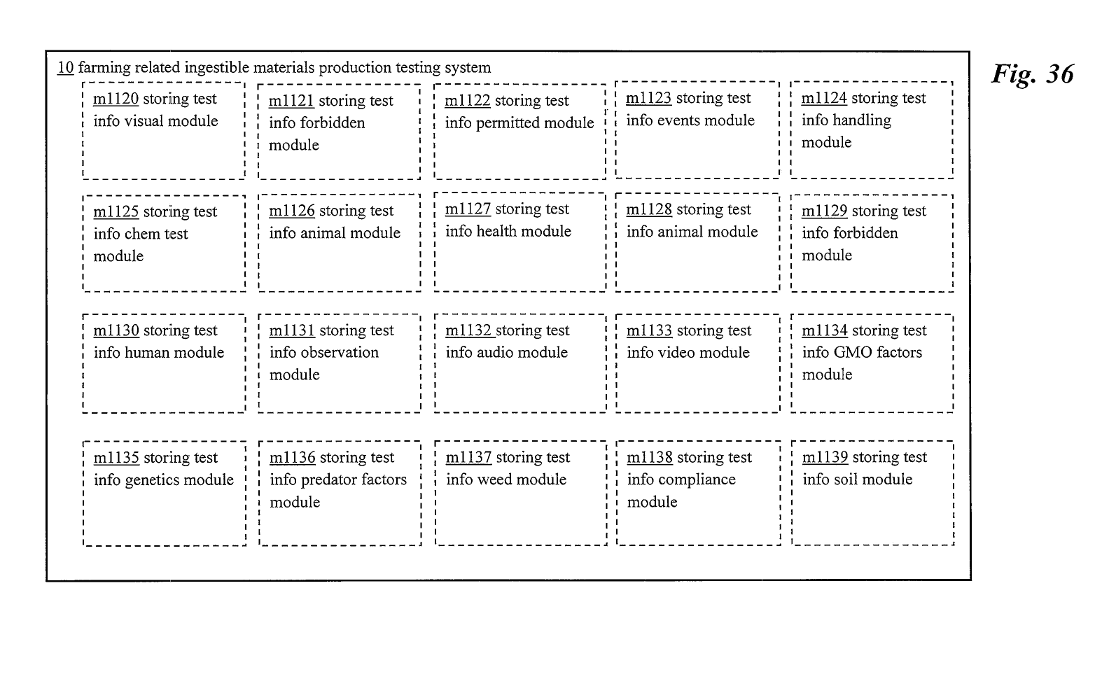

Some of these modules are depicted in FIG. 36 to include storing test info visual module m1120, storing test info forbidden module m1121, storing test info permitted module m1122, storing test info events module m1123, storing test info handling module m1124, storing test info chem test module m1125, storing test info animal module m1126, storing test info health module m1127, storing test info animal module m1128, storing test info forbidden module m1129, storing test info human module m1130, storing test info observation module m113, storing test info audio module m1132, storing test info video module m1133, storing test info GMO factors module m1134, storing test info genetics module m1135, storing test info predator factors module m1136, storing test info weed module m1137, storing test info compliance module m1138, and storing test info soil module m1139.

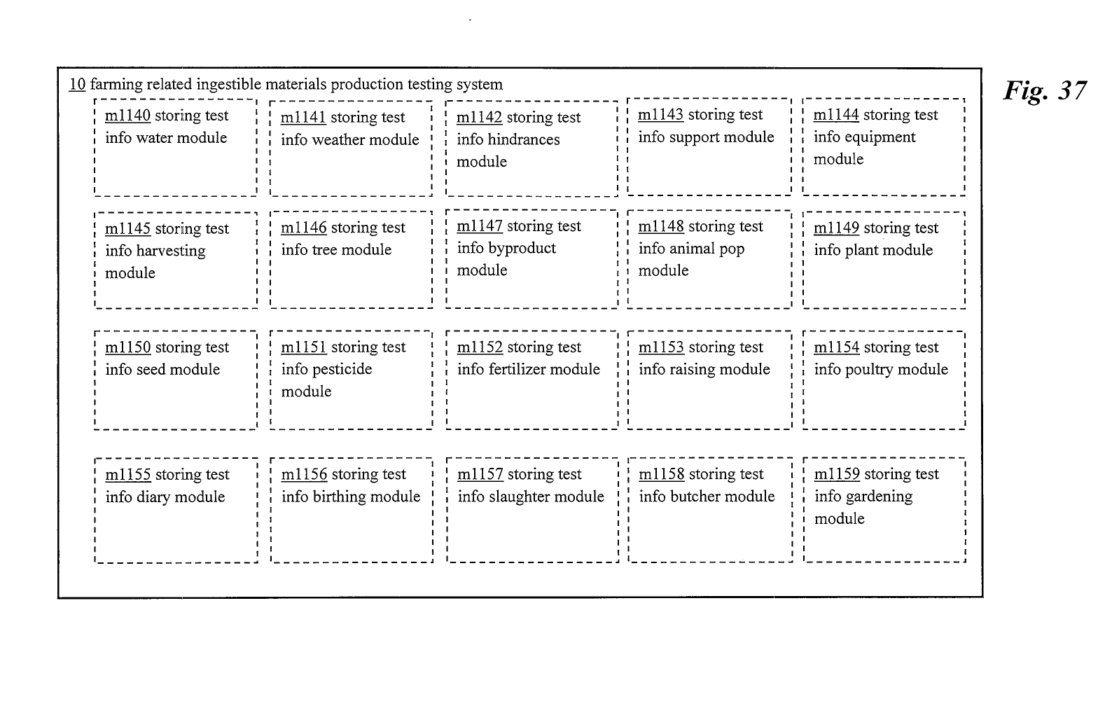

Some of these modules are depicted in FIG. 37 to include storing test info water module m1140, storing test info weather module m1141, storing test info hindrances module m1142, storing test info support module m1143, storing test info equipment module m1144, storing test info harvesting module m1145, storing test info tree module m1146, storing test info byproduct module m1147, storing test info animal pop module m1148, storing test info plant module m1149, storing test info seed module m1150, storing test info pesticide module m1151, storing test info fertilizer module m1152, storing test info raising module m1153, storing test info poultry module m1154, storing test info diary module m1155, storing test info birthing module m1156, storing test info slaughter module m1157, storing test info butcher module m1158, and storing test info gardening module m1159.

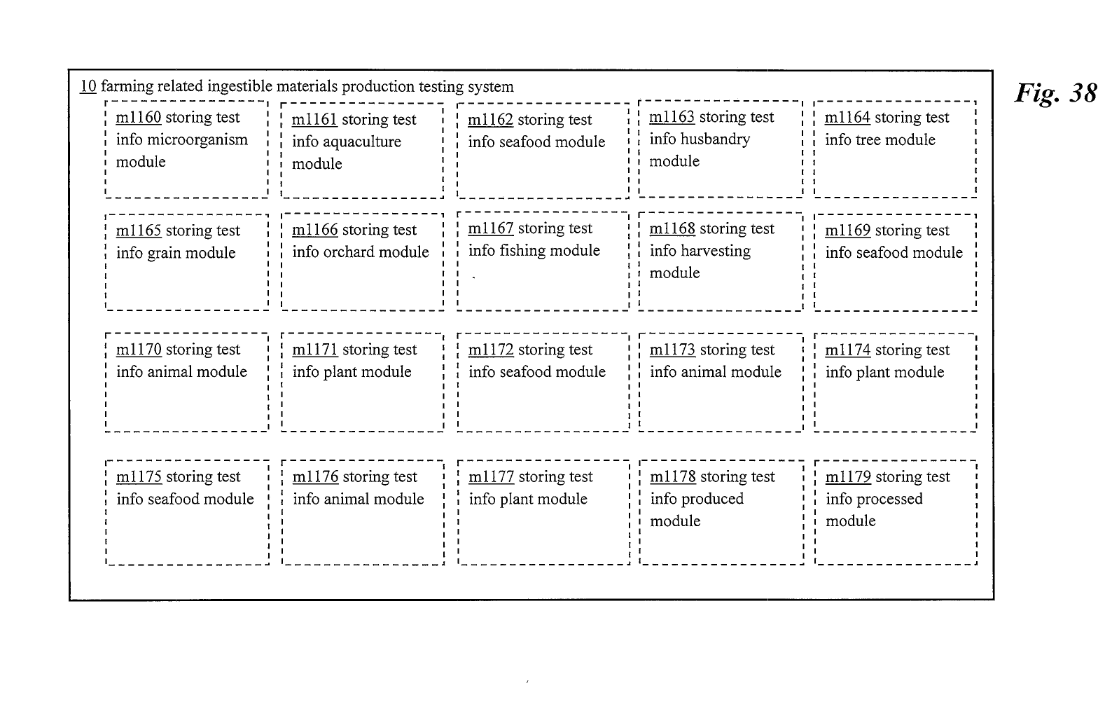

Some of these modules are depicted in FIG. 38 to include storing test info microorganism module m1160, storing test info aquaculture module m1161, storing test info seafood module m1162, storing test info husbandry module m1163, storing test info tree module m1164, storing test info grain module m1165, and storing test info orchard module m1166, storing test info fishing module m1167, storing test info harvesting module m1168, storing test info seafood module m1169, storing test info animal module m1170, storing test info plant module m1171, storing test info seafood module m1172, storing test info animal module m1173, storing test info plant module m1174, storing test info seafood module m1175, storing test info animal module m1176, storing test info plant module m1177, storing test info produced module m1178, and storing test info processed module m1179.

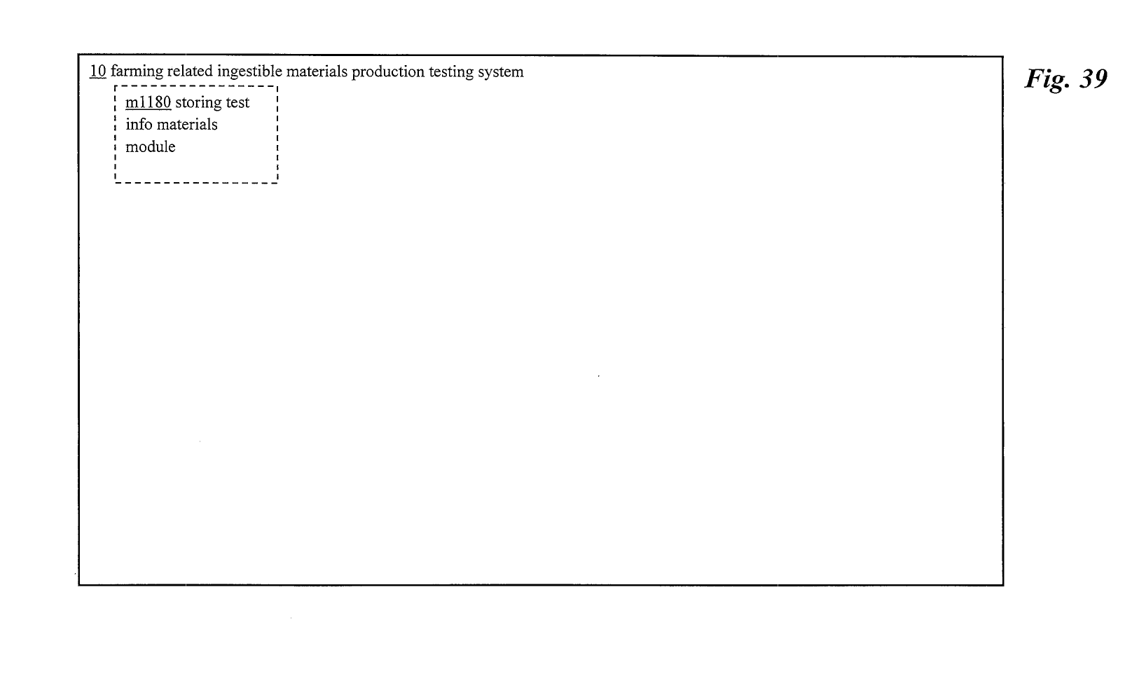

Some of these modules are depicted in FIG. 39 to include storing test info materials.

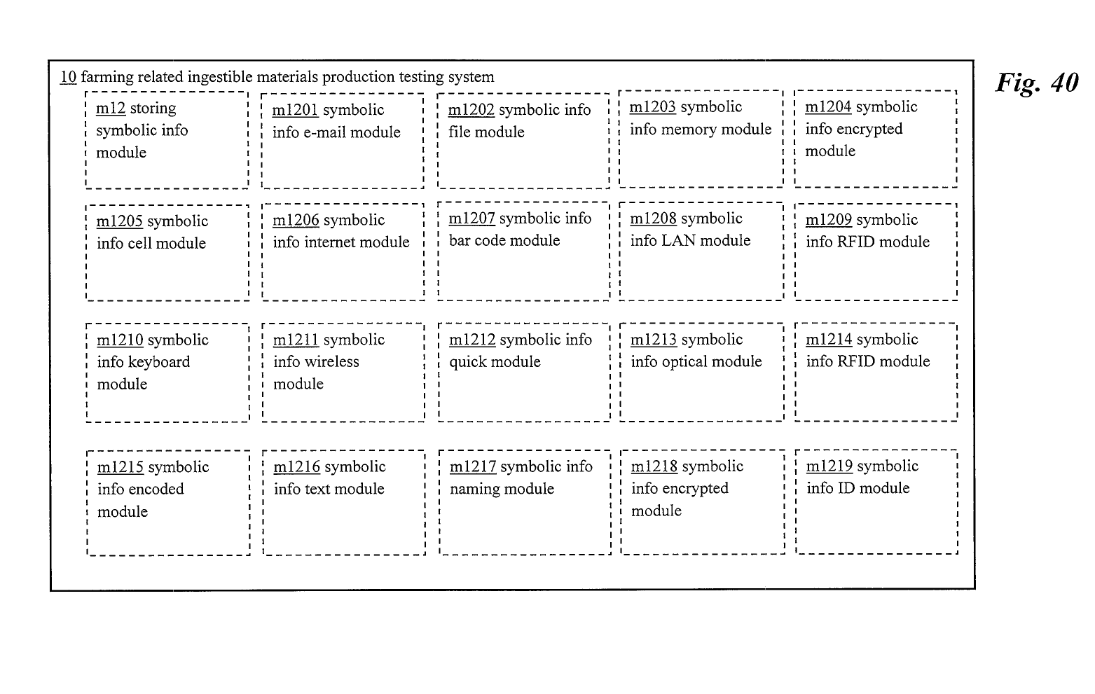

Some of these modules are depicted in FIG. 40 to include storing symbolic info module m12, symbolic info e-mail module m1201, symbolic info file module m1202, symbolic info memory module m1203, symbolic info encrypted module m1204, symbolic info cell module m1205, symbolic info internet module m1206, symbolic info bar code module m1207, symbolic info LAN module m1208, symbolic info RFID module m1209, symbolic info keyboard module m1210, symbolic info wireless module m1211, and symbolic info quick module m1212, symbolic info optical module m1213, symbolic info RFID module m1214, symbolic info encoded module m1215, symbolic info text module m1216, symbolic info naming module m1217, symbolic info encrypted module m1218, and symbolic info ID module m1219.

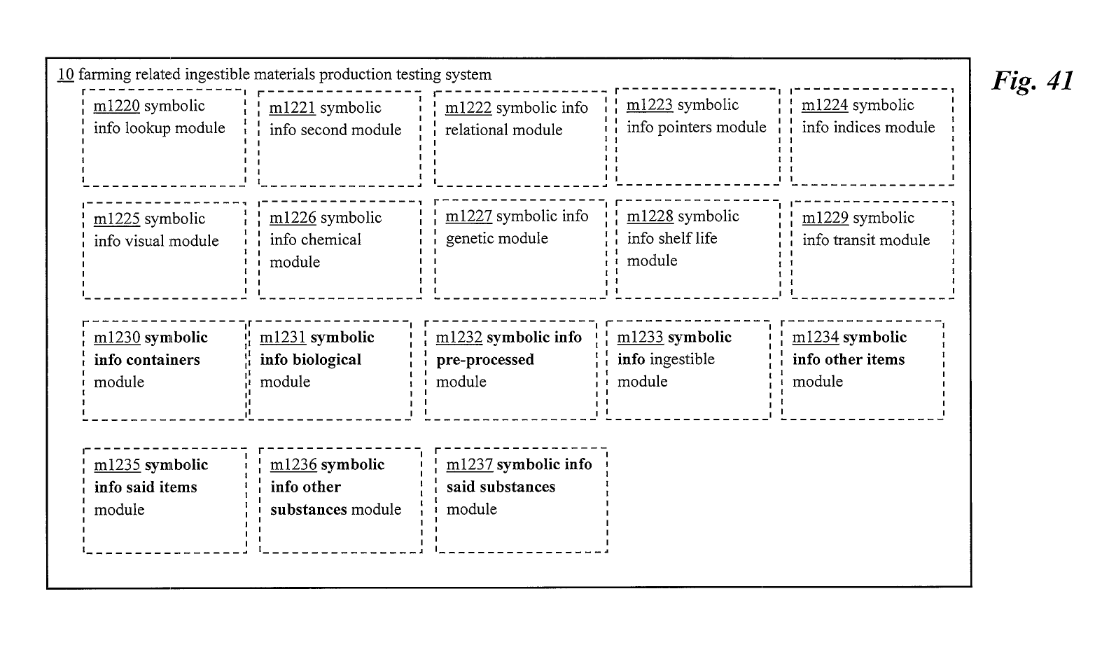

Some of these modules are depicted in FIG. 41 to include symbolic info lookup module m12, symbolic info second module m1221, symbolic info relational module m1222, symbolic info pointers module m1223, symbolic info indices module m1224, symbolic info visual module m1225, symbolic info chemical module m1226, symbolic info genetic module m1227, symbolic info shelf life module m1228, symbolic info transit module m1229, symbolic info other items module m1234, symbolic info biological module m1231, symbolic info pre-processed module m1232, symbolic info ingestible module m1233, symbolic info other items module m1234, symbolic info said items module m1235, symbolic info other substances module m1236, and symbolic info said substances module m1237.

In some implementations, non-transistory signal-bearing medium of information storage subsystem s200 as articles of manufacture may store the one or more exemplary instructions. In some implementations, the non-transistory signal bearing medium may include a computer-readable medium. In some implementations, the non-transitory signal-bearing medium may include a recordable medium. In some implementations, the signal-bearing medium may include a communication medium.

The various subsystems and components of the farming related ingestible materials production testing system s10 such as the control and information processing subsystem s100, the information storage subsystem s200, the information user interface subsystem s300, the sensing subsystem s400 and the electronic communication subsystem s500 and their sub-components and the other exemplary entities depicted may be embodied by hardware, software and/or firmware (limited to patentable subject matter under 35 USC 101). For example, in some implementations of the farming related ingestible materials production testing system s10, aspects may be implemented with a processor (e.g., microprocessor, controller, and so forth) executing computer readable instructions (e.g., computer program product) stored in a storage medium (e.g., volatile or non-volatile memory) such as a signal-bearing medium. Alternatively, hardware such as application specific integrated circuit (ASIC) may be employed in order to implement such modules in some alternative implementations.

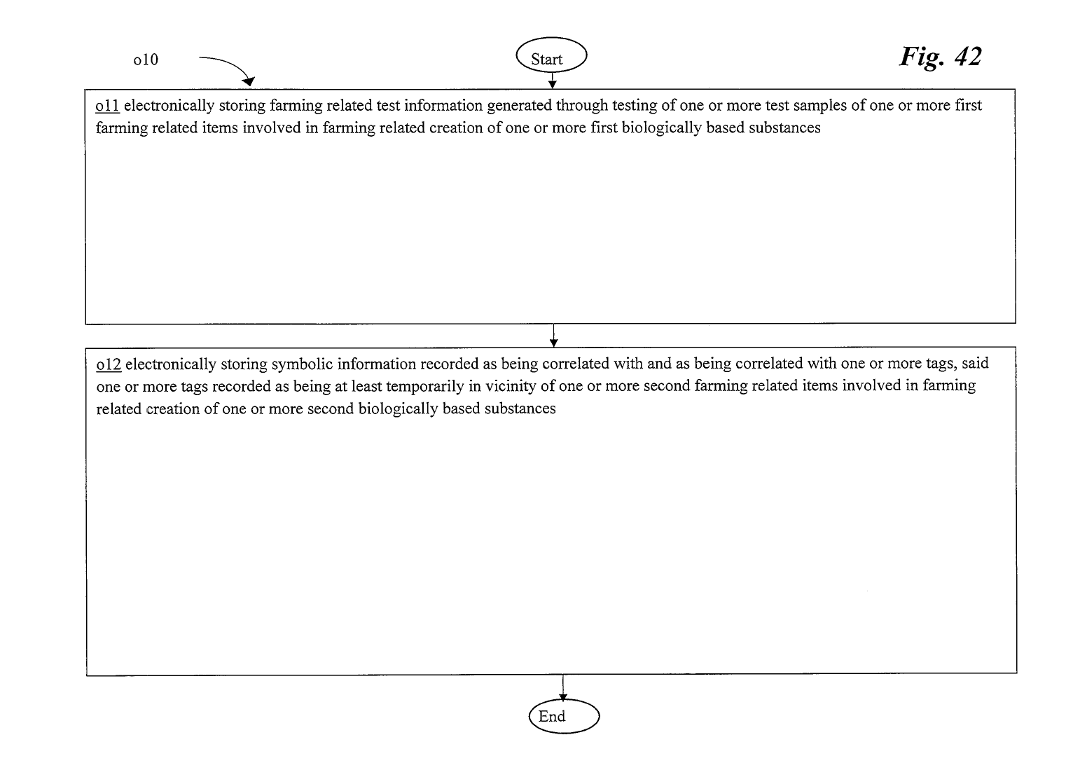

An operational flow o10 as shown in FIG. 42 represents example operations related to electronically storing farming related test information generated through testing of one or more test samples of one or more first farming related items involved in farming related creation of one or more first biologically based substances and electronically storing symbolic information recorded as being correlated with and as being correlated with one or more tags, said one or more tags recorded as being at least temporarily in vicinity of one or more second farming related items involved in farming related creation of one or more second biologically based substances.

FIG. 42 and those figures that follow may have various examples of operational flows, and explanation may be provided with respect to the above-described examples of FIGS. 1-11 and/or with respect to other examples and contexts. Nonetheless, it should be understood that the operational flows may be executed in a number of other environments and contexts, and/or in modified versions of FIGS. 1-11. Furthermore, although the various operational flows are presented in the sequence(s) illustrated, it should be understood that the various operations may be performed in other orders than those which are illustrated, or may be performed concurrently.

In FIG. 42 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

As shown in FIG. 42, the operational flow o10 proceeds to operation o11 for electronically storing farming related test information generated through testing of one or more test samples of one or more first farming related items involved in farming related creation of one or more first biologically based substances. An exemplary version of a non-transitory signal bearing medium of information storage subsystem s200 is depicted as bearing one or more storing test info instructions ill that when executed will direct performance of the operation o11. In an implementation, the one or more storing test info instructions ill when executed direct electronically storing (e.g. stored from SMTP server, stored from push-based file transfer, stored from compact flash card access, etc.) farming related test information (e.g. testing of methane presence, monitoring of long-term effects of calcium on alfalfa, testing of polyphenol levels in grape seed, etc.) generated through testing of (e.g. through automated testing, through manual testing, through destructive testing, etc.) one or more test samples of (e.g. one or more test tube samples, one or more air samples, one or more dirt samples, etc.) one or more first farming related items involved in (e.g. cost of shipping container dimensions, time of sunrise, gross capacity of vessel, etc.) farming related creation of (e.g. oat harvesting, carrot growing, lentil cultivation, etc.) one or more first biologically based substances (e.g. king crab, cellulous, wood, etc.). Furthermore, the storing test info electrical circuitry arrangement (“elec circ arrange”) e11 when activated will perform the operation o1101. Also, the storing test info e-mail module m1101, when executed and/or activated, will direct performance of and/or performs the operation o11. In an implementation, the storing test info electrical circuitry arrangement e11, when activated performs electronically storing (e.g. stored from SMTP server, stored from push-based file transfer, stored from compact flash card access, etc.) farming related test information (e.g. testing of methane presence, monitoring of long-term effects of calcium on alfalfa, testing of polyphenol levels in grape seed, etc.) generated through testing of (e.g. through automated testing, through manual testing, through destructive testing, etc.) one or more test samples of (e.g. one or more test tube samples, one or more air samples, one or more dirt samples, etc.) one or more first farming related items involved in (e.g. cost of shipping container dimensions, time of sunrise, gross capacity of vessel, etc.) farming related creation of (e.g. oat harvesting, carrot growing, lentil cultivation, etc.) one or more first biologically based substances (e.g. king crab, cellulous, wood, etc.). Also, the storing test info module m11, when executed and/or activated, will direct performance of and/or perform the operation o11. In an implementation, the electronically storing farming related test information generated through testing of one or more test samples of one or more first farming related items involved in farming related creation of one or more first biologically based substances is carried out by electronically storing (e.g. stored from SMTP server, stored from push-based file transfer, stored from compact flash card access, etc.) farming related test information (e.g. testing of methane presence, monitoring of long-term effects of calcium on alfalfa, testing of polyphenol levels in grape seed, etc.) generated through testing of (e.g. through automated testing, through manual testing, through destructive testing, etc.) one or more test samples of (e.g. one or more test tube samples, one or more air samples, one or more dirt samples, etc.) one or more first farming related items involved in (e.g. cost of shipping container dimensions, time of sunrise, gross capacity of vessel, etc.) farming related creation of (e.g. oat harvesting, carrot growing, lentil cultivation, etc.) one or more first biologically based substances (e.g. king crab, cellulous, wood, etc.).

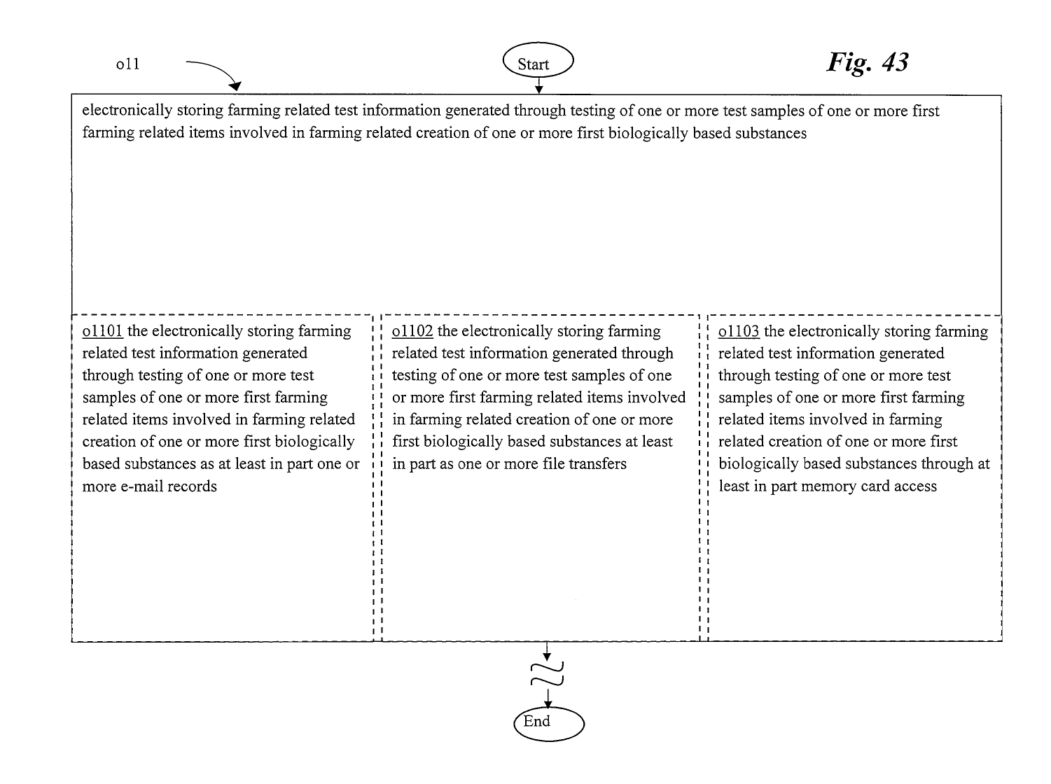

In one or more implementations, as shown in FIG. 43, operation o11 includes an operation o1101 for the electronically storing farming related test information generated through testing of one or more test samples of one or more first farming related items involved in farming related creation of one or more first biologically based substances as at least in part one or more e-mail records. Origination of an illustratively derived storing test info e-mail component group can be accomplished through skilled in the art design choice selection of one or more of the above depicted components from one or more of the above depicted subsystems shown in FIG. 12. Components from the storing test info e-mail component group can be used in implementing execution of the one or more storing test info e-mail instructions i1101 of FIG. 28, can be used in performance of the storing test info e-mail electrical circuitry arrangement e1101 of FIG. 21, and/or can be used in otherwise fulfillment of the operation o1101. An exemplary non-transitory signal bearing medium version of the information storage subsystem s200 is depicted in FIG. 28 as bearing the one or more storing test info e-mail instructions i1101 that when executed will direct performance of the operation o1101. Furthermore, the storing test info e-mail electrical circuitry arrangement (“elec circ arrange”) e1101, when activated, will perform the operation o1101. Also, the storing test info e-mail module m1101, when executed and/or activated, will direct performance of and/or perform the operation o1101. For instance, in one or more exemplary implementations, the one or more storing test info e-mail instructions i1101, when executed, direct performance of the operation o1101 in the illustrative depiction as follows, and/or the storing test info e-mail electrical circuitry arrangement e1101, when activated, performs the operation o1101 in the illustrative depiction as follows, and/or the storing test info e-mail module m1101, when executed and/or activated, directs performance of and/or performs the operation o1101 in the illustrative depiction as follows, and/or the operation o1101 is otherwise carried out in the illustrative depiction as follows: the electronically storing (e.g. stored from SMTP server, etc.) farming related test information (e.g. testing of methane presence, etc.) generated through testing of (e.g. through automated testing, etc.) one or more test samples of (e.g. one or more test tube samples, etc.) one or more first farming related items involved in (e.g. cost of shipping container dimensions, etc.) farming related creation of (e.g. oat harvesting, etc.) one or more first biologically based substances (e.g. king crab, etc.) as at least in part one or more e-mail records (e.g. database of e-mail attachments transferred by handheld devices, etc.).

In one or more implementations, as shown in FIG. 43, operation o11 includes an operation o1102 for the electronically storing farming related test information generated through testing of one or more test samples of one or more first farming related items involved in farming related creation of one or more first biologically based substances at least in part as one or more file transfers. Origination of an illustratively derived storing test info file component group can be accomplished through skilled in the art design choice selection of one or more of the above depicted components from one or more of the above depicted subsystems shown in FIG. 12. Components from the storing test info file component group can be used in implementing execution of the one or more storing test info file instructions i1102 of FIG. 28, can be used in performance of the storing test info file electrical circuitry arrangement e1102 of FIG. 21, and/or can be used in otherwise fulfillment of the operation o1102. An exemplary non-transitory signal bearing medium version of the information storage subsystem s200 is depicted in FIG. 28 as bearing the one or more storing test info file instructions i1102 that when executed will direct performance of the operation o1102. Furthermore, the storing test info file electrical circuitry arrangement (“elec circ arrange”) e1102, when activated, will perform the operation o1102. Also, the storing test info file module m1102, when executed and/or activated, will direct performance of and/or perform the operation o1102. For instance, in one or more exemplary implementations, the one or more storing test info file instructions i1102, when executed, direct performance of the operation o1102 in the illustrative depiction as follows, and/or the storing test info file electrical circuitry arrangement e1102, when activated, performs the operation O1102 in the illustrative depiction as follows, and/or the storing test info file module m1102, when executed and/or activated, directs performance of and/or performs the operation o1102 in the illustrative depiction as follows, and/or the operation o1102 is otherwise carried out in the illustrative depiction as follows: the electronically storing (e.g. stored from push-based file transfer, etc.) farming related test information (e.g. monitoring of long-term effects of calcium on alfalfa, etc.) generated through testing of (e.g. through manual testing, etc.) one or more test samples of (e.g. one or more air samples, etc.) one or more first farming related items involved in (e.g. time of sunrise, etc.) farming related creation of (e.g. carrot growing, etc.) one or more first biologically based substances (e.g. cellulous, etc.) at least in part as one or more file transfers (e.g. records transmitting as peer-to-peer file transfers to be electronically stored on server, etc.).

In one or more implementations, as shown in FIG. 43, operation o11 includes an operation o1103 for the electronically storing farming related test information generated through testing of one or more test samples of one or more first farming related items involved in farming related creation of one or more first biologically based substances through at least in part memory card access. Origination of an illustratively derived storing test info memory component group can be accomplished through skilled in the art design choice selection of one or more of the above depicted components from one or more of the above depicted subsystems shown in FIG. 12. Components from the storing test info memory component group can be used in implementing execution of the one or more storing test info memory instructions i1103 of FIG. 28, can be used in performance of the storing test info memory electrical circuitry arrangement e1103 of FIG. 21, and/or can be used in otherwise fulfillment of the operation o1103. An exemplary non-transitory signal bearing medium version of the information storage subsystem s200 is depicted in FIG. 28 as bearing the one or more storing test info memory instructions i1103 that when executed will direct performance of the operation o1103. Furthermore, the storing test info memory electrical circuitry arrangement (“elec circ arrange”) e1103, when activated, will perform the operation o1103. Also, the storing test info memory module m1103, when executed and/or activated, will direct performance of and/or perform the operation o1103. For instance, in one or more exemplary implementations, the one or more storing test info memory instructions i1103, when executed, direct performance of the operation o1103 in the illustrative depiction as follows, and/or the storing test info memory electrical circuitry arrangement e1103, when activated, performs the operation o1103 in the illustrative depiction as follows, and/or the storing test info memory module m1103, when executed and/or activated, directs performance of and/or performs the operation o1103 in the illustrative depiction as follows, and/or the operation o1103 is otherwise carried out in the illustrative depiction as follows: the electronically storing (e.g. stored from compact flash card access, etc.) farming related test information (e.g. testing of polyphenol levels in grape seed, etc.) generated through testing of (e.g. through destructive testing, etc.) one or more test samples of (e.g. one or more dirt samples, etc.) one or more first farming related items involved in (e.g. gross capacity of vessel, etc.) farming related creation of (e.g. lentil cultivation, etc.) one or more first biologically based substances (e.g. wood, etc.) through at least in part memory card access (e.g. memory card part of handheld device, etc.).

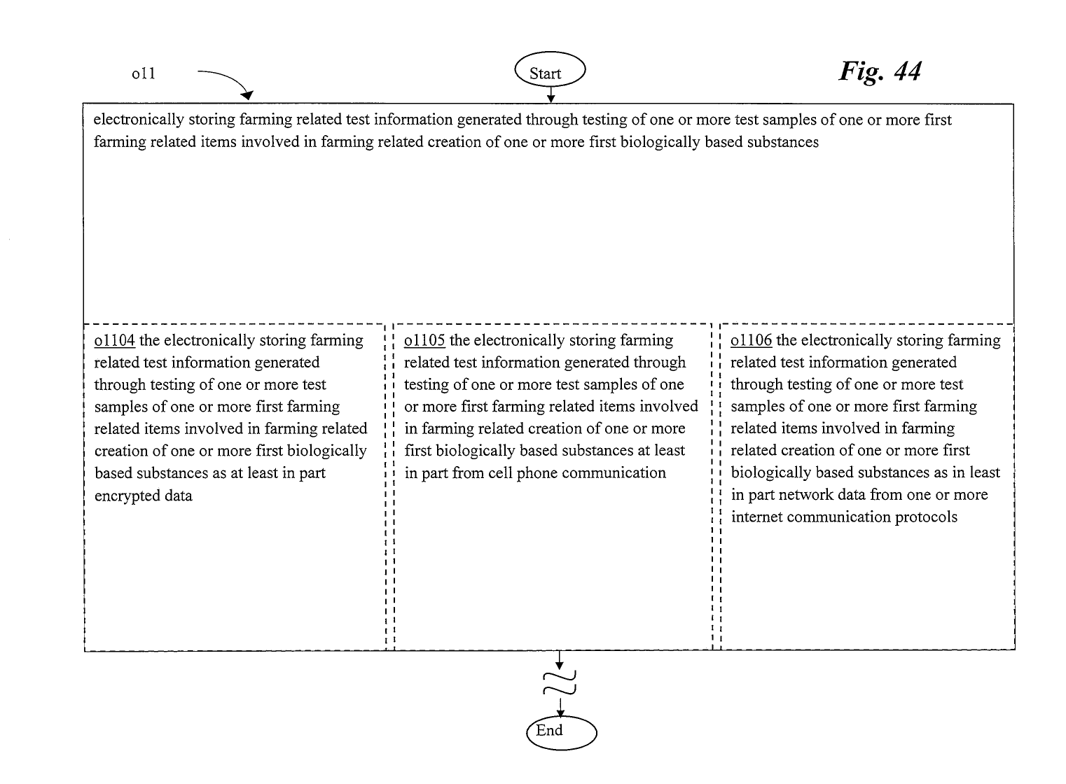

In one or more implementations, as shown in FIG. 44, operation o11 includes an operation o1104 for the electronically storing farming related test information generated through testing of one or more test samples of one or more first farming related items involved in farming related creation of one or more first biologically based substances as at least in part encrypted data. Origination of an illustratively derived storing test info encrypted component group can be accomplished through skilled in the art design choice selection of one or more of the above depicted components from one or more of the above depicted subsystems shown in FIG. 12. Components from the storing test info encrypted component group can be used in implementing execution of the one or more storing test info encrypted instructions i1104 of FIG. 28, can be used in performance of the storing test info encrypted electrical circuitry arrangement e1104 of FIG. 21, and/or can be used in otherwise fulfillment of the operation o1104. An exemplary non-transitory signal bearing medium version of the information storage subsystem s200 is depicted in FIG. 28 as bearing the one or more storing test info encrypted instructions i1104 that when executed will direct performance of the operation o1104. Furthermore, the storing test info encrypted electrical circuitry arrangement (“elec circ arrange”) e1104, when activated, will perform the operation o1104. Also, the storing test info encrypted module m1104, when executed and/or activated, will direct performance of and/or perform the operation o1104. For instance, in one or more exemplary implementations, the one or more storing test info encrypted instructions i1104, when executed, direct performance of the operation o1104 in the illustrative depiction as follows, and/or the storing test info encrypted electrical circuitry arrangement e1104, when activated, performs the operation o1104 in the illustrative depiction as follows, and/or the storing test info encrypted module m1104, when executed and/or activated, directs performance of and/or performs the operation o1104 in the illustrative depiction as follows, and/or the operation o1104 is otherwise carried out in the illustrative depiction as follows: the electronically storing (e.g. stored from 256-bit AES encrypted data, etc.) farming related test information (e.g. monitoring of glycosylation of plant matter, etc.) generated through testing of (e.g. through reconstructive testing, etc.) one or more test samples of (e.g. one or more aquatic samples, etc.) one or more first farming related items involved in (e.g. cost of vessel maintenance, etc.) farming related creation of (e.g. rice threshing, etc.) one or more first biologically based substances (e.g. manure, etc.) as at least in part encrypted data (e.g. storing on encrypted server, etc.).

In one or more implementations, as shown in FIG. 44, operation o11 includes an operation o1105 for the electronically storing farming related test information generated through testing of one or more test samples of one or more first farming related items involved in farming related creation of one or more first biologically based substances at least in part from cell phone communication. Origination of an illustratively derived storing test info cell component group can be accomplished through skilled in the art design choice selection of one or more of the above depicted components from one or more of the above depicted subsystems shown in FIG. 12. Components from the storing test info cell component group can be used in implementing execution of the one or more storing test info cell instructions i1105 of FIG. 28, can be used in performance of the storing test info cell electrical circuitry arrangement e1105 of FIG. 21, and/or can be used in otherwise fulfillment of the operation o1105. An exemplary non-transitory signal bearing medium version of the information storage subsystem s200 is depicted in FIG. 28 as bearing the one or more storing test info cell instructions i1105 that when executed will direct performance of the operation o1105. Furthermore, the storing test info cell electrical circuitry arrangement (“elec circ arrange”) e1105, when activated, will perform the operation o1105. Also, the storing test info cell module m1105, when executed and/or activated, will direct performance of and/or perform the operation o1105. For instance, in one or more exemplary implementations, the one or more storing test info cell instructions i1105, when executed, direct performance of the operation o1105 in the illustrative depiction as follows, and/or the storing test info cell electrical circuitry arrangement e1105, when activated, performs the operation o1105 in the illustrative depiction as follows, and/or the storing test info cell module m1105, when executed and/or activated, directs performance of and/or performs the operation o1105 in the illustrative depiction as follows, and/or the operation o1105 is otherwise carried out in the illustrative depiction as follows: the electronically storing (e.g. stored from MMS communication, etc.) farming related test information (e.g. monitoring effects of rhizobia inoculation, etc.) generated through testing of (e.g. through computer controlled testing, etc.) one or more test samples of (e.g. one or more geologic samples, etc.) one or more first farming related items involved in (e.g. tide schedule, etc.) farming related creation of (e.g. apple harvesting, etc.) one or more first biologically based substances (e.g. ground chicken, etc.) at least in part from cell phone communication (e.g. storing from smart phone communication, etc.).

In one or more implementations, as shown in FIG. 44, operation o11 includes an operation o1106 for the electronically storing farming related test information generated through testing of one or more test samples of one or more first farming related items involved in farming related creation of one or more first biologically based substances as in least in part network data from one or more internet communication protocols. Origination of an illustratively derived storing test info internet component group can be accomplished through skilled in the art design choice selection of one or more of the above depicted components from one or more of the above depicted subsystems shown in FIG. 12. Components from the storing test info internet component group can be used in implementing execution of the one or more storing test info internet instructions i1106 of FIG. 28, can be used in performance of the storing test info internet electrical circuitry arrangement e1106 of FIG. 21, and/or can be used in otherwise fulfillment of the operation o1106. An exemplary non-transitory signal bearing medium version of the information storage subsystem s200 is depicted in FIG. 28 as bearing the one or more storing test info internet instructions i1106 that when executed will direct performance of the operation o1106. Furthermore, the storing test info internet electrical circuitry arrangement (“elec circ arrange”) e1106, when activated, will perform the operation o1106. Also, the storing test info internet module m1106, when executed and/or activated, will direct performance of and/or perform the operation o1106. For instance, in one or more exemplary implementations, the one or more storing test info internet instructions i1106, when executed, direct performance of the operation o1106 in the illustrative depiction as follows, and/or the storing test info internet electrical circuitry arrangement e1106, when activated, performs the operation o1106 in the illustrative depiction as follows, and/or the storing test info internet module m1106, when executed and/or activated, directs performance of and/or performs the operation O1106 in the illustrative depiction as follows, and/or the operation o1106 is otherwise carried out in the illustrative depiction as follows: the electronically storing (e.g. stored from TCP/IP communication, etc.) farming related test information (e.g. monitoring cultivation management decisions, etc.) generated through testing of (e.g. via remote controlled testing, etc.) one or more test samples of (e.g. one or more biologic samples, etc.) one or more first farming related items involved in (e.g. herbicide type, etc.) farming related creation of (e.g. crab trapping, etc.) one or more first biologically based substances (e.g. chicken feathers, etc.) as in least in part network data from one or more internet communication protocols (e.g. storing on internet based server, etc.).

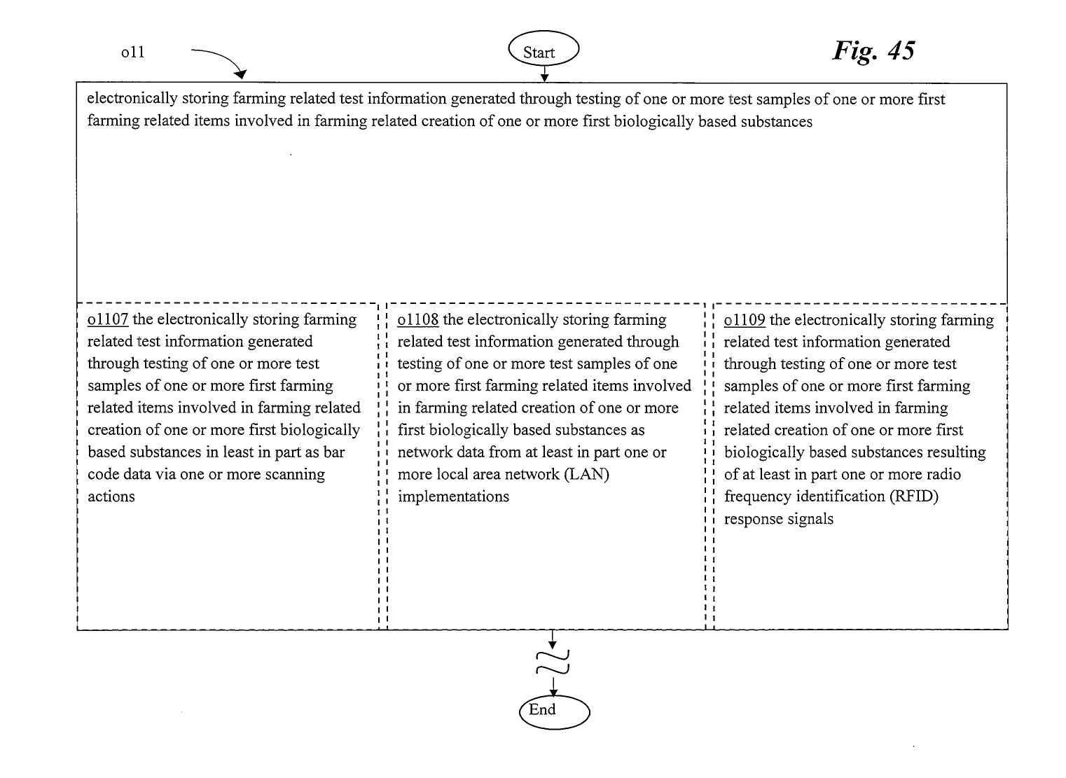

In one or more implementations, as shown in FIG. 45, operation o11 includes an operation o1107 for the electronically storing farming related test information generated through testing of one or more test samples of one or more first farming related items involved in farming related creation of one or more first biologically based substances in least in part as bar code data via one or more scanning actions. Origination of an illustratively derived storing test info bar code component group can be accomplished through skilled in the art design choice selection of one or more of the above depicted components from one or more of the above depicted subsystems shown in FIG. 12. Components from the storing test info bar code component group can be used in implementing execution of the one or more storing test info bar code instructions i1107 of FIG. 28, can be used in performance of the storing test info bar code electrical circuitry arrangement e1107 of FIG. 21, and/or can be used in otherwise fulfillment of the operation o1107. An exemplary non-transitory signal bearing medium version of the information storage subsystem s200 is depicted in FIG. 28 as bearing the one or more storing test info bar code instructions i1107 that when executed will direct performance of the operation o1107. Furthermore, the storing test info bar code electrical circuitry arrangement (“elec circ arrange”) e1107, when activated, will perform the operation o1107. Also, the storing test info bar code module m1107, when executed and/or activated, will direct performance of and/or perform the operation o1107. For instance, in one or more exemplary implementations, the one or more storing test info bar code instructions i1107, when executed, direct performance of the operation o1107 in the illustrative depiction as follows, and/or the storing test info bar code electrical circuitry arrangement e1107, when activated, performs the operation o1107 in the illustrative depiction as follows, and/or the storing test info bar code module m1107, when executed and/or activated, directs performance of and/or performs the operation o1107 in the illustrative depiction as follows, and/or the operation o1107 is otherwise carried out in the illustrative depiction as follows: the electronically storing (e.g. stored from UPC scan, etc.) farming related test information (e.g. testing boron levels, etc.) generated through testing of (e.g. via internet controlled testing, etc.) one or more test samples of (e.g. one or more chemical samples, etc.) one or more first farming related items involved in (e.g. nutrient additive to diet, etc.) farming related creation of (e.g. mushroom cultivation, etc.) one or more first biologically based substances (e.g. hoofs, etc.) in least in part as bar code data via one or more scanning actions (e.g. storing into hand-held bar code scanner, etc.).

In one or more implementations, as shown in FIG. 45, operation o11 includes an operation o1108 for the electronically storing farming related test information generated through testing of one or more test samples of one or more first farming related items involved in farming related creation of one or more first biologically based substances as network data from at least in part one or more local area network (LAN) implementations. Origination of an illustratively derived storing test info LAN component group can be accomplished through skilled in the art design choice selection of one or more of the above depicted components from one or more of the above depicted subsystems shown in FIG. 12. Components from the storing test info LAN component group can be used in implementing execution of the one or more storing test info LAN instructions i1108 of FIG. 28, can be used in performance of the storing test info LAN electrical circuitry arrangement e1108 of FIG. 21, and/or can be used in otherwise fulfillment of the operation o1108. An exemplary non-transitory signal bearing medium version of the information storage subsystem s200 is depicted in FIG. 28 as bearing the one or more storing test info LAN instructions i1108 that when executed will direct performance of the operation o1108. Furthermore, the storing test info LAN electrical circuitry arrangement (“elec circ arrange”) e1108, when activated, will perform the operation o1108. Also, the storing test info LAN module m1108, when executed and/or activated, will direct performance of and/or perform the operation o1108. For instance, in one or more exemplary implementations, the one or more storing test info LAN instructions i1108, when executed, direct performance of the operation o1108 in the illustrative depiction as follows, and/or the storing test info LAN electrical circuitry arrangement e1108, when activated, performs the operation o1108 in the illustrative depiction as follows, and/or the storing test info LAN module m1108, when executed and/or activated, directs performance of and/or performs the operation o1108 in the illustrative depiction as follows, and/or the operation o1108 is otherwise carried out in the illustrative depiction as follows: the electronically storing (e.g. stored from ethernet, etc.) farming related test information (e.g. testing for presence of bovine spongiform encephalopathy, etc.) generated through testing of (e.g. via networked testing, etc.) one or more test samples of (e.g. one or more microscopic samples, etc.) one or more first farming related items involved in (e.g. invasive plant type, etc.) farming related creation of (e.g. alfalfa cutting, etc.) one or more first biologically based substances (e.g. leather, etc.) as network data from at least in part one or more local area network (LAN) implementations (e.g. storing on wireless LAN based server, etc.).

In one or more implementations, as shown in FIG. 45, operation o11 includes an operation o1109 for the electronically storing farming related test information generated through testing of one or more test samples of one or more first farming related items involved in farming related creation of one or more first biologically based substances resulting of at least in part one or more radio frequency identification (RFID) response signals. Origination of an illustratively derived storing test info RFID component group can be accomplished through skilled in the art design choice selection of one or more of the above depicted components from one or more of the above depicted subsystems shown in FIG. 12. Components from the storing test info RFID component group can be used in implementing execution of the one or more storing test info RFID instructions i1109 of FIG. 28, can be used in performance of the storing test info RFID electrical circuitry arrangement e1109 of FIG. 21, and/or can be used in otherwise fulfillment of the operation o1109. An exemplary non-transitory signal bearing medium version of the information storage subsystem s200 is depicted in FIG. 28 as bearing the one or more storing test info RFID instructions i1109 that when executed will direct performance of the operation o1109. Furthermore, the storing test info RFID electrical circuitry arrangement (“elec circ arrange”) e1109, when activated, will perform the operation o1109. Also, the storing test info RFID module m1109, when executed and/or activated, will direct performance of and/or perform the operation o1109. For instance, in one or more exemplary implementations, the one or more storing test info RFID instructions i1109, when executed, direct performance of the operation o1109 in the illustrative depiction as follows, and/or the storing test info RFID electrical circuitry arrangement e1109, when activated, performs the operation o1109 in the illustrative depiction as follows, and/or the storing test info RFID module m1109, when executed and/or activated, directs performance of and/or performs the operation o1109 in the illustrative depiction as follows, and/or the operation o1109 is otherwise carried out in the illustrative depiction as follows: the electronically storing (e.g. stored from high frequency RFID scan, etc.) farming related test information (e.g. monitoring root depth, etc.) generated through testing of (e.g. through central testing, etc.) one or more test samples of (e.g. one or more micro-array samples, etc.) one or more first farming related items involved in (e.g. feeding schedule, etc.) farming related creation of (e.g. potato harvesting, etc.) one or more first biologically based substances (e.g. fur, etc.) resulting of at least in part one or more radio frequency identification (RFID) response signals (e.g. storing radio beacon signals, etc.).

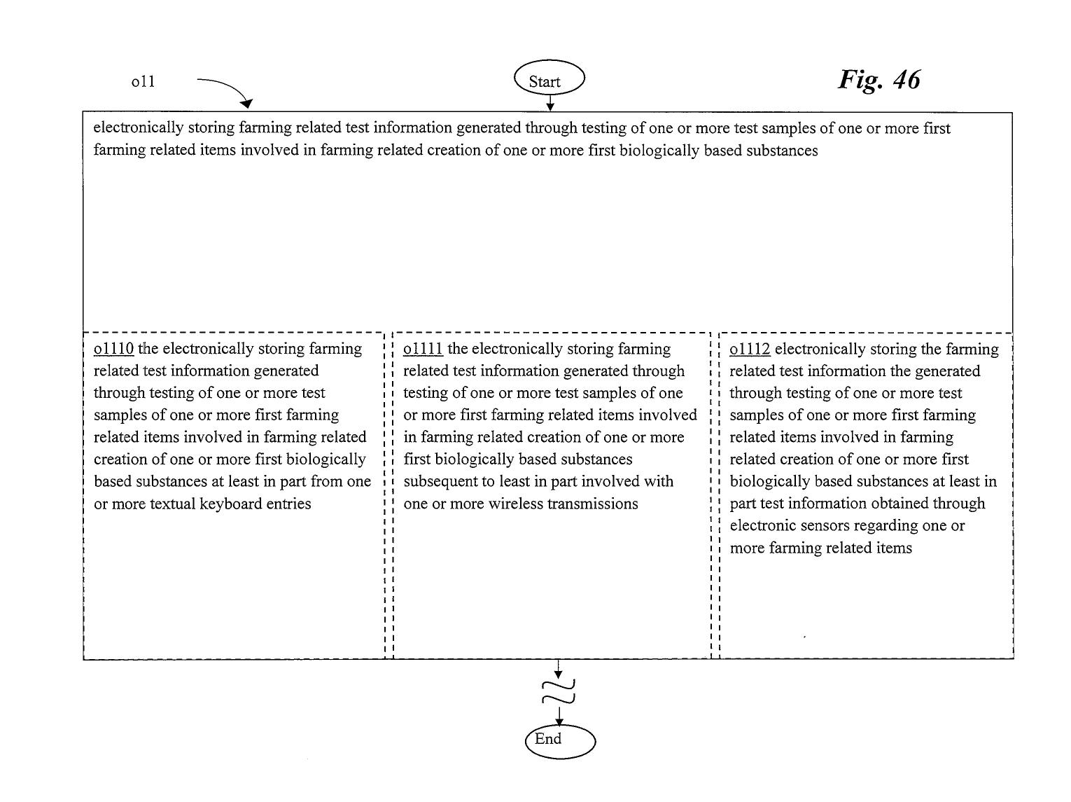

In one or more implementations, as shown in FIG. 46, operation o11 includes an operation o1110 for the electronically storing farming related test information generated through testing of one or more test samples of one or more first farming related items involved in farming related creation of one or more first biologically based substances at least in part from one or more textual keyboard entries. Origination of an illustratively derived storing test info keyboard component group can be accomplished through skilled in the art design choice selection of one or more of the above depicted components from one or more of the above depicted subsystems shown in FIG. 12. Components from the storing test info keyboard component group can be used in implementing execution of the one or more storing test info keyboard instructions i1110 of FIG. 28, can be used in performance of the storing test info keyboard electrical circuitry arrangement e1110 of FIG. 21, and/or can be used in otherwise fulfillment of the operation o1110. An exemplary non-transitory signal bearing medium version of the information storage subsystem s200 is depicted in FIG. 28 as bearing the one or more storing test info keyboard instructions i1110 that when executed will direct performance of the operation o1110. Furthermore, the storing test info keyboard electrical circuitry arrangement (“elec circ arrange”) e1110, when activated, will perform the operation o1110. Also, the storing test info keyboard module m1110, when executed and/or activated, will direct performance of and/or perform the operation o1110. For instance, in one or more exemplary implementations, the one or more storing test info keyboard instructions i1110, when executed, direct performance of the operation o1110 in the illustrative depiction as follows, and/or the storing test info keyboard electrical circuitry arrangement e1110, when activated, performs the operation o1110 in the illustrative depiction as follows, and/or the storing test info keyboard module m1110, when executed and/or activated, directs performance of and/or performs the operation o1110 in the illustrative depiction as follows, and/or the operation o1110 is otherwise carried out in the illustrative depiction as follows: the electronically storing (e.g. stored from laptop entry, etc.) farming related test information (e.g. monitoring UV index, etc.) generated through testing of (e.g. through laboratory testing, etc.) one or more test samples of (e.g. one or more Gaussian distribution samples, etc.) one or more first farming related items involved in (e.g. lighting schedule, etc.) farming related creation of (e.g. beet root harvesting, etc.) one or more first biologically based substances (e.g. wool, etc.) at least in part from one or more textual keyboard entries (e.g. storing field worker entries on laptop, etc.).

In one or more implementations, as shown in FIG. 46, operation o11 includes an operation o1111 for the electronically storing farming related test information generated through testing of one or more test samples of one or more first farming related items involved in farming related creation of one or more first biologically based substances subsequent to least in part involved with one or more wireless transmissions. Origination of an illustratively derived storing test info wireless component group can be accomplished through skilled in the art design choice selection of one or more of the above depicted components from one or more of the above depicted subsystems shown in FIG. 12. Components from the storing test info wireless component group can be used in implementing execution of the one or more storing test info wireless instructions i1111 of FIG. 28, can be used in performance of the storing test info wireless electrical circuitry arrangement e1111 of FIG. 21, and/or can be used in otherwise fulfillment of the operation o1111. An exemplary non-transitory signal bearing medium version of the information storage subsystem s200 is depicted in FIG. 28 as bearing the one or more storing test info wireless instructions i1111 that when executed will direct performance of the operation o1111. Furthermore, the storing test info wireless electrical circuitry arrangement (“elec circ arrange”) e1111, when activated, will perform the operation o1111. Also, the storing test info wireless module m1111, when executed and/or activated, will direct performance of and/or perform the operation o1111. For instance, in one or more exemplary implementations, the one or more storing test info wireless instructions i1111, when executed, direct performance of the operation o1111 in the illustrative depiction as follows, and/or the storing test info wireless electrical circuitry arrangement e1111, when activated, performs the operation o1111 in the illustrative depiction as follows, and/or the storing test info wireless module m1111, when executed and/or activated, directs performance of and/or performs the operation o1111 in the illustrative depiction as follows, and/or the operation o1111 is otherwise carried out in the illustrative depiction as follows: the electronically storing (e.g. stored from wifi transmission, etc.) farming related test information (e.g. testing pecan levels in plant matter, etc.) generated through testing of (e.g. through test kit testing, etc.) one or more test samples of (e.g. one or more random samples, etc.) one or more first farming related items involved in (e.g. type of pollination required, etc.) farming related creation of (e.g. cherry picking, etc.) one or more first biologically based substances (e.g. feed grain, etc.) subsequent to least in part involved with one or more wireless transmissions (e.g. storing WIFI based transmissions, etc.).

In one or more implementations, as shown in FIG. 46, operation o11 includes an operation o1112 for electronically storing the farming related test information the generated through testing of one or more test samples of one or more first farming related items involved in farming related creation of one or more first biologically based substances at least in part test information obtained through electronic sensors regarding one or more farming related items. Origination of an illustratively derived storing test info sensors component group can be accomplished through skilled in the art design choice selection of one or more of the above depicted components from one or more of the above depicted subsystems shown in FIG. 12. Components from the storing test info sensors component group can be used in implementing execution of the one or more storing test info sensors instructions i1112 of FIG. 28, can be used in performance of the storing test info sensors electrical circuitry arrangement e1112 of FIG. 21, and/or can be used in otherwise fulfillment of the operation o1112. An exemplary non-transitory signal bearing medium version of the information storage subsystem s200 is depicted in FIG. 28 as bearing the one or more storing test info sensors instructions i1112 that when executed will direct performance of the operation o1112. Furthermore, the storing test info sensors electrical circuitry arrangement (“elec circ arrange”) e1112, when activated, will perform the operation o1112. Also, the storing test info sensors module m1112, when executed and/or activated, will direct performance of and/or perform the operation o1112. For instance, in one or more exemplary implementations, the one or more storing test info sensors instructions i1112, when executed, direct performance of the operation o1112 in the illustrative depiction as follows, and/or the storing test info sensors electrical circuitry arrangement e1112, when activated, performs the operation o1112 in the illustrative depiction as follows, and/or the storing test info sensors module m1112, when executed and/or activated, directs performance of and/or performs the operation o1112 in the illustrative depiction as follows, and/or the operation o1112 is otherwise carried out in the illustrative depiction as follows: electronically storing (e.g. stored from HTTP, etc.) the farming related test information (e.g. testing nitrogen levels, etc.) the generated through testing of (e.g. through handheld testing, etc.) one or more test samples of (e.g. one or more statistical samples, etc.) one or more first farming related items involved in (e.g. cost of pollinations, etc.) farming related creation of (e.g. peach picking, etc.) one or more first biologically based substances (e.g. beet pulp, etc.) at least in part test information obtained through electronic sensors regarding one or more farming related items (e.g. obtained through electronic air detectors regarding pesticide levels, etc.).

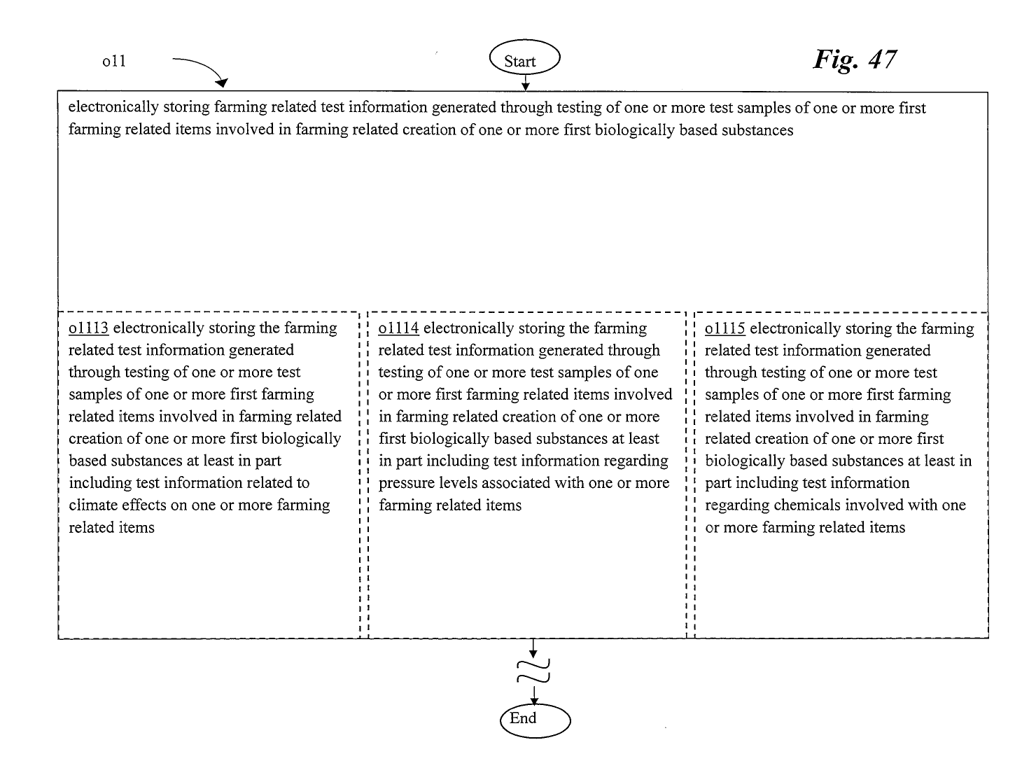

In one or more implementations, as shown in FIG. 47, operation o11 includes an operation o1113 for electronically storing the farming related test information generated through testing of one or more test samples of one or more first farming related items involved in farming related creation of one or more first biologically based substances at least in part including test information related to climate effects on one or more farming related items. Origination of an illustratively derived storing test info climate component group can be accomplished through skilled in the art design choice selection of one or more of the above depicted components from one or more of the above depicted subsystems shown in FIG. 12. Components from the storing test info climate component group can be used in implementing execution of the one or more storing test info climate instructions i1113 of FIG. 28, can be used in performance of the storing test info climate electrical circuitry arrangement e1113 of FIG. 21, and/or can be used in otherwise fulfillment of the operation o1113. An exemplary non-transitory signal bearing medium version of the information storage subsystem s200 is depicted in FIG. 28 as bearing the one or more storing test info climate instructions i1113 that when executed will direct performance of the operation o1113. Furthermore, the storing test info climate electrical circuitry arrangement (“elec circ arrange”) e1113, when activated, will perform the operation o1113. Also, the storing test info climate module m1113, when executed and/or activated, will direct performance of and/or perform the operation o1113. For instance, in one or more exemplary implementations, the one or more storing test info climate instructions i1113, when executed, direct performance of the operation o1113 in the illustrative depiction as follows, and/or the storing test info climate electrical circuitry arrangement e1113, when activated, performs the operation o1113 in the illustrative depiction as follows, and/or the storing test info climate module m1113, when executed and/or activated, directs performance of and/or performs the operation o1113 in the illustrative depiction as follows, and/or the operation o1113 is otherwise carried out in the illustrative depiction as follows: electronically storing (e.g. stored from FTP server, etc.) the farming related test information (e.g. monitoring rainfall, etc.) generated through testing of (e.g. through batch generation, etc.) one or more test samples of (e.g. one or more polling samples, etc.) one or more first farming related items involved in (e.g. duration of pollination, etc.) farming related creation of (e.g. duck egg laying, etc.) one or more first biologically based substances (e.g. water, etc.) at least in part including test information related to climate effects on one or more farming related items (e.g. temperature profiles versus growth rates, etc.).

In one or more implementations, as shown in FIG. 47, operation o11 includes an operation o1114 for electronically storing the farming related test information generated through testing of one or more test samples of one or more first farming related items involved in farming related creation of one or more first biologically based substances at least in part including test information regarding pressure levels associated with one or more farming related items. Origination of an illustratively derived storing test info pressure component group can be accomplished through skilled in the art design choice selection of one or more of the above depicted components from one or more of the above depicted subsystems shown in FIG. 12. Components from the storing test info pressure component group can be used in implementing execution of the one or more storing test info pressure instructions i1114 of FIG. 28, can be used in performance of the storing test info pressure electrical circuitry arrangement e1114 of FIG. 21, and/or can be used in otherwise fulfillment of the operation o1114. An exemplary non-transitory signal bearing medium version of the information storage subsystem s200 is depicted in FIG. 28 as bearing the one or more storing test info pressure instructions i1114 that when executed will direct performance of the operation o1114. Furthermore, the storing test info pressure electrical circuitry arrangement (“elec circ arrange”) e1114, when activated, will perform the operation o1114. Also, the storing test info pressure module m1114, when executed and/or activated, will direct performance of and/or perform the operation o1114. For instance, in one or more exemplary implementations, the one or more storing test info pressure instructions i1114, when executed, direct performance of the operation o1114 in the illustrative depiction as follows, and/or the storing test info pressure electrical circuitry arrangement e1114, when activated, performs the operation o1114 in the illustrative depiction as follows, and/or the storing test info pressure module m1114, when executed and/or activated, directs performance of and/or performs the operation o1114 in the illustrative depiction as follows, and/or the operation o1114 is otherwise carried out in the illustrative depiction as follows: electronically storing (e.g. store from USB port communication, etc.) the farming related test information (e.g. monitoring sealed carton pressure, etc.) generated through testing of (e.g. via sequenced generation, etc.) one or more test samples of (e.g. one or more social network samples, etc.) one or more first farming related items involved in (e.g. be pollinations schedule, etc.) farming related creation of (e.g. sheep butchering, etc.) one or more first biologically based substances (e.g. meal worms, etc.) at least in part including test information regarding pressure levels associated with one or more farming related items (e.g. pressure levels of automated fruit pickers, etc.).

In one or more implementations, as shown in FIG. 47, operation o11 includes an operation o1115 for electronically storing the farming related test information generated through testing of one or more test samples of one or more first farming related items involved in farming related creation of one or more first biologically based substances at least in part including test information regarding chemicals involved with one or more farming related items. Origination of an illustratively derived storing test info chemicals component group can be accomplished through skilled in the art design choice selection of one or more of the above depicted components from one or more of the above depicted subsystems shown in FIG. 12. Components from the storing test info chemicals component group can be used in implementing execution of the one or more storing test info chemicals instructions i1115 of FIG. 28, can be used in performance of the storing test info chemicals electrical circuitry arrangement e1115 of FIG. 21, and/or can be used in otherwise fulfillment of the operation o1115. An exemplary non-transitory signal bearing medium version of the information storage subsystem s200 is depicted in FIG. 28 as bearing the one or more storing test info chemicals instructions i1115 that when executed will direct performance of the operation o1115. Furthermore, the storing test info chemicals electrical circuitry arrangement (“elec circ arrange”) e1115, when activated, will perform the operation o1115. Also, the storing test info chemicals module m1115, when executed and/or activated, will direct performance of and/or perform the operation o1115. For instance, in one or more exemplary implementations, the one or more storing test info chemicals instructions i1115, when executed, direct performance of the operation o1115 in the illustrative depiction as follows, and/or the storing test info chemicals electrical circuitry arrangement e1115, when activated, performs the operation o1115 in the illustrative depiction as follows, and/or the storing test info chemicals module m1115, when executed and/or activated, directs performance of and/or performs the operation o1115 in the illustrative depiction as follows, and/or the operation o1115 is otherwise carried out in the illustrative depiction as follows: electronically storing (e.g. stored from 10-key entry, etc.) the farming related test information (e.g. testing for presence of pesticides, etc.) generated through testing of (e.g. by mass spectrum generation, etc.) one or more test samples of (e.g. one or more micro-dot samples, etc.) one or more first farming related items involved in (e.g. livestock fertility, etc.) farming related creation of (e.g. clam digging, etc.) one or more first biologically based substances (e.g. parsnip, etc.) at least in part including test information regarding chemicals involved with one or more farming related items (e.g. gasoline residue content of organic apples, etc.).

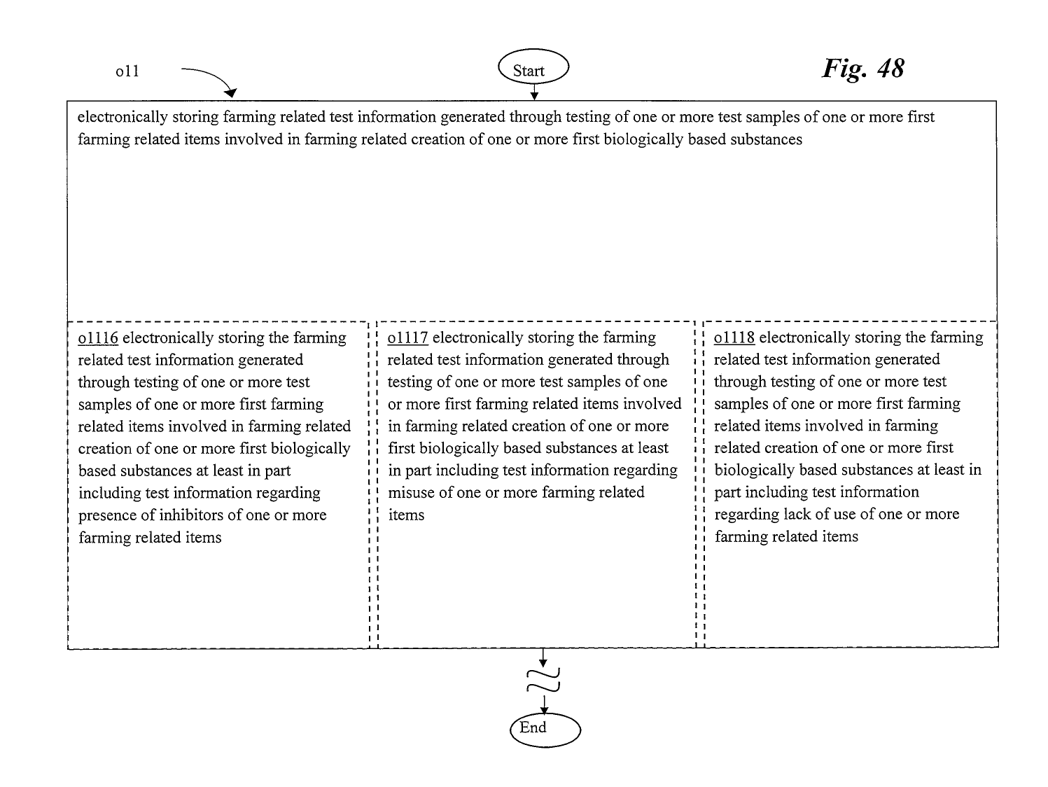

In one or more implementations, as shown in FIG. 48, operation o11 includes an operation o1116 for electronically storing the farming related test information generated through testing of one or more test samples of one or more first farming related items involved in farming related creation of one or more first biologically based substances at least in part including test information regarding presence of inhibitors of one or more farming related items. Origination of an illustratively derived storing test info inhibitors component group can be accomplished through skilled in the art design choice selection of one or more of the above depicted components from one or more of the above depicted subsystems shown in FIG. 12. Components from the storing test info inhibitors component group can be used in implementing execution of the one or more storing test info inhibitors instructions i1116 of FIG. 28, can be used in performance of the storing test info inhibitors electrical circuitry arrangement e1116 of FIG. 21, and/or can be used in otherwise fulfillment of the operation o1116. An exemplary non-transitory signal bearing medium version of the information storage subsystem s200 is depicted in FIG. 28 as bearing the one or more storing test info inhibitors instructions i1116 that when executed will direct performance of the operation o1116. Furthermore, the storing test info inhibitors electrical circuitry arrangement (“elec circ arrange”) e1116, when activated, will perform the operation o1116. Also, the storing test info inhibitors module m1116, when executed and/or activated, will direct performance of and/or perform the operation o1116. For instance, in one or more exemplary implementations, the one or more storing test info inhibitors instructions i1116, when executed, direct performance of the operation o1116 in the illustrative depiction as follows, and/or the storing test info inhibitors electrical circuitry arrangement e1116, when activated, performs the operation o1116 in the illustrative depiction as follows, and/or the storing test info inhibitors module m1116, when executed and/or activated, directs performance of and/or performs the operation o1116 in the illustrative depiction as follows, and/or the operation o1116 is otherwise carried out in the illustrative depiction as follows: electronically storing (e.g. stored from peer to peer communication, etc.) the farming related test information (e.g. testing for soil contaminants, etc.) generated through testing of (e.g. by periodic generation, etc.) one or more test samples of (e.g. one or more notepad samples, etc.) one or more first farming related items involved in (e.g. safety regulations, etc.) farming related creation of (e.g. blueberry cultivation, etc.) one or more first biologically based substances (e.g. goat milk, etc.) at least in part including test information regarding presence of inhibitors of one or more farming related items (e.g. fungus levels in peanut crops, etc.).

In one or more implementations, as shown in FIG. 48, operation o11 includes an operation o1117 for electronically storing the farming related test information generated through testing of one or more test samples of one or more first farming related items involved in farming related creation of one or more first biologically based substances at least in part including test information regarding misuse of one or more farming related items. Origination of an illustratively derived storing test info misuse component group can be accomplished through skilled in the art design choice selection of one or more of the above depicted components from one or more of the above depicted subsystems shown in FIG. 12. Components from the storing test info misuse component group can be used in implementing execution of the one or more storing test info misuse instructions i1117 of FIG. 28, can be used in performance of the storing test info misuse electrical circuitry arrangement e1117 of FIG. 21, and/or can be used in otherwise fulfillment of the operation o1117. An exemplary non-transitory signal bearing medium version of the information storage subsystem s200 is depicted in FIG. 28 as bearing the one or more storing test info misuse instructions i1117 that when executed will direct performance of the operation o1117. Furthermore, the storing test info misuse electrical circuitry arrangement (“elec circ arrange”) e1117, when activated, will perform the operation o1117. Also, the storing test info misuse module m1117, when executed and/or activated, will direct performance of and/or perform the operation o1117. For instance, in one or more exemplary implementations, the one or more storing test info misuse instructions i1117, when executed, direct performance of the operation o1117 in the illustrative depiction as follows, and/or the storing test info misuse electrical circuitry arrangement e1117, when activated, performs the operation o1117 in the illustrative depiction as follows, and/or the storing test info misuse module m1117, when executed and/or activated, directs performance of and/or performs the operation o1117 in the illustrative depiction as follows, and/or the operation o1117 is otherwise carried out in the illustrative depiction as follows: electronically storing (e.g. stored from email, etc.) the farming related test information (e.g. monitoring herbicide use, etc.) generated through testing of (e.g. by web based generation, etc.) one or more test samples of (e.g. one or more computer samples, etc.) one or more first farming related items involved in (e.g. labor laws, etc.) farming related creation of (e.g. raspberry harvesting, etc.) one or more first biologically based substances (e.g. ostrich meat, etc.) at least in part including test information regarding misuse of one or more farming related items (e.g. cage time for poultry hens, etc.).

In one or more implementations, as shown in FIG. 48, operation o11 includes an operation o1118 for electronically storing the farming related test information generated through testing of one or more test samples of one or more first farming related items involved in farming related creation of one or more first biologically based substances at least in part including test information regarding lack of use of one or more farming related items. Origination of an illustratively derived storing test info lack component group can be accomplished through skilled in the art design choice selection of one or more of the above depicted components from one or more of the above depicted subsystems shown in FIG. 12. Components from the storing test info lack component group can be used in implementing execution of the one or more storing test info lack instructions i1118 of FIG. 28, can be used in performance of the storing test info lack electrical circuitry arrangement e1118 of FIG. 21, and/or can be used in otherwise fulfillment of the operation o1118. An exemplary non-transitory signal bearing medium version of the information storage subsystem s200 is depicted in FIG. 28 as bearing the one or more storing test info lack instructions i1118 that when executed will direct performance of the operation o1118. Furthermore, the storing test info lack electrical circuitry arrangement (“elec circ arrange”) e1118, when activated, will perform the operation o1118. Also, the storing test info lack module m1118, when executed and/or activated, will direct performance of and/or perform the operation o1118. For instance, in one or more exemplary implementations, the one or more storing test info lack instructions i1118, when executed, direct performance of the operation o1118 in the illustrative depiction as follows, and/or the storing test info lack electrical circuitry arrangement e1118, when activated, performs the operation o1118 in the illustrative depiction as follows, and/or the storing test info lack module m1118, when executed and/or activated, directs performance of and/or performs the operation o1118 in the illustrative depiction as follows, and/or the operation o1118 is otherwise carried out in the illustrative depiction as follows: electronically storing (e.g. stored from SIM card data, etc.) the farming related test information (e.g. monitoring water availability, etc.) generated through testing of (e.g. by random generation, etc.) one or more test samples of (e.g. one or more automated samples, etc.) one or more first farming related items involved in (e.g. range schedule, etc.) farming related creation of (e.g. corn growing, etc.) one or more first biologically based substances (e.g. emu meat, etc.) at least in part including test information regarding lack of use of one or more farming related items (e.g. worm density in soil, etc.).

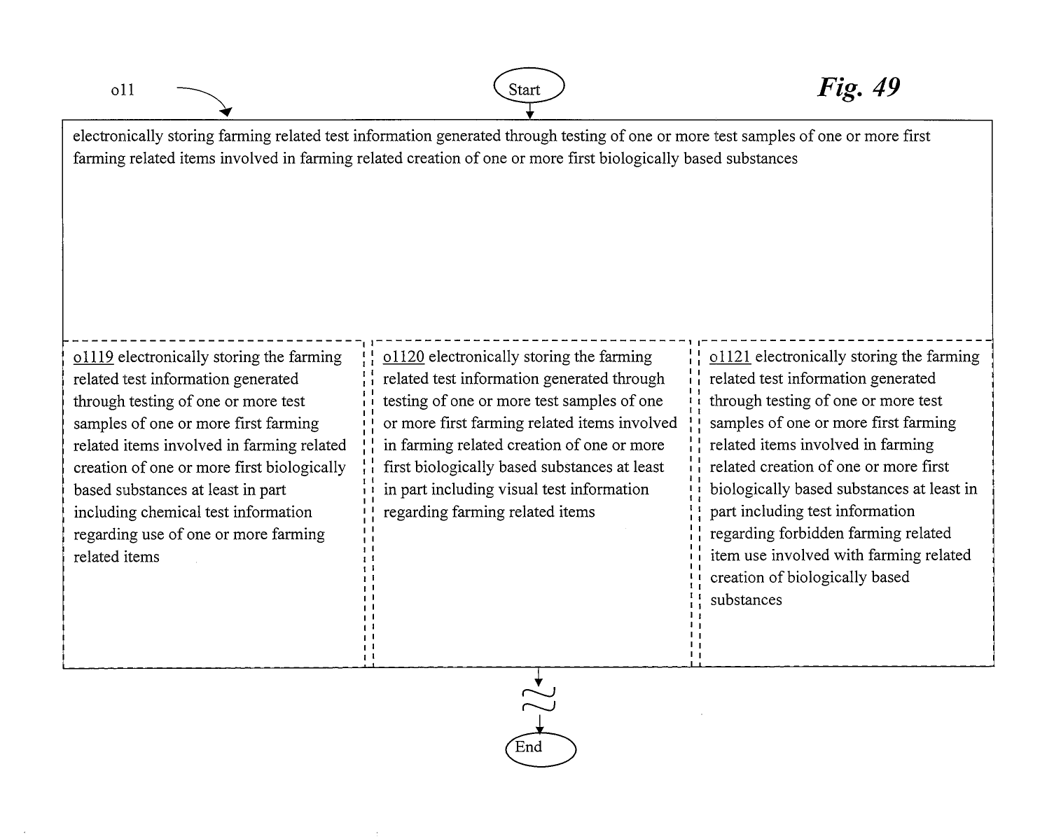

In one or more implementations, as shown in FIG. 49, operation o11 includes an operation o1119 for electronically storing the farming related test information generated through testing of one or more test samples of one or more first farming related items involved in farming related creation of one or more first biologically based substances at least in part including chemical test information regarding use of one or more farming related items. Origination of an illustratively derived storing test info chem test component group can be accomplished through skilled in the art design choice selection of one or more of the above depicted components from one or more of the above depicted subsystems shown in FIG. 12. Components from the storing test info chem test component group can be used in implementing execution of the one or more storing test info chem test instructions i1119 of FIG. 28, can be used in performance of the storing test info chem test electrical circuitry arrangement e1119 of FIG. 21, and/or can be used in otherwise fulfillment of the operation o1119. An exemplary non-transitory signal bearing medium version of the information storage subsystem s200 is depicted in FIG. 28 as bearing the one or more storing test info chem test instructions i1119 that when executed will direct performance of the operation o1119. Furthermore, the storing test info chem test electrical circuitry arrangement (“elec circ arrange”) e1119, when activated, will perform the operation o1119. Also, the storing test info chem test module m1119, when executed and/or activated, will direct performance of and/or perform the operation o1119. For instance, in one or more exemplary implementations, the one or more storing test info chem test instructions i1119, when executed, direct performance of the operation o1119 in the illustrative depiction as follows, and/or the storing test info chem test electrical circuitry arrangement e1119, when activated, performs the operation o1119 in the illustrative depiction as follows, and/or the storing test info chem test module m1119, when executed and/or activated, directs performance of and/or performs the operation o1119 in the illustrative depiction as follows, and/or the operation o1119 is otherwise carried out in the illustrative depiction as follows: electronically storing (e.g. stored from SD card access, etc.) the farming related test information (e.g. monitoring presence of fertilizer ratios in irrigation water, etc.) generated through testing of (e.g. by social network generation, etc.) one or more test samples of (e.g. one or more worker collected samples, etc.) one or more first farming related items involved in (e.g. livestock inventory, etc.) farming related creation of (e.g. soy bean harvesting, etc.) one or more first biologically based substances (e.g. goat cheese, etc.) at least in part including chemical test information regarding use of one or more farming related items (e.g. arsenic levels in soil, etc.).

In one or more implementations, as shown in FIG. 49, operation o11 includes an operation o1120 for electronically storing the farming related test information generated through testing of one or more test samples of one or more first farming related items involved in farming related creation of one or more first biologically based substances at least in part including visual test information regarding farming related items. Origination of an illustratively derived storing test info visual component group can be accomplished through skilled in the art design choice selection of one or more of the above depicted components from one or more of the above depicted subsystems shown in FIG. 12. Components from the storing test info visual component group can be used in implementing execution of the one or more storing test info visual instructions i1120 of FIG. 29, can be used in performance of the storing test info visual electrical circuitry arrangement e1120 of FIG. 22, and/or can be used in otherwise fulfillment of the operation o1120. An exemplary non-transitory signal bearing medium version of the information storage subsystem s200 is depicted in FIG. 29 as bearing the one or more storing test info visual instructions i1120 that when executed will direct performance of the operation o1120. Furthermore, the storing test info visual electrical circuitry arrangement (“elec circ arrange”) e1120, when activated, will perform the operation o1120. Also, the storing test info visual module m1120, when executed and/or activated, will direct performance of and/or perform the operation o1120. For instance, in one or more exemplary implementations, the one or more storing test info visual instructions i1120, when executed, direct performance of the operation o1120 in the illustrative depiction as follows, and/or the storing test info visual electrical circuitry arrangement e1120, when activated, performs the operation o1120 in the illustrative depiction as follows, and/or the storing test info visual module m1120, when executed and/or activated, directs performance of and/or performs the operation o1120 in the illustrative depiction as follows, and/or the operation o1120 is otherwise carried out in the illustrative depiction as follows: electronically storing (e.g. stored from software based encryption, etc.) the farming related test information (e.g. testing chlorophyll levels in plant matter, etc.) generated through testing of (e.g. by inter-region testing, etc.) one or more test samples of (e.g. one or more remotely collected samples, etc.) one or more first farming related items involved in (e.g. range area, etc.) farming related creation of (e.g. canola harvesting, etc.) one or more first biologically based substances (e.g. sheep cheese, etc.) at least in part including visual test information regarding farming related items (e.g. visual appearance quality of crop, etc.).

In one or more implementations, as shown in FIG. 49, operation o11 includes an operation o1121 for electronically storing the farming related test information generated through testing of one or more test samples of one or more first farming related items involved in farming related creation of one or more first biologically based substances at least in part including test information regarding forbidden farming related item use involved with farming related creation of biologically based substances. Origination of an illustratively derived storing test info forbidden component group can be accomplished through skilled in the art design choice selection of one or more of the above depicted components from one or more of the above depicted subsystems shown in FIG. 12. Components from the storing test info forbidden component group can be used in implementing execution of the one or more storing test info forbidden instructions i1121 of FIG. 29, can be used in performance of the storing test info forbidden electrical circuitry arrangement e1121 of FIG. 22, and/or can be used in otherwise fulfillment of the operation o1121. An exemplary non-transitory signal bearing medium version of the information storage subsystem s200 is depicted in FIG. 29 as bearing the one or more storing test info forbidden instructions i1121 that when executed will direct performance of the operation o1121. Furthermore, the storing test info forbidden electrical circuitry arrangement (“elec circ arrange”) e1121, when activated, will perform the operation o1121. Also, the storing test info forbidden module m1121, when executed and/or activated, will direct performance of and/or perform the operation o1121. For instance, in one or more exemplary implementations, the one or more storing test info forbidden instructions i1121, when executed, direct performance of the operation o1121 in the illustrative depiction as follows, and/or the storing test info forbidden electrical circuitry arrangement e1121, when activated, performs the operation o1121 in the illustrative depiction as follows, and/or the storing test info forbidden module m1121, when executed and/or activated, directs performance of and/or performs the operation o1121 in the illustrative depiction as follows, and/or the operation o1121 is otherwise carried out in the illustrative depiction as follows: electronically storing (e.g. stored from hardware based encryption, etc.) the farming related test information (e.g. testing for banned pesticide presence, etc.) generated through testing of (e.g. by statewide testing, etc.) one or more test samples of (e.g. one or more locally collected samples, etc.) one or more first farming related items involved in (e.g. acreage available, etc.) farming related creation of (e.g. pear picking, etc.) one or more first biologically based substances (e.g. sturgeon eggs, etc.) at least in part including test information regarding forbidden farming related item use involved with farming related creation of biologically based substances (e.g. chemicals not approved by USDA to be used to grow organic strawberries, etc.).

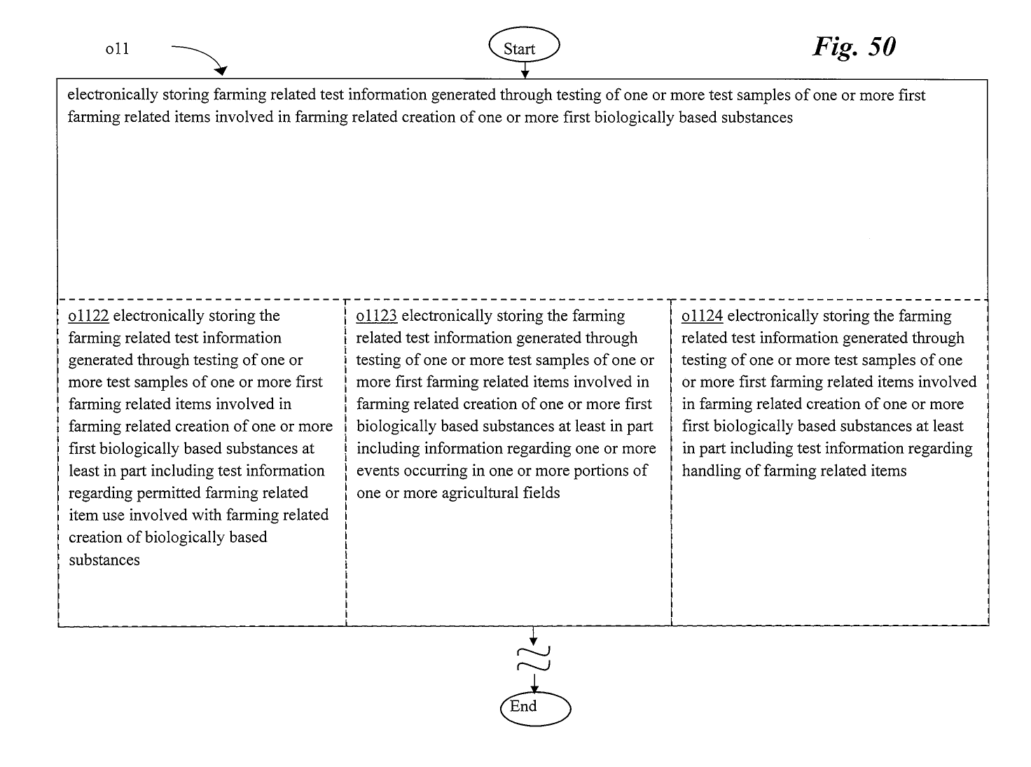

In one or more implementations, as shown in FIG. 50, operation o11 includes an operation o1122 for electronically storing the farming related test information generated through testing of one or more test samples of one or more first farming related items involved in farming related creation of one or more first biologically based substances at least in part including test information regarding permitted farming related item use involved with farming related creation of biologically based substances. Origination of an illustratively derived storing test info permitted component group can be accomplished through skilled in the art design choice selection of one or more of the above depicted components from one or more of the above depicted subsystems shown in FIG. 12. Components from the storing test info permitted component group can be used in implementing execution of the one or more storing test info permitted instructions i1122 of FIG. 29, can be used in performance of the storing test info permitted electrical circuitry arrangement e1122 of FIG. 22, and/or can be used in otherwise fulfillment of the operation o1122. An exemplary non-transitory signal bearing medium version of the information storage subsystem s200 is depicted in FIG. 29 as bearing the one or more storing test info permitted instructions i1122 that when executed will direct performance of the operation o1122. Furthermore, the storing test info permitted electrical circuitry arrangement (“elec circ arrange”) e1122, when activated, will perform the operation o1122. Also, the storing test info permitted module m1122, when executed and/or activated, will direct performance of and/or perform the operation o1122. For instance, in one or more exemplary implementations, the one or more storing test info permitted instructions i1122, when executed, direct performance of the operation o1122 in the illustrative depiction as follows, and/or the storing test info permitted electrical circuitry arrangement e1122, when activated, performs the operation o1122 in the illustrative depiction as follows, and/or the storing test info permitted module m1122, when executed and/or activated, directs performance of and/or performs the operation o1122 in the illustrative depiction as follows, and/or the operation o1122 is otherwise carried out in the illustrative depiction as follows: electronically storing (e.g. stored from POP3 server, etc.) the farming related test information (e.g. testing for natural insect predator population, etc.) generated through testing of (e.g. by pandemic based testing, etc.) one or more test samples of (e.g. one or more animal samples, etc.) one or more first farming related items involved in (e.g. land terrain, etc.) farming related creation of (e.g. peanut harvesting, etc.) one or more first biologically based substances (e.g. venison, etc.) at least in part including test information regarding permitted farming related item use involved with farming related creation of biologically based substances (e.g. fertilizers authorized for use by a horticulture expert to grow bio-dynamic vegetables, etc.).

In one or more implementations, as shown in FIG. 50, operation o11 includes an operation o1123 for electronically storing the farming related test information generated through testing of one or more test samples of one or more first farming related items involved in farming related creation of one or more first biologically based substances at least in part including information regarding one or more events occurring in one or more portions of one or more agricultural fields. Origination of an illustratively derived storing test info events component group can be accomplished through skilled in the art design choice selection of one or more of the above depicted components from one or more of the above depicted subsystems shown in FIG. 12. Components from the storing test info events component group can be used in implementing execution of the one or more storing test info events instructions i1123 of FIG. 29, can be used in performance of the storing test info events electrical circuitry arrangement e1123 of FIG. 22, and/or can be used in otherwise fulfillment of the operation o1123. An exemplary non-transitory signal bearing medium version of the information storage subsystem s200 is depicted in FIG. 29 as bearing the one or more storing test info events instructions i1123 that when executed will direct performance of the operation o1123. Furthermore, the storing test info events electrical circuitry arrangement (“elec circ arrange”) e1123, when activated, will perform the operation o1123. Also, the storing test info events module m1123, when executed and/or activated, will direct performance of and/or perform the operation o1123. For instance, in one or more exemplary implementations, the one or more storing test info events instructions i1123, when executed, direct performance of the operation o1123 in the illustrative depiction as follows, and/or the storing test info events electrical circuitry arrangement e1123, when activated, performs the operation o1123 in the illustrative depiction as follows, and/or the storing test info events module m1123, when executed and/or activated, directs performance of and/or performs the operation o1123 in the illustrative depiction as follows, and/or the operation o1123 is otherwise carried out in the illustrative depiction as follows: electronically storing (e.g. stored from pull-based file transfer, etc.) the farming related test information (e.g. monitoring crop growth over time span, etc.) generated through testing of (e.g. by government mandated testing, etc.) one or more test samples of (e.g. one or more plant samples, etc.) one or more first farming related items involved in (e.g. efficiency of tilling, etc.) farming related creation of (e.g. parsnip growing, etc.) one or more first biologically based substances (e.g. kangaroo meat, etc.) at least in part including information regarding one or more events occurring in one or more portions of one or more agricultural fields (e.g. insecticide spraying schedules for designated fields, etc.).

In one or more implementations, as shown in FIG. 50, operation o11 includes an operation o1124 for electronically storing the farming related test information generated through testing of one or more test samples of one or more first farming related items involved in farming related creation of one or more first biologically based substances at least in part including test information regarding handling of farming related items. Origination of an illustratively derived storing test info handling component group can be accomplished through skilled in the art design choice selection of one or more of the above depicted components from one or more of the above depicted subsystems shown in FIG. 12. Components from the storing test info handling component group can be used in implementing execution of the one or more storing test info handling instructions i1124 of FIG. 29, can be used in performance of the storing test info handling electrical circuitry arrangement e1124 of FIG. 22, and/or can be used in otherwise fulfillment of the operation o1124. An exemplary non-transitory signal bearing medium version of the information storage subsystem s200 is depicted in FIG. 29 as bearing the one or more storing test info handling instructions i1124 that when executed will direct performance of the operation o1124. Furthermore, the storing test info handling electrical circuitry arrangement (“elec circ arrange”) e1124, when activated, will perform the operation o1124. Also, the storing test info handling module m1124, when executed and/or activated, will direct performance of and/or perform the operation o1124. For instance, in one or more exemplary implementations, the one or more storing test info handling instructions i1124, when executed, direct performance of the operation o1124 in the illustrative depiction as follows, and/or the storing test info handling electrical circuitry arrangement e1124, when activated, performs the operation o1124 in the illustrative depiction as follows, and/or the storing test info handling module m1124, when executed and/or activated, directs performance of and/or performs the operation o1124 in the illustrative depiction as follows, and/or the operation o1124 is otherwise carried out in the illustrative depiction as follows: electronically storing (e.g. stored from satellite transmission, etc.) the farming related test information (e.g. monitoring threshing speed of wheat, etc.) generated through testing of (e.g. via protocol based testing, etc.) one or more test samples of (e.g. one or more microorganism samples, etc.) one or more first farming related items involved in (e.g. corral dimensions, etc.) farming related creation of (e.g. cow milking, etc.) one or more first biologically based substances (e.g. oyster shell, etc.) at least in part including test information regarding handling of farming related items (e.g. storage times for picked fruit, etc.).

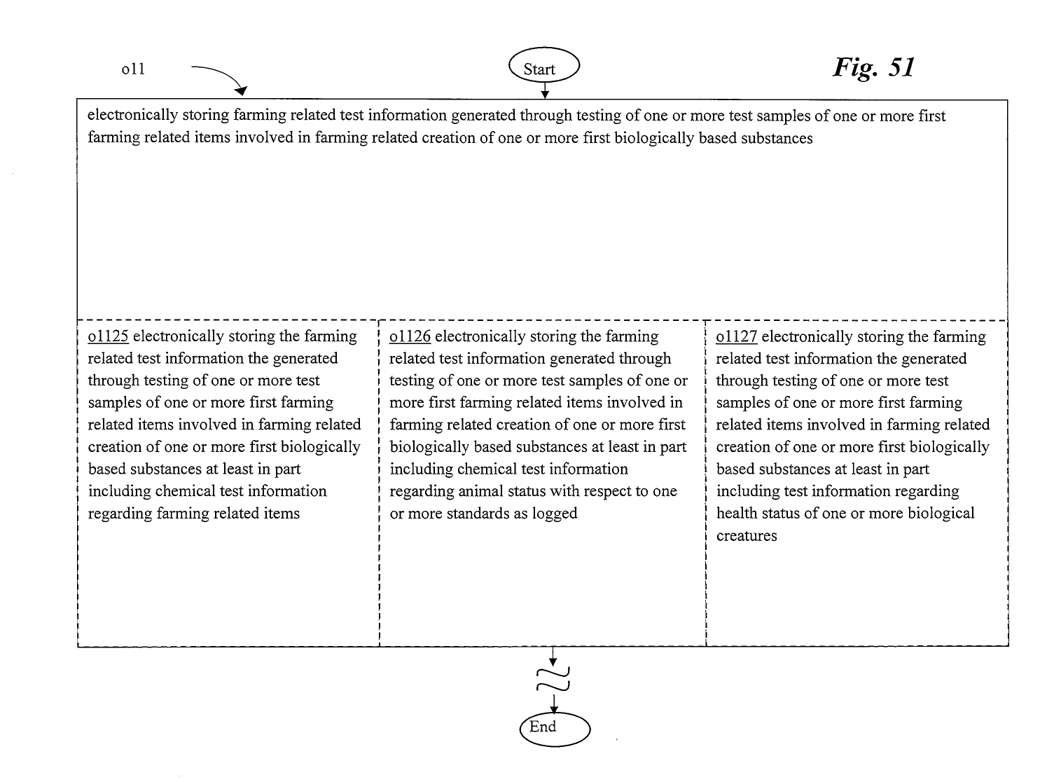

In one or more implementations, as shown in FIG. 51, operation o11 includes an operation o1125 for electronically storing the farming related test information the generated through testing of one or more test samples of one or more first farming related items involved in farming related creation of one or more first biologically based substances at least in part including chemical test information regarding farming related items. Origination of an illustratively derived storing test info chem test component group can be accomplished through skilled in the art design choice selection of one or more of the above depicted components from one or more of the above depicted subsystems shown in FIG. 12. Components from the storing test info chem test component group can be used in implementing execution of the one or more storing test info chem test instructions i1125 of FIG. 29, can be used in performance of the storing test info chem test electrical circuitry arrangement e1125 of FIG. 22, and/or can be used in otherwise fulfillment of the operation o1125. An exemplary non-transitory signal bearing medium version of the information storage subsystem s200 is depicted in FIG. 29 as bearing the one or more storing test info chem test instructions i1125 that when executed will direct performance of the operation o1125. Furthermore, the storing test info chem test electrical circuitry arrangement (“elec circ arrange”) e1125, when activated, will perform the operation o1125. Also, the storing test info chem test module m1125, when executed and/or activated, will direct performance of and/or perform the operation o1125. For instance, in one or more exemplary implementations, the one or more storing test info chem test instructions i1125, when executed, direct performance of the operation o1125 in the illustrative depiction as follows, and/or the storing test info chem test electrical circuitry arrangement e1125, when activated, performs the operation o1125 in the illustrative depiction as follows, and/or the storing test info chem test module m1125, when executed and/or activated, directs performance of and/or performs the operation o1125 in the illustrative depiction as follows, and/or the operation o1125 is otherwise carried out in the illustrative depiction as follows: electronically storing (e.g. stored from cellphone entry, etc.) the farming related test information (e.g. testing for fungicide levels, etc.) the generated through testing of (e.g. through institute managed testing, etc.) one or more test samples of (e.g. one or more spectral analysis samples, etc.) one or more first farming related items involved in (e.g. lease duration of equipment, etc.) farming related creation of (e.g. goat milking, etc.) one or more first biologically based substances (e.g. shrimp, etc.) at least in part including chemical test information regarding farming related items (e.g. heavy metal levels in fish oils, etc.).

In one or more implementations, as shown in FIG. 51, operation o11 includes an operation o1126 for electronically storing the farming related test information generated through testing of one or more test samples of one or more first farming related items involved in farming related creation of one or more first biologically based substances at least in part including chemical test information regarding animal status with respect to one or more standards as logged. Origination of an illustratively derived storing test info animal component group can be accomplished through skilled in the art design choice selection of one or more of the above depicted components from one or more of the above depicted subsystems shown in FIG. 12. Components from the storing test info animal component group can be used in implementing execution of the one or more storing test info animal instructions i1126 of FIG. 29, can be used in performance of the storing test info animal electrical circuitry arrangement e1126 of FIG. 22, and/or can be used in otherwise fulfillment of the operation o1126. An exemplary non-transitory signal bearing medium version of the information storage subsystem s200 is depicted in FIG. 29 as bearing the one or more storing test info animal instructions i1126 that when executed will direct performance of the operation o1126. Furthermore, the storing test info animal electrical circuitry arrangement (“elec circ arrange”) e1126, when activated, will perform the operation o1126. Also, the storing test info animal module m1126, when executed and/or activated, will direct performance of and/or perform the operation o1126. For instance, in one or more exemplary implementations, the one or more storing test info animal instructions i1126, when executed, direct performance of the operation o1126 in the illustrative depiction as follows, and/or the storing test info animal electrical circuitry arrangement e1126, when activated, performs the operation o1126 in the illustrative depiction as follows, and/or the storing test info animal module m1126, when executed and/or activated, directs performance of and/or performs the operation o1126 in the illustrative depiction as follows, and/or the operation o1126 is otherwise carried out in the illustrative depiction as follows: electronically storing (e.g. stored from website data, etc.) the farming related test information (e.g. testing oxygen levels in blood, etc.) generated through testing of (e.g. through worker implemented testing, etc.) one or more test samples of (e.g. one or more gas samples, etc.) one or more first farming related items involved in (e.g. shade tree type, etc.) farming related creation of (e.g. flax growing, etc.) one or more first biologically based substances (e.g. cucumber, etc.) at least in part including chemical test information regarding animal status with respect to one or more standards as logged (e.g. growth hormone levels in cattle, etc.).

In one or more implementations, as shown in FIG. 51, operation o11 includes an operation o1127 for electronically storing the farming related test information the generated through testing of one or more test samples of one or more first farming related items involved in farming related creation of one or more first biologically based substances at least in part including test information regarding health status of one or more biological creatures. Origination of an illustratively derived storing test info health component group can be accomplished through skilled in the art design choice selection of one or more of the above depicted components from one or more of the above depicted subsystems shown in FIG. 12. Components from the storing test info health component group can be used in implementing execution of the one or more storing test info health instructions i1127 of FIG. 29, can be used in performance of the storing test info health electrical circuitry arrangement e1127 of FIG. 22, and/or can be used in otherwise fulfillment of the operation o1127. An exemplary non-transitory signal bearing medium version of the information storage subsystem s200 is depicted in FIG. 29 as bearing the one or more storing test info health instructions i1127 that when executed will direct performance of the operation o1127. Furthermore, the storing test info health electrical circuitry arrangement (“elec circ arrange”) e1127, when activated, will perform the operation o1127. Also, the storing test info health module m1127, when executed and/or activated, will direct performance of and/or perform the operation o1127. For instance, in one or more exemplary implementations, the one or more storing test info health instructions i1127, when executed, direct performance of the operation o1127 in the illustrative depiction as follows, and/or the storing test info health electrical circuitry arrangement e1127, when activated, performs the operation o1127 in the illustrative depiction as follows, and/or the storing test info health module m1127, when executed and/or activated, directs performance of and/or performs the operation o1127 in the illustrative depiction as follows, and/or the operation o1127 is otherwise carried out in the illustrative depiction as follows: electronically storing (e.g. stored from webpage data, etc.) the farming related test information (e.g. testing for proper organ function in animal, etc.) the generated through testing of (e.g. via worker implemented generation, etc.) one or more test samples of (e.g. one or more liquid samples, etc.) one or more first farming related items involved in (e.g. genetic code of current crop, etc.) farming related creation of (e.g. squash cultivation, etc.) one or more first biologically based substances (e.g. snail, etc.) at least in part including test information regarding health status of one or more biological creatures (e.g. basic metabolic profiles of cows, etc.).

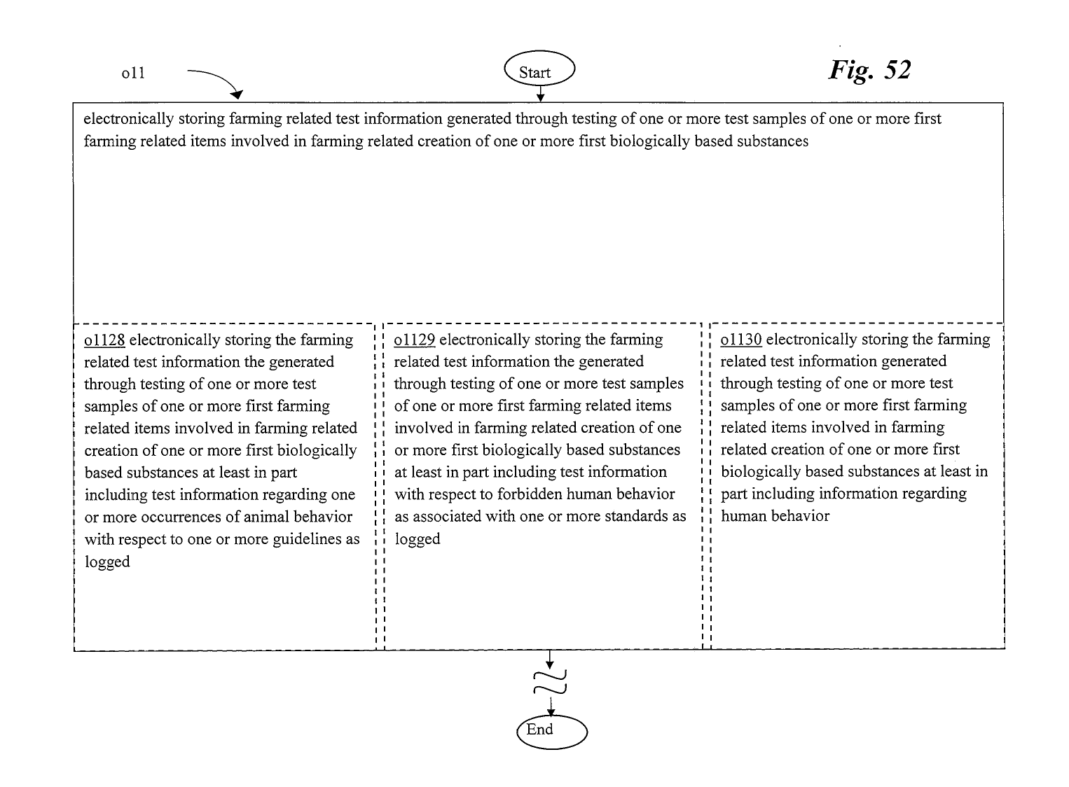

In one or more implementations, as shown in FIG. 52, operation o11 includes an operation o1128 for electronically storing the farming related test information the generated through testing of one or more test samples of one or more first farming related items involved in farming related creation of one or more first biologically based substances at least in part including test information regarding one or more occurrences of animal behavior with respect to one or more guidelines as logged. Origination of an illustratively derived storing test info animal component group can be accomplished through skilled in the art design choice selection of one or more of the above depicted components from one or more of the above depicted subsystems shown in FIG. 12. Components from the storing test info animal component group can be used in implementing execution of the one or more storing test info animal instructions i1128 of FIG. 29, can be used in performance of the storing test info animal electrical circuitry arrangement e1128 of FIG. 22, and/or can be used in otherwise fulfillment of the operation o1128. An exemplary non-transitory signal bearing medium version of the information storage subsystem s200 is depicted in FIG. 29 as bearing the one or more storing test info animal instructions i1128 that when executed will direct performance of the operation o1128. Furthermore, the storing test info animal electrical circuitry arrangement (“elec circ arrange”) e1128, when activated, will perform the operation o1128. Also, the storing test info animal module m1128, when executed and/or activated, will direct performance of and/or perform the operation o1128. For instance, in one or more exemplary implementations, the one or more storing test info animal instructions i1128, when executed, direct performance of the operation o1128 in the illustrative depiction as follows, and/or the storing test info animal electrical circuitry arrangement e1128, when activated, performs the operation o1128 in the illustrative depiction as follows, and/or the storing test info animal module m1128, when executed and/or activated, directs performance of and/or performs the operation o1128 in the illustrative depiction as follows, and/or the operation o1128 is otherwise carried out in the illustrative depiction as follows: electronically storing (e.g. stored from bluetooth communication, etc.) the farming related test information (e.g. monitoring feed consumption of livestock, etc.) the generated through testing of (e.g. through automated generation, etc.) one or more test samples of (e.g. one or more solid samples, etc.) one or more first farming related items involved in family tree of heirloom seeds used, etc.) farming related creation of (e.g. strawberry picking, etc.) one or more first biologically based substances (e.g. snail shell, etc.) at least in part including test information regarding one or more occurrences of animal behavior with respect to one or more guidelines as logged (e.g. amount of free-range time for poultry according to free-range designation, etc.).

In one or more implementations, as shown in FIG. 52, operation o11 includes an operation o1129 for electronically storing the farming related test information the generated through testing of one or more test samples of one or more first farming related items involved in farming related creation of one or more first biologically based substances at least in part including test information with respect to forbidden human behavior as associated with one or more standards as logged. Origination of an illustratively derived storing test info forbidden component group can be accomplished through skilled in the art design choice selection of one or more of the above depicted components from one or more of the above depicted subsystems shown in FIG. 12. Components from the storing test info forbidden component group can be used in implementing execution of the one or more storing test info forbidden instructions i1129 of FIG. 29, can be used in performance of the storing test info forbidden electrical circuitry arrangement e1129 of FIG. 22, and/or can be used in otherwise fulfillment of the operation o1129. An exemplary non-transitory signal bearing medium version of the information storage subsystem s200 is depicted in FIG. 29 as bearing the one or more storing test info forbidden instructions i1129 that when executed will direct performance of the operation o1129. Furthermore, the storing test info forbidden electrical circuitry arrangement (“elec circ arrange”) e1129, when activated, will perform the operation o1129. Also, the storing test info forbidden module m1129, when executed and/or activated, will direct performance of and/or perform the operation o1129. For instance, in one or more exemplary implementations, the one or more storing test info forbidden instructions i1129, when executed, direct performance of the operation o1129 in the illustrative depiction as follows, and/or the storing test info forbidden electrical circuitry arrangement e1129, when activated, performs the operation o1129 in the illustrative depiction as follows, and/or the storing test info forbidden module m1129, when executed and/or activated, directs performance of and/or performs the operation o1129 in the illustrative depiction as follows, and/or the operation o1129 is otherwise carried out in the illustrative depiction as follows: electronically storing (e.g. stored infra-red transmission, etc.) the farming related test information (e.g. monitoring improper hand sanitation of workers, etc.) the generated through testing of (e.g. via psychologically based testing, etc.) one or more test samples of (e.g. one or more diseased samples, etc.) one or more first farming related items involved in quality of feed water, etc.) farming related creation of (e.g. rice planting, etc.) one or more first biologically based substances (e.g. carp, etc.) at least in part including test information with respect to forbidden human behavior as associated with one or more standards as logged (e.g. lack of human supervision required for animal feeding procedures, etc.).

In one or more implementations, as shown in FIG. 52, operation o11 includes an operation o1130 for electronically storing the farming related test information generated through testing of one or more test samples of one or more first farming related items involved in farming related creation of one or more first biologically based substances at least in part including information regarding human behavior. Origination of an illustratively derived storing test info human component group can be accomplished through skilled in the art design choice selection of one or more of the above depicted components from one or more of the above depicted subsystems shown in FIG. 12. Components from the storing test info human component group can be used in implementing execution of the one or more storing test info human instructions i1130 of FIG. 29, can be used in performance of the storing test info human electrical circuitry arrangement e1130 of FIG. 22, and/or can be used in otherwise fulfillment of the operation o1130. An exemplary non-transitory signal bearing medium version of the information storage subsystem s200 is depicted in FIG. 29 as bearing the one or more storing test info human instructions i1130 that when executed will direct performance of the operation o1130. Furthermore, the storing test info human electrical circuitry arrangement (“elec circ arrange”) e1130, when activated, will perform the operation o1130. Also, the storing test info human module m1130, when executed and/or activated, will direct performance of and/or perform the operation o1130. For instance, in one or more exemplary implementations, the one or more storing test info human instructions i1130, when executed, direct performance of the operation o1130 in the illustrative depiction as follows, and/or the storing test info human electrical circuitry arrangement e1130, when activated, performs the operation o1130 in the illustrative depiction as follows, and/or the storing test info human module m1130, when executed and/or activated, directs performance of and/or performs the operation o1130 in the illustrative depiction as follows, and/or the operation o1130 is otherwise carried out in the illustrative depiction as follows: electronically storing (e.g. stored from radio wave reception, etc.) the farming related test information (e.g. monitoring worker health trend, etc.) generated through testing of (e.g. through electronic based testing, etc.) one or more test samples of (e.g. one or more healthy samples, etc.) one or more first farming related items involved in (e.g. total cost of harvest, etc.) farming related creation of (e.g. tomato growing, etc.) one or more first biologically based substances (e.g. sturgeon, etc.) at least in part including information regarding human behavior (e.g. presence of human supervisors during testing procedures, etc.).

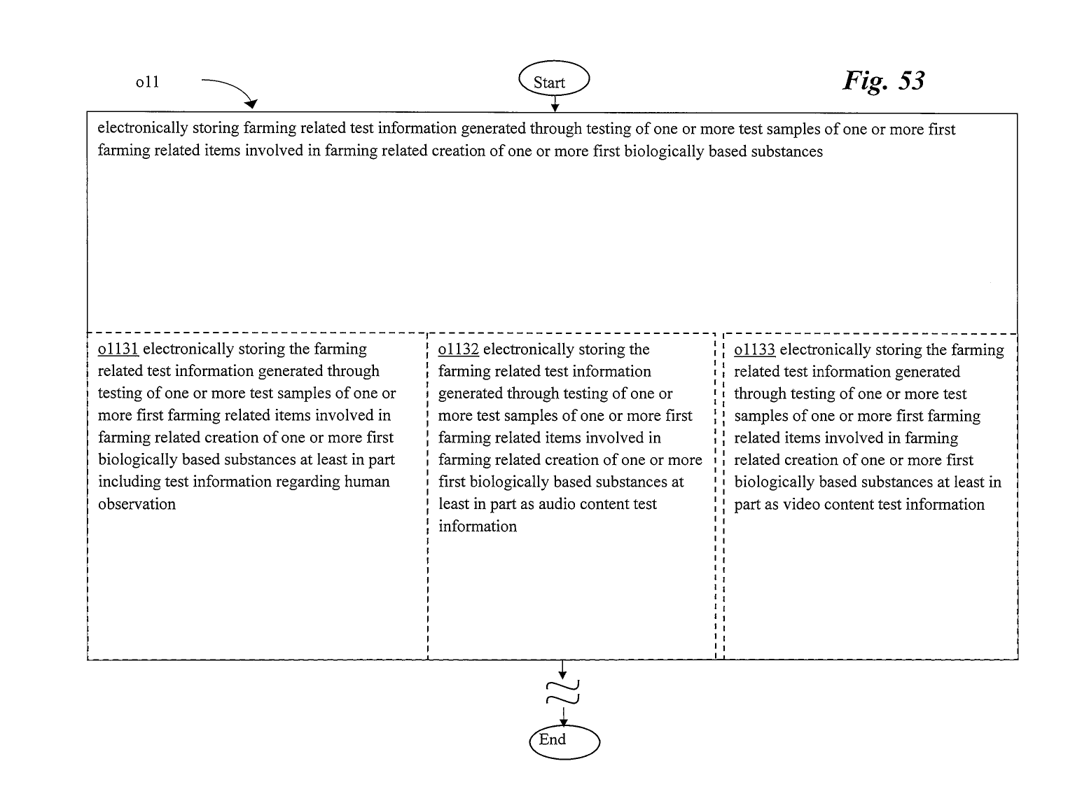

In one or more implementations, as shown in FIG. 53, operation o11 includes an operation o1131 for electronically storing the farming related test information generated through testing of one or more test samples of one or more first farming related items involved in farming related creation of one or more first biologically based substances at least in part including test information regarding human observation. Origination of an illustratively derived storing test info observation component group can be accomplished through skilled in the art design choice selection of one or more of the above depicted components from one or more of the above depicted subsystems shown in FIG. 12. Components from the storing test info observation component group can be used in implementing execution of the one or more storing test info observation instructions i1131 of FIG. 29, can be used in performance of the storing test info observation electrical circuitry arrangement e1131 of FIG. 22, and/or can be used in otherwise fulfillment of the operation o1131. An exemplary non-transitory signal bearing medium version of the information storage subsystem s200 is depicted in FIG. 29 as bearing the one or more storing test info observation instructions i1131 that when executed will direct performance of the operation o1131. Furthermore, the storing test info observation electrical circuitry arrangement (“elec circ arrange”) e1131, when activated, will perform the operation o1131. Also, the storing test info observation module m1131, when executed and/or activated, will direct performance of and/or perform the operation o1131. For instance, in one or more exemplary implementations, the one or more storing test info observation instructions i1131, when executed, direct performance of the operation o1131 in the illustrative depiction as follows, and/or the storing test info observation electrical circuitry arrangement e1131, when activated, performs the operation o1131 in the illustrative depiction as follows, and/or the storing test info observation module m1131, when executed and/or activated, directs performance of and/or performs the operation o1131 in the illustrative depiction as follows, and/or the operation o1131 is otherwise carried out in the illustrative depiction as follows: electronically storing (e.g. stored from SMTP server, etc.) the farming related test information (e.g. testing for visual clues in livestock health status, etc.) generated through testing of (e.g. through chemical based testing, etc.) one or more test samples of (e.g. one or more business samples, etc.) one or more first farming related items involved in (e.g. tide height, etc.) farming related creation of (e.g. pepper harvesting, etc.) one or more first biologically based substances (e.g. domestic goose, etc.) at least in part including test information regarding human observation (e.g. percentage of trees that appear healthy, etc.).

In one or more implementations, as shown in FIG. 53, operation o11 includes an operation o1132 for electronically storing the farming related test information generated through testing of one or more test samples of one or more first farming related items involved in farming related creation of one or more first biologically based substances at least in part as audio content test information. Origination of an illustratively derived storing test info audio component group can be accomplished through skilled in the art design choice selection of one or more of the above depicted components from one or more of the above depicted subsystems shown in FIG. 12. Components from the storing test info audio component group can be used in implementing execution of the one or more storing test info audio instructions i1132 of FIG. 29, can be used in performance of the storing test info audio electrical circuitry arrangement e1132 of FIG. 22, and/or can be used in otherwise fulfillment of the operation o1132. An exemplary non-transitory signal bearing medium version of the information storage subsystem s200 is depicted in FIG. 29 as bearing the one or more storing test info audio instructions i1132 that when executed will direct performance of the operation o1132. Furthermore, the storing test info audio electrical circuitry arrangement (“elec circ arrange”) e1132, when activated, will perform the operation o1132. Also, the storing test info audio module m1132, when executed and/or activated, will direct performance of and/or perform the operation o1132. For instance, in one or more exemplary implementations, the one or more storing test info audio instructions i1132, when executed, direct performance of the operation o1132 in the illustrative depiction as follows, and/or the storing test info audio electrical circuitry arrangement e1132, when activated, performs the operation o1132 in the illustrative depiction as follows, and/or the storing test info audio module m1132, when executed and/or activated, directs performance of and/or performs the operation o1132 in the illustrative depiction as follows, and/or the operation o1132 is otherwise carried out in the illustrative depiction as follows: electronically storing (e.g. stored from push-based file transfer, etc.) the farming related test information (e.g. monitoring audible clues in livestock chatter, etc.) generated through testing of (e.g. through image recognition based testing, etc.) one or more test samples of (e.g. one or more arbor samples, etc.) one or more first farming related items involved in (e.g. estimated rat population, etc.) farming related creation of (e.g. corn growing, etc.) one or more first biologically based substances (e.g. edible frog, etc.) at least in part as audio content test information (e.g. presence of predator animal sounds, etc.).

In one or more implementations, as shown in FIG. 53, operation o11 includes an operation o1133 for electronically storing the farming related test information generated through testing of one or more test samples of one or more first farming related items involved in farming related creation of one or more first biologically based substances at least in part as video content test information. Origination of an illustratively derived storing test info video component group can be accomplished through skilled in the art design choice selection of one or more of the above depicted components from one or more of the above depicted subsystems shown in FIG. 12. Components from the storing test info video component group can be used in implementing execution of the one or more storing test info video instructions i1133 of FIG. 29, can be used in performance of the storing test info video electrical circuitry arrangement e1133 of FIG. 22, and/or can be used in otherwise fulfillment of the operation o1133. An exemplary non-transitory signal bearing medium version of the information storage subsystem s200 is depicted in FIG. 29 as bearing the one or more storing test info video instructions i1133 that when executed will direct performance of the operation o1133. Furthermore, the storing test info video electrical circuitry arrangement (“elec circ arrange”) e1133, when activated, will perform the operation o1133. Also, the storing test info video module m1133, when executed and/or activated, will direct performance of and/or perform the operation o1133. For instance, in one or more exemplary implementations, the one or more storing test info video instructions i1133, when executed, direct performance of the operation o1133 in the illustrative depiction as follows, and/or the storing test info video electrical circuitry arrangement e1133, when activated, performs the operation o1133 in the illustrative depiction as follows, and/or the storing test info video module m1133, when executed and/or activated, directs performance of and/or performs the operation o1133 in the illustrative depiction as follows, and/or the operation o1133 is otherwise carried out in the illustrative depiction as follows: electronically storing (e.g. stored from compact flash card access, etc.) the farming related test information (e.g. monitoring livestock feeding behavior, etc.) generated through testing of (e.g. through audio recognition based testing, etc.) one or more test samples of (e.g. one or more fishery samples, etc.) one or more first farming related items involved in known weed species population, etc.) farming related creation of (e.g. hops cultivation, etc.) one or more first biologically based substances (e.g. catfish, etc.) at least in part as video content test information (e.g. presence of forbidden crop damaging human activity in video, etc.).

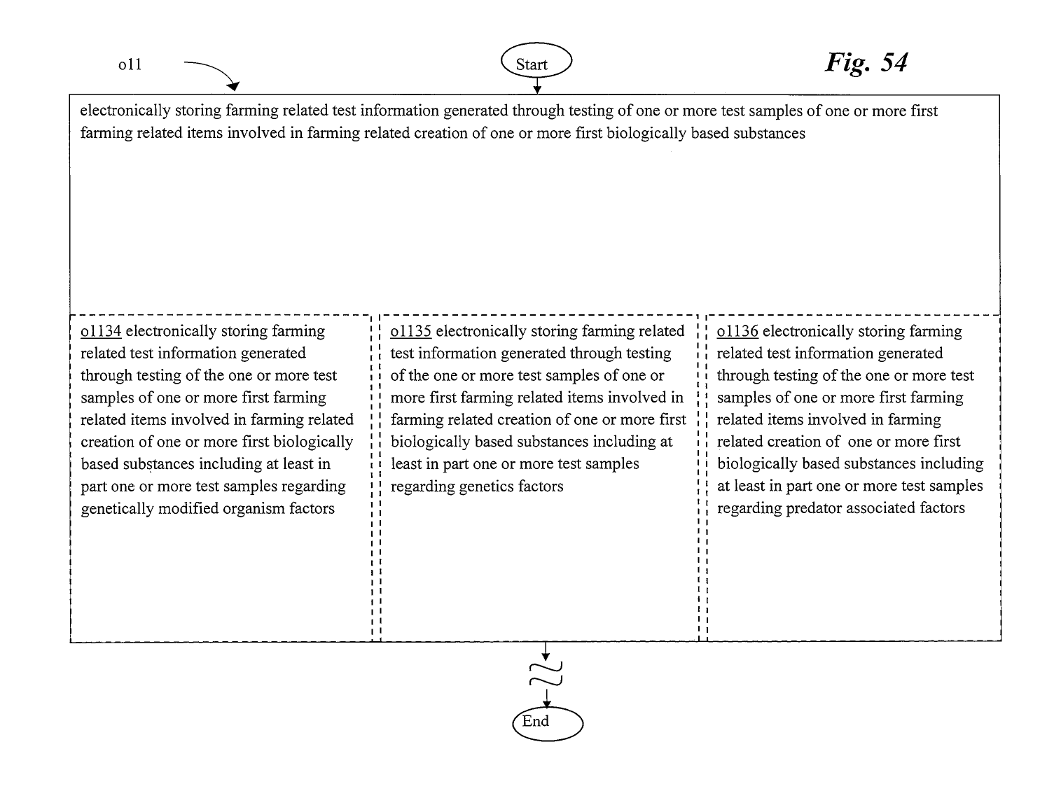

In one or more implementations, as shown in FIG. 54, operation o11 includes an operation o1134 for electronically storing farming related test information generated through testing of the one or more test samples of one or more first farming related items involved in farming related creation of one or more first biologically based substances including at least in part one or more test samples regarding genetically modified organism factors. Origination of an illustratively derived storing test info GMO factors component group can be accomplished through skilled in the art design choice selection of one or more of the above depicted components from one or more of the above depicted subsystems shown in FIG. 12. Components from the storing test info GMO factors component group can be used in implementing execution of the one or more storing test info GMO factors instructions i1134 of FIG. 29, can be used in performance of the storing test info GMO factors electrical circuitry arrangement e1134 of FIG. 22, and/or can be used in otherwise fulfillment of the operation o1134. An exemplary non-transitory signal bearing medium version of the information storage subsystem s200 is depicted in FIG. 29 as bearing the one or more storing test info GMO factors instructions i1134 that when executed will direct performance of the operation o1134. Furthermore, the storing test info GMO factors electrical circuitry arrangement (“elec circ arrange”) e1134, when activated, will perform the operation o1134. Also, the storing test info GMO factors module m1134, when executed and/or activated, will direct performance of and/or perform the operation o1134. For instance, in one or more exemplary implementations, the one or more storing test info GMO factors instructions i1134, when executed, direct performance of the operation o1134 in the illustrative depiction as follows, and/or the storing test info GMO factors electrical circuitry arrangement e1134, when activated, performs the operation o1134 in the illustrative depiction as follows, and/or the storing test info GMO factors module m1134, when executed and/or activated, directs performance of and/or performs the operation o1134 in the illustrative depiction as follows, and/or the operation o1134 is otherwise carried out in the illustrative depiction as follows: electronically storing (e.g. stored from 256-bit AES encrypted data, etc.) farming related test information (e.g. testing phosphate levels, etc.) generated through testing of (e.g. through comparison based testing, etc.) the one or more test samples of (e.g. one or more flock samples, etc.) one or more first farming related items involved in (e.g. soil composition, etc.) farming related creation of (e.g. huckleberry harvesting, etc.) one or more first biologically based substances (e.g. corn, etc.) including at least in part one or more test samples regarding genetically modified organism factors (e.g. test samples for genetically modified grains, etc.).

In one or more implementations, as shown in FIG. 54, operation o11 includes an operation o1135 for electronically storing farming related test information generated through testing of the one or more test samples of one or more first farming related items involved in farming related creation of one or more first biologically based substances including at least in part one or more test samples regarding genetics factors. Origination of an illustratively derived storing test info genetics component group can be accomplished through skilled in the art design choice selection of one or more of the above depicted components from one or more of the above depicted subsystems shown in FIG. 12. Components from the storing test info genetics component group can be used in implementing execution of the one or more storing test info genetics instructions i1135 of FIG. 29, can be used in performance of the storing test info genetics electrical circuitry arrangement e1135 of FIG. 22, and/or can be used in otherwise fulfillment of the operation o1135. An exemplary non-transitory signal bearing medium version of the information storage subsystem s200 is depicted in FIG. 29 as bearing the one or more storing test info genetics instructions i1135 that when executed will direct performance of the operation o1135. Furthermore, the storing test info genetics electrical circuitry arrangement (“elec circ arrange”) e1135, when activated, will perform the operation o1135. Also, the storing test info genetics module m1135, when executed and/or activated, will direct performance of and/or perform the operation o1135. For instance, in one or more exemplary implementations, the one or more storing test info genetics instructions i1135, when executed, direct performance of the operation o1135 in the illustrative depiction as follows, and/or the storing test info genetics electrical circuitry arrangement e1135, when activated, performs the operation o1135 in the illustrative depiction as follows, and/or the storing test info genetics module m1135, when executed and/or activated, directs performance of and/or performs the operation o1135 in the illustrative depiction as follows, and/or the operation o1135 is otherwise carried out in the illustrative depiction as follows: electronically storing (e.g. stored from MMS communication, etc.) farming related test information (e.g. testing irrigation water for pathogens, etc.) generated through testing of (e.g. via holographic based testing, etc.) the one or more test samples of (e.g. one or more poultry samples, etc.) one or more first farming related items involved in (e.g. lack of record keeping, etc.) farming related creation of (e.g. canola growing, etc.) one or more first biologically based substances (e.g. lamb meat, etc.) including at least in part one or more test samples regarding genetics factors (e.g. test samples regarding genetic weakness in livestock, etc.).

In one or more implementations, as shown in FIG. 54, operation o11 includes an operation o1136 for electronically storing farming related test information generated through testing of the one or more test samples of one or more first farming related items involved in farming related creation of one or more first biologically based substances including at least in part one or more test samples regarding predator associated factors. Origination of an illustratively derived storing test info predator factors component group can be accomplished through skilled in the art design choice selection of one or more of the above depicted components from one or more of the above depicted subsystems shown in FIG. 12. Components from the storing test info predator factors component group can be used in implementing execution of the one or more storing test info predator factors instructions i1136 of FIG. 29, can be used in performance of the storing test info predator factors electrical circuitry arrangement e1136 of FIG. 22, and/or can be used in otherwise fulfillment of the operation o1136. An exemplary non-transitory signal bearing medium version of the information storage subsystem s200 is depicted in FIG. 29 as bearing the one or more storing test info predator factors instructions i1136 that when executed will direct performance of the operation o1136. Furthermore, the storing test info predator factors electrical circuitry arrangement (“elec circ arrange”) e1136, when activated, will perform the operation o1136. Also, the storing test info predator factors module m1136, when executed and/or activated, will direct performance of and/or perform the operation o1136. For instance, in one or more exemplary implementations, the one or more storing test info predator factors instructions i1136, when executed, direct performance of the operation o1136 in the illustrative depiction as follows, and/or the storing test info predator factors electrical circuitry arrangement e1136, when activated, performs the operation o1136 in the illustrative depiction as follows, and/or the storing test info predator factors module m1136, when executed and/or activated, directs performance of and/or performs the operation o1136 in the illustrative depiction as follows, and/or the operation o1136 is otherwise carried out in the illustrative depiction as follows: electronically storing (e.g. stored from TCP/IP communication, etc.) farming related test information (e.g. monitoring quarantined livestock symptoms, etc.) generated through testing of (e.g. through olfactory based testing, etc.) the one or more test samples of (e.g. one or more swine samples, etc.) one or more first farming related items involved in (e.g. weather forecast, etc.) farming related creation of (e.g. sheep butchering, etc.) one or more first biologically based substances (e.g. octopus, etc.) including at least in part one or more test samples regarding predator associated factors (e.g. test samples of degree of insect infestation, etc.).

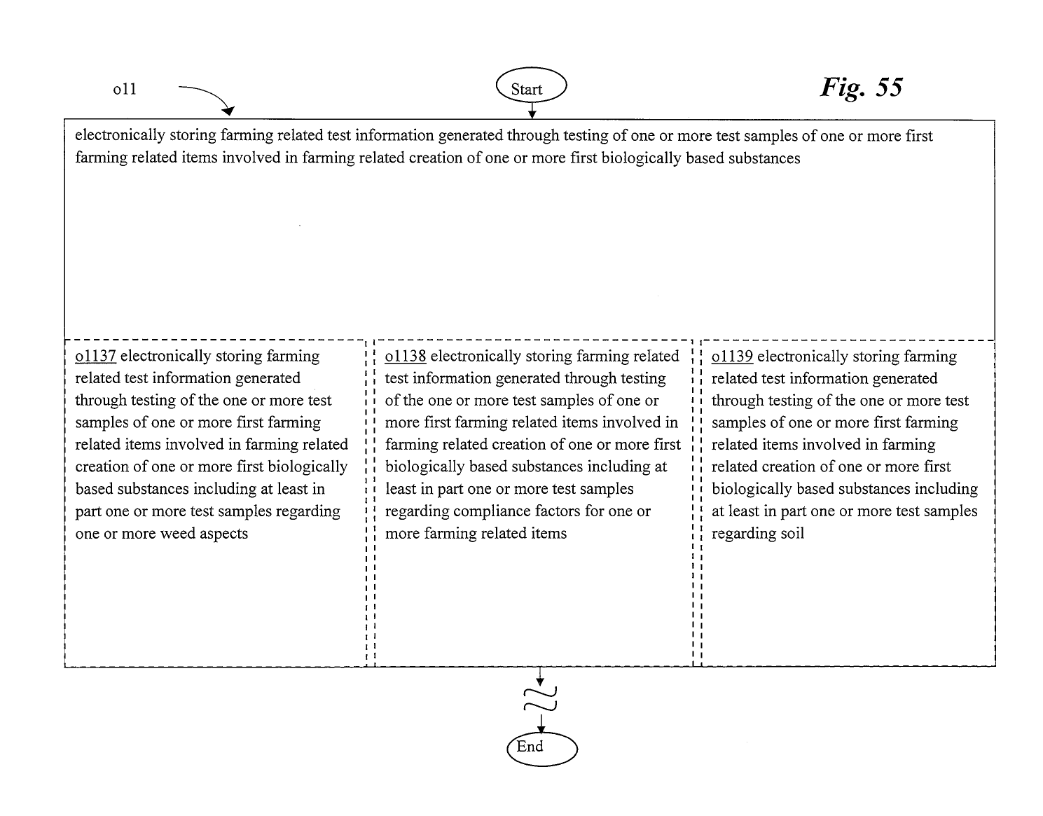

In one or more implementations, as shown in FIG. 55, operation o11 includes an operation o1137 for electronically storing farming related test information generated through testing of the one or more test samples of one or more first farming related items involved in farming related creation of one or more first biologically based substances including at least in part one or more test samples regarding one or more weed aspects. Origination of an illustratively derived storing test info weed component group can be accomplished through skilled in the art design choice selection of one or more of the above depicted components from one or more of the above depicted subsystems shown in FIG. 12. Components from the storing test info weed component group can be used in implementing execution of the one or more storing test info weed instructions i1137 of FIG. 29, can be used in performance of the storing test info weed electrical circuitry arrangement e1137 of FIG. 22, and/or can be used in otherwise fulfillment of the operation o1137. An exemplary non-transitory signal bearing medium version of the information storage subsystem s200 is depicted in FIG. 29 as bearing the one or more storing test info weed instructions i1137 that when executed will direct performance of the operation o1137. Furthermore, the storing test info weed electrical circuitry arrangement (“elec circ arrange”) e1137, when activated, will perform the operation o1137. Also, the storing test info weed module m1137, when executed and/or activated, will direct performance of and/or perform the operation o1137. For instance, in one or more exemplary implementations, the one or more storing test info weed instructions i1137, when executed, direct performance of the operation o1137 in the illustrative depiction as follows, and/or the storing test info weed electrical circuitry arrangement e1137, when activated, performs the operation o1137 in the illustrative depiction as follows, and/or the storing test info weed module m1137, when executed and/or activated, directs performance of and/or performs the operation o1137 in the illustrative depiction as follows, and/or the operation o1137 is otherwise carried out in the illustrative depiction as follows: electronically storing (e.g. stored from UPC scan, etc.) farming related test information (e.g. testing fruit tree fertility, etc.) generated through testing of (e.g. via university based testing, etc.) the one or more test samples of (e.g. one or more diary samples, etc.) one or more first farming related items involved in (e.g. generator fuel type used, etc.) farming related creation of (e.g. cereal harvesting, etc.) one or more first biologically based substances (e.g. squid, etc.) including at least in part one or more test samples regarding one or more weed aspects (e.g. test samples regarding type of fungal blight, etc.).

In one or more implementations, as shown in FIG. 55, operation o11 includes an operation o1138 for electronically storing farming related test information generated through testing of the one or more test samples of one or more first farming related items involved in farming related creation of one or more first biologically based substances including at least in part one or more test samples regarding compliance factors for one or more farming related items. Origination of an illustratively derived storing test info compliance component group can be accomplished through skilled in the art design choice selection of one or more of the above depicted components from one or more of the above depicted subsystems shown in FIG. 12. Components from the storing test info compliance component group can be used in implementing execution of the one or more storing test info compliance instructions i1138 of FIG. 29, can be used in performance of the storing test info compliance electrical circuitry arrangement e1138 of FIG. 22, and/or can be used in otherwise fulfillment of the operation o1138. An exemplary non-transitory signal bearing medium version of the information storage subsystem s200 is depicted in FIG. 29 as bearing the one or more storing test info compliance instructions i1138 that when executed will direct performance of the operation o1138. Furthermore, the storing test info compliance electrical circuitry arrangement (“elec circ arrange”) e1138, when activated, will perform the operation o1138. Also, the storing test info compliance module m1138, when executed and/or activated, will direct performance of and/or perform the operation o1138. For instance, in one or more exemplary implementations, the one or more storing test info compliance instructions i1138, when executed, direct performance of the operation o1138 in the illustrative depiction as follows, and/or the storing test info compliance electrical circuitry arrangement e1138, when activated, performs the operation o1138 in the illustrative depiction as follows, and/or the storing test info compliance module m1138, when executed and/or activated, directs performance of and/or performs the operation o1138 in the illustrative depiction as follows, and/or the operation o1138 is otherwise carried out in the illustrative depiction as follows: electronically storing (e.g. stored from ethernet, etc.) farming related test information (e.g. testing of new forage legume cultivars, etc.) generated through testing of (e.g. via recall based testing, etc.) the one or more test samples of (e.g. one or more livestock, etc.) one or more first farming related items involved in (e.g. adequate record keeping of weather patterns, etc.) farming related creation of (e.g. peach picking, etc.) one or more first biologically based substances (e.g. green algae, etc.) including at least in part one or more test samples regarding compliance factors for one or more farming related items (e.g. test samples regarding maximum concentration of pesticides permitted, etc.).

In one or more implementations, as shown in FIG. 55, operation o11 includes an operation o1139 for electronically storing farming related test information generated through testing of the one or more test samples of one or more first farming related items involved in farming related creation of one or more first biologically based substances including at least in part one or more test samples regarding soil. Origination of an illustratively derived storing test info soil component group can be accomplished through skilled in the art design choice selection of one or more of the above depicted components from one or more of the above depicted subsystems shown in FIG. 12. Components from the storing test info soil component group can be used in implementing execution of the one or more storing test info soil instructions i1139 of FIG. 29, can be used in performance of the storing test info soil electrical circuitry arrangement e1139 of FIG. 22, and/or can be used in otherwise fulfillment of the operation o1139. An exemplary non-transitory signal bearing medium version of the information storage subsystem s200 is depicted in FIG. 29 as bearing the one or more storing test info soil instructions i1139 that when executed will direct performance of the operation o1139. Furthermore, the storing test info soil electrical circuitry arrangement (“elec circ arrange”) e1139, when activated, will perform the operation o1139. Also, the storing test info soil module m1139, when executed and/or activated, will direct performance of and/or perform the operation o1139. For instance, in one or more exemplary implementations, the one or more storing test info soil instructions i1139, when executed, direct performance of the operation o1139 in the illustrative depiction as follows, and/or the storing test info soil electrical circuitry arrangement e1139, when activated, performs the operation o1139 in the illustrative depiction as follows, and/or the storing test info soil module m1139, when executed and/or activated, directs performance of and/or performs the operation o1139 in the illustrative depiction as follows, and/or the operation o1139 is otherwise carried out in the illustrative depiction as follows: electronically storing (e.g. stored from bittorent communication, etc.) farming related test information (e.g. testing of small-grain cultivars, etc.) generated through testing of (e.g. via human observation based testing, etc.) the one or more test samples of (e.g. one or more partial samples, etc.) one or more first farming related items involved in (e.g. welding machine usage, etc.) farming related creation of (e.g. goose butchering, etc.) one or more first biologically based substances (e.g. oats, etc.) including at least in part one or more test samples regarding soil (e.g. manure composition, etc.).

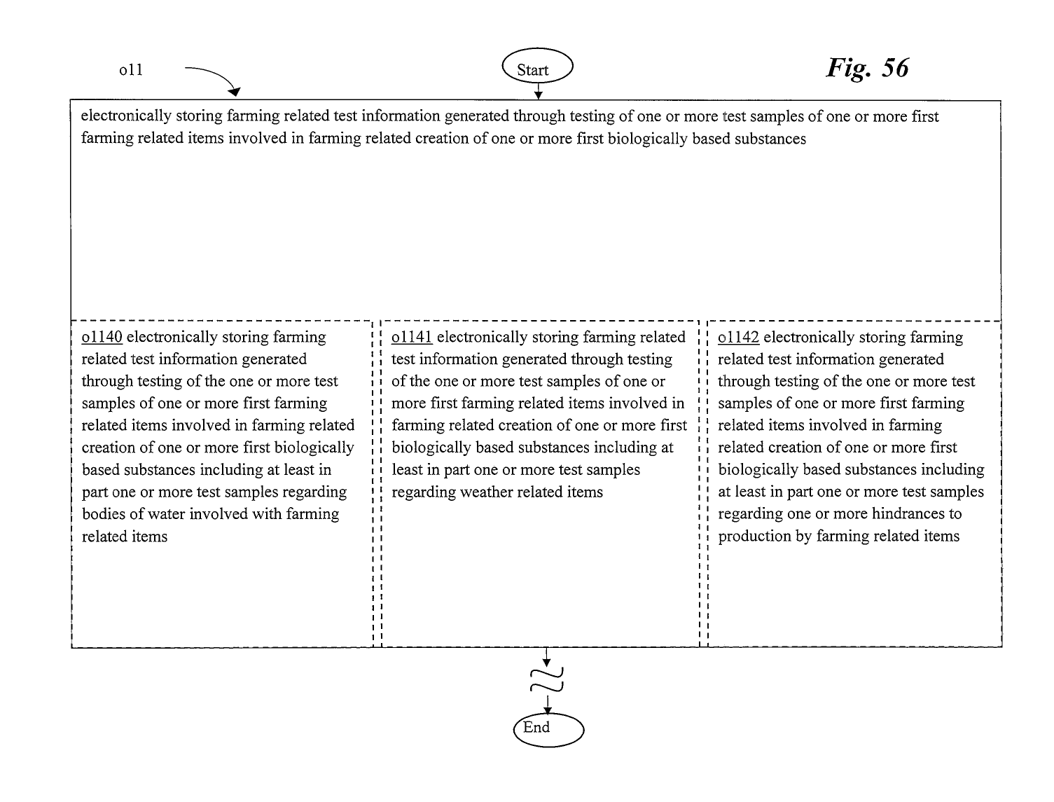

In one or more implementations, as shown in FIG. 56, operation o11 includes an operation o1140 for electronically storing farming related test information generated through testing of the one or more test samples of one or more first farming related items involved in farming related creation of one or more first biologically based substances including at least in part one or more test samples regarding bodies of water involved with farming related items. Origination of an illustratively derived storing test info water component group can be accomplished through skilled in the art design choice selection of one or more of the above depicted components from one or more of the above depicted subsystems shown in FIG. 12. Components from the storing test info water component group can be used in implementing execution of the one or more storing test info water instructions i1140 of FIG. 30, can be used in performance of the storing test info water electrical circuitry arrangement e1140 of FIG. 23, and/or can be used in otherwise fulfillment of the operation o1140. An exemplary non-transitory signal bearing medium version of the information storage subsystem s200 is depicted in FIG. 30 as bearing the one or more storing test info water instructions i1140 that when executed will direct performance of the operation o1140. Furthermore, the storing test info water electrical circuitry arrangement (“elec circ arrange”) e1140, when activated, will perform the operation o1140. Also, the storing test info water module m1140, when executed and/or activated, will direct performance of and/or perform the operation o1140. For instance, in one or more exemplary implementations, the one or more storing test info water instructions i1140, when executed, direct performance of the operation o1140 in the illustrative depiction as follows, and/or the storing test info water electrical circuitry arrangement e1140, when activated, performs the operation o1140 in the illustrative depiction as follows, and/or the storing test info water module m1140, when executed and/or activated, directs performance of and/or performs the operation o1140 in the illustrative depiction as follows, and/or the operation o1140 is otherwise carried out in the illustrative depiction as follows: electronically storing (e.g. stored from tablet entry, etc.) farming related test information (e.g. monitoring of genetic transformation, etc.) generated through testing of (e.g. through proactive based testing, etc.) the one or more test samples of (e.g. one or more vegetable samples, etc.) one or more first farming related items involved in (e.g. combine run time, etc.) farming related creation of (e.g. goose egg laying, etc.) one or more first biologically based substances (e.g. bison meat, etc.) including at least in part one or more test samples regarding bodies of water involved with farming related items (e.g. test samples for mercury levels in water, etc.).

In one or more implementations, as shown in FIG. 56, operation o11 includes an operation o1141 for electronically storing farming related test information generated through testing of the one or more test samples of one or more first farming related items involved in farming related creation of one or more first biologically based substances including at least in part one or more test samples regarding weather related items. Origination of an illustratively derived storing test info weather component group can be accomplished through skilled in the art design choice selection of one or more of the above depicted components from one or more of the above depicted subsystems shown in FIG. 12. Components from the storing test info weather component group can be used in implementing execution of the one or more storing test info weather instructions i1141 of FIG. 30, can be used in performance of the storing test info weather electrical circuitry arrangement e1141 of FIG. 23, and/or can be used in otherwise fulfillment of the operation o1141. An exemplary non-transitory signal bearing medium version of the information storage subsystem s200 is depicted in FIG. 30 as bearing the one or more storing test info weather instructions i1141 that when executed will direct performance of the operation o1141. Furthermore, the storing test info weather electrical circuitry arrangement (“elec circ arrange”) e1141, when activated, will perform the operation o1141. Also, the storing test info weather module m1141, when executed and/or activated, will direct performance of and/or perform the operation o1141. For instance, in one or more exemplary implementations, the one or more storing test info weather instructions i1141, when executed, direct performance of the operation o1141 in the illustrative depiction as follows, and/or the storing test info weather electrical circuitry arrangement e1141, when activated, performs the operation o1141 in the illustrative depiction as follows, and/or the storing test info weather module m1141, when executed and/or activated, directs performance of and/or performs the operation o1141 in the illustrative depiction as follows, and/or the operation o1141 is otherwise carried out in the illustrative depiction as follows: electronically storing (e.g. stored from PDA entry, etc.) farming related test information (e.g. monitoring cultivation management decisions, etc.) generated through testing of (e.g. through crisis prevention based testing, etc.) the one or more test samples of (e.g. one or more portion of whole object, etc.) one or more first farming related items involved in (e.g. genetic signature of heirloom tomato seeds used, etc.) farming related creation of (e.g. turkey butchering, etc.) one or more first biologically based substances (e.g. cow heart, etc.) including at least in part one or more test samples regarding weather related items (e.g. rain gauge monitoring samples, etc.).

In one or more implementations, as shown in FIG. 56, operation o11 includes an operation o1142 for electronically storing farming related test information generated through testing of the one or more test samples of one or more first farming related items involved in farming related creation of one or more first biologically based substances including at least in part one or more test samples regarding one or more hindrances to production by farming related items. Origination of an illustratively derived storing test info hindrances component group can be accomplished through skilled in the art design choice selection of one or more of the above depicted components from one or more of the above depicted subsystems shown in FIG. 12. Components from the storing test info hindrances component group can be used in implementing execution of the one or more storing test info hindrances instructions i1142 of FIG. 30, can be used in performance of the storing test info hindrances electrical circuitry arrangement e1142 of FIG. 23, and/or can be used in otherwise fulfillment of the operation o1142. An exemplary non-transitory signal bearing medium version of the information storage subsystem s200 is depicted in FIG. 30 as bearing the one or more storing test info hindrances instructions i1142 that when executed will direct performance of the operation o1142. Furthermore, the storing test info hindrances electrical circuitry arrangement (“elec circ arrange”) e1142, when activated, will perform the operation o1142. Also, the storing test info hindrances module m1142, when executed and/or activated, will direct performance of and/or perform the operation o1142. For instance, in one or more exemplary implementations, the one or more storing test info hindrances instructions i1142, when executed, direct performance of the operation o1142 in the illustrative depiction as follows, and/or the storing test info hindrances electrical circuitry arrangement e1142, when activated, performs the operation o1142 in the illustrative depiction as follows, and/or the storing test info hindrances module m1142, when executed and/or activated, directs performance of and/or performs the operation o1142 in the illustrative depiction as follows, and/or the operation o1142 is otherwise carried out in the illustrative depiction as follows: electronically storing (e.g. stored from hard drive storage, etc.) farming related test information (e.g. testing boron levels, etc.) generated through testing of (e.g. via alarm based generation, etc.) the one or more test samples of (e.g. one or more dietary based samples, etc.) one or more first farming related items involved in (e.g. invasive plant population, etc.) farming related creation of (e.g. lettuce harvesting, etc.) one or more first biologically based substances (e.g. cow liver, etc.) including at least in part one or more test samples regarding one or more hindrances to production by farming related items (e.g. test samples regarding disease rates among livestock, etc.).

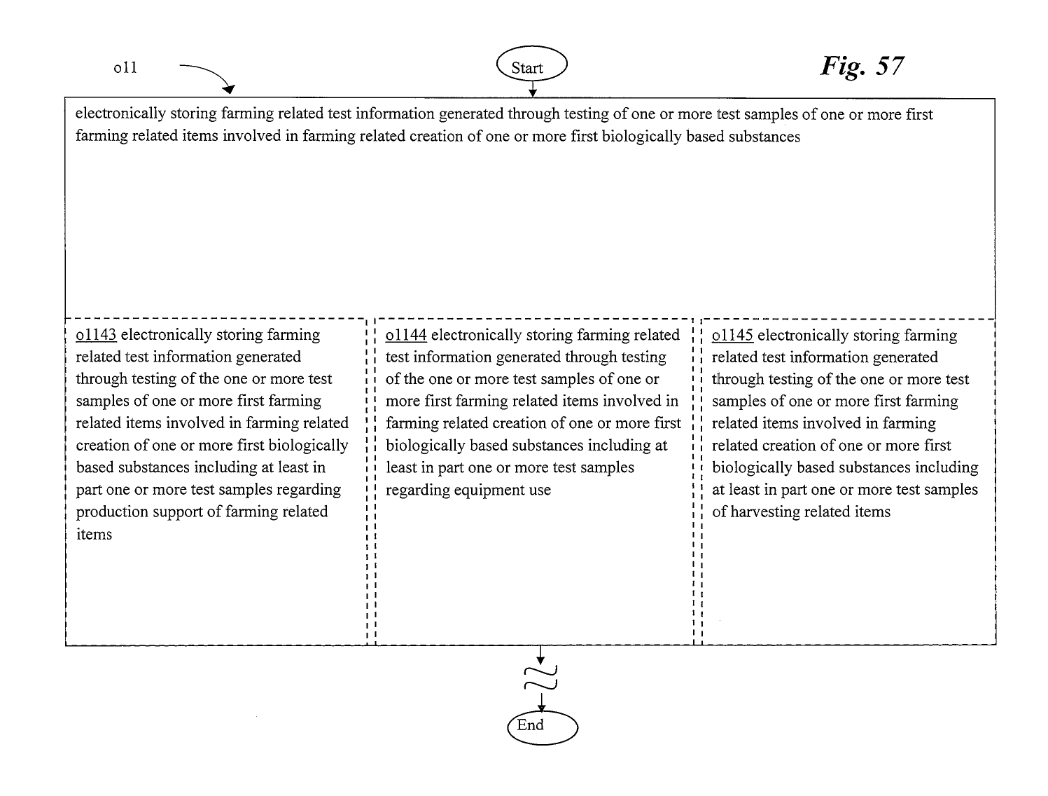

In one or more implementations, as shown in FIG. 57, operation o11 includes an operation o1143 for electronically storing farming related test information generated through testing of the one or more test samples of one or more first farming related items involved in farming related creation of one or more first biologically based substances including at least in part one or more test samples regarding production support of farming related items. Origination of an illustratively derived storing test info support component group can be accomplished through skilled in the art design choice selection of one or more of the above depicted components from one or more of the above depicted subsystems shown in FIG. 12. Components from the storing test info support component group can be used in implementing execution of the one or more storing test info support instructions i1143 of FIG. 30, can be used in performance of the storing test info support electrical circuitry arrangement e1143 of FIG. 23, and/or can be used in otherwise fulfillment of the operation o1143. An exemplary non-transitory signal bearing medium version of the information storage subsystem s200 is depicted in FIG. 30 as bearing the one or more storing test info support instructions i1143 that when executed will direct performance of the operation o1143. Furthermore, the storing test info support electrical circuitry arrangement (“elec circ arrange”) e1143, when activated, will perform the operation o1143. Also, the storing test info support module m1143, when executed and/or activated, will direct performance of and/or perform the operation o1143. For instance, in one or more exemplary implementations, the one or more storing test info support instructions i1143, when executed, direct performance of the operation o1143 in the illustrative depiction as follows, and/or the storing test info support electrical circuitry arrangement e1143, when activated, performs the operation o1143 in the illustrative depiction as follows, and/or the storing test info support module m1143, when executed and/or activated, directs performance of and/or performs the operation o1143 in the illustrative depiction as follows, and/or the operation o1143 is otherwise carried out in the illustrative depiction as follows: electronically storing (e.g. stored from DVD disc, etc.) farming related test information (e.g. testing for presence of bovine spongiform encephalopathy, etc.) generated through testing of (e.g. via polling based generation, etc.) the one or more test samples of (e.g. one or more hand collected samples, etc.) one or more first farming related items involved in (e.g. rodent population, etc.) farming related creation of (e.g. rosemary cultivation, etc.) one or more first biologically based substances (e.g. cow tongue, etc.) including at least in part one or more test samples regarding production support of farming related items (e.g. test samples of nitrogen levels after crop rotation schedules, etc.).

In one or more implementations, as shown in FIG. 57, operation o11 includes an operation o1144 for electronically storing farming related test information generated through testing of the one or more test samples of one or more first farming related items involved in farming related creation of one or more first biologically based substances including at least in part one or more test samples regarding equipment use. Origination of an illustratively derived storing test info equipment component group can be accomplished through skilled in the art design choice selection of one or more of the above depicted components from one or more of the above depicted subsystems shown in FIG. 12. Components from the storing test info equipment component group can be used in implementing execution of the one or more storing test info equipment instructions i1144 of FIG. 30, can be used in performance of the storing test info equipment electrical circuitry arrangement e1144 of FIG. 23, and/or can be used in otherwise fulfillment of the operation o1144. An exemplary non-transitory signal bearing medium version of the information storage subsystem s200 is depicted in FIG. 30 as bearing the one or more storing test info equipment instructions i1144 that when executed will direct performance of the operation o1144. Furthermore, the storing test info equipment electrical circuitry arrangement (“elec circ arrange”) e1144, when activated, will perform the operation o1144. Also, the storing test info equipment module m1144, when executed and/or activated, will direct performance of and/or perform the operation o1144. For instance, in one or more exemplary implementations, the one or more storing test info equipment instructions i1144, when executed, direct performance of the operation o1144 in the illustrative depiction as follows, and/or the storing test info equipment electrical circuitry arrangement e1144, when activated, performs the operation o1144 in the illustrative depiction as follows, and/or the storing test info equipment module m1144, when executed and/or activated, directs performance of and/or performs the operation o1144 in the illustrative depiction as follows, and/or the operation o1144 is otherwise carried out in the illustrative depiction as follows: electronically storing (e.g. stored from CD-ROM disc, etc.) farming related test information (e.g. monitoring root depth, etc.) generated through testing of (e.g. through lottery based testing, etc.) the one or more test samples of (e.g. one or more alert based samples, etc.) one or more first farming related items involved in (e.g. manure composition, etc.) farming related creation of (e.g. basil harvesting, etc.) one or more first biologically based substances (e.g. intestine casing, etc.) including at least in part one or more test samples regarding equipment use (e.g. test samples of contamination by chemicals used to operate farm machinery, etc.).

In one or more implementations, as shown in FIG. 57, operation o11 includes an operation o1145 for electronically storing farming related test information generated through testing of the one or more test samples of one or more first farming related items involved in farming related creation of one or more first biologically based substances including at least in part one or more test samples of harvesting related items. Origination of an illustratively derived storing test info harvesting component group can be accomplished through skilled in the art design choice selection of one or more of the above depicted components from one or more of the above depicted subsystems shown in FIG. 12. Components from the storing test info harvesting component group can be used in implementing execution of the one or more storing test info harvesting instructions i1145 of FIG. 30, can be used in performance of the storing test info harvesting electrical circuitry arrangement e1145 of FIG. 23, and/or can be used in otherwise fulfillment of the operation o1145. An exemplary non-transitory signal bearing medium version of the information storage subsystem s200 is depicted in FIG. 30 as bearing the one or more storing test info harvesting instructions i1145 that when executed will direct performance of the operation o1145. Furthermore, the storing test info harvesting electrical circuitry arrangement (“elec circ arrange”) e1145, when activated, will perform the operation o1145. Also, the storing test info harvesting module m1145, when executed and/or activated, will direct performance of and/or perform the operation o1145. For instance, in one or more exemplary implementations, the one or more storing test info harvesting instructions i1145, when executed, direct performance of the operation o1145 in the illustrative depiction as follows, and/or the storing test info harvesting electrical circuitry arrangement e1145, when activated, performs the operation o1145 in the illustrative depiction as follows, and/or the storing test info harvesting module m1145, when executed and/or activated, directs performance of and/or performs the operation o1145 in the illustrative depiction as follows, and/or the operation o1145 is otherwise carried out in the illustrative depiction as follows: electronically storing (e.g. G4 based communication, etc.) farming related test information (e.g. monitoring UV index, etc.) generated through testing of (e.g. via thermal based testing, etc.) the one or more test samples of (e.g. one or more authority directed samples, etc.) one or more first farming related items involved in (e.g. shade tree population density, etc.) farming related creation of (e.g. oregano growing, etc.) one or more first biologically based substances (e.g. chicken feet, etc.) including at least in part one or more test samples of harvesting related items (e.g. test samples fruit harvested, etc.).

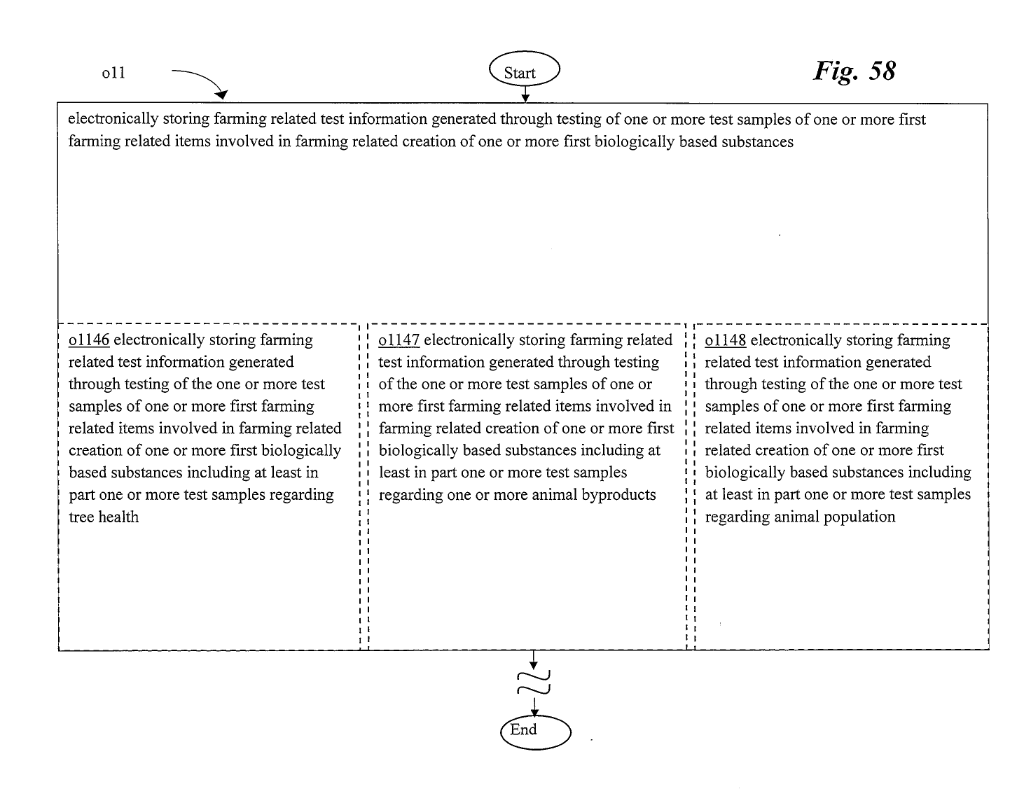

In one or more implementations, as shown in FIG. 58, operation o11 includes an operation o1146 for electronically storing farming related test information generated through testing of the one or more test samples of one or more first farming related items involved in farming related creation of one or more first biologically based substances including at least in part one or more test samples regarding tree health. Origination of an illustratively derived storing test info tree component group can be accomplished through skilled in the art design choice selection of one or more of the above depicted components from one or more of the above depicted subsystems shown in FIG. 12. Components from the storing test info tree component group can be used in implementing execution of the one or more storing test info tree instructions i1146 of FIG. 30, can be used in performance of the storing test info tree electrical circuitry arrangement e1146 of FIG. 23, and/or can be used in otherwise fulfillment of the operation o1146. An exemplary non-transitory signal bearing medium version of the information storage subsystem s200 is depicted in FIG. 30 as bearing the one or more storing test info tree instructions i1146 that when executed will direct performance of the operation o1146. Furthermore, the storing test info tree electrical circuitry arrangement (“elec circ arrange”) e1146, when activated, will perform the operation o1146. Also, the storing test info tree module m1146, when executed and/or activated, will direct performance of and/or perform the operation o1146. For instance, in one or more exemplary implementations, the one or more storing test info tree instructions i1146, when executed, direct performance of the operation o1146 in the illustrative depiction as follows, and/or the storing test info tree electrical circuitry arrangement e1146, when activated, performs the operation o1146 in the illustrative depiction as follows, and/or the storing test info tree module m1146, when executed and/or activated, directs performance of and/or performs the operation o1146 in the illustrative depiction as follows, and/or the operation o1146 is otherwise carried out in the illustrative depiction as follows: electronically storing (e.g. stored from G3 based communication, etc.) farming related test information (e.g. testing pecan levels in plant matter, etc.) generated through testing of (e.g. through pressure based testing, etc.) the one or more test samples of (e.g. one or more scratch samples, etc.) one or more first farming related items involved in (e.g. neighbor's crop harvest, etc.) farming related creation of (e.g. oat harvesting, etc.) one or more first biologically based substances (e.g. ground chicken, etc.) including at least in part one or more test samples regarding tree health (e.g. test samples for seasonal moisture content, etc.).

In one or more implementations, as shown in FIG. 58, operation o11 includes an operation o1147 for electronically storing farming related test information generated through testing of the one or more test samples of one or more first farming related items involved in farming related creation of one or more first biologically based substances including at least in part one or more test samples regarding one or more animal byproducts. Origination of an illustratively derived storing test info byproduct component group can be accomplished through skilled in the art design choice selection of one or more of the above depicted components from one or more of the above depicted subsystems shown in FIG. 12. Components from the storing test info byproduct component group can be used in implementing execution of the one or more storing test info byproduct instructions i1147 of FIG. 30, can be used in performance of the storing test info byproduct electrical circuitry arrangement e1147 of FIG. 23, and/or can be used in otherwise fulfillment of the operation o1147. An exemplary non-transitory signal bearing medium version of the information storage subsystem s200 is depicted in FIG. 30 as bearing the one or more storing test info byproduct instructions i1147 that when executed will direct performance of the operation o1147. Furthermore, the storing test info byproduct electrical circuitry arrangement (“elec circ arrange”) e1147, when activated, will perform the operation o1147. Also, the storing test info byproduct module m1147, when executed and/or activated, will direct performance of and/or perform the operation o1147. For instance, in one or more exemplary implementations, the one or more storing test info byproduct instructions it 147, when executed, direct performance of the operation o1147 in the illustrative depiction as follows, and/or the storing test info byproduct electrical circuitry arrangement e1147, when activated, performs the operation o1147 in the illustrative depiction as follows, and/or the storing test info byproduct module m1147, when executed and/or activated, directs performance of and/or performs the operation o1147 in the illustrative depiction as follows, and/or the operation o1147 is otherwise carried out in the illustrative depiction as follows: electronically storing (e.g. stored from GPRS data service, etc.) farming related test information (e.g. testing nitrogen levels, etc.) generated through testing of (e.g. via hydraulic based testing, etc.) the one or more test samples of (e.g. one or more blood draw samples, etc.) one or more first farming related items involved in (e.g. crop rotation demands, etc.) farming related creation of (e.g. carrot growing, etc.) one or more first biologically based substances (e.g. goat milk, etc.) including at least in part one or more test samples regarding one or more animal byproducts (e.g. test samples of egg production line, etc.).

In one or more implementations, as shown in FIG. 58, operation o11 includes an operation o1148 for electronically storing farming related test information generated through testing of the one or more test samples of one or more first farming related items involved in farming related creation of one or more first biologically based substances including at least in part one or more test samples regarding animal population. Origination of an illustratively derived storing test info animal pop component group can be accomplished through skilled in the art design choice selection of one or more of the above depicted components from one or more of the above depicted subsystems shown in FIG. 12. Components from the storing test info animal pop component group can be used in implementing execution of the one or more storing test info animal pop instructions i1148 of FIG. 30, can be used in performance of the storing test info animal pop electrical circuitry arrangement e1148 of FIG. 23, and/or can be used in otherwise fulfillment of the operation o1148. An exemplary non-transitory signal bearing medium version of the information storage subsystem s200 is depicted in FIG. 30 as bearing the one or more storing test info animal pop instructions i1148 that when executed will direct performance of the operation o1148. Furthermore, the storing test info animal pop electrical circuitry arrangement (“elec circ arrange”) e1148, when activated, will perform the operation o1148. Also, the storing test info animal pop module m1148, when executed and/or activated, will direct performance of and/or perform the operation o1148. For instance, in one or more exemplary implementations, the one or more storing test info animal pop instructions i1148, when executed, direct performance of the operation o1148 in the illustrative depiction as follows, and/or the storing test info animal pop electrical circuitry arrangement e1148, when activated, performs the operation o1148 in the illustrative depiction as follows, and/or the storing test info animal pop module m1148, when executed and/or activated, directs performance of and/or performs the operation o1148 in the illustrative depiction as follows, and/or the operation o1148 is otherwise carried out in the illustrative depiction as follows: electronically storing (e.g. stored from CDMA transmission, etc.) farming related test information (e.g. monitoring rainfall, etc.) generated through testing of (e.g. via hydrostatic based testing, etc.) the one or more test samples of (e.g. one or more vacuum collected samples, etc.) one or more first farming related items involved in (e.g. government subsidy status, etc.) farming related creation of (e.g. lentil cultivation, etc.) one or more first biologically based substances (e.g. oyster shell, etc.) including at least in part one or more test samples regarding animal population (e.g. blood samples of livestock, etc.).

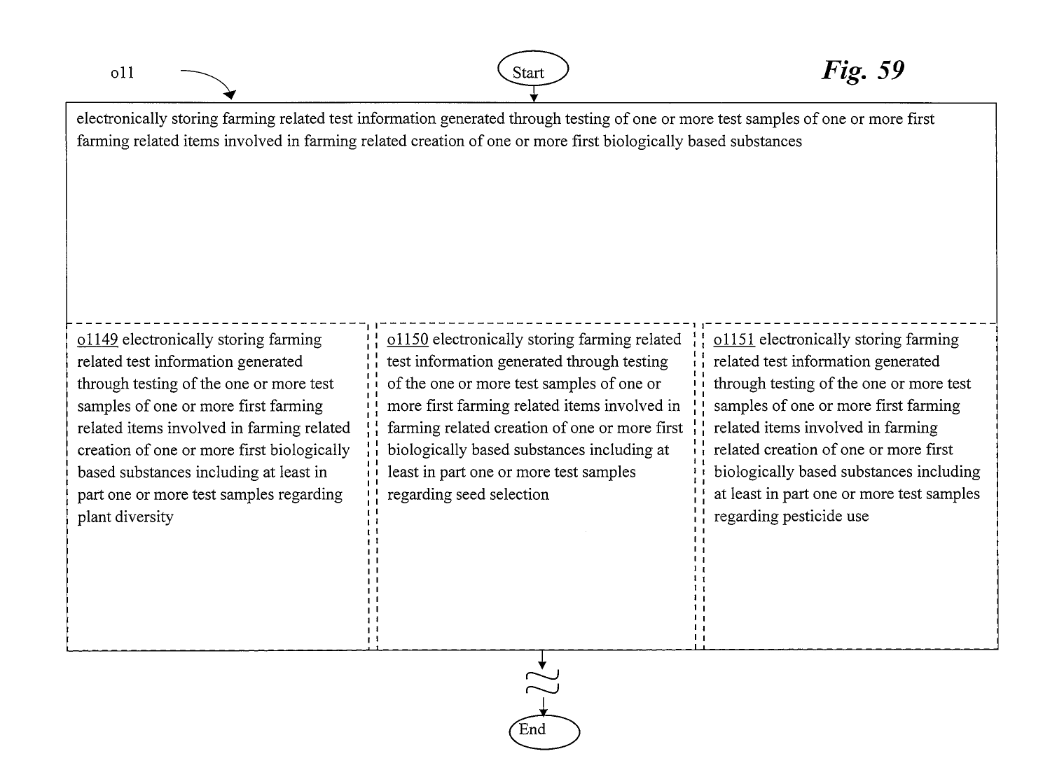

In one or more implementations, as shown in FIG. 59, operation o11 includes an operation o1149 for electronically storing farming related test information generated through testing of the one or more test samples of one or more first farming related items involved in farming related creation of one or more first biologically based substances including at least in part one or more test samples regarding plant diversity. Origination of an illustratively derived storing test info plant component group can be accomplished through skilled in the art design choice selection of one or more of the above depicted components from one or more of the above depicted subsystems shown in FIG. 12. Components from the storing test info plant component group can be used in implementing execution of the one or more storing test info plant instructions i1149 of FIG. 30, can be used in performance of the storing test info plant electrical circuitry arrangement e1149 of FIG. 23, and/or can be used in otherwise fulfillment of the operation o1149. An exemplary non-transitory signal bearing medium version of the information storage subsystem s200 is depicted in FIG. 30 as bearing the one or more storing test info plant instructions i1149 that when executed will direct performance of the operation o1149. Furthermore, the storing test info plant electrical circuitry arrangement (“elec circ arrange”) e1149, when activated, will perform the operation o1149. Also, the storing test info plant module m1149, when executed and/or activated, will direct performance of and/or perform the operation o1149. For instance, in one or more exemplary implementations, the one or more storing test info plant instructions i1149, when executed, direct performance of the operation o1149 in the illustrative depiction as follows, and/or the storing test info plant electrical circuitry arrangement e1149, when activated, performs the operation o1149 in the illustrative depiction as follows, and/or the storing test info plant module m1149, when executed and/or activated, directs performance of and/or performs the operation o1149 in the illustrative depiction as follows, and/or the operation o1149 is otherwise carried out in the illustrative depiction as follows: electronically storing (e.g. stored from IEEE 802.11 communication, etc.) farming related test information (e.g. monitoring sealed carton pressure, etc.) generated through testing of (e.g. though semi-automated based generation, etc.) the one or more test samples of (e.g. one or more refuse samples, etc.) one or more first farming related items involved in (e.g. schedule of pesticide application, etc.) farming related creation of (e.g. rice threshing, etc.) one or more first biologically based substances (e.g. goat cheese, etc.) including at least in part one or more test samples regarding plant diversity (e.g. aerial surveys of integrated pest management through plant diversity, etc.).

In one or more implementations, as shown in FIG. 59, operation o11 includes an operation o1150 for electronically storing farming related test information generated through testing of the one or more test samples of one or more first farming related items involved in farming related creation of one or more first biologically based substances including at least in part one or more test samples regarding seed selection. Origination of an illustratively derived storing test info seed component group can be accomplished through skilled in the art design choice selection of one or more of the above depicted components from one or more of the above depicted subsystems shown in FIG. 12. Components from the storing test info seed component group can be used in implementing execution of the one or more storing test info seed instructions i1150 of FIG. 30, can be used in performance of the storing test info seed electrical circuitry arrangement e1150 of FIG. 23, and/or can be used in otherwise fulfillment of the operation o1150. An exemplary non-transitory signal bearing medium version of the information storage subsystem s200 is depicted in FIG. 30 as bearing the one or more storing test info seed instructions i1150 that when executed will direct performance of the operation o1150. Furthermore, the storing test info seed electrical circuitry arrangement (“elec circ arrange”) e1150, when activated, will perform the operation o1150. Also, the storing test info seed module m1150, when executed and/or activated, will direct performance of and/or perform the operation o1150. For instance, in one or more exemplary implementations, the one or more storing test info seed instructions i1150, when executed, direct performance of the operation o1150 in the illustrative depiction as follows, and/or the storing test info seed electrical circuitry arrangement e1150, when activated, performs the operation o1150 in the illustrative depiction as follows, and/or the storing test info seed module m1150, when executed and/or activated, directs performance of and/or performs the operation o1150 in the illustrative depiction as follows, and/or the operation o1150 is otherwise carried out in the illustrative depiction as follows: electronically storing (e.g. stored from UHF reception, etc.) farming related test information (e.g. testing for presence of pesticides, etc.) generated through testing of (e.g. via climatic based generation, etc.) the one or more test samples of (e.g. one or more dust samples, etc.) one or more first farming related items involved in (e.g. type of fertilizer used, etc.) farming related creation of (e.g. apple harvesting, etc.) one or more first biologically based substances (e.g. abalone shell, etc.) including at least in part one or more test samples regarding seed selection (e.g. test samples of hybrid versus antique seeds used, etc.).

In one or more implementations, as shown in FIG. 59, operation o11 includes an operation o1151 for electronically storing farming related test information generated through testing of the one or more test samples of one or more first farming related items involved in farming related creation of one or more first biologically based substances including at least in part one or more test samples regarding pesticide use. Origination of an illustratively derived storing test info pesticide component group can be accomplished through skilled in the art design choice selection of one or more of the above depicted components from one or more of the above depicted subsystems shown in FIG. 12. Components from the storing test info pesticide component group can be used in implementing execution of the one or more storing test info pesticide instructions i1151 of FIG. 30, can be used in performance of the storing test info pesticide electrical circuitry arrangement e1151 of FIG. 23, and/or can be used in otherwise fulfillment of the operation o1151. An exemplary non-transitory signal bearing medium version of the information storage subsystem s200 is depicted in FIG. 30 as bearing the one or more storing test info pesticide instructions i1151 that when executed will direct performance of the operation o1151. Furthermore, the storing test info pesticide electrical circuitry arrangement (“elec circ arrange”) e1151, when activated, will perform the operation o1151. Also, the storing test info pesticide module m1151, when executed and/or activated, will direct performance of and/or perform the operation o1151. For instance, in one or more exemplary implementations, the one or more storing test info pesticide instructions i1151, when executed, direct performance of the operation o1151 in the illustrative depiction as follows, and/or the storing test info pesticide electrical circuitry arrangement e1151, when activated, performs the operation o1151 in the illustrative depiction as follows, and/or the storing test info pesticide module m1151, when executed and/or activated, directs performance of and/or performs the operation o1151 in the illustrative depiction as follows, and/or the operation o1151 is otherwise carried out in the illustrative depiction as follows: electronically storing (e.g. stored from VHF reception, etc.) farming related test information (e.g. testing for soil contaminants, etc.) generated through testing of (e.g. via seismic based testing, etc.) the one or more test samples of (e.g. one or more dander samples, etc.) one or more first farming related items involved in (e.g. safety regulations, etc.) farming related creation of (e.g. crab trapping, etc.) one or more first biologically based substances (e.g. wool, etc.) including at least in part one or more test samples regarding pesticide use (e.g. test samples regarding pesticide residue on harvested corn, etc.).

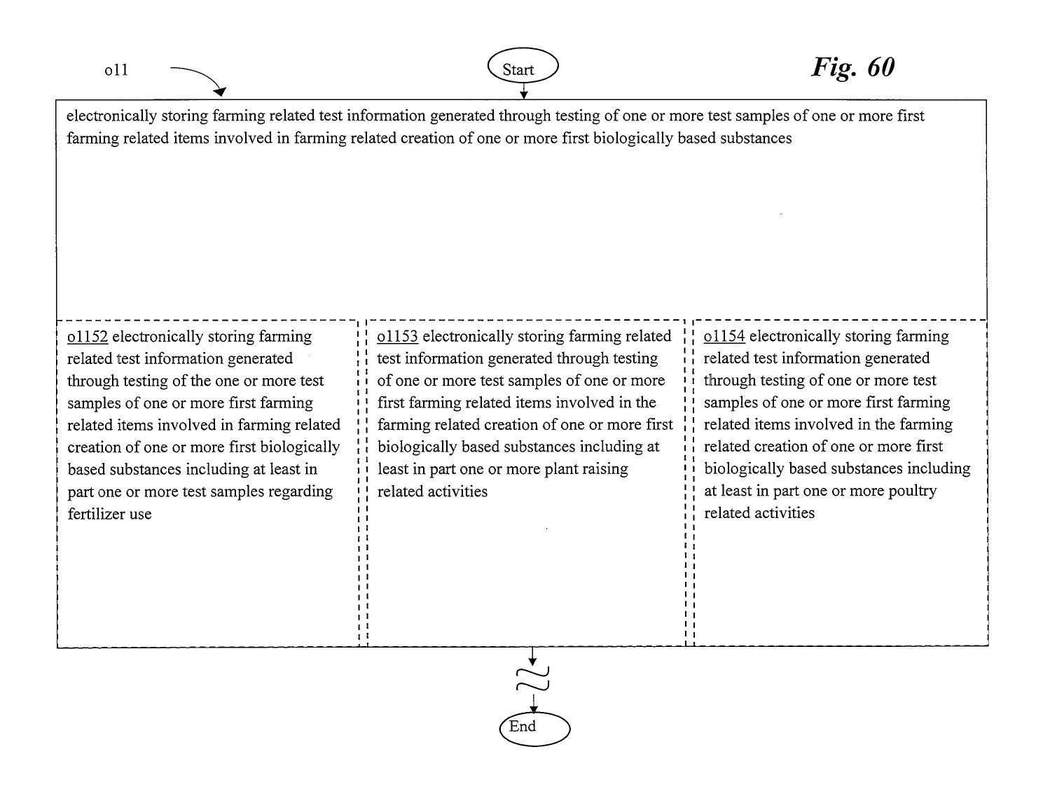

In one or more implementations, as shown in FIG. 60, operation o11 includes an operation o1152 for electronically storing farming related test information generated through testing of the one or more test samples of one or more first farming related items involved in farming related creation of one or more first biologically based substances including at least in part one or more test samples regarding fertilizer use. Origination of an illustratively derived storing test info fertilizer component group can be accomplished through skilled in the art design choice selection of one or more of the above depicted components from one or more of the above depicted subsystems shown in FIG. 12. Components from the storing test info fertilizer component group can be used in implementing execution of the one or more storing test info fertilizer instructions i1152 of FIG. 30, can be used in performance of the storing test info fertilizer electrical circuitry arrangement e1152 of FIG. 23, and/or can be used in otherwise fulfillment of the operation o1152. An exemplary non-transitory signal bearing medium version of the information storage subsystem s200 is depicted in FIG. 30 as bearing the one or more storing test info fertilizer instructions i1152 that when executed will direct performance of the operation o1152. Furthermore, the storing test info fertilizer electrical circuitry arrangement (“elec circ arrange”) e1152, when activated, will perform the operation o1152. Also, the storing test info fertilizer module m1152, when executed and/or activated, will direct performance of and/or perform the operation o1152. For instance, in one or more exemplary implementations, the one or more storing test info fertilizer instructions i1152, when executed, direct performance of the operation o1152 in the illustrative depiction as follows, and/or the storing test info fertilizer electrical circuitry arrangement e1152, when activated, performs the operation o1152 in the illustrative depiction as follows, and/or the storing test info fertilizer module m1152, when executed and/or activated, directs performance of and/or performs the operation o1152 in the illustrative depiction as follows, and/or the operation o1152 is otherwise carried out in the illustrative depiction as follows: electronically storing (e.g. stored from acoustic energy reception, etc.) farming related test information (e.g. monitoring herbicide use, etc.) generated through testing of (e.g. through profile based testing, etc.) the one or more test samples of (e.g. one or more particle samples, etc.) one or more first farming related items involved in (e.g. range area, etc.) farming related creation of (e.g. mushroom cultivation, etc.) one or more first biologically based substances (e.g. water, etc.) including at least in part one or more test samples regarding fertilizer use (e.g. test samples of soil for probiotic levels versus synthetic nitrogen levels, etc.).

In one or more implementations, as shown in FIG. 60, operation o11 includes an operation o1153 for electronically storing farming related test information generated through testing of one or more test samples of one or more first farming related items involved in the farming related creation of one or more first biologically based substances including at least in part one or more plant raising related activities. Origination of an illustratively derived storing test info raising component group can be accomplished through skilled in the art design choice selection of one or more of the above depicted components from one or more of the above depicted subsystems shown in FIG. 12. Components from the storing test info raising component group can be used in implementing execution of the one or more storing test info raising instructions it 153 of FIG. 30, can be used in performance of the storing test info raising electrical circuitry arrangement e1153 of FIG. 23, and/or can be used in otherwise fulfillment of the operation o1153. An exemplary non-transitory signal bearing medium version of the information storage subsystem s200 is depicted in FIG. 30 as bearing the one or more storing test info raising instructions i1153 that when executed will direct performance of the operation o1153. Furthermore, the storing test info raising electrical circuitry arrangement (“elec circ arrange”) e1153, when activated, will perform the operation o1153. Also, the storing test info raising module m1153, when executed and/or activated, will direct performance of and/or perform the operation o1153. For instance, in one or more exemplary implementations, the one or more storing test info raising instructions i1153, when executed, direct performance of the operation o1153 in the illustrative depiction as follows, and/or the storing test info raising electrical circuitry arrangement e1153, when activated, performs the operation o1153 in the illustrative depiction as follows, and/or the storing test info raising module m1153, when executed and/or activated, directs performance of and/or performs the operation o1153 in the illustrative depiction as follows, and/or the operation o1153 is otherwise carried out in the illustrative depiction as follows: electronically storing (e.g. stored from desktop computer entry, etc.) farming related test information (e.g. monitoring water availability, etc.) generated through testing of (e.g. via chem-strip based testing, etc.) one or more test samples of (e.g. one or more color samples, etc.) one or more first farming related items involved in (e.g. labor laws, etc.) the farming related creation of (e.g. jalapeno pepper growing, etc.) one or more first biologically based substances (e.g. cow milk, etc.) including at least in part one or more plant raising related activities (e.g. distributing beneficial insects amongst crops, etc.).

In one or more implementations, as shown in FIG. 60, operation o11 includes an operation o1154 for electronically storing farming related test information generated through testing of one or more test samples of one or more first farming related items involved in the farming related creation of one or more first biologically based substances including at least in part one or more poultry related activities. Origination of an illustratively derived storing test info poultry component group can be accomplished through skilled in the art design choice selection of one or more of the above depicted components from one or more of the above depicted subsystems shown in FIG. 12. Components from the storing test info poultry component group can be used in implementing execution of the one or more storing test info poultry instructions i1154 of FIG. 30, can be used in performance of the storing test info poultry electrical circuitry arrangement e1154 of FIG. 23, and/or can be used in otherwise fulfillment of the operation o1154. An exemplary non-transitory signal bearing medium version of the information storage subsystem s200 is depicted in FIG. 30 as bearing the one or more storing test info poultry instructions i1154 that when executed will direct performance of the operation o1154. Furthermore, the storing test info poultry electrical circuitry arrangement (“elec circ arrange”) e1154, when activated, will perform the operation o1154. Also, the storing test info poultry module m1154, when executed and/or activated, will direct performance of and/or perform the operation o1154. For instance, in one or more exemplary implementations, the one or more storing test info poultry instructions i1154, when executed, direct performance of the operation o1154 in the illustrative depiction as follows, and/or the storing test info poultry electrical circuitry arrangement e1154, when activated, performs the operation o1154 in the illustrative depiction as follows, and/or the storing test info poultry module m1154, when executed and/or activated, directs performance of and/or performs the operation o1154 in the illustrative depiction as follows, and/or the operation o1154 is otherwise carried out in the illustrative depiction as follows: electronically storing (e.g. stored from PDA entry, etc.) farming related test information (e.g. monitoring presence of fertilizer ratios in irrigation water, etc.) generated through testing of (e.g. via physics based testing, etc.) one or more test samples of (e.g. one or more image samples, etc.) one or more first farming related items involved in (e.g. livestock inventory, etc.) the farming related creation of (e.g. chicken egg laying, etc.) one or more first biologically based substances (e.g. sheep milk, etc.) including at least in part one or more poultry related activities (e.g. density of poultry hens throughout a 24 hour period, etc.).

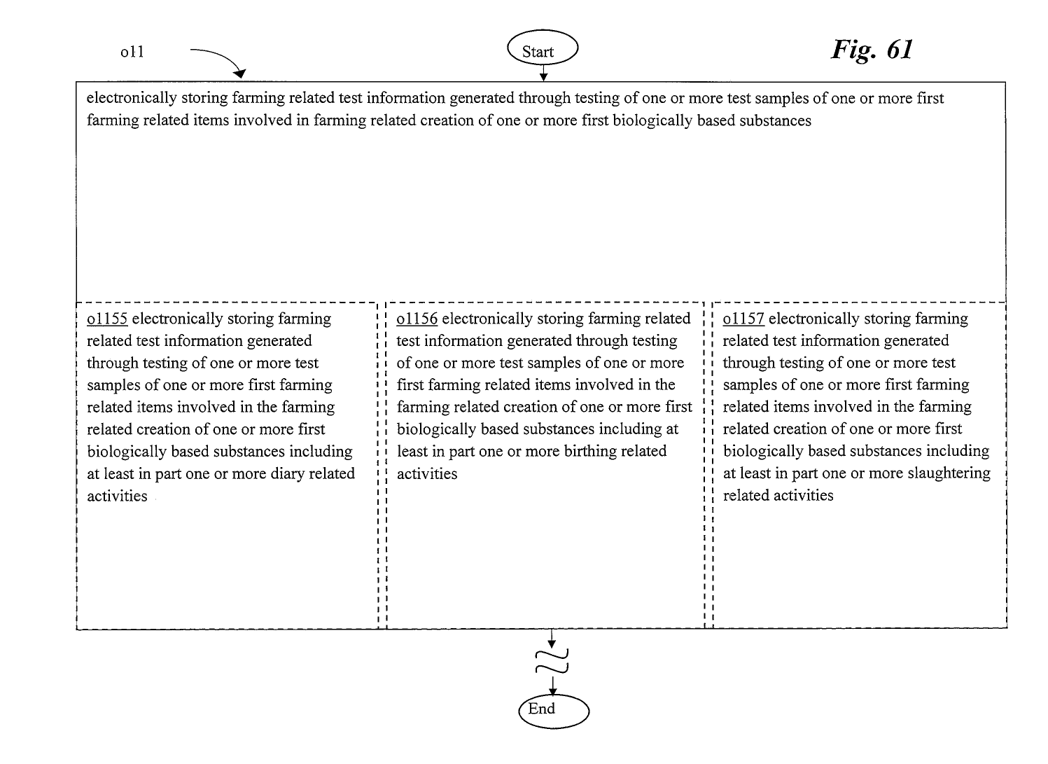

In one or more implementations, as shown in FIG. 61, operation o11 includes an operation o1155 for electronically storing farming related test information generated through testing of one or more test samples of one or more first farming related items involved in the farming related creation of one or more first biologically based substances including at least in part one or more diary related activities. Origination of an illustratively derived storing test info diary component group can be accomplished through skilled in the art design choice selection of one or more of the above depicted components from one or more of the above depicted subsystems shown in FIG. 12. Components from the storing test info diary component group can be used in implementing execution of the one or more storing test info diary instructions i1155 of FIG. 30, can be used in performance of the storing test info diary electrical circuitry arrangement e1155 of FIG. 23, and/or can be used in otherwise fulfillment of the operation o1155. An exemplary non-transitory signal bearing medium version of the information storage subsystem s200 is depicted in FIG. 30 as bearing the one or more storing test info diary instructions i1155 that when executed will direct performance of the operation o1155. Furthermore, the storing test info diary electrical circuitry arrangement (“elec circ arrange”) e1155, when activated, will perform the operation o1155. Also, the storing test info diary module m1155, when executed and/or activated, will direct performance of and/or perform the operation o1155. For instance, in one or more exemplary implementations, the one or more storing test info diary instructions i1155, when executed, direct performance of the operation o1155 in the illustrative depiction as follows, and/or the storing test info diary electrical circuitry arrangement e1155, when activated, performs the operation o1155 in the illustrative depiction as follows, and/or the storing test info diary module m1155, when executed and/or activated, directs performance of and/or performs the operation o1155 in the illustrative depiction as follows, and/or the operation o1155 is otherwise carried out in the illustrative depiction as follows: electronically storing (e.g. stored from MMS communication, etc.) farming related test information (e.g. testing chlorophyll levels in plant matter, etc.) generated through testing of (e.g. through mechanical testing, etc.) one or more test samples of (e.g. one or more audio samples, etc.) one or more first farming related items involved in (e.g. range schedule, etc.) the farming related creation of (e.g. cow milking, etc.) one or more first biologically based substances (e.g. fresh water eel, etc.) including at least in part one or more diary related activities (e.g. percentage of grass fed to cows versus grain, etc.).

In one or more implementations, as shown in FIG. 61, operation o11 includes an operation o1156 for electronically storing farming related test information generated through testing of one or more test samples of one or more first farming related items involved in the farming related creation of one or more first biologically based substances including at least in part one or more birthing related activities. Origination of an illustratively derived storing test info birthing component group can be accomplished through skilled in the art design choice selection of one or more of the above depicted components from one or more of the above depicted subsystems shown in FIG. 12. Components from the storing test info birthing component group can be used in implementing execution of the one or more storing test info birthing instructions i1156 of FIG. 30, can be used in performance of the storing test info birthing electrical circuitry arrangement e1156 of FIG. 23, and/or can be used in otherwise fulfillment of the operation o1156. An exemplary non-transitory signal bearing medium version of the information storage subsystem s200 is depicted in FIG. 30 as bearing the one or more storing test info birthing instructions i1156 that when executed will direct performance of the operation o1156. Furthermore, the storing test info birthing electrical circuitry arrangement (“elec circ arrange”) e1156, when activated, will perform the operation o1156. Also, the storing test info birthing module m1156, when executed and/or activated, will direct performance of and/or perform the operation o1156. For instance, in one or more exemplary implementations, the one or more storing test info birthing instructions i1156, when executed, direct performance of the operation o1156 in the illustrative depiction as follows, and/or the storing test info birthing electrical circuitry arrangement e1156, when activated, performs the operation o1156 in the illustrative depiction as follows, and/or the storing test info birthing module m1156, when executed and/or activated, directs performance of and/or performs the operation o1156 in the illustrative depiction as follows, and/or the operation o1156 is otherwise carried out in the illustrative depiction as follows: electronically storing (e.g. stored from TCP/IP communication, etc.) farming related test information (e.g. testing for banned pesticide presence, etc.) generated through testing of (e.g. through electrical testing, etc.) one or more test samples of (e.g. one or more video samples, etc.) one or more first farming related items involved in (e.g. land terrain, etc.) the farming related creation of (e.g. pig birthing, etc.) one or more first biologically based substances (e.g. salmon eggs, etc.) including at least in part one or more birthing related activities (e.g. number of stillborn calves occurring in a year, etc.).

In one or more implementations, as shown in FIG. 61, operation o11 includes an operation o1157 for electronically storing farming related test information generated through testing of one or more test samples of one or more first farming related items involved in the farming related creation of one or more first biologically based substances including at least in part one or more slaughtering related activities. Origination of an illustratively derived storing test info slaughter component group can be accomplished through skilled in the art design choice selection of one or more of the above depicted components from one or more of the above depicted subsystems shown in FIG. 12. Components from the storing test info slaughter component group can be used in implementing execution of the one or more storing test info slaughter instructions i1157 of FIG. 30, can be used in performance of the storing test info slaughter electrical circuitry arrangement e1157 of FIG. 23, and/or can be used in otherwise fulfillment of the operation o1157. An exemplary non-transitory signal bearing medium version of the information storage subsystem s200 is depicted in FIG. 30 as bearing the one or more storing test info slaughter instructions i1157 that when executed will direct performance of the operation o1157. Furthermore, the storing test info slaughter electrical circuitry arrangement (“elec circ arrange”) e1157, when activated, will perform the operation o1157. Also, the storing test info slaughter module m1157, when executed and/or activated, will direct performance of and/or perform the operation o1157. For instance, in one or more exemplary implementations, the one or more storing test info slaughter instructions i1157, when executed, direct performance of the operation o1157 in the illustrative depiction as follows, and/or the storing test info slaughter electrical circuitry arrangement e1157, when activated, performs the operation o1157 in the illustrative depiction as follows, and/or the storing test info slaughter module m1157, when executed and/or activated, directs performance of and/or performs the operation o1157 in the illustrative depiction as follows, and/or the operation o1157 is otherwise carried out in the illustrative depiction as follows: electronically storing (e.g. stored from UPC scan, etc.) farming related test information (e.g. testing for natural insect predator population, etc.) generated through testing of (e.g. through mechanical generation, etc.) one or more test samples of (e.g. one or more progressive samples, etc.) one or more first farming related items involved in (e.g. local regulations, etc.) the farming related creation of (e.g. chicken slaughtering, etc.) one or more first biologically based substances (e.g. trout, etc.) including at least in part one or more slaughtering related activities (e.g. bacteria counts on often exposed or used surfaces, etc.).

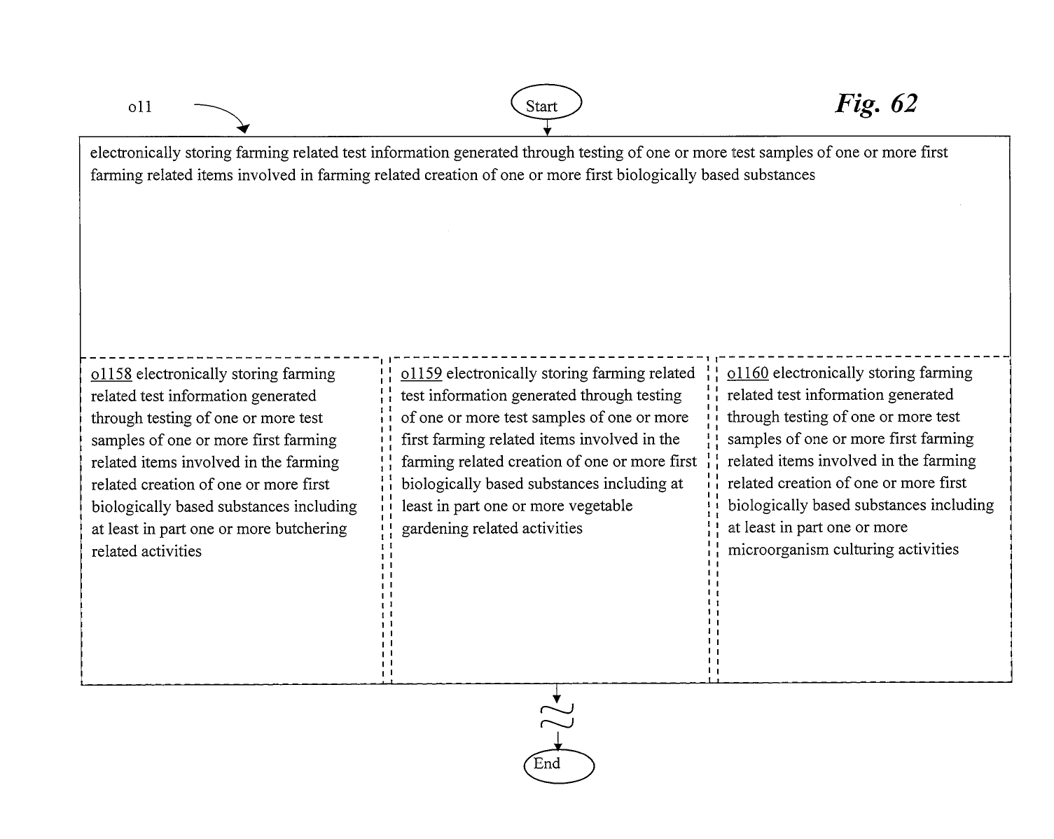

In one or more implementations, as shown in FIG. 62, operation o11 includes an operation o1158 for electronically storing farming related test information generated through testing of one or more test samples of one or more first farming related items involved in the farming related creation of one or more first biologically based substances including at least in part one or more butchering related activities. Origination of an illustratively derived storing test info butcher component group can be accomplished through skilled in the art design choice selection of one or more of the above depicted components from one or more of the above depicted subsystems shown in FIG. 12. Components from the storing test info butcher component group can be used in implementing execution of the one or more storing test info butcher instructions i1158 of FIG. 30, can be used in performance of the storing test info butcher electrical circuitry arrangement e1158 of FIG. 23, and/or can be used in otherwise fulfillment of the operation o1158. An exemplary non-transitory signal bearing medium version of the information storage subsystem s200 is depicted in FIG. 30 as bearing the one or more storing test info butcher instructions i1158 that when executed will direct performance of the operation o1158. Furthermore, the storing test info butcher electrical circuitry arrangement (“elec circ arrange”) e1158, when activated, will perform the operation o1158. Also, the storing test info butcher module m1158, when executed and/or activated, will direct performance of and/or perform the operation o1158. For instance, in one or more exemplary implementations, the one or more storing test info butcher instructions i1158, when executed, direct performance of the operation o1158 in the illustrative depiction as follows, and/or the storing test info butcher electrical circuitry arrangement e1158, when activated, performs the operation o1158 in the illustrative depiction as follows, and/or the storing test info butcher module m1158, when executed and/or activated, directs performance of and/or performs the operation o1158 in the illustrative depiction as follows, and/or the operation o1158 is otherwise carried out in the illustrative depiction as follows: electronically storing (e.g. stored from ethernet, etc.) farming related test information (e.g. monitoring crop growth over time span, etc.) generated through testing of (e.g. through electrical generation, etc.) one or more test samples of (e.g. one or more alternating samples, etc.) one or more first farming related items involved in (e.g. tool requirement for repairs, etc.) the farming related creation of (e.g. cow butchering, etc.) one or more first biologically based substances (e.g. duck eggs, etc.) including at least in part one or more butchering related activities (e.g. packaging of butchered cows, etc.).

In one or more implementations, as shown in FIG. 62, operation o11 includes an operation o1159 for electronically storing farming related test information generated through testing of one or more test samples of one or more first farming related items involved in the farming related creation of one or more first biologically based substances including at least in part one or more vegetable gardening related activities. Origination of an illustratively derived storing test info gardening component group can be accomplished through skilled in the art design choice selection of one or more of the above depicted components from one or more of the above depicted subsystems shown in FIG. 12. Components from the storing test info gardening component group can be used in implementing execution of the one or more storing test info gardening instructions i1159 of FIG. 30, can be used in performance of the storing test info gardening electrical circuitry arrangement e1159 of FIG. 23, and/or can be used in otherwise fulfillment of the operation o1159. An exemplary non-transitory signal bearing medium version of the information storage subsystem s200 is depicted in FIG. 30 as bearing the one or more storing test info gardening instructions i1159 that when executed will direct performance of the operation o1159. Furthermore, the storing test info gardening electrical circuitry arrangement (“elec circ arrange”) e1159, when activated, will perform the operation o1159. Also, the storing test info gardening module m1159, when executed and/or activated, will direct performance of and/or perform the operation o1159. For instance, in one or more exemplary implementations, the one or more storing test info gardening instructions i1159, when executed, direct performance of the operation o1159 in the illustrative depiction as follows, and/or the storing test info gardening electrical circuitry arrangement e1159, when activated, performs the operation o1159 in the illustrative depiction as follows, and/or the storing test info gardening module m1159, when executed and/or activated, directs performance of and/or performs the operation o1159 in the illustrative depiction as follows, and/or the operation o1159 is otherwise carried out in the illustrative depiction as follows: electronically storing (e.g. stored from high frequency RFID scan, etc.) farming related test information (e.g. monitoring threshing speed of wheat, etc.) generated through testing of (e.g. via cryogenic based testing, etc.) one or more test samples of (e.g. one or more material samples, etc.) one or more first farming related items involved in (e.g. equipment maintenance schedule, etc.) the farming related creation of (e.g. cabbage harvesting, etc.) one or more first biologically based substances (e.g. chicken eggs, etc.) including at least in part one or more vegetable gardening related activities (e.g. weeding schedules compared with yields, etc.).

In one or more implementations, as shown in FIG. 62, operation o11 includes an operation o1160 for electronically storing farming related test information generated through testing of one or more test samples of one or more first farming related items involved in the farming related creation of one or more first biologically based substances including at least in part one or more microorganism culturing activities. Origination of an illustratively derived storing test info microorganism component group can be accomplished through skilled in the art design choice selection of one or more of the above depicted components from one or more of the above depicted subsystems shown in FIG. 12. Components from the storing test info microorganism component group can be used in implementing execution of the one or more storing test info microorganism instructions i1160 of FIG. 31, can be used in performance of the storing test info microorganism electrical circuitry arrangement e1160 of FIG. 24, and/or can be used in otherwise fulfillment of the operation o1160. An exemplary non-transitory signal bearing medium version of the information storage subsystem s200 is depicted in FIG. 31 as bearing the one or more storing test info microorganism instructions i1160 that when executed will direct performance of the operation o1160. Furthermore, the storing test info microorganism electrical circuitry arrangement (“elec circ arrange”) e1160, when activated, will perform the operation o1160. Also, the storing test info microorganism module m1160, when executed and/or activated, will direct performance of and/or perform the operation o1160. For instance, in one or more exemplary implementations, the one or more storing test info microorganism instructions i1160, when executed, direct performance of the operation o1160 in the illustrative depiction as follows, and/or the storing test info microorganism electrical circuitry arrangement e1160, when activated, performs the operation o1160 in the illustrative depiction as follows, and/or the storing test info microorganism module m1160, when executed and/or activated, directs performance of and/or performs the operation o1160 in the illustrative depiction as follows, and/or the operation o1160 is otherwise carried out in the illustrative depiction as follows: electronically storing (e.g. stored from laptop entry, etc.) farming related test information (e.g. testing for fungicide levels, etc.) generated through testing of (e.g. via calendar based testing, etc.) one or more test samples of (e.g. one or more residue samples, etc.) one or more first farming related items involved in (e.g. cost of tractor rental, etc.) the farming related creation of (e.g. cremini mushroom harvesting, etc.) one or more first biologically based substances (e.g. ground pork, etc.) including at least in part one or more microorganism culturing activities (e.g. mushroom densities per temperature profiles, etc.).

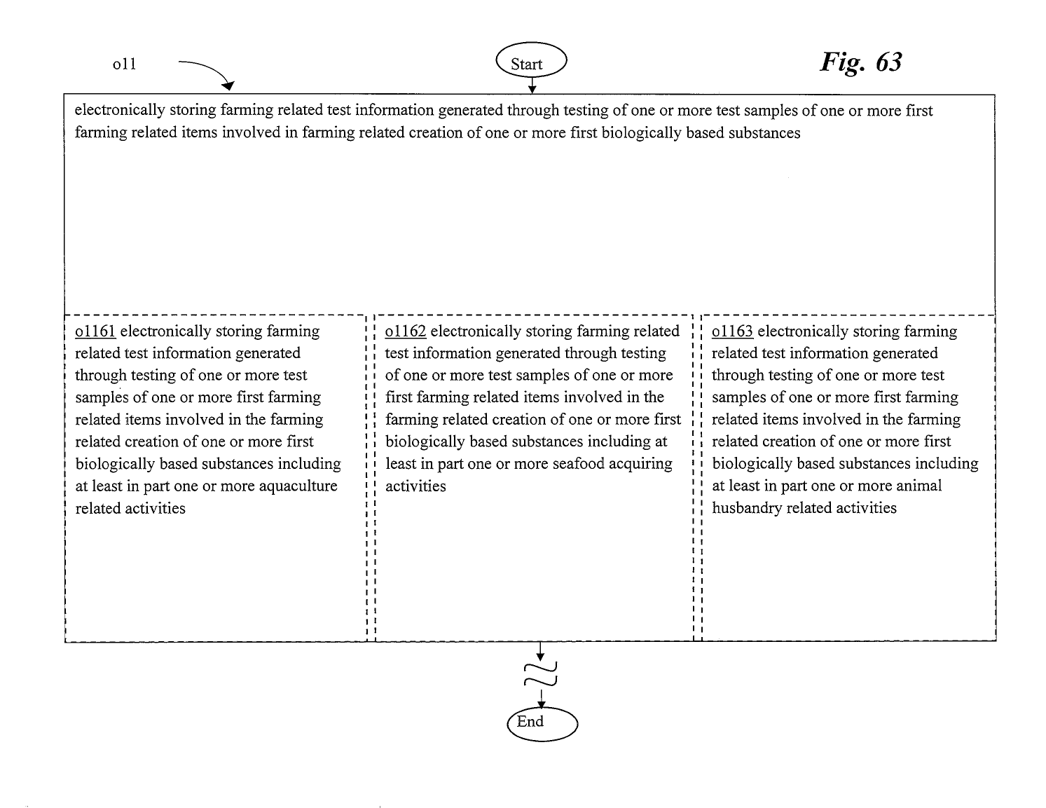

In one or more implementations, as shown in FIG. 63, operation o11 includes an operation o1161 for electronically storing farming related test information generated through testing of one or more test samples of one or more first farming related items involved in the farming related creation of one or more first biologically based substances including at least in part one or more aquaculture related activities. Origination of an illustratively derived storing test info aquaculture component group can be accomplished through skilled in the art design choice selection of one or more of the above depicted components from one or more of the above depicted subsystems shown in FIG. 12. Components from the storing test info aquaculture component group can be used in implementing execution of the one or more storing test info aquaculture instructions i1161 of FIG. 31, can be used in performance of the storing test info aquaculture electrical circuitry arrangement e1161 of FIG. 24, and/or can be used in otherwise fulfillment of the operation o1161. An exemplary non-transitory signal bearing medium version of the information storage subsystem s200 is depicted in FIG. 31 as bearing the one or more storing test info aquaculture instructions i1161 that when executed will direct performance of the operation o1161. Furthermore, the storing test info aquaculture electrical circuitry arrangement (“elec circ arrange”) e1161, when activated, will perform the operation o1161. Also, the storing test info aquaculture module m1161, when executed and/or activated, will direct performance of and/or perform the operation o1161. For instance, in one or more exemplary implementations, the one or more storing test info aquaculture instructions i1161, when executed, direct performance of the operation o1161 in the illustrative depiction as follows, and/or the storing test info aquaculture electrical circuitry arrangement e1161, when activated, performs the operation o1161 in the illustrative depiction as follows, and/or the storing test info aquaculture module m1161, when executed and/or activated, directs performance of and/or performs the operation o1161 in the illustrative depiction as follows, and/or the operation o1161 is otherwise carried out in the illustrative depiction as follows: electronically storing (e.g. stored from wifi transmission, etc.) farming related test information (e.g. testing oxygen levels in blood, etc.) generated through testing of (e.g. via random generation, etc.) one or more test samples of (e.g. one or more pesticide samples, etc.) one or more first farming related items involved in (e.g. livestock fertility, etc.) the farming related creation of (e.g. clam harvesting, etc.) one or more first biologically based substances (e.g. king crab, etc.) including at least in part one or more aquaculture related activities (e.g. presence of disease among fish, etc.).

In one or more implementations, as shown in FIG. 63, operation o11 includes an operation o1162 for electronically storing farming related test information generated through testing of one or more test samples of one or more first farming related items involved in the farming related creation of one or more first biologically based substances including at least in part one or more seafood acquiring activities. Origination of an illustratively derived storing test info seafood component group can be accomplished through skilled in the art design choice selection of one or more of the above depicted components from one or more of the above depicted subsystems shown in FIG. 12. Components from the storing test info seafood component group can be used in implementing execution of the one or more storing test info seafood instructions i1162 of FIG. 31, can be used in performance of the storing test info seafood electrical circuitry arrangement e1162 of FIG. 24, and/or can be used in otherwise fulfillment of the operation o1162. An exemplary non-transitory signal bearing medium version of the information storage subsystem s200 is depicted in FIG. 31 as bearing the one or more storing test info seafood instructions i1162 that when executed will direct performance of the operation o1162. Furthermore, the storing test info seafood electrical circuitry arrangement (“elec circ arrange”) e1162, when activated, will perform the operation o1162. Also, the storing test info seafood module m1162, when executed and/or activated, will direct performance of and/or perform the operation o1162. For instance, in one or more exemplary implementations, the one or more storing test info seafood instructions i1162, when executed, direct performance of the operation o1162 in the illustrative depiction as follows, and/or the storing test info seafood electrical circuitry arrangement e1162, when activated, performs the operation o1162 in the illustrative depiction as follows, and/or the storing test info seafood module m1162, when executed and/or activated, directs performance of and/or performs the operation o1162 in the illustrative depiction as follows, and/or the operation o1162 is otherwise carried out in the illustrative depiction as follows: electronically storing (e.g. stored from HTTP, etc.) farming related test information (e.g. testing for proper organ function in animal, etc.) generated through testing of (e.g. via survey based generation, etc.) one or more test samples of (e.g. one or more soil samples, etc.) one or more first farming related items involved in (e.g. livestock breeding schedule, etc.) the farming related creation of (e.g. tuna harvesting, etc.) one or more first biologically based substances (e.g. cellulous, etc.) including at least in part one or more seafood acquiring activities (e.g. pollution levels in fishing waters, etc.).

In one or more implementations, as shown in FIG. 63, operation o11 includes an operation o1163 for electronically storing farming related test information generated through testing of one or more test samples of one or more first farming related items involved in the farming related creation of one or more first biologically based substances including at least in part one or more animal husbandry related activities. Origination of an illustratively derived storing test info husbandry component group can be accomplished through skilled in the art design choice selection of one or more of the above depicted components from one or more of the above depicted subsystems shown in FIG. 12. Components from the storing test info husbandry component group can be used in implementing execution of the one or more storing test info husbandry instructions i1163 of FIG. 31, can be used in performance of the storing test info husbandry electrical circuitry arrangement e1163 of FIG. 24, and/or can be used in otherwise fulfillment of the operation o1163. An exemplary non-transitory signal bearing medium version of the information storage subsystem s200 is depicted in FIG. 31 as bearing the one or more storing test info husbandry instructions i1163 that when executed will direct performance of the operation o1163. Furthermore, the storing test info husbandry electrical circuitry arrangement (“elec circ arrange”) e1163, when activated, will perform the operation o1163. Also, the storing test info husbandry module m1163, when executed and/or activated, will direct performance of and/or perform the operation o1163. For instance, in one or more exemplary implementations, the one or more storing test info husbandry instructions i1163, when executed, direct performance of the operation o1163 in the illustrative depiction as follows, and/or the storing test info husbandry electrical circuitry arrangement e1163, when activated, performs the operation o1163 in the illustrative depiction as follows, and/or the storing test info husbandry module m1163, when executed and/or activated, directs performance of and/or performs the operation o1163 in the illustrative depiction as follows, and/or the operation o1163 is otherwise carried out in the illustrative depiction as follows: electronically storing (e.g. stored from FTP server, etc.) farming related test information (e.g. monitoring feed consumption of livestock, etc.) generated through testing of (e.g. via consumer based generation, etc.) one or more test samples of (e.g. one or more fertilizer samples, etc.) one or more first farming related items involved in (e.g. livestock slaughter schedule, etc.) the farming related creation of (e.g. lamb harvesting, etc.) one or more first biologically based substances (e.g. wood, etc.) including at least in part one or more animal husbandry related activities (e.g. cleaning the animal stalls, etc.).

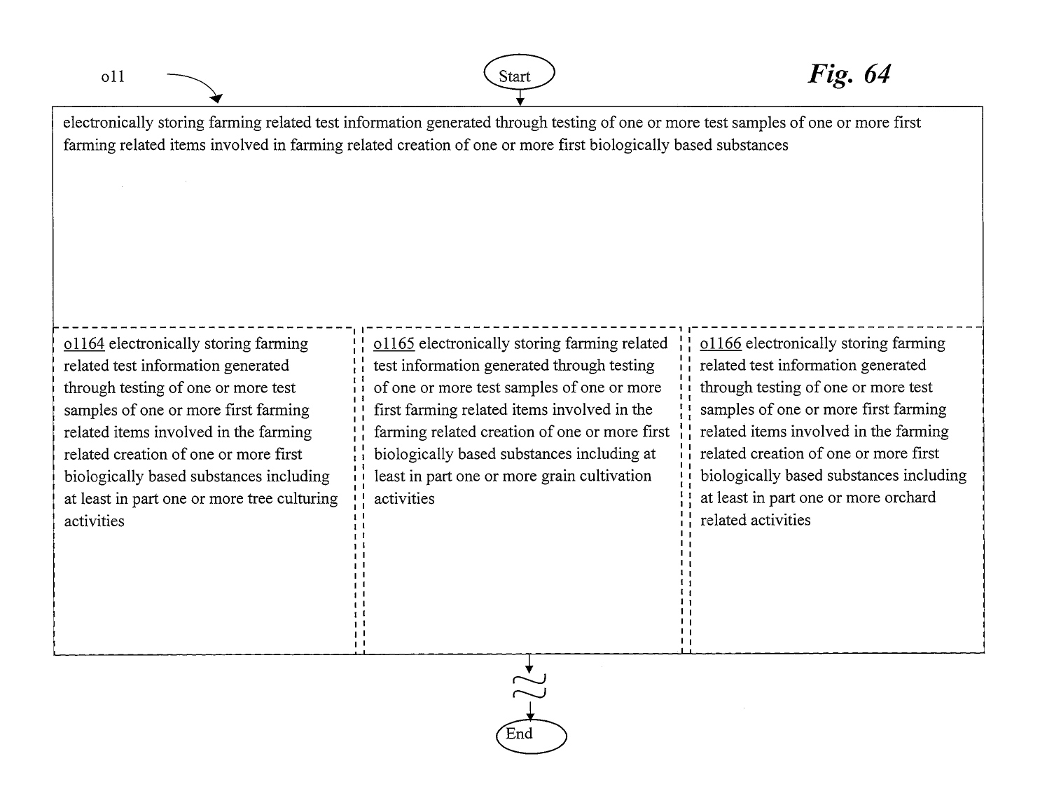

In one or more implementations, as shown in FIG. 64, operation o11 includes an operation o1164 for electronically storing farming related test information generated through testing of one or more test samples of one or more first farming related items involved in the farming related creation of one or more first biologically based substances including at least in part one or more tree culturing activities. Origination of an illustratively derived storing test info tree component group can be accomplished through skilled in the art design choice selection of one or more of the above depicted components from one or more of the above depicted subsystems shown in FIG. 12. Components from the storing test info tree component group can be used in implementing execution of the one or more storing test info tree instructions i1164 of FIG. 31, can be used in performance of the storing test info tree electrical circuitry arrangement e1164 of FIG. 24, and/or can be used in otherwise fulfillment of the operation o1164. An exemplary non-transitory signal bearing medium version of the information storage subsystem s200 is depicted in FIG. 31 as bearing the one or more storing test info tree instructions i1164 that when executed will direct performance of the operation o1164. Furthermore, the storing test info tree electrical circuitry arrangement (“elec circ arrange”) e1164, when activated, will perform the operation o1164. Also, the storing test info tree module m1164, when executed and/or activated, will direct performance of and/or perform the operation o1164. For instance, in one or more exemplary implementations, the one or more storing test info tree instructions i1164, when executed, direct performance of the operation o1164 in the illustrative depiction as follows, and/or the storing test info tree electrical circuitry arrangement e1164, when activated, performs the operation o1164 in the illustrative depiction as follows, and/or the storing test info tree module m1164, when executed and/or activated, directs performance of and/or performs the operation o1164 in the illustrative depiction as follows, and/or the operation o1164 is otherwise carried out in the illustrative depiction as follows: electronically storing (e.g. stored from USB port communication, etc.) farming related test information (e.g. monitoring improper hand sanitation of workers, etc.) generated through testing of (e.g. via supplier based generation, etc.) one or more test samples of (e.g. one or more autopsy samples, etc.) one or more first farming related items involved in (e.g. egg storage temperature, etc.) the farming related creation of (e.g. hazelnut harvesting, etc.) one or more first biologically based substances (e.g. manure, etc.) including at least in part one or more tree culturing activities (e.g. tree pruning, etc.).

In one or more implementations, as shown in FIG. 64, operation o11 includes an operation o1165 for electronically storing farming related test information generated through testing of one or more test samples of one or more first farming related items involved in the farming related creation of one or more first biologically based substances including at least in part one or more grain cultivation activities. Origination of an illustratively derived storing test info grain component group can be accomplished through skilled in the art design choice selection of one or more of the above depicted components from one or more of the above depicted subsystems shown in FIG. 12. Components from the storing test info grain component group can be used in implementing execution of the one or more storing test info grain instructions i1165 of FIG. 31, can be used in performance of the storing test info grain electrical circuitry arrangement e1165 of FIG. 24, and/or can be used in otherwise fulfillment of the operation o1165. An exemplary non-transitory signal bearing medium version of the information storage subsystem s200 is depicted in FIG. 31 as bearing the one or more storing test info grain instructions i1165 that when executed will direct performance of the operation o1165. Furthermore, the storing test info grain electrical circuitry arrangement (“elec circ arrange”) e1165, when activated, will perform the operation o1165. Also, the storing test info grain module m1165, when executed and/or activated, will direct performance of and/or perform the operation o1165. For instance, in one or more exemplary implementations, the one or more storing test info grain instructions i1165, when executed, direct performance of the operation o1165 in the illustrative depiction as follows, and/or the storing test info grain electrical circuitry arrangement e1165, when activated, performs the operation o1165 in the illustrative depiction as follows, and/or the storing test info grain module m1165, when executed and/or activated, directs performance of and/or performs the operation o1165 in the illustrative depiction as follows, and/or the operation o1165 is otherwise carried out in the illustrative depiction as follows: electronically storing (e.g. stored from 10-key entry, etc.) farming related test information (e.g. monitoring worker health trend, etc.) generated through testing of (e.g. through retail based testing, etc.) one or more test samples of (e.g. one or more birthing samples, etc.) one or more first farming related items involved in (e.g. animal byproduct inventory, etc.) the farming related creation of (e.g. wheat threshing, etc.) one or more first biologically based substances (e.g. ground chicken, etc.) including at least in part one or more grain cultivation activities (e.g. tilling grain fields, etc.).

In one or more implementations, as shown in FIG. 64, operation o11 includes an operation o1166 for electronically storing farming related test information generated through testing of one or more test samples of one or more first farming related items involved in the farming related creation of one or more first biologically based substances including at least in part one or more orchard related activities. Origination of an illustratively derived storing test info orchard component group can be accomplished through skilled in the art design choice selection of one or more of the above depicted components from one or more of the above depicted subsystems shown in FIG. 12. Components from the storing test info orchard component group can be used in implementing execution of the one or more storing test info orchard instructions i1166 of FIG. 31, can be used in performance of the storing test info orchard electrical circuitry arrangement e1166 of FIG. 24, and/or can be used in otherwise fulfillment of the operation o1166. An exemplary non-transitory signal bearing medium version of the information storage subsystem s200 is depicted in FIG. 31 as bearing the one or more storing test info orchard instructions i1166 that when executed will direct performance of the operation o1166. Furthermore, the storing test info orchard electrical circuitry arrangement (“elec circ arrange”) e1166, when activated, will perform the operation o1166. Also, the storing test info orchard module m1166, when executed and/or activated, will direct performance of and/or perform the operation o1166. For instance, in one or more exemplary implementations, the one or more storing test info orchard instructions i1166, when executed, direct performance of the operation o1166 in the illustrative depiction as follows, and/or the storing test info orchard electrical circuitry arrangement e1166, when activated, performs the operation o1166 in the illustrative depiction as follows, and/or the storing test info orchard module m1166, when executed and/or activated, directs performance of and/or performs the operation o1166 in the illustrative depiction as follows, and/or the operation o1166 is otherwise carried out in the illustrative depiction as follows: electronically storing (e.g. stored from peer to peer communication, etc.) farming related test information (e.g. testing for visual clues in livestock health status, etc.) generated through testing of (e.g. through wholesaler based testing, etc.) one or more test samples of (e.g. one or more water samples, etc.) one or more first farming related items involved in (e.g. crop disease status, etc.) the farming related creation of (e.g. pear harvesting, etc.) one or more first biologically based substances (e.g. feed grain, etc.) including at least in part one or more orchard related activities (e.g. rotating crop production in orchards, etc.).

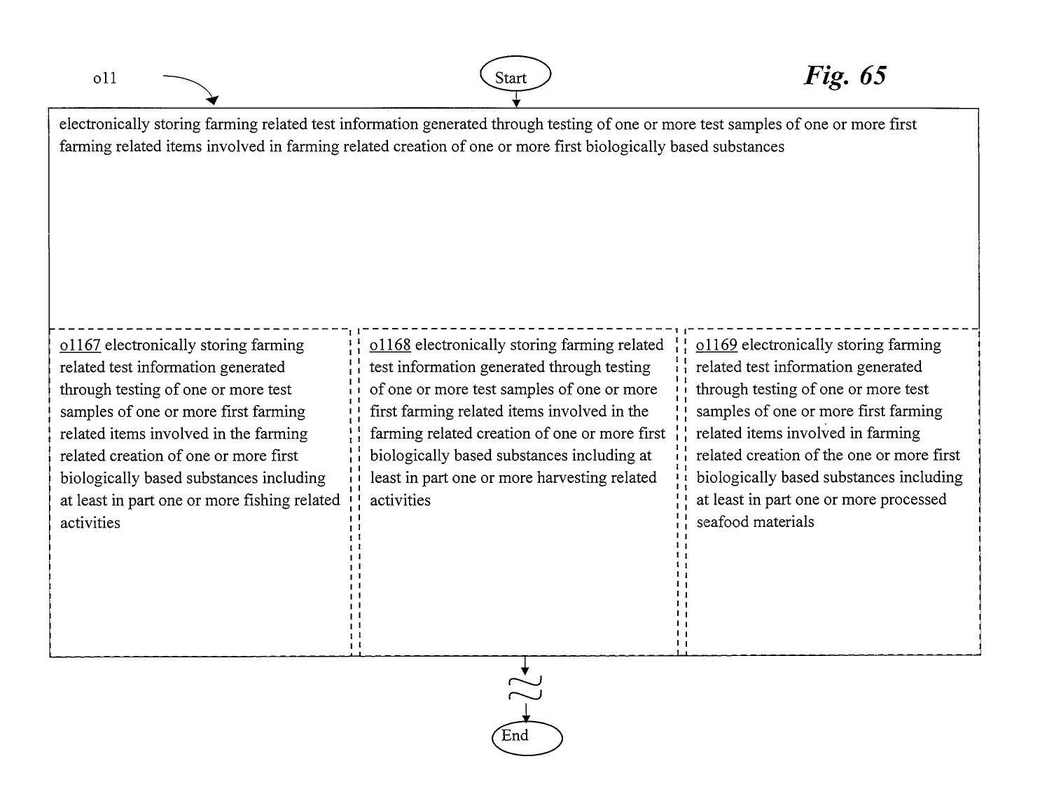

In one or more implementations, as shown in FIG. 65, operation o11 includes an operation o1167 for electronically storing farming related test information generated through testing of one or more test samples of one or more first farming related items involved in the farming related creation of one or more first biologically based substances including at least in part one or more fishing related activities. Origination of an illustratively derived storing test info fishing component group can be accomplished through skilled in the art design choice selection of one or more of the above depicted components from one or more of the above depicted subsystems shown in FIG. 12. Components from the storing test info fishing component group can be used in implementing execution of the one or more storing test info fishing instructions i1167 of FIG. 31, can be used in performance of the storing test info fishing electrical circuitry arrangement e1167 of FIG. 24, and/or can be used in otherwise fulfillment of the operation o1167. An exemplary non-transitory signal bearing medium version of the information storage subsystem s200 is depicted in FIG. 31 as bearing the one or more storing test info fishing instructions i1167 that when executed will direct performance of the operation o1167. Furthermore, the storing test info fishing electrical circuitry arrangement (“elec circ arrange”) e1167, when activated, will perform the operation o1167. Also, the storing test info fishing module m1167, when executed and/or activated, will direct performance of and/or perform the operation o1167. For instance, in one or more exemplary implementations, the one or more storing test info fishing instructions i1167, when executed, direct performance of the operation o1167 in the illustrative depiction as follows, and/or the storing test info fishing electrical circuitry arrangement e1167, when activated, performs the operation o1167 in the illustrative depiction as follows, and/or the storing test info fishing module m1167, when executed and/or activated, directs performance of and/or performs the operation o1167 in the illustrative depiction as follows, and/or the operation o1167 is otherwise carried out in the illustrative depiction as follows: electronically storing (e.g. stored from email, etc.) farming related test information (e.g. monitoring audible clues in livestock chatter, etc.) generated through testing of (e.g. via hydrologic testing, etc.) one or more test samples of (e.g. one or more rainfall samples, etc.) one or more first farming related items involved in (e.g. market demands, etc.) the farming related creation of (e.g. cod fishing, etc.) one or more first biologically based substances (e.g. beet pulp, etc.) including at least in part one or more fishing related activities (e.g. time at sea for a fishing trip, etc.).

In one or more implementations, as shown in FIG. 65, operation o11 includes an operation o1168 for electronically storing farming related test information generated through testing of one or more test samples of one or more first farming related items involved in the farming related creation of one or more first biologically based substances including at least in part one or more harvesting related activities. Origination of an illustratively derived storing test info harvesting component group can be accomplished through skilled in the art design choice selection of one or more of the above depicted components from one or more of the above depicted subsystems shown in FIG. 12. Components from the storing test info harvesting component group can be used in implementing execution of the one or more storing test info harvesting instructions i1168 of FIG. 31, can be used in performance of the storing test info harvesting electrical circuitry arrangement e1168 of FIG. 24, and/or can be used in otherwise fulfillment of the operation o1168. An exemplary non-transitory signal bearing medium version of the information storage subsystem s200 is depicted in FIG. 31 as bearing the one or more storing test info harvesting instructions i1168 that when executed will direct performance of the operation o1168. Furthermore, the storing test info harvesting electrical circuitry arrangement (“elec circ arrange”) e1168, when activated, will perform the operation o1168. Also, the storing test info harvesting module m1168, when executed and/or activated, will direct performance of and/or perform the operation o1168. For instance, in one or more exemplary implementations, the one or more storing test info harvesting instructions i1168, when executed, direct performance of the operation o1168 in the illustrative depiction as follows, and/or the storing test info harvesting electrical circuitry arrangement e1168, when activated, performs the operation o1168 in the illustrative depiction as follows, and/or the storing test info harvesting module m1168, when executed and/or activated, directs performance of and/or performs the operation o1168 in the illustrative depiction as follows, and/or the operation o1168 is otherwise carried out in the illustrative depiction as follows: electronically storing (e.g. stored from SIM card data, etc.) farming related test information (e.g. monitoring livestock feed behavior, etc.) generated through testing of (e.g. through restaurant based generation, etc.) one or more test samples of (e.g. one or more solar based samples, etc.) one or more first farming related items involved in (e.g. known pandemic status, etc.) the farming related creation of (e.g. barley harvesting, etc.) one or more first biologically based substances (e.g. venison, etc.) including at least in part one or more harvesting related activities (e.g. picking tomatoes, etc.).

In one or more implementations, as shown in FIG. 65, operation o11 includes an operation o1169 for electronically storing farming related test information generated through testing of one or more test samples of one or more first farming related items involved in farming related creation of the one or more first biologically based substances including at least in part one or more processed seafood materials. Origination of an illustratively derived storing test info seafood component group can be accomplished through skilled in the art design choice selection of one or more of the above depicted components from one or more of the above depicted subsystems shown in FIG. 12. Components from the storing test info seafood component group can be used in implementing execution of the one or more storing test info seafood instructions i1169 of FIG. 31, can be used in performance of the storing test info seafood electrical circuitry arrangement e1169 of FIG. 24, and/or can be used in otherwise fulfillment of the operation o1169. An exemplary non-transitory signal bearing medium version of the information storage subsystem s200 is depicted in FIG. 31 as bearing the one or more storing test info seafood instructions i1169 that when executed will direct performance of the operation o1169. Furthermore, the storing test info seafood electrical circuitry arrangement (“elec circ arrange”) e1169, when activated, will perform the operation o1169. Also, the storing test info seafood module m1169, when executed and/or activated, will direct performance of and/or perform the operation o1169. For instance, in one or more exemplary implementations, the one or more storing test info seafood instructions i1169, when executed, direct performance of the operation o1169 in the illustrative depiction as follows, and/or the storing test info seafood electrical circuitry arrangement e1169, when activated, performs the operation o1169 in the illustrative depiction as follows, and/or the storing test info seafood module m1169, when executed and/or activated, directs performance of and/or performs the operation o1169 in the illustrative depiction as follows, and/or the operation o1169 is otherwise carried out in the illustrative depiction as follows: electronically storing (e.g. stored from SD card access, etc.) farming related test information (e.g. testing phosphate levels, etc.) generated through testing of (e.g. through grocery store based generation, etc.) one or more test samples of (e.g. one or more laboratory samples, etc.) one or more first farming related items involved in (e.g. shipping schedule, etc.) farming related creation of (e.g. oyster harvesting, etc.) the one or more first biologically based substances (e.g. cod liver oil, etc.) including at least in part one or more processed seafood materials (e.g. crab legs, etc.).

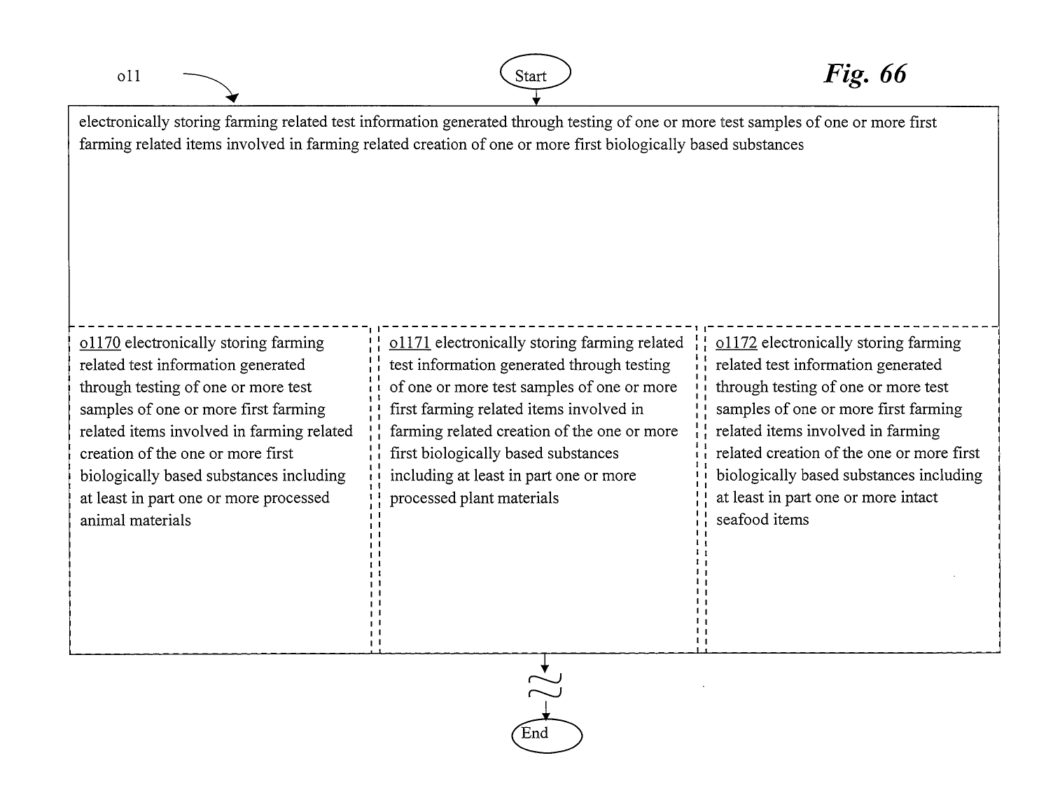

In one or more implementations, as shown in FIG. 66, operation o11 includes an operation o1170 for electronically storing farming related test information generated through testing of one or more test samples of one or more first farming related items involved in farming related creation of the one or more first biologically based substances including at least in part one or more processed animal materials. Origination of an illustratively derived storing test info animal component group can be accomplished through skilled in the art design choice selection of one or more of the above depicted components from one or more of the above depicted subsystems shown in FIG. 12. Components from the storing test info animal component group can be used in implementing execution of the one or more storing test info animal instructions i1170 of FIG. 31, can be used in performance of the storing test info animal electrical circuitry arrangement e1170 of FIG. 24, and/or can be used in otherwise fulfillment of the operation o1170. An exemplary non-transitory signal bearing medium version of the information storage subsystem s200 is depicted in FIG. 31 as bearing the one or more storing test info animal instructions i1170 that when executed will direct performance of the operation o1170. Furthermore, the storing test info animal electrical circuitry arrangement (“elec circ arrange”) e1170, when activated, will perform the operation o1170. Also, the storing test info animal module m1170, when executed and/or activated, will direct performance of and/or perform the operation o1170. For instance, in one or more exemplary implementations, the one or more storing test info animal instructions i1170, when executed, direct performance of the operation o1170 in the illustrative depiction as follows, and/or the storing test info animal electrical circuitry arrangement e1170, when activated, performs the operation o1170 in the illustrative depiction as follows, and/or the storing test info animal module m1170, when executed and/or activated, directs performance of and/or performs the operation o1170 in the illustrative depiction as follows, and/or the operation o1170 is otherwise carried out in the illustrative depiction as follows: electronically storing (e.g. stored from software based encryption, etc.) farming related test information (e.g. testing irrigation water for pathogens, etc.) generated through testing of (e.g. through home based generation, etc.) one or more test samples of (e.g. one or more sample kit samples, etc.) one or more first farming related items involved in (e.g. cost of shipping, etc.) farming related creation of (e.g. tuna canning, etc.) the one or more first biologically based substances (e.g. ground beef, etc.) including at least in part one or more processed animal materials (e.g. hamburger, etc.).

In one or more implementations, as shown in FIG. 66, operation o11 includes an operation o1171 for electronically storing farming related test information generated through testing of one or more test samples of one or more first farming related items involved in farming related creation of the one or more first biologically based substances including at least in part one or more processed plant materials. Origination of an illustratively derived storing test info plant component group can be accomplished through skilled in the art design choice selection of one or more of the above depicted components from one or more of the above depicted subsystems shown in FIG. 12. Components from the storing test info plant component group can be used in implementing execution of the one or more storing test info plant instructions i1171 of FIG. 31, can be used in performance of the storing test info plant electrical circuitry arrangement e1171 of FIG. 24, and/or can be used in otherwise fulfillment of the operation o1171. An exemplary non-transitory signal bearing medium version of the information storage subsystem s200 is depicted in FIG. 31 as bearing the one or more storing test info plant instructions i1171 that when executed will direct performance of the operation o1171. Furthermore, the storing test info plant electrical circuitry arrangement (“elec circ arrange”) e1171, when activated, will perform the operation o1171. Also, the storing test info plant module m1171, when executed and/or activated, will direct performance of and/or perform the operation o1171. For instance, in one or more exemplary implementations, the one or more storing test info plant instructions i1171, when executed, direct performance of the operation o1171 in the illustrative depiction as follows, and/or the storing test info plant electrical circuitry arrangement e1171, when activated, performs the operation o1171 in the illustrative depiction as follows, and/or the storing test info plant module m1171, when executed and/or activated, directs performance of and/or performs the operation o1171 in the illustrative depiction as follows, and/or the operation o1171 is otherwise carried out in the illustrative depiction as follows: electronically storing (e.g. stored from website data, etc.) farming related test information (e.g. monitoring quarantined livestock, etc.) generated through testing of (e.g. via exception based generation, etc.) one or more test samples of (e.g. one or more orchard samples, etc.) one or more first farming related items involved in (e.g. banned pesticides, etc.) farming related creation of (e.g. cow butchering, etc.) the one or more first biologically based substances (e.g. rice flour, etc.) including at least in part one or more processed plant materials (e.g. sauerkraut, etc.).

In one or more implementations, as shown in FIG. 66, operation o11 includes an operation o1172 for electronically storing farming related test information generated through testing of one or more test samples of one or more first farming related items involved in farming related creation of the one or more first biologically based substances including at least in part one or more intact seafood items. Origination of an illustratively derived storing test info seafood component group can be accomplished through skilled in the art design choice selection of one or more of the above depicted components from one or more of the above depicted subsystems shown in FIG. 12. Components from the storing test info seafood component group can be used in implementing execution of the one or more storing test info seafood instructions i1172 of FIG. 31, can be used in performance of the storing test info seafood electrical circuitry arrangement e1172 of FIG. 24, and/or can be used in otherwise fulfillment of the operation o1172. An exemplary non-transitory signal bearing medium version of the information storage subsystem s200 is depicted in FIG. 31 as bearing the one or more storing test info seafood instructions i1172 that when executed will direct performance of the operation o1172. Furthermore, the storing test info seafood electrical circuitry arrangement (“elec circ arrange”) e1172, when activated, will perform the operation o1172. Also, the storing test info seafood module m1172, when executed and/or activated, will direct performance of and/or perform the operation o1172. For instance, in one or more exemplary implementations, the one or more storing test info seafood instructions i1172, when executed, direct performance of the operation o1172 in the illustrative depiction as follows, and/or the storing test info seafood electrical circuitry arrangement e1172, when activated, performs the operation o1172 in the illustrative depiction as follows, and/or the storing test info seafood module m1172, when executed and/or activated, directs performance of and/or performs the operation o1172 in the illustrative depiction as follows, and/or the operation o1172 is otherwise carried out in the illustrative depiction as follows: electronically storing (e.g. stored from webpage data, etc.) farming related test information (e.g. testing fruit tree fertility, etc.) generated through testing of (e.g. through electromagnetic based generation, etc.) one or more test samples of (e.g. one or more worker samples, etc.) one or more first farming related items involved in (e.g. amount of historical rainfall, etc.) farming related creation of (e.g. almond harvesting, etc.) the one or more first biologically based substances (e.g. whole crab, etc.) including at least in part one or more intact seafood items (e.g. whole salmon, etc.).

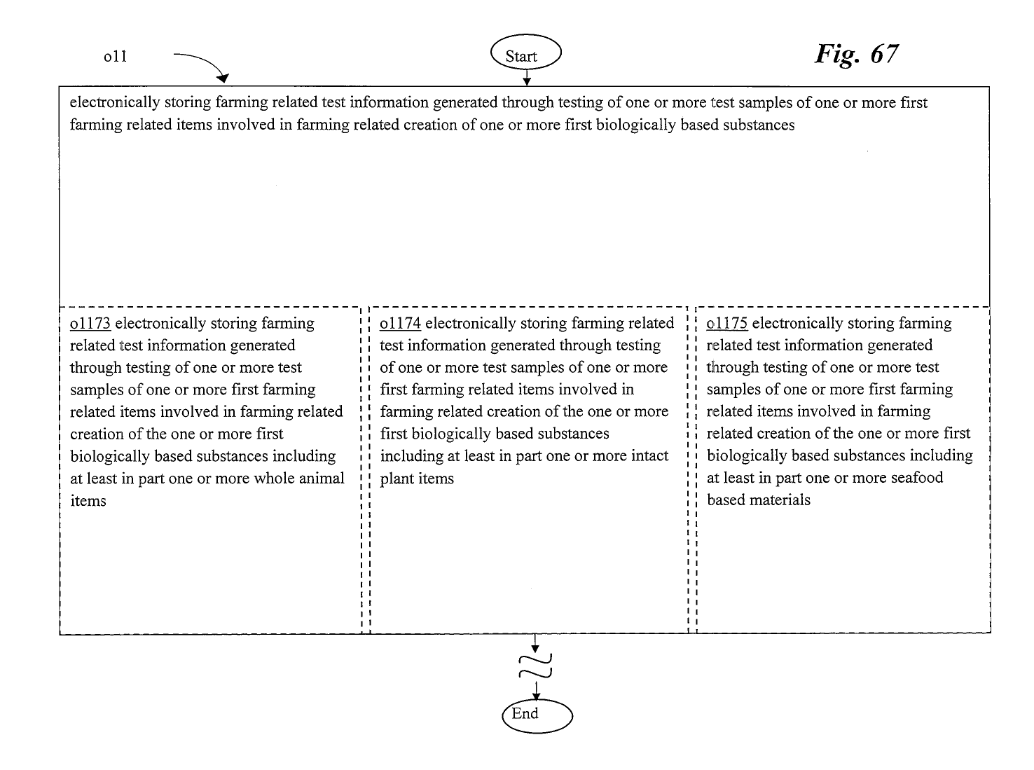

In one or more implementations, as shown in FIG. 67, operation o11 includes an operation o1173 for electronically storing farming related test information generated through testing of one or more test samples of one or more first farming related items involved in farming related creation of the one or more first biologically based substances including at least in part one or more whole animal items. Origination of an illustratively derived storing test info animal component group can be accomplished through skilled in the art design choice selection of one or more of the above depicted components from one or more of the above depicted subsystems shown in FIG. 12. Components from the storing test info animal component group can be used in implementing execution of the one or more storing test info animal instructions i1173 of FIG. 31, can be used in performance of the storing test info animal electrical circuitry arrangement e1173 of FIG. 24, and/or can be used in otherwise fulfillment of the operation o1173. An exemplary non-transitory signal bearing medium version of the information storage subsystem s200 is depicted in FIG. 31 as bearing the one or more storing test info animal instructions i1173 that when executed will direct performance of the operation o1173. Furthermore, the storing test info animal electrical circuitry arrangement (“elec circ arrange”) e1173, when activated, will perform the operation o1173. Also, the storing test info animal module m1173, when executed and/or activated, will direct performance of and/or perform the operation o1173. For instance, in one or more exemplary implementations, the one or more storing test info animal instructions i1173, when executed, direct performance of the operation o1173 in the illustrative depiction as follows, and/or the storing test info animal electrical circuitry arrangement e1173, when activated, performs the operation o1173 in the illustrative depiction as follows, and/or the storing test info animal module m1173, when executed and/or activated, directs performance of and/or performs the operation o1173 in the illustrative depiction as follows, and/or the operation o1173 is otherwise carried out in the illustrative depiction as follows: electronically storing (e.g. stored from compact flash card access, etc.) farming related test information (e.g. testing of new forage legume cultivars, etc.) generated through testing of (e.g. via sample set testing, etc.) one or more test samples of (e.g. one or more hygiene samples, etc.) one or more first farming related items involved in (e.g. amount of predicted rainfall, etc.) farming related creation of (e.g. rice threshing, etc.) the one or more first biologically based substances (e.g. whole turkey, etc.) including at least in part one or more whole animal items (e.g. whole pig, etc.).

In one or more implementations, as shown in FIG. 67, operation o11 includes an operation o1174 for electronically storing farming related test information generated through testing of one or more test samples of one or more first farming related items involved in farming related creation of the one or more first biologically based substances including at least in part one or more intact plant items. Origination of an illustratively derived storing test info plant component group can be accomplished through skilled in the art design choice selection of one or more of the above depicted components from one or more of the above depicted subsystems shown in FIG. 12. Components from the storing test info plant component group can be used in implementing execution of the one or more storing test info plant instructions i1174 of FIG. 31, can be used in performance of the storing test info plant electrical circuitry arrangement e1174 of FIG. 24, and/or can be used in otherwise fulfillment of the operation o1174. An exemplary non-transitory signal bearing medium version of the information storage subsystem s200 is depicted in FIG. 31 as bearing the one or more storing test info plant instructions i1174 that when executed will direct performance of the operation o1174. Furthermore, the storing test info plant electrical circuitry arrangement (“elec circ arrange”) e1174, when activated, will perform the operation o1174. Also, the storing test info plant module m1174, when executed and/or activated, will direct performance of and/or perform the operation o1174. For instance, in one or more exemplary implementations, the one or more storing test info plant instructions i1174, when executed, direct performance of the operation o1174 in the illustrative depiction as follows, and/or the storing test info plant electrical circuitry arrangement e1174, when activated, performs the operation o1174 in the illustrative depiction as follows, and/or the storing test info plant module m1174, when executed and/or activated, directs performance of and/or performs the operation o1174 in the illustrative depiction as follows, and/or the operation o1174 is otherwise carried out in the illustrative depiction as follows: electronically storing (e.g. stored from micro SD card access, etc.) farming related test information (e.g. testing of small-grain cultivars, etc.) generated through testing of (e.g. through distributor based generation, etc.) one or more test samples of (e.g. one or more refuse samples, etc.) one or more first farming related items involved in (e.g. size of labor force, etc.) farming related creation of (e.g. squash cultivation, etc.) the one or more first biologically based substances (e.g. whole carrot, etc.) including at least in part one or more intact plant items (e.g. apples, etc.).

In one or more implementations, as shown in FIG. 67, operation o11 includes an operation o1175 for electronically storing farming related test information generated through testing of one or more test samples of one or more first farming related items involved in farming related creation of the one or more first biologically based substances including at least in part one or more seafood based materials. Origination of an illustratively derived storing test info seafood component group can be accomplished through skilled in the art design choice selection of one or more of the above depicted components from one or more of the above depicted subsystems shown in FIG. 12. Components from the storing test info seafood component group can be used in implementing execution of the one or more storing test info seafood instructions i1175 of FIG. 31, can be used in performance of the storing test info seafood electrical circuitry arrangement e1175 of FIG. 24, and/or can be used in otherwise fulfillment of the operation o1175. An exemplary non-transitory signal bearing medium version of the information storage subsystem s200 is depicted in FIG. 31 as bearing the one or more storing test info seafood instructions i1175 that when executed will direct performance of the operation o1175. Furthermore, the storing test info seafood electrical circuitry arrangement (“elec circ arrange”) e1175, when activated, will perform the operation

o1175. Also, the storing test info seafood module m1175, when executed and/or activated, will direct performance of and/or perform the operation o1175. For instance, in one or more exemplary implementations, the one or more storing test info seafood instructions i1175, when executed, direct performance of the operation o1175 in the illustrative depiction as follows, and/or the storing test info seafood electrical circuitry arrangement e1175, when activated, performs the operation o1175 in the illustrative depiction as follows, and/or the storing test info seafood module m1175, when executed and/or activated, directs performance of and/or performs the operation o1175 in the illustrative depiction as follows, and/or the operation o1175 is otherwise carried out in the illustrative depiction as follows: electronically storing (e.g. stored from floppy disc storage access, etc.) farming related test information (e.g. monitoring of genetic transformation, etc.) generated through testing of (e.g. via invoice based generation, etc.) one or more test samples of (e.g. one or more safety guideline samples, etc.) one or more first farming related items involved in (e.g. cost of labor, etc.) farming related creation of (e.g. flax growing, etc.) the one or more first biologically based substances (e.g. salmon, etc.) including at least in part one or more seafood based materials (e.g. alginate from seaweed, etc.).

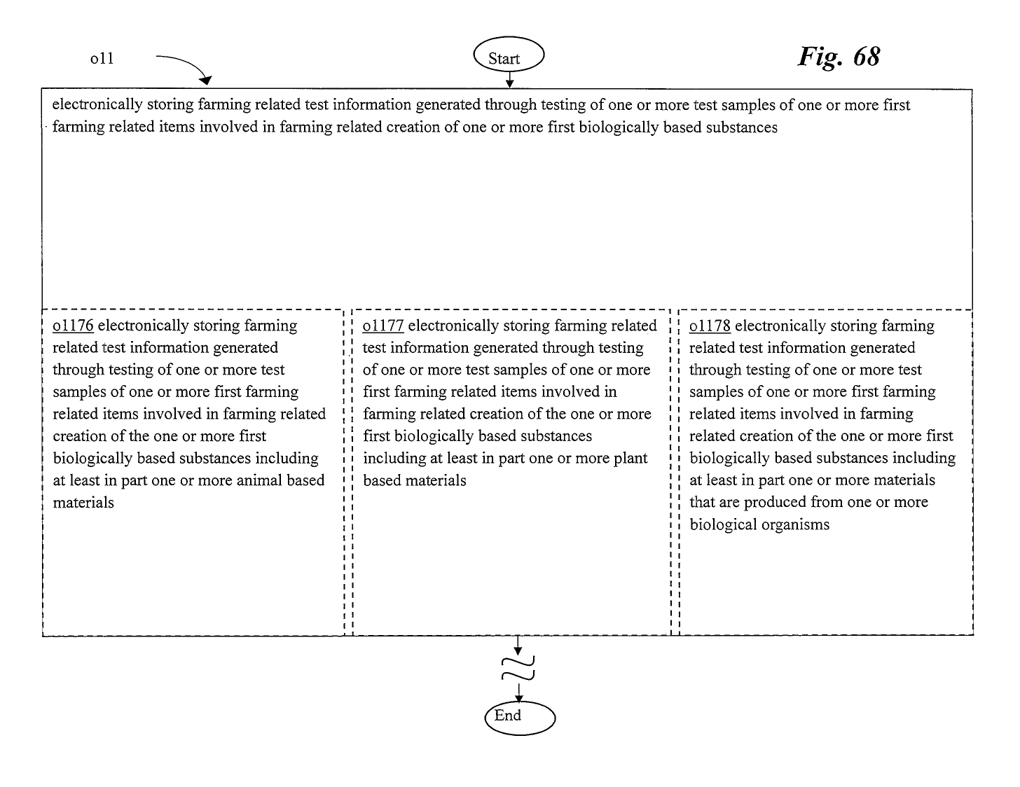

In one or more implementations, as shown in FIG. 68, operation o11 includes an operation o1176 for electronically storing farming related test information generated through testing of one or more test samples of one or more first farming related items involved in farming related creation of the one or more first biologically based substances including at least in part one or more animal based materials. Origination of an illustratively derived storing test info animal component group can be accomplished through skilled in the art design choice selection of one or more of the above depicted components from one or more of the above depicted subsystems shown in FIG. 12. Components from the storing test info animal component group can be used in implementing execution of the one or more storing test info animal instructions i1176 of FIG. 31, can be used in performance of the storing test info animal electrical circuitry arrangement e1176 of FIG. 24, and/or can be used in otherwise fulfillment of the operation o1176. An exemplary non-transitory signal bearing medium version of the information storage subsystem s200 is depicted in FIG. 31 as bearing the one or more storing test info animal instructions i1176 that when executed will direct performance of the operation o1176. Furthermore, the storing test info animal electrical circuitry arrangement (“elec circ arrange”) e1176, when activated, will perform the operation o1176. Also, the storing test info animal module m1176, when executed and/or activated, will direct performance of and/or perform the operation o1176. For instance, in one or more exemplary implementations, the one or more storing test info animal instructions i1176, when executed, direct performance of the operation o1176 in the illustrative depiction as follows, and/or the storing test info animal electrical circuitry arrangement e1176, when activated, performs the operation o1176 in the illustrative depiction as follows, and/or the storing test info animal module m1176, when executed and/or activated, directs performance of and/or performs the operation o1176 in the illustrative depiction as follows, and/or the operation o1176 is otherwise carried out in the illustrative depiction as follows: electronically storing (e.g. stored from SMTP server, etc.) farming related test information (e.g. testing of methane presence, etc.) generated through testing of (e.g. through order based generation, etc.) one or more test samples of (e.g. one or more pollution samples, etc.) one or more first farming related items involved in (e.g. types of fertilizers on order, etc.) farming related creation of (e.g. lentil harvesting, etc.) the one or more first biologically based substances (e.g. pork meat, etc.) including at least in part one or more animal based materials (e.g. gelatin from livestock, etc.).

In one or more implementations, as shown in FIG. 68, operation o11 includes an operation o1177 for electronically storing farming related test information generated through testing of one or more test samples of one or more first farming related items involved in farming related creation of the one or more first biologically based substances including at least in part one or more plant based materials. Origination of an illustratively derived storing test info plant component group can be accomplished through skilled in the art design choice selection of one or more of the above depicted components from one or more of the above depicted subsystems shown in FIG. 12. Components from the storing test info plant component group can be used in implementing execution of the one or more storing test info plant instructions i1177 of FIG. 31, can be used in performance of the storing test info plant electrical circuitry arrangement e1177 of FIG. 24, and/or can be used in otherwise fulfillment of the operation o1177. An exemplary non-transitory signal bearing medium version of the information storage subsystem s200 is depicted in FIG. 31 as bearing the one or more storing test info plant instructions i1177 that when executed will direct performance of the operation o1177. Furthermore, the storing test info plant electrical circuitry arrangement (“elec circ arrange”) e1177, when activated, will perform the operation o1177. Also, the storing test info plant module m1177, when executed and/or activated, will direct performance of and/or perform the operation o1177. For instance, in one or more exemplary implementations, the one or more storing test info plant instructions i1177, when executed, direct performance of the operation o1177 in the illustrative depiction as follows, and/or the storing test info plant electrical circuitry arrangement e1177, when activated, performs the operation o1177 in the illustrative depiction as follows, and/or the storing test info plant module m1177, when executed and/or activated, directs performance of and/or performs the operation o1177 in the illustrative depiction as follows, and/or the operation o1177 is otherwise carried out in the illustrative depiction as follows: electronically storing (e.g. stored from MMS communication, etc.) farming related test information (e.g. monitoring of long term effects of calcium on alfalfa, etc.) generated through testing of (e.g. through supply based generation, etc.) one or more test samples of (e.g. one or more forbidden list samples, etc.) one or more first farming related items involved in (e.g. fuel delivery schedule, etc.) farming related creation of (e.g. broccoli harvesting, etc.) the one or more first biologically based substances (e.g. potato, etc.) including at least in part one or more plant based materials (e.g. dried green juice powder from barley grass, etc.).

In one or more implementations, as shown in FIG. 68, operation o11 includes an operation o1178 for electronically storing farming related test information generated through testing of one or more test samples of one or more first farming related items involved in farming related creation of the one or more first biologically based substances including at least in part one or more materials that are produced from one or more biological organisms. Origination of an illustratively derived storing test info produced component group can be accomplished through skilled in the art design choice selection of one or more of the above depicted components from one or more of the above depicted subsystems shown in FIG. 12. Components from the storing test info produced component group can be used in implementing execution of the one or more storing test info produced instructions i1178 of FIG. 31, can be used in performance of the storing test info produced electrical circuitry arrangement e1178 of FIG. 24, and/or can be used in otherwise fulfillment of the operation o1178. An exemplary non-transitory signal bearing medium version of the information storage subsystem s200 is depicted in FIG. 31 as bearing the one or more storing test info produced instructions i1178 that when executed will direct performance of the operation o1178. Furthermore, the storing test info produced electrical circuitry arrangement (“elec circ arrange”) e1178, when activated, will perform the operation o1178. Also, the storing test info produced module m1178, when executed and/or activated, will direct performance of and/or perform the operation o1178. For instance, in one or more exemplary implementations, the one or more storing test info produced instructions i1178, when executed, direct performance of the operation o1178 in the illustrative depiction as follows, and/or the storing test info produced electrical circuitry arrangement e1178, when activated, performs the operation o1178 in the illustrative depiction as follows, and/or the storing test info produced module m1178, when executed and/or activated, directs performance of and/or performs the operation o1178 in the illustrative depiction as follows, and/or the operation o1178 is otherwise carried out in the illustrative depiction as follows: electronically storing (e.g. stored from tablet entry, etc.) farming related test information (e.g. testing of polyphenol levels in grape seed, etc.) generated through testing of (e.g. through algorithmic based generation, etc.) one or more test samples of (e.g. one or more permitted list samples, etc.) one or more first farming related items involved in (e.g. cost of fuel, etc.) farming related creation of (e.g. carrot harvesting, etc.) the one or more first biologically based substances (e.g. bone, etc.) including at least in part one or more materials that are produced from one or more biological organisms (e.g. milk from goats, etc.).

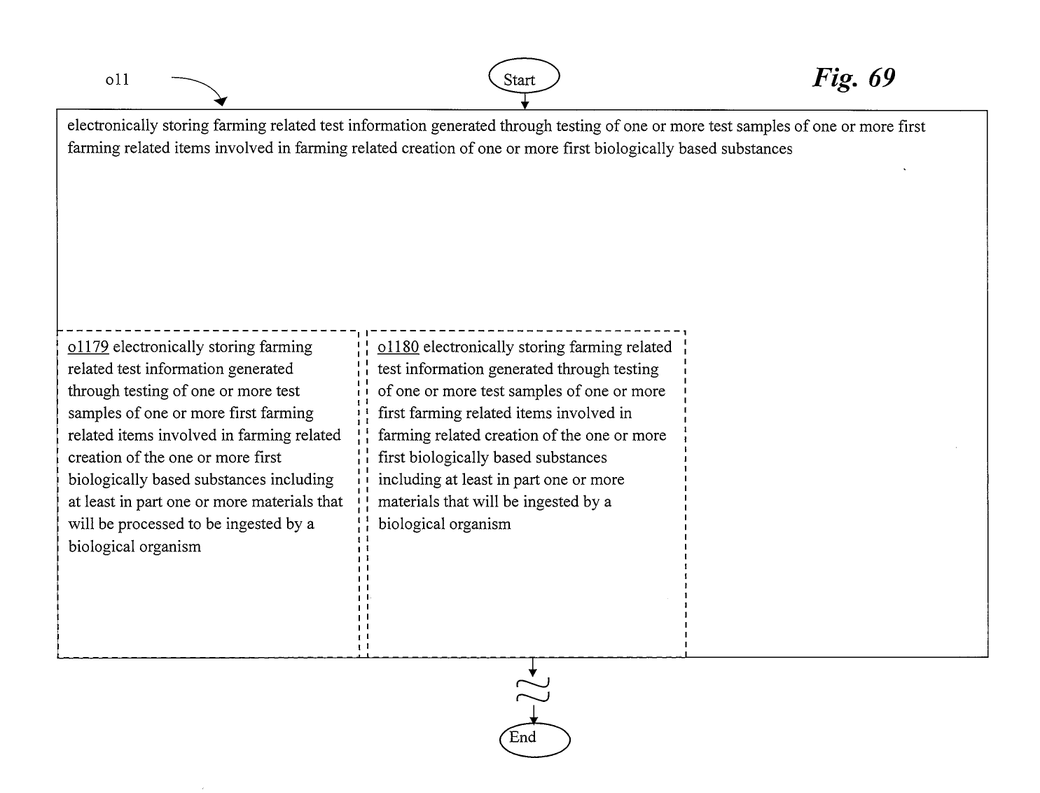

In one or more implementations, as shown in FIG. 69, operation o11 includes an operation o1179 for electronically storing farming related test information generated through testing of one or more test samples of one or more first farming related items involved in farming related creation of the one or more first biologically based substances including at least in part one or more materials that will be processed to be ingested by a biological organism. Origination of an illustratively derived storing test info processed component group can be accomplished through skilled in the art design choice selection of one or more of the above depicted components from one or more of the above depicted subsystems shown in FIG. 12. Components from the storing test info processed component group can be used in implementing execution of the one or more storing test info processed instructions i1179 of FIG. 31, can be used in performance of the storing test info processed electrical circuitry arrangement e1179 of FIG. 24, and/or can be used in otherwise fulfillment of the operation o1179. An exemplary non-transitory signal bearing medium version of the information storage subsystem s200 is depicted in FIG. 31 as bearing the one or more storing test info processed instructions i1179 that when executed will direct performance of the operation o1179. Furthermore, the storing test info processed electrical circuitry arrangement (“elec circ arrange”) e1179, when activated, will perform the operation o1179. Also, the storing test info processed module m1179, when executed and/or activated, will direct performance of and/or perform the operation o1179. For instance, in one or more exemplary implementations, the one or more storing test info processed instructions i1179, when executed, direct performance of the operation o1179 in the illustrative depiction as follows, and/or the storing test info processed electrical circuitry arrangement e1179, when activated, performs the operation o1179 in the illustrative depiction as follows, and/or the storing test info processed module m1179, when executed and/or activated, directs performance of and/or performs the operation o1179 in the illustrative depiction as follows, and/or the operation o1179 is otherwise carried out in the illustrative depiction as follows: electronically storing (e.g. stored from acoustic energy reception, etc.) farming related test information (e.g. monitoring of glycosylation of plant matter, etc.) generated through testing of (e.g. via laser testing, etc.) one or more test samples of (e.g. one or more exhaust samples, etc.) one or more first farming related items involved in (e.g. certification deadlines, etc.) farming related creation of (e.g. oat harvesting, etc.) the one or more first biologically based substances (e.g. wheat, etc.) including at least in part one or more materials that will be processed to be ingested by a biological organism (e.g. gluten free cereal for dogs, etc.).

In one or more implementations, as shown in FIG. 69, operation o11 includes an operation o1180 for electronically storing farming related test information generated through testing of one or more test samples of one or more first farming related items involved in farming related creation of the one or more first biologically based substances including at least in part one or more materials that will be ingested by a biological organism. Origination of an illustratively derived storing test info materials component group can be accomplished through skilled in the art design choice selection of one or more of the above depicted components from one or more of the above depicted subsystems shown in FIG. 12. Components from the storing test info materials component group can be used in implementing execution of the one or more storing test info materials instructions i1180 of FIG. 32, can be used in performance of the storing test info materials electrical circuitry arrangement e1180 of FIG. 25, and/or can be used in otherwise fulfillment of the operation o1180. An exemplary non-transitory signal bearing medium version of the information storage subsystem s200 is depicted in FIG. 32 as bearing the one or more storing test info materials instructions i1180 that when executed will direct performance of the operation o1180. Furthermore, the storing test info materials electrical circuitry arrangement (“elec circ arrange”) e1180, when activated, will perform the operation o1180. Also, the storing test info materials module m1180, when executed and/or activated, will direct performance of and/or perform the operation o1180. For instance, in one or more exemplary implementations, the one or more storing test info materials instructions i1180, when executed, direct performance of the operation o1180 in the illustrative depiction as follows, and/or the storing test info materials electrical circuitry arrangement e1180, when activated, performs the operation o1180 in the illustrative depiction as follows, and/or the storing test info materials module m1180, when executed and/or activated, directs performance of and/or performs the operation o1180 in the illustrative depiction as follows, and/or the operation o1180 is otherwise carried out in the illustrative depiction as follows: electronically storing (e.g. stored from PDA entry, etc.) farming related test information (e.g. monitoring effects of rhizobia inoculation, etc.) generated through testing of (e.g. through scaled based testing, etc.) one or more test samples of (e.g. one or more operational samples, etc.) one or more first farming related items involved in (e.g. record keeping methods, etc.) farming related creation of (e.g. beet root harvesting, etc.) the one or more first biologically based substances (e.g. barley, etc.) including at least in part one or more materials that will be ingested by a biological organism (e.g. filleted salmon to be served at a restaurant, etc.).

As shown in FIG. 42, the operational flow o10 proceeds to operation o12 for electronically storing symbolic information recorded as being correlated with and as being correlated with one or more tags, said one or more tags recorded as being at least temporarily in vicinity of one or more second farming related items involved in farming related creation of one or more second biologically based substances. An exemplary version of a non-transitory signal bearing medium of information storage subsystem s200 is depicted as bearing one or more storing symbolic info instructions i12 that when executed will direct performance of the operation o12. In an implementation, the one or more storing symbolic info instructions i12 when executed direct electronically storing (e.g. stored from SMTP server, stored from push-based file transfer, stored from compact flash card access, etc.) symbolic information (e.g. testing of methane presence, monitoring of long-term effects of calcium on alfalfa, testing of polyphenol levels in grape seed, etc.) recorded as being correlated with (e.g. through automated testing, through manual testing, through destructive testing, etc.) (e.g. one or more test tube samples, one or more air samples, one or more dirt samples, etc.) and as being correlated with (e.g. cost of shipping container dimensions, time of sunrise, gross capacity of vessel, etc.) one or more tags, (e.g. oat harvesting, carrot growing, lentil cultivation, etc.) said one or more tags recorded as being (e.g. king crab, cellulous, wood, etc.) at least temporarily (e.g. time since introduction of oxygen absorber, shipping time on truck from distribution center to market, portion of shipping time returning from laboratory, etc.) in vicinity of (e.g. adhered to container, tied to material, stapled to container, etc.) one or more second farming related items (e.g. cost of shipping container, herbicide type, type of pollination required, etc.) involved in farming related creation of (e.g. crab trapping, mushroom cultivation, alfalfa cutting, etc.) one or more second biologically based substances (e.g. salmon, whole carrot, whole turkey, etc.). Furthermore, the storing symbolic info electrical circuitry arrangement e12 when activated will perform the operation o12. Also, the storing symbolic info module m12, when executed and/or activated, will direct performance of and/or perform the operation o12. In an implementation, the storing symbolic info electrical circuitry arrangement e12, when activated performs the operation o12 in the illustrative depiction as follows, and/or the storing symbolic info module m12, when executed and/or activated, directs performance of and/or performs electronically storing (e.g. stored from SMTP server, stored from push-based file transfer, stored from compact flash card access, etc.) symbolic information (e.g. testing of methane presence, monitoring of long-term effects of calcium on alfalfa, testing of polyphenol levels in grape seed, etc.) recorded as being correlated with (e.g. through automated testing, through manual testing, through destructive testing, etc.) (e.g. one or more test tube samples, one or more air samples, one or more dirt samples, etc.) and as being correlated with (e.g. cost of shipping container dimensions, time of sunrise, gross capacity of vessel, etc.) one or more tags, (e.g. oat harvesting, carrot growing, lentil cultivation, etc.) said one or more tags recorded as being (e.g. king crab, cellulous, wood, etc.) at least temporarily (e.g. time since introduction of oxygen absorber, shipping time on truck from distribution center to market, portion of shipping time returning from laboratory, etc.) in vicinity of (e.g. adhered to container, tied to material, stapled to container, etc.) one or more second farming related items (e.g. cost of shipping container, herbicide type, type of pollination required, etc.) involved in farming related creation of (e.g. crab trapping, mushroom cultivation, alfalfa cutting, etc.) one or more second biologically based substances (e.g. salmon, whole carrot, whole turkey, etc.). In an implementation, the electronically storing symbolic information recorded as being correlated with and as being correlated with one or more tags, said one or more tags recorded as being at least temporarily in vicinity of one or more second farming related items involved in farming related creation of one or more second biologically based substances is carried out by electronically storing (e.g. stored from SMTP server, stored from push-based file transfer, stored from compact flash card access, etc.) symbolic information (e.g. testing of methane presence, monitoring of long-term effects of calcium on alfalfa, testing of polyphenol levels in grape seed, etc.) recorded as being correlated with (e.g. through automated testing, through manual testing, through destructive testing, etc.) (e.g. one or more test tube samples, one or more air samples, one or more dirt samples, etc.) and as being correlated with (e.g. cost of shipping container dimensions, time of sunrise, gross capacity of vessel, etc.) one or more tags, (e.g. oat harvesting, carrot growing, lentil cultivation, etc.) said one or more tags recorded as being (e.g. king crab, cellulous, wood, etc.) at least temporarily (e.g. time since introduction of oxygen absorber, shipping time on truck from distribution center to market, portion of shipping time returning from laboratory, etc.) in vicinity of (e.g. adhered to container, tied to material, stapled to container, etc.) one or more second farming related items (e.g. cost of shipping container, herbicide type, type of pollination required, etc.) involved in farming related creation of (e.g. crab trapping, mushroom cultivation, alfalfa cutting, etc.) one or more second biologically based substances (e.g. salmon, whole carrot, whole turkey, etc.).

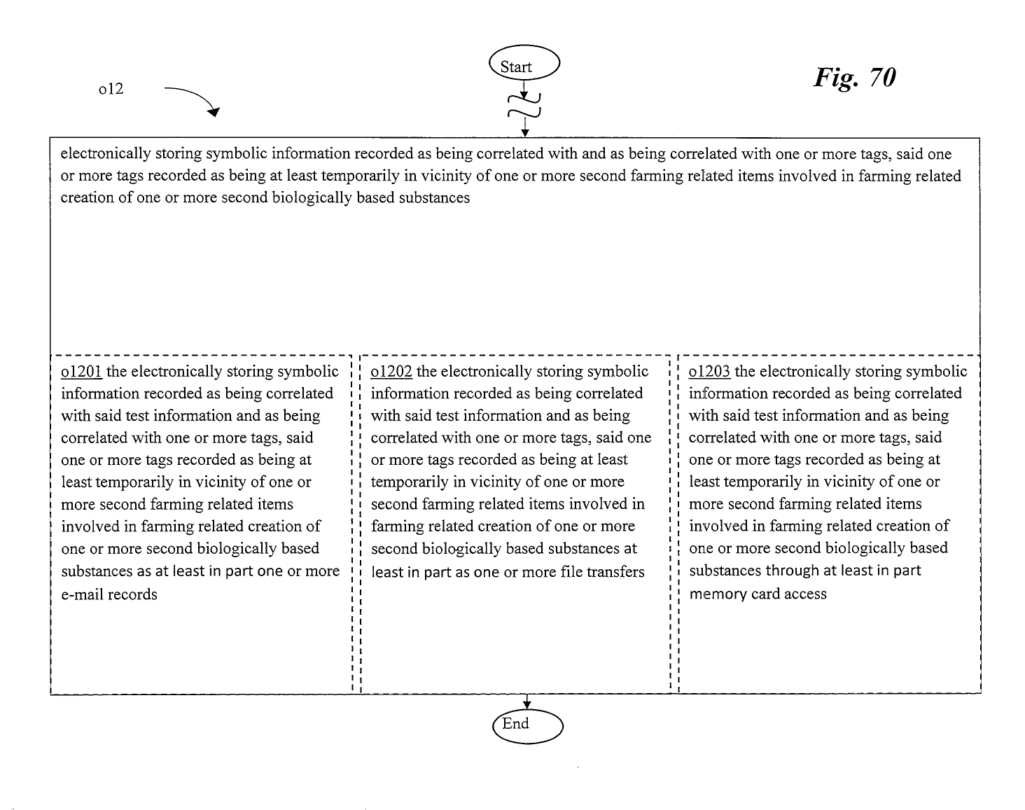

In one or more implementations, as shown in FIG. 70, operation o12 includes an operation o1201 for the electronically storing symbolic information recorded as being correlated with said test information and as being correlated with one or more tags, said one or more tags recorded as being at least temporarily in vicinity of one or more second farming related items involved in farming related creation of one or more second biologically based substances as at least in part one or more e-mail records. Origination of an illustratively derived symbolic info e-mail component group can be accomplished through skilled in the art design choice selection of one or more of the above depicted components from one or more of the above depicted subsystems shown in FIG. 12. Components from the symbolic info e-mail component group can be used in implementing execution of the one or more symbolic info e-mail instructions i1201 of FIG. 33, can be used in performance of the symbolic info e-mail electrical circuitry arrangement e1201 of FIG. 26, and/or can be used in otherwise fulfillment of the operation o1201. An exemplary non-transitory signal bearing medium version of the information storage subsystem s200 is depicted in FIG. 33 as bearing the one or more symbolic info e-mail instructions i1201 that when executed will direct performance of the operation o1201. Furthermore, the symbolic info e-mail electrical circuitry arrangement (“elec circ arrange”) e1201, when activated, will perform the operation o1201. Also, the symbolic info e-mail module m1201, when executed and/or activated, will direct performance of and/or perform the operation o1201. For instance, in one or more exemplary implementations, the one or more symbolic info e-mail instructions i1201, when executed, direct performance of the operation o1201 in the illustrative depiction as follows, and/or the symbolic info e-mail electrical circuitry arrangement e1201, when activated, performs the operation o1201 in the illustrative depiction as follows, and/or the symbolic info e-mail module m1201, when executed and/or activated, directs performance of and/or performs the operation o1201 in the illustrative depiction as follows, and/or the operation o1201 is otherwise carried out in the illustrative depiction as follows: the electronically storing (e.g. stored from POP3 server, etc.) symbolic information (e.g. SPARQCode, etc.) recorded as being correlated with (e.g. through a dense index, etc.) said test information (e.g. monitoring cultivation management decisions, etc.) and as being correlated with (e.g. through inclusion of data, etc.) one or more tags, (e.g. high capacity color barcode, etc.) said one or more tags recorded as being (e.g. recorded as video MPEG file, etc.) at least temporarily (e.g. time since introduction of oxygen absorber, etc.) in vicinity of (e.g. adhered to container, etc.) one or more second farming related items (e.g. cost of shipping container, etc.) involved in farming related creation of (e.g. crab trapping, etc.) one or more second biologically based substances (e.g. salmon, etc.) as at least in part one or more e-mail records (e.g. storing e-mail text strings, etc.).

In one or more implementations, as shown in FIG. 70, operation o12 includes an operation o1202 for the electronically storing symbolic information recorded as being correlated with said test information and as being correlated with one or more tags, said one or more tags recorded as being at least temporarily in vicinity of one or more second farming related items involved in farming related creation of one or more second biologically based substances at least in part as one or more file transfers. Origination of an illustratively derived symbolic info file component group can be accomplished through skilled in the art design choice selection of one or more of the above depicted components from one or more of the above depicted subsystems shown in FIG. 12. Components from the symbolic info file component group can be used in implementing execution of the one or more symbolic info file instructions i1202 of FIG. 33, can be used in performance of the symbolic info file electrical circuitry arrangement e1202 of FIG. 26, and/or can be used in otherwise fulfillment of the operation o1202. An exemplary non-transitory signal bearing medium version of the information storage subsystem s200 is depicted in FIG. 33 as bearing the one or more symbolic info file instructions i1202 that when executed will direct performance of the operation o1202. Furthermore, the symbolic info file electrical circuitry arrangement (“elec circ arrange”) e1202, when activated, will perform the operation o1202. Also, the symbolic info file module m1202, when executed and/or activated, will direct performance of and/or perform the operation o1202. For instance, in one or more exemplary implementations, the one or more symbolic info file instructions i1202, when executed, direct performance of the operation o1202 in the illustrative depiction as follows, and/or the symbolic info file electrical circuitry arrangement e1202, when activated, performs the operation o1202 in the illustrative depiction as follows, and/or the symbolic info file module m1202, when executed and/or activated, directs performance of and/or performs the operation o1202 in the illustrative depiction as follows, and/or the operation o1202 is otherwise carried out in the illustrative depiction as follows: the electronically storing (e.g. stored from pull-based file transfer, etc.) symbolic information (e.g. matrix code, etc.) recorded as being correlated with (e.g. through a bitmap index, etc.) said test information (e.g. testing boron levels, etc.) and as being correlated with (e.g. through search terms, etc.) one or more tags, (e.g. inertial sensor, etc.) said one or more tags recorded as being (e.g. recorded as audio WAV file, etc.) at least temporarily (e.g. shipping time on truck from distribution center to market, etc.) in vicinity of (e.g. tied to material, etc.) one or more second farming related items (e.g. herbicide type, etc.) involved in farming related creation of (e.g. mushroom cultivation, etc.) one or more second biologically based substances (e.g. whole carrot, etc.) at least in part as one or more file transfers (e.g. storing broadcasted file traffic, etc.).

In one or more implementations, as shown in FIG. 70, operation o12 includes an operation o1203 for the electronically storing symbolic information recorded as being correlated with said test information and as being correlated with one or more tags, said one or more tags recorded as being at least temporarily in vicinity of one or more second farming related items involved in farming related creation of one or more second biologically based substances through at least in part memory card access. Origination of an illustratively derived symbolic info memory component group can be accomplished through skilled in the art design choice selection of one or more of the above depicted components from one or more of the above depicted subsystems shown in FIG. 12. Components from the symbolic info memory component group can be used in implementing execution of the one or more symbolic info memory instructions i1203 of FIG. 33, can be used in performance of the symbolic info memory electrical circuitry arrangement e1203 of FIG. 26, and/or can be used in otherwise fulfillment of the operation o1203. An exemplary non-transitory signal bearing medium version of the information storage subsystem s200 is depicted in FIG. 33 as bearing the one or more symbolic info memory instructions i1203 that when executed will direct performance of the operation o1203. Furthermore, the symbolic info memory electrical circuitry arrangement (“elec circ arrange”) e1203, when activated, will perform the operation o1203. Also, the symbolic info memory module m1203, when executed and/or activated, will direct performance of and/or perform the operation o1203. For instance, in one or more exemplary implementations, the one or more symbolic info memory instructions i1203, when executed, direct performance of the operation o1203 in the illustrative depiction as follows, and/or the symbolic info memory electrical circuitry arrangement e1203, when activated, performs the operation o1203 in the illustrative depiction as follows, and/or the symbolic info memory module m1203, when executed and/or activated, directs performance of and/or performs the operation o1203 in the illustrative depiction as follows, and/or the operation o1203 is otherwise carried out in the illustrative depiction as follows: the electronically storing (e.g. stored from SD flash card access, etc.) symbolic information (e.g. kanji character set, etc.) recorded as being correlated with (e.g. through SQL search, etc.) said test information (e.g. testing for presence of bovine spongiform encephalopathy, etc.) and as being correlated with (e.g. through equations, etc.) one or more tags, (e.g. ISM band emitter, etc.) said one or more tags recorded as being (e.g. recorded on SD flash memory, etc.) at least temporarily (e.g. portion of shipping time returning from laboratory, etc.) in vicinity of (e.g. stapled to container, etc.) one or more second farming related items (e.g. type of pollination required, etc.) involved in farming related creation of (e.g. alfalfa cutting, etc.) one or more second biologically based substances (e.g. whole turkey, etc.) through at least in part memory card access (e.g. storing through SD card communication, etc.).

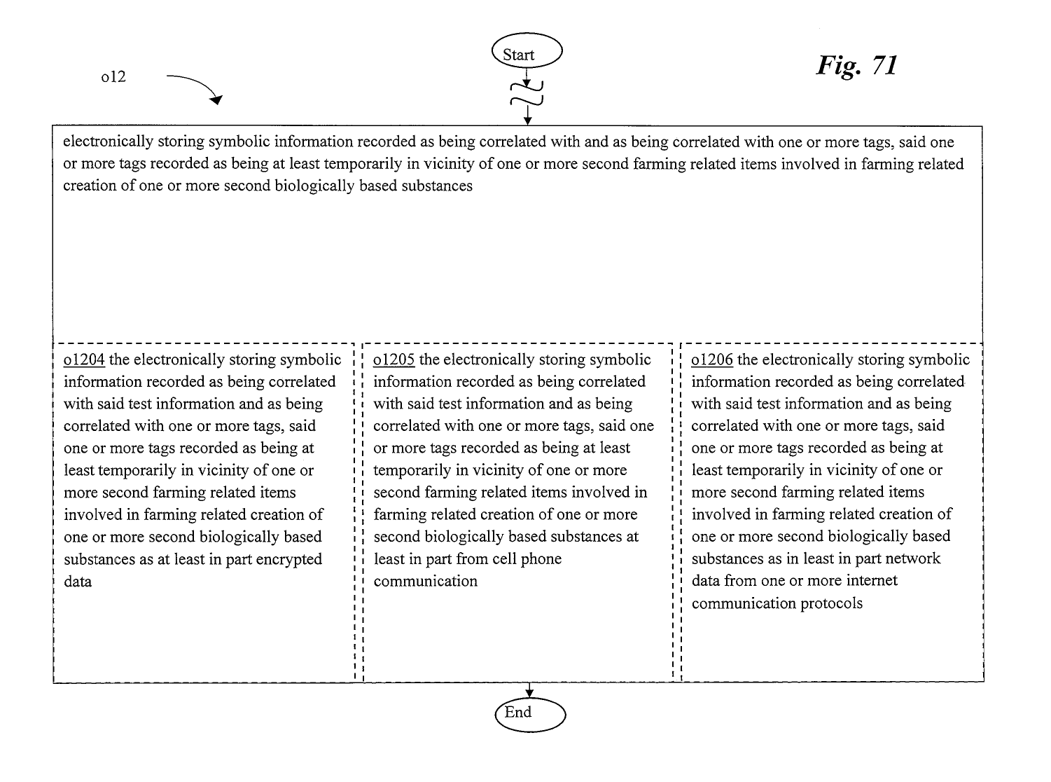

In one or more implementations, as shown in FIG. 71, operation o12 includes an operation o1204 for the electronically storing symbolic information recorded as being correlated with said test information and as being correlated with one or more tags, said one or more tags recorded as being at least temporarily in vicinity of one or more second farming related items involved in farming related creation of one or more second biologically based substances as at least in part encrypted data. Origination of an illustratively derived symbolic info encrypted component group can be accomplished through skilled in the art design choice selection of one or more of the above depicted components from one or more of the above depicted subsystems shown in FIG. 12. Components from the symbolic info encrypted component group can be used in implementing execution of the one or more symbolic info encrypted instructions i1204 of FIG. 33, can be used in performance of the symbolic info encrypted electrical circuitry arrangement e1204 of FIG. 26, and/or can be used in otherwise fulfillment of the operation o1204. An exemplary non-transitory signal bearing medium version of the information storage subsystem s200 is depicted in FIG. 33 as bearing the one or more symbolic info encrypted instructions i1204 that when executed will direct performance of the operation o1204. Furthermore, the symbolic info encrypted electrical circuitry arrangement (“elec circ arrange”) e1204, when activated, will perform the operation o1204. Also, the symbolic info encrypted module m1204, when executed and/or activated, will direct performance of and/or perform the operation o1204. For instance, in one or more exemplary implementations, the one or more symbolic info encrypted instructions i1204, when executed, direct performance of the operation o1204 in the illustrative depiction as follows, and/or the symbolic info encrypted electrical circuitry arrangement e1204, when activated, performs the operation o1204 in the illustrative depiction as follows, and/or the symbolic info encrypted module m1204, when executed and/or activated, directs performance of and/or performs the operation o1204 in the illustrative depiction as follows, and/or the operation o1204 is otherwise carried out in the illustrative depiction as follows: the electronically storing (e.g. stored from 128-bit encrypted data, etc.) symbolic information (e.g. barcode, etc.) recorded as being correlated with (e.g. through a hash table search, etc.) said test information (e.g. monitoring root depth, etc.) and as being correlated with (e.g. through functions, etc.) one or more tags, (e.g. asset tag, etc.) said one or more tags recorded as being (e.g. recorded on SMTP server, etc.) at least temporarily (e.g. time spent on conveyor belt, etc.) in vicinity of (e.g. laser etched onto container, etc.) one or more second farming related items (e.g. safety regulations, etc.) involved in farming related creation of (e.g. potato harvesting, etc.) one or more second biologically based substances (e.g. whole crab, etc.) as at least in part encrypted data (e.g. storing reverse encrypted data, etc.).

In one or more implementations, as shown in FIG. 71, operation o12 includes an operation o1205 for the electronically storing symbolic information recorded as being correlated with said test information and as being correlated with one or more tags, said one or more tags recorded as being at least temporarily in vicinity of one or more second farming related items involved in farming related creation of one or more second biologically based substances at least in part from cell phone communication. Origination of an illustratively derived symbolic info cell component group can be accomplished through skilled in the art design choice selection of one or more of the above depicted components from one or more of the above depicted subsystems shown in FIG. 12. Components from the symbolic info cell component group can be used in implementing execution of the one or more symbolic info cell instructions i1205 of FIG. 33, can be used in performance of the symbolic info cell electrical circuitry arrangement e1205 of FIG. 26, and/or can be used in otherwise fulfillment of the operation o1205. An exemplary non-transitory signal bearing medium version of the information storage subsystem s200 is depicted in FIG. 33 as bearing the one or more symbolic info cell instructions i1205 that when executed will direct performance of the operation o1205. Furthermore, the symbolic info cell electrical circuitry arrangement (“elec circ arrange”) e1205, when activated, will perform the operation o1205. Also, the symbolic info cell module m1205, when executed and/or activated, will direct performance of and/or perform the operation o1205. For instance, in one or more exemplary implementations, the one or more symbolic info cell instructions i1205, when executed, direct performance of the operation o1205 in the illustrative depiction as follows, and/or the symbolic info cell electrical circuitry arrangement e1205, when activated, performs the operation o1205 in the illustrative depiction as follows, and/or the symbolic info cell module m1205, when executed and/or activated, directs performance of and/or performs the operation o1205 in the illustrative depiction as follows, and/or the operation o1205 is otherwise carried out in the illustrative depiction as follows: the electronically storing (e.g. stored from MMS communication, etc.) symbolic information (e.g. serial number, etc.) recorded as being correlated with (e.g. through foreign key search, etc.) said test information (e.g. monitoring UV index, etc.) and as being correlated with (e.g. through expressions, etc.) one or more tags, (e.g. retrograde neuronal tracer, etc.) said one or more tags recorded as being (e.g. recorded on compact flash drive, etc.) at least temporarily (e.g. portion of time since sealed in carton, etc.) in vicinity of (e.g. riveted to container, etc.) one or more second farming related items (e.g. acreage available, etc.) involved in farming related creation of (e.g. beet root harvesting, etc.) one or more second biologically based substances (e.g. rice flour, etc.) at least in part from cell phone communication (e.g. storing cell phone voice communication, etc.).

In one or more implementations, as shown in FIG. 71, operation o12 includes an operation o1206 for the electronically storing symbolic information recorded as being correlated with said test information and as being correlated with one or more tags, said one or more tags recorded as being at least temporarily in vicinity of one or more second farming related items involved in farming related creation of one or more second biologically based substances as in least in part network data from one or more internet communication protocols. Origination of an illustratively derived symbolic info internet component group can be accomplished through skilled in the art design choice selection of one or more of the above depicted components from one or more of the above depicted subsystems shown in FIG. 12. Components from the symbolic info internet component group can be used in implementing execution of the one or more symbolic info internet instructions i1206 of FIG. 33, can be used in performance of the symbolic info internet electrical circuitry arrangement e1206 of FIG. 26, and/or can be used in otherwise fulfillment of the operation o1206. An exemplary non-transitory signal bearing medium version of the information storage subsystem s200 is depicted in FIG. 33 as bearing the one or more symbolic info internet instructions i1206 that when executed will direct performance of the operation o1206. Furthermore, the symbolic info internet electrical circuitry arrangement (“elec circ arrange”) e1206, when activated, will perform the operation o1206. Also, the symbolic info internet module m1206, when executed and/or activated, will direct performance of and/or perform the operation o1206. For instance, in one or more exemplary implementations, the one or more symbolic info internet instructions i1206, when executed, direct performance of the operation o1206 in the illustrative depiction as follows, and/or the symbolic info internet electrical circuitry arrangement e1206, when activated, performs the operation o1206 in the illustrative depiction as follows, and/or the symbolic info internet module m1206, when executed and/or activated, directs performance of and/or performs the operation o1206 in the illustrative depiction as follows, and/or the operation o1206 is otherwise carried out in the illustrative depiction as follows: the electronically storing (e.g. stored from TCP/IP communication, etc.) symbolic information (e.g. symmetrically encrypted data packet, etc.) recorded as being correlated with (e.g. through primary key, etc.) said test information (e.g. testing for soil contaminants, etc.) and as being correlated with (e.g. through primary key, etc.) one or more tags, (e.g. high frequency RFID, etc.) said one or more tags recorded as being (e.g. recorded as 256-bit AES encrypted data, etc.) at least temporarily (e.g. portion of time spent packaged with similar material, etc.) in vicinity of (e.g. placed inside material, etc.) one or more second farming related items (e.g. shade tree type, etc.) involved in farming related creation of (e.g. blueberry cultivation, etc.) one or more second biologically based substances (e.g. ground chicken, etc.) as in least in part network data from one or more internet communication protocols (e.g. storing internet streaming data, etc.).

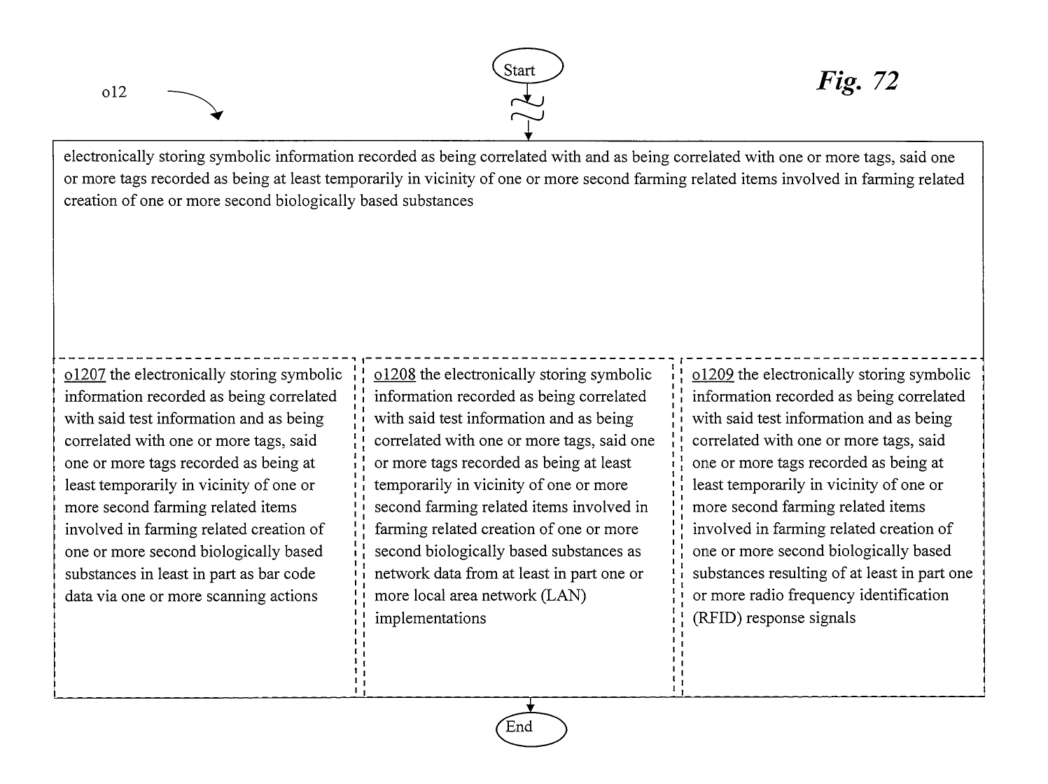

In one or more implementations, as shown in FIG. 72, operation o12 includes an operation o1207 for the electronically storing symbolic information recorded as being correlated with said test information and as being correlated with one or more tags, said one or more tags recorded as being at least temporarily in vicinity of one or more second farming related items involved in farming related creation of one or more second biologically based substances in least in part as bar code data via one or more scanning actions. Origination of an illustratively derived symbolic info bar code component group can be accomplished through skilled in the art design choice selection of one or more of the above depicted components from one or more of the above depicted subsystems shown in FIG. 12. Components from the symbolic info bar code component group can be used in implementing execution of the one or more symbolic info bar code instructions i1207 of FIG. 33, can be used in performance of the symbolic info bar code electrical circuitry arrangement e1207 of FIG. 26, and/or can be used in otherwise fulfillment of the operation o1207. An exemplary non-transitory signal bearing medium version of the information storage subsystem s200 is depicted in FIG. 33 as bearing the one or more symbolic info bar code instructions i1207 that when executed will direct performance of the operation o1207. Furthermore, the symbolic info bar code electrical circuitry arrangement (“elec circ arrange”) e1207, when activated, will perform the operation o1207. Also, the symbolic info bar code module m1207, when executed and/or activated, will direct performance of and/or perform the operation o1207. For instance, in one or more exemplary implementations, the one or more symbolic info bar code instructions i1207, when executed, direct performance of the operation o1207 in the illustrative depiction as follows, and/or the symbolic info bar code electrical circuitry arrangement e1207, when activated, performs the operation o1207 in the illustrative depiction as follows, and/or the symbolic info bar code module m1207, when executed and/or activated, directs performance of and/or performs the operation o1207 in the illustrative depiction as follows, and/or the operation o1207 is otherwise carried out in the illustrative depiction as follows: the electronically storing (e.g. stored from QR code scan, etc.) symbolic information (e.g. reverse polish notation, etc.) recorded as being correlated with (e.g. through unique exclusions of data, etc.) said test information (e.g. monitoring herbicide use, etc.) and as being correlated with (e.g. through data structure, etc.) one or more tags, (e.g. phase difference sensor, etc.) said one or more tags recorded as being (e.g. recorded as UPC scan data, etc.) at least temporarily (e.g. portion of time spent on shipping vessel, etc.) in vicinity of (e.g. placed inside container, etc.) one or more second farming related items (e.g. tide height, etc.) involved in farming related creation of (e.g. ISO basic Latin alphabet, etc.) one or more second biologically based substances (e.g. manure, etc.) in least in part as bar code data via one or more scanning actions (e.g. storing color bar code data, etc.).

In one or more implementations, as shown in FIG. 72, operation o12 includes an operation o1208 for the electronically storing symbolic information recorded as being correlated with said test information and as being correlated with one or more tags, said one or more tags recorded as being at least temporarily in vicinity of one or more second farming related items involved in farming related creation of one or more second biologically based substances as network data from at least in part one or more local area network (LAN) implementations. Origination of an illustratively derived symbolic info LAN component group can be accomplished through skilled in the art design choice selection of one or more of the above depicted components from one or more of the above depicted subsystems shown in FIG. 12. Components from the symbolic info LAN component group can be used in implementing execution of the one or more symbolic info LAN instructions i1208 of FIG. 33, can be used in performance of the symbolic info LAN electrical circuitry arrangement e1208 of FIG. 26, and/or can be used in otherwise fulfillment of the operation o1208. An exemplary non-transitory signal bearing medium version of the information storage subsystem s200 is depicted in FIG. 33 as bearing the one or more symbolic info LAN instructions i1208 that when executed will direct performance of the operation o1208. Furthermore, the symbolic info LAN electrical circuitry arrangement (“elec circ arrange”) e1208, when activated, will perform the operation o1208. Also, the symbolic info LAN module m1208, when executed and/or activated, will direct performance of and/or perform the operation o1208. For instance, in one or more exemplary implementations, the one or more symbolic info LAN instructions i1208, when executed, direct performance of the operation o1208 in the illustrative depiction as follows, and/or the symbolic info LAN electrical circuitry arrangement e1208, when activated, performs the operation o1208 in the illustrative depiction as follows, and/or the symbolic info LAN module m1208, when executed and/or activated, directs performance of and/or performs the operation o1208 in the illustrative depiction as follows, and/or the operation o1208 is otherwise carried out in the illustrative depiction as follows: the electronically storing (e.g. stored from ethernet, etc.) symbolic information (e.g. alpha-numeric, etc.) recorded as being correlated with (e.g. through database constraints, etc.) said test information (e.g. monitoring water availability, etc.) and as being correlated with (e.g. through data search, etc.) one or more tags, (e.g. laser ranging tracker, etc.) said one or more tags recorded as being (e.g. recorded on FTP server, etc.) at least temporarily (e.g. time spent in cold storage, etc.) in vicinity of (e.g. enveloping container, etc.) one or more second farming related items (e.g. weather forecast, etc.) involved in farming related creation of (e.g. corn growing, etc.) one or more second biologically based substances (e.g. wood, etc.) as network data from at least in part one or more local area network (LAN) implementations (e.g. storing on a LAN server, etc.).

In one or more implementations, as shown in FIG. 72, operation o12 includes an operation o1209 for the electronically storing symbolic information recorded as being correlated with said test information and as being correlated with one or more tags, said one or more tags recorded as being at least temporarily in vicinity of one or more second farming related items involved in farming related creation of one or more second biologically based substances resulting of at least in part one or more radio frequency identification (RFID) response signals. Origination of an illustratively derived symbolic info RFID component group can be accomplished through skilled in the art design choice selection of one or more of the above depicted components from one or more of the above depicted subsystems shown in FIG. 12. Components from the symbolic info RFID component group can be used in implementing execution of the one or more symbolic info RFID instructions i1209 of FIG. 33, can be used in performance of the symbolic info RFID electrical circuitry arrangement e1209 of FIG. 26, and/or can be used in otherwise fulfillment of the operation o1209. An exemplary non-transitory signal bearing medium version of the information storage subsystem s200 is depicted in FIG. 33 as bearing the one or more symbolic info RFID instructions i1209 that when executed will direct performance of the operation o1209. Furthermore, the symbolic info RFID electrical circuitry arrangement (“elec circ arrange”) e1209, when activated, will perform the operation o1209. Also, the symbolic info RFID module m1209, when executed and/or activated, will direct performance of and/or perform the operation o1209. For instance, in one or more exemplary implementations, the one or more symbolic info RFID instructions i1209, when executed, direct performance of the operation o1209 in the illustrative depiction as follows, and/or the symbolic info RFID electrical circuitry arrangement e1209, when activated, performs the operation o1209 in the illustrative depiction as follows, and/or the symbolic info RFID module m1209, when executed and/or activated, directs performance of and/or performs the operation o1209 in the illustrative depiction as follows, and/or the operation o1209 is otherwise carried out in the illustrative depiction as follows: the electronically storing (e.g. stored from low frequency RFID scan, etc.) symbolic information (e.g. ASCII string, etc.) recorded as being correlated with (e.g. through linear search, etc.) said test information (e.g. monitoring presence of fertilizer ratios in irrigation water, etc.) and as being correlated with (e.g. through database constraints, etc.) one or more tags, (e.g. ultrasonic tracker, etc.) said one or more tags recorded as being (e.g. recorded as wifi transmission, etc.) at least temporarily (e.g. time since application of safety seal, etc.) in vicinity of (e.g. debossed on material, etc.) one or more second farming related items (e.g. genetic signature of heirloom tomato seeds used, etc.) involved in farming related creation of (e.g. soy bean harvesting, etc.) one or more second biologically based substances (e.g. cellulous, etc.) resulting of at least in part one or more radio frequency identification (RFID) response signals (e.g. storing high density RFID communication, etc.).

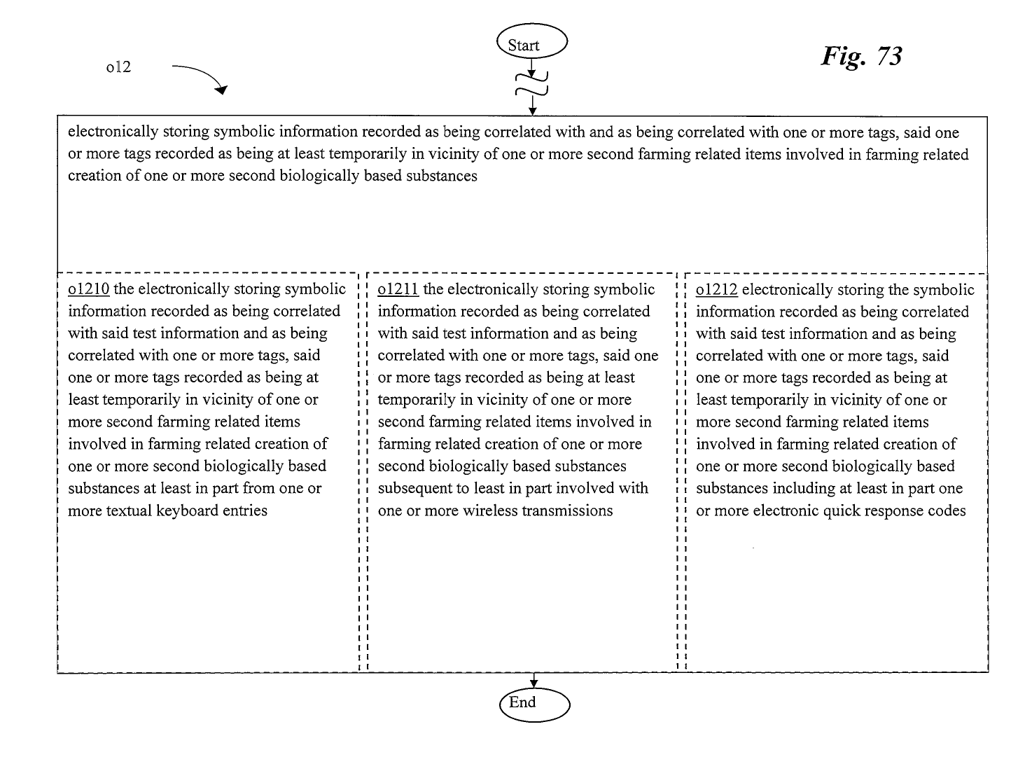

In one or more implementations, as shown in FIG. 73, operation o12 includes an operation o1210 for the electronically storing symbolic information recorded as being correlated with said test information and as being correlated with one or more tags, said one or more tags recorded as being at least temporarily in vicinity of one or more second farming related items involved in farming related creation of one or more second biologically based substances at least in part from one or more textual keyboard entries. Origination of an illustratively derived symbolic info keyboard component group can be accomplished through skilled in the art design choice selection of one or more of the above depicted components from one or more of the above depicted subsystems shown in FIG. 12. Components from the symbolic info keyboard component group can be used in implementing execution of the one or more symbolic info keyboard instructions i1210 of FIG. 33, can be used in performance of the symbolic info keyboard electrical circuitry arrangement e1210 of FIG. 26, and/or can be used in otherwise fulfillment of the operation o1210. An exemplary non-transitory signal bearing medium version of the information storage subsystem s200 is depicted in FIG. 33 as bearing the one or more symbolic info keyboard instructions i1210 that when executed will direct performance of the operation o1210. Furthermore, the symbolic info keyboard electrical circuitry arrangement (“elec circ arrange”) e1210, when activated, will perform the operation o1210. Also, the symbolic info keyboard module m1210, when executed and/or activated, will direct performance of and/or perform the operation o1210. For instance, in one or more exemplary implementations, the one or more symbolic info keyboard instructions i1210, when executed, direct performance of the operation o1210 in the illustrative depiction as follows, and/or the symbolic info keyboard electrical circuitry arrangement e1210, when activated, performs the operation o1210 in the illustrative depiction as follows, and/or the symbolic info keyboard module m1210, when executed and/or activated, directs performance of and/or performs the operation o1210 in the illustrative depiction as follows, and/or the operation o1210 is otherwise carried out in the illustrative depiction as follows: the electronically storing stored from tablet entry, etc.) symbolic information binary sequence, etc.) recorded as being correlated with through sub-linear time lookup, etc.) said test information testing chlorophyll levels in plant matter, etc.) and as being correlated with through unique exclusions of data, etc.) one or more tags, gyroscope, etc.) said one or more tags recorded as being recorded as JPG image format, etc.) at least temporarily time spent expose to air before packaging, etc.) in vicinity of welded onto container, etc.) one or more second farming related items neighbor's crop harvest, etc.) involved in farming related creation of canola harvesting, etc.) one or more second biologically based substances (e.g. king crab, etc.) at least in part from one or more textual keyboard entries (e.g. storing keypad entries, etc.).

In one or more implementations, as shown in FIG. 73, operation o12 includes an operation o1211 for the electronically storing symbolic information recorded as being correlated with said test information and as being correlated with one or more tags, said one or more tags recorded as being at least temporarily in vicinity of one or more second farming related items involved in farming related creation of one or more second biologically based substances subsequent to least in part involved with one or more wireless transmissions. Origination of an illustratively derived symbolic info wireless component group can be accomplished through skilled in the art design choice selection of one or more of the above depicted components from one or more of the above depicted subsystems shown in FIG. 12. Components from the symbolic info wireless component group can be used in implementing execution of the one or more symbolic info wireless instructions i1211 of FIG. 33, can be used in performance of the symbolic info wireless electrical circuitry arrangement e1211 of FIG. 26, and/or can be used in otherwise fulfillment of the operation o1211. An exemplary non-transitory signal bearing medium version of the information storage subsystem s200 is depicted in FIG. 33 as bearing the one or more symbolic info wireless instructions i1211 that when executed will direct performance of the operation o1211. Furthermore, the symbolic info wireless electrical circuitry arrangement (“elec circ arrange”) e1211, when activated, will perform the operation o1211. Also, the symbolic info wireless module m1211, when executed and/or activated, will direct performance of and/or perform the operation o1211. For instance, in one or more exemplary implementations, the one or more symbolic info wireless instructions i1211, when executed, direct performance of the operation o1211 in the illustrative depiction as follows, and/or the symbolic info wireless electrical circuitry arrangement e1211, when activated, performs the operation o1211 in the illustrative depiction as follows, and/or the symbolic info wireless module m1211, when executed and/or activated, directs performance of and/or performs the operation o1211 in the illustrative depiction as follows, and/or the operation o1211 is otherwise carried out in the illustrative depiction as follows: the electronically storing (e.g. stored from bluetooth transmission, etc.) symbolic information (e.g. security data, etc.) recorded as being correlated with (e.g. through field query, etc.) said test information (e.g. monitoring effects of rhizobia inoculation, etc.) and as being correlated with (e.g. through a dense index, etc.) one or more tags, (e.g. UHF emitter, etc.) said one or more tags recorded as being (e.g. recorded as MP3 file, etc.) at least temporarily (e.g. portion of time spent in ice bath, etc.) in vicinity of (e.g. bolted to container, etc.) one or more second farming related items (e.g. time of sunrise, etc.) involved in farming related creation of (e.g. flax growing, etc.) one or more second biologically based substances (e.g. fresh water eel, etc.) subsequent to least in part involved with one or more wireless transmissions (e.g. storing wireless Ethernet communication, etc.).

In one or more implementations, as shown in FIG. 73, operation o12 includes an operation o1212 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part one or more electronic quick response codes. Origination of an illustratively derived symbolic info quick component group can be accomplished through skilled in the art design choice selection of one or more of the above depicted components from one or more of the above depicted subsystems shown in FIG. 12. Components from the symbolic info quick component group can be used in implementing execution of the one or more symbolic info quick instructions i1212 of FIG. 33, can be used in performance of the symbolic info quick electrical circuitry arrangement e1212 of FIG. 26, and/or can be used in otherwise fulfillment of the operation o1212. An exemplary non-transitory signal bearing medium version of the information storage subsystem s200 is depicted in FIG. 33 as bearing the one or more symbolic info quick instructions i1212 that when executed will direct performance of the operation o1212. Furthermore, the symbolic info quick electrical circuitry arrangement (“elec circ arrange”) e1212, when activated, will perform the operation o1212. Also, the symbolic info quick module m1212, when executed and/or activated, will direct performance of and/or perform the operation o1212. For instance, in one or more exemplary implementations, the one or more symbolic info quick instructions i1212, when executed, direct performance of the operation o1212 in the illustrative depiction as follows, and/or the symbolic info quick electrical circuitry arrangement e1212, when activated, performs the operation o1212 in the illustrative depiction as follows, and/or the symbolic info quick module m1212, when executed and/or activated, directs performance of and/or performs the operation o1212 in the illustrative depiction as follows, and/or the operation o1212 is otherwise carried out in the illustrative depiction as follows: electronically storing (e.g. stored from micro SD card access, etc.) the symbolic information (e.g. Arabic alphabet, etc.) recorded as being correlated with (e.g. through functions, etc.) said test information (e.g. monitoring of glycosylation of plant matter, etc.) and as being correlated with (e.g. through foreign key search, etc.) one or more tags, (e.g. light emitting diode, etc.) said one or more tags recorded as being (e.g. recorded as audio on magnetic tape, etc.) at least temporarily (e.g. shipping time from grocery store to home, etc.) in vicinity of (e.g. embossed on container, etc.) one or more second farming related items (e.g. nutrient additive to diet, etc.) involved in farming related creation of (e.g. squash cultivation, etc.) one or more second biologically based substances (e.g. sheep milk, etc.) including at least in part one or more electronic quick response codes (e.g. quick response code on container, etc.).

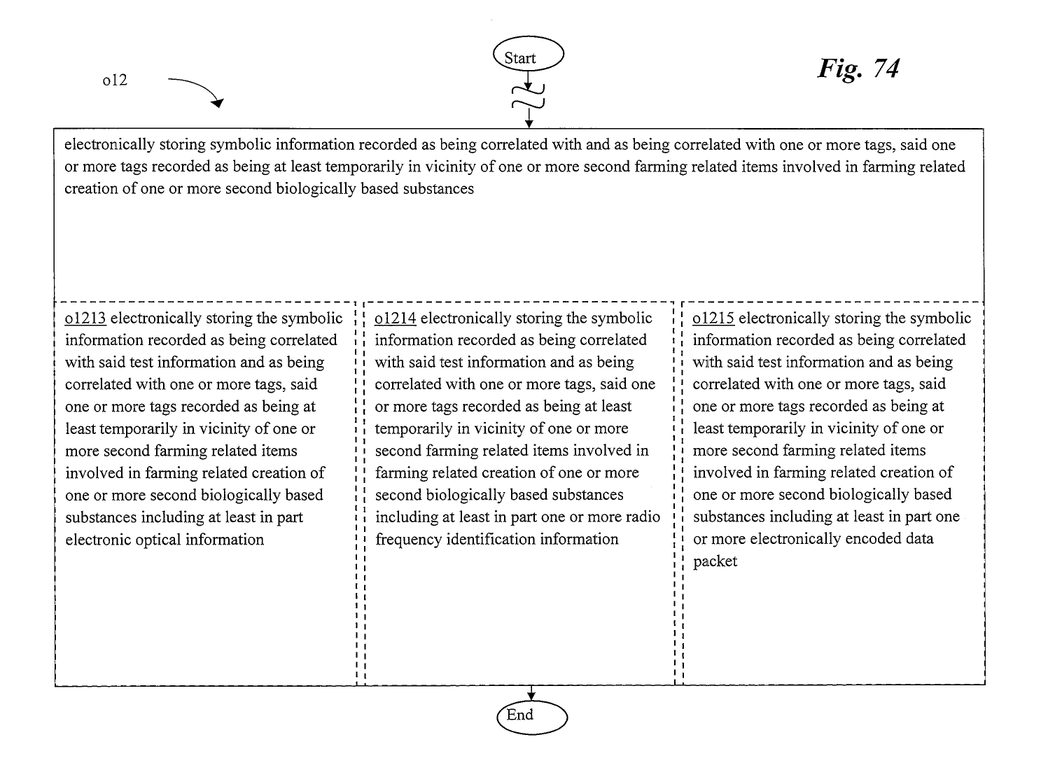

In one or more implementations, as shown in FIG. 74, operation o12 includes an operation o1213 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part electronic optical information. Origination of an illustratively derived symbolic info optical component group can be accomplished through skilled in the art design choice selection of one or more of the above depicted components from one or more of the above depicted subsystems shown in FIG. 12. Components from the symbolic info optical component group can be used in implementing execution of the one or more symbolic info optical instructions i1213 of FIG. 33, can be used in performance of the symbolic info optical electrical circuitry arrangement e1213 of FIG. 26, and/or can be used in otherwise fulfillment of the operation o1213. An exemplary non-transitory signal bearing medium version of the information storage subsystem s200 is depicted in FIG. 33 as bearing the one or more symbolic info optical instructions i1213 that when executed will direct performance of the operation o1213. Furthermore, the symbolic info optical electrical circuitry arrangement (“elec circ arrange”) e1213, when activated, will perform the operation o1213. Also, the symbolic info optical module m1213, when executed and/or activated, will direct performance of and/or perform the operation o1213. For instance, in one or more exemplary implementations, the one or more symbolic info optical instructions i1213, when executed, direct performance of the operation o1213 in the illustrative depiction as follows, and/or the symbolic info optical electrical circuitry arrangement e1213, when activated, performs the operation o1213 in the illustrative depiction as follows, and/or the symbolic info optical module m1213, when executed and/or activated, directs performance of and/or performs the operation o1213 in the illustrative depiction as follows, and/or the operation o1213 is otherwise carried out in the illustrative depiction as follows: electronically storing (e.g. stored from compact flash card access, etc.) the symbolic information (e.g. phonetic alphabet, etc.) recorded as being correlated with (e.g. through access of ordered records, etc.) said test information (e.g. testing of polyphenol levels in grape seed, etc.) and as being correlated with (e.g. through a hash table search, etc.) one or more tags, (e.g. expressed sequenced tag, etc.) said one or more tags recorded as being (e.g. recorded as video on magnetic tape, etc.) at least temporarily (e.g. time spent in laboratory for testing, etc.) in vicinity of (e.g. snapped onto container, etc.) one or more second farming related items (e.g. cost of pollinations, etc.) involved in farming related creation of (e.g. strawberry picking, etc.) one or more second biologically based substances (e.g. cow milk, etc.) including at least in part electronic optical information (e.g. holographic information, etc.).

In one or more implementations, as shown in FIG. 74, operation o12 includes an operation o1214 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part one or more radio frequency identification information. Origination of an illustratively derived symbolic info RFID component group can be accomplished through skilled in the art design choice selection of one or more of the above depicted components from one or more of the above depicted subsystems shown in FIG. 12. Components from the symbolic info RFID component group can be used in implementing execution of the one or more symbolic info RFID instructions i1214 of FIG. 33, can be used in performance of the symbolic info RFID electrical circuitry arrangement e1214 of FIG. 26, and/or can be used in otherwise fulfillment of the operation o1214. An exemplary non-transitory signal bearing medium version of the information storage subsystem s200 is depicted in FIG. 33 as bearing the one or more symbolic info RFID instructions i1214 that when executed will direct performance of the operation o1214. Furthermore, the symbolic info RFID electrical circuitry arrangement (“elec circ arrange”) e1214, when activated, will perform the operation o1214. Also, the symbolic info RFID module m1214, when executed and/or activated, will direct performance of and/or perform the operation o1214. For instance, in one or more exemplary implementations, the one or more symbolic info RFID instructions i1214, when executed, direct performance of the operation o1214 in the illustrative depiction as follows, and/or the symbolic info RFID electrical circuitry arrangement e1214, when activated, performs the operation o1214 in the illustrative depiction as follows, and/or the symbolic info RFID module m1214, when executed and/or activated, directs performance of and/or performs the operation o1214 in the illustrative depiction as follows, and/or the operation o1214 is otherwise carried out in the illustrative depiction as follows: electronically storing (e.g. stored from webpage data, etc.) the symbolic information (e.g. model number, etc.) recorded as being correlated with (e.g. through common search terms, etc.) said test information (e.g. monitoring of long-term effects of calcium on alfalfa, etc.) and as being correlated with (e.g. through SQL search, etc.) one or more tags, (e.g. hybrid positioning system, etc.) said one or more tags recorded as being (e.g. recorded as radio wave communication, etc.) at least temporarily (e.g. partial time spent on retail display, etc.) in vicinity of (e.g. magnetically attached to container, etc.) one or more second farming related items (e.g. labor laws, etc.) involved in farming related creation of (e.g. rice planting, etc.) one or more second biologically based substances (e.g. water, etc.) including at least in part one or more radio frequency identification information (e.g. RFID scanning information, etc.).

In one or more implementations, as shown in FIG. 74, operation o12 includes an operation o1215 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part one or more electronically encoded data packet. Origination of an illustratively derived symbolic info encoded component group can be accomplished through skilled in the art design choice selection of one or more of the above depicted components from one or more of the above depicted subsystems shown in FIG. 12. Components from the symbolic info encoded component group can be used in implementing execution of the one or more symbolic info encoded instructions i1215 of FIG. 33, can be used in performance of the symbolic info encoded electrical circuitry arrangement e1215 of FIG. 26, and/or can be used in otherwise fulfillment of the operation o1215. An exemplary non-transitory signal bearing medium version of the information storage subsystem s200 is depicted in FIG. 33 as bearing the one or more symbolic info encoded instructions i1215 that when executed will direct performance of the operation o1215. Furthermore, the symbolic info encoded electrical circuitry arrangement (“elec circ arrange”) e1215, when activated, will perform the operation o1215. Also, the symbolic info encoded module m1215, when executed and/or activated, will direct performance of and/or perform the operation o1215. For instance, in one or more exemplary implementations, the one or more symbolic info encoded instructions i1215, when executed, direct performance of the operation o1215 in the illustrative depiction as follows, and/or the symbolic info encoded electrical circuitry arrangement e1215, when activated, performs the operation o1215 in the illustrative depiction as follows, and/or the symbolic info encoded module m1215, when executed and/or activated, directs performance of and/or performs the operation o1215 in the illustrative depiction as follows, and/or the operation o1215 is otherwise carried out in the illustrative depiction as follows: electronically storing (e.g. stored from website data, etc.) the symbolic information (e.g. tertiary code, etc.) recorded as being correlated with (e.g. through data structure, etc.) said test information (e.g. testing of methane presence, etc.) and as being correlated with (e.g. through a bitmap index, etc.) one or more tags, (e.g. accelerometer, etc.) said one or more tags recorded as being (e.g. recorded as radio wave reception, etc.) at least temporarily (e.g. time on train between two terminals, etc.) in vicinity of (e.g. stamped onto container, etc.) one or more second farming related items (e.g. land terrain, etc.) involved in farming related creation of (e.g. tomato growing, etc.) one or more second biologically based substances (e.g. wool, etc.) including at least in part one or more electronically encoded data packet (e.g. TCP/IP packets, etc.).

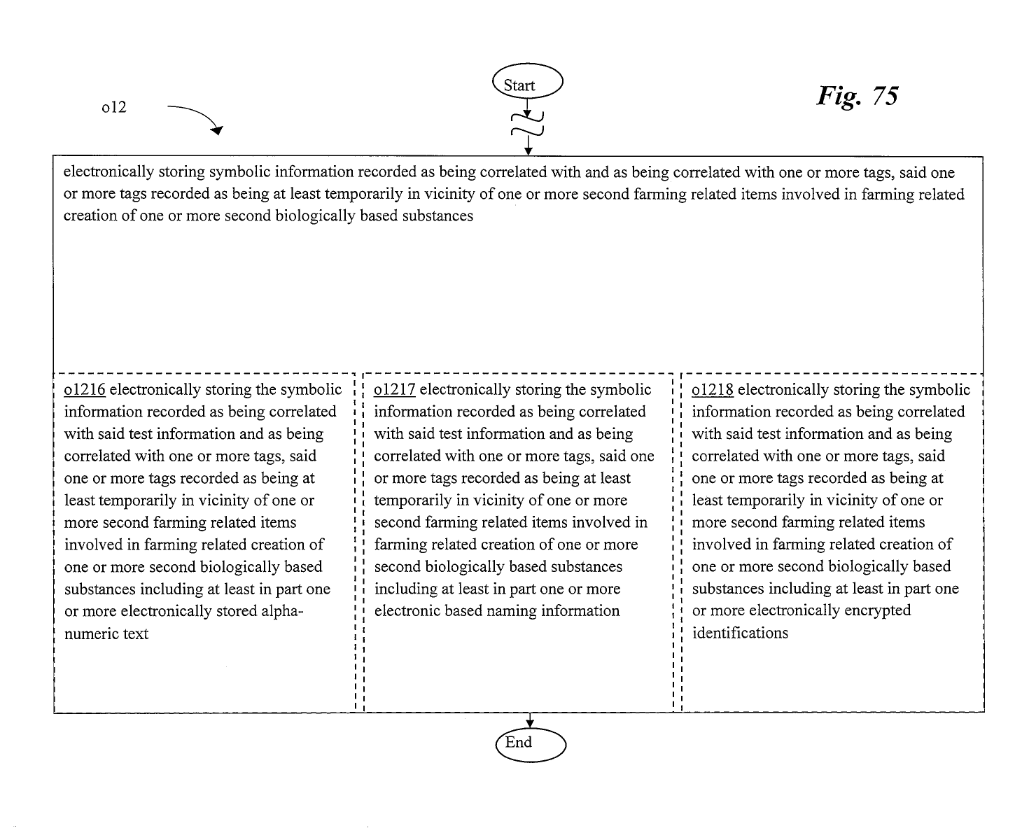

In one or more implementations, as shown in FIG. 75, operation o12 includes an operation o1216 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part one or more electronically stored alpha-numeric text. Origination of an illustratively derived symbolic info text component group can be accomplished through skilled in the art design choice selection of one or more of the above depicted components from one or more of the above depicted subsystems shown in FIG. 12. Components from the symbolic info text component group can be used in implementing execution of the one or more symbolic info text instructions i1216 of FIG. 33, can be used in performance of the symbolic info text electrical circuitry arrangement e1216 of FIG. 26, and/or can be used in otherwise fulfillment of the operation o1216. An exemplary non-transitory signal bearing medium version of the information storage subsystem s200 is depicted in FIG. 33 as bearing the one or more symbolic info text instructions i1216 that when executed will direct performance of the operation o1216. Furthermore, the symbolic info text electrical circuitry arrangement (“elec circ arrange”) e1216, when activated, will perform the operation o1216. Also, the symbolic info text module m1216, when executed and/or activated, will direct performance of and/or perform the operation o1216. For instance, in one or more exemplary implementations, the one or more symbolic info text instructions i1216, when executed, direct performance of the operation o1216 in the illustrative depiction as follows, and/or the symbolic info text electrical circuitry arrangement e1216, when activated, performs the operation o1216 in the illustrative depiction as follows, and/or the symbolic info text module m1216, when executed and/or activated, directs performance of and/or performs the operation o1216 in the illustrative depiction as follows, and/or the operation o1216 is otherwise carried out in the illustrative depiction as follows: electronically storing (e.g. stored from software based encrypted data, etc.) the symbolic information (e.g. Morse code, etc.) recorded as being correlated with (e.g. through standardization of index, etc.) said test information (e.g. testing for presence of pesticides, etc.) and as being correlated with (e.g. through a sparse index, etc.) one or more tags, (e.g. microwave emitter, etc.) said one or more tags recorded as being (e.g. recorded as radio wave transmission, etc.) at least temporarily (e.g. time held in port for inspection period, etc.) in vicinity of (e.g. tied to container, etc.) one or more second farming related items (e.g. genetic code of current crop, etc.) involved in farming related creation of (e.g. sheep butchering, etc.) one or more second biologically based substances (e.g. abalone shell, etc.) including at least in part one or more electronically stored alpha-numeric text (e.g. French language text, etc.).

In one or more implementations, as shown in FIG. 75, operation o12 includes an operation o1217 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part one or more electronic based naming information. Origination of an illustratively derived symbolic info naming component group can be accomplished through skilled in the art design choice selection of one or more of the above depicted components from one or more of the above depicted subsystems shown in FIG. 12. Components from the symbolic info naming component group can be used in implementing execution of the one or more symbolic info naming instructions i1217 of FIG. 33, can be used in performance of the symbolic info naming electrical circuitry arrangement e1217 of FIG. 26, and/or can be used in otherwise fulfillment of the operation o1217. An exemplary non-transitory signal bearing medium version of the information storage subsystem s200 is depicted in FIG. 33 as bearing the one or more symbolic info naming instructions i1217 that when executed will direct performance of the operation o1217. Furthermore, the symbolic info naming electrical circuitry arrangement (“elec circ arrange”) e1217, when activated, will perform the operation o1217. Also, the symbolic info naming module m1217, when executed and/or activated, will direct performance of and/or perform the operation o1217. For instance, in one or more exemplary implementations, the one or more symbolic info naming instructions i1217, when executed, direct performance of the operation o1217 in the illustrative depiction as follows, and/or the symbolic info naming electrical circuitry arrangement e1217, when activated, performs the operation o1217 in the illustrative depiction as follows, and/or the symbolic info naming module m1217, when executed and/or activated, directs performance of and/or performs the operation o1217 in the illustrative depiction as follows, and/or the operation o1217 is otherwise carried out in the illustrative depiction as follows: electronically storing (e.g. stored from SD flash card access, etc.) the symbolic information (e.g. visual pattern, etc.) recorded as being correlated with (e.g. through index locking, etc.) said test information (e.g. monitoring sealed carton pressure, etc.) and as being correlated with (e.g. through database index, etc.) one or more tags, (e.g. speaker, etc.) said one or more tags recorded as being (e.g. recorded through USB port communication, etc.) at least temporarily (e.g. time in holding bay, etc.) in vicinity of (e.g. stapled to container, etc.) one or more second farming related items (e.g. estimated rat population, etc.) involved in farming related creation of (e.g. cereal harvesting, etc.) one or more second biologically based substances (e.g. intestine casing, etc.) including at least in part one or more electronic based naming information (e.g. binary coded decimal information, etc.).

In one or more implementations, as shown in FIG. 75, operation o12 includes an operation o1218 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part one or more electronically encrypted identifications. Origination of an illustratively derived symbolic info encrypted component group can be accomplished through skilled in the art design choice selection of one or more of the above depicted components from one or more of the above depicted subsystems shown in FIG. 12. Components from the symbolic info encrypted component group can be used in implementing execution of the one or more symbolic info encrypted instructions i1218 of FIG. 33, can be used in performance of the symbolic info encrypted electrical circuitry arrangement e1218 of FIG. 26, and/or can be used in otherwise fulfillment of the operation o1218. An exemplary non-transitory signal bearing medium version of the information storage subsystem s200 is depicted in FIG. 33 as bearing the one or more symbolic info encrypted instructions i1218 that when executed will direct performance of the operation o1218. Furthermore, the symbolic info encrypted electrical circuitry arrangement (“elec circ arrange”) e1218, when activated, will perform the operation o1218. Also, the symbolic info encrypted module m1218, when executed and/or activated, will direct performance of and/or perform the operation o1218. For instance, in one or more exemplary implementations, the one or more symbolic info encrypted instructions i1218, when executed, direct performance of the operation o1218 in the illustrative depiction as follows, and/or the symbolic info encrypted electrical circuitry arrangement e1218, when activated, performs the operation o1218 in the illustrative depiction as follows, and/or the symbolic info encrypted module m1218, when executed and/or activated, directs performance of and/or performs the operation o1218 in the illustrative depiction as follows, and/or the operation o1218 is otherwise carried out in the illustrative depiction as follows: electronically storing (e.g. stored from SIM card data, etc.) the symbolic information (e.g. ASCII string, etc.) recorded as being correlated with (e.g. through index concurrency control, etc.) said test information (e.g. monitoring rainfall, etc.) and as being correlated with (e.g. through database pointers, etc.) one or more tags, (e.g. scintillation counter, etc.) said one or more tags recorded as being (e.g. recorded through ethernet, etc.) at least temporarily (e.g. shipping time across ocean, etc.) in vicinity of (e.g. snapped onto container, etc.) one or more second farming related items (e.g. generator fuel type used, etc.) involved in farming related creation of (e.g. peach picking, etc.) one or more second biologically based substances (e.g. cow tongue, etc.) including at least in part one or more electronically encrypted identifications (e.g. DoD encryption scheme, etc.).

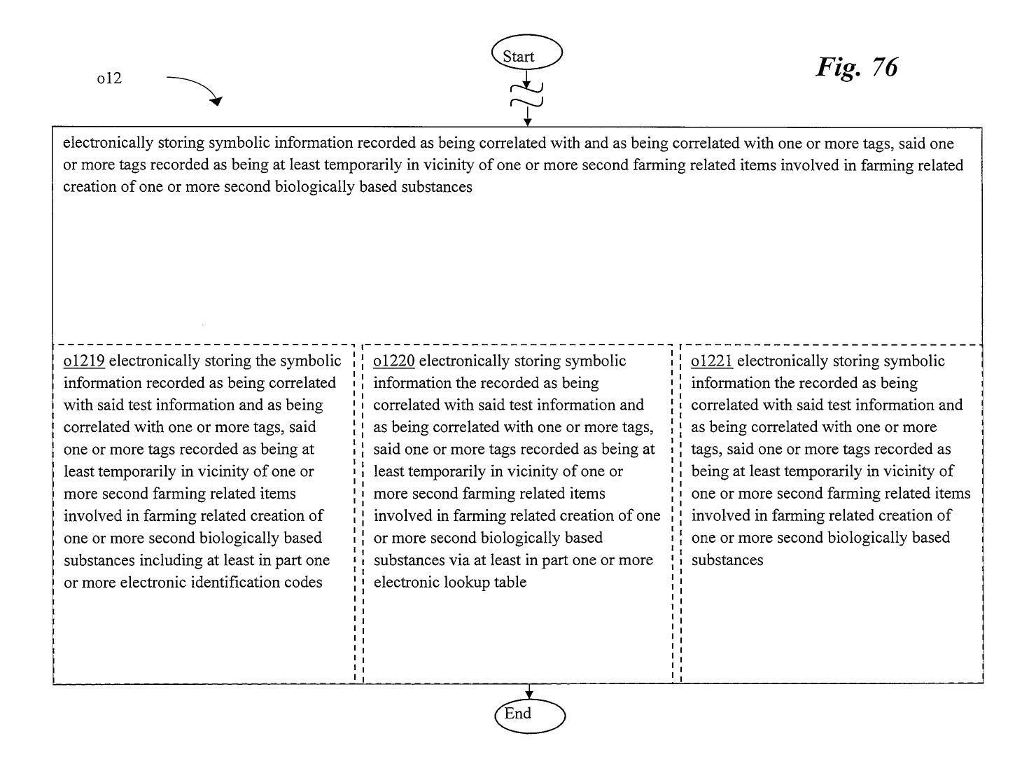

In one or more implementations, as shown in FIG. 76, operation o12 includes an operation o1219 for electronically storing the symbolic information recorded as being correlated with said test information and as being correlated with one or more tags, said one or more tags recorded as being at least temporarily in vicinity of one or more second farming related items involved in farming related creation of one or more second biologically based substances including at least in part one or more electronic identification codes. Origination of an illustratively derived symbolic info ID component group can be accomplished through skilled in the art design choice selection of one or more of the above depicted components from one or more of the above depicted subsystems shown in FIG. 12. Components from the symbolic info ID component group can be used in implementing execution of the one or more symbolic info ID instructions i1219 of FIG. 33, can be used in performance of the symbolic info ID electrical circuitry arrangement e1219 of FIG. 26, and/or can be used in otherwise fulfillment of the operation o1219. An exemplary non-transitory signal bearing medium version of the information storage subsystem s200 is depicted in FIG. 33 as bearing the one or more symbolic info ID instructions i1219 that when executed will direct performance of the operation o1219. Furthermore, the symbolic info ID electrical circuitry arrangement (“elec circ arrange”) e1219, when activated, will perform the operation o1219. Also, the symbolic info ID module m1219, when executed and/or activated, will direct performance of and/or perform the operation o1219. For instance, in one or more exemplary implementations, the one or more symbolic info ID instructions i1219, when executed, direct performance of the operation o1219 in the illustrative depiction as follows, and/or the symbolic info ID electrical circuitry arrangement e1219, when activated, performs the operation o1219 in the illustrative depiction as follows, and/or the symbolic info ID module m1219, when executed and/or activated, directs performance of and/or performs the operation o1219 in the illustrative depiction as follows, and/or the operation o1219 is otherwise carried out in the illustrative depiction as follows: electronically storing (e.g. stored from email, etc.) the symbolic information (e.g. binary sequence, etc.) recorded as being correlated with (e.g. through a reverse index, etc.) said test information (e.g. testing nitrogen levels, etc.) and as being correlated with (e.g. through common attributes found in data set, etc.) one or more tags, (e.g. inclinometer, etc.) said one or more tags recorded as being (e.g. recorded from RFID scan, etc.) at least temporarily (e.g. time in storage and display after unpacking, etc.) in vicinity of (e.g. burned into material, etc.) one or more second farming related items (e.g. invasive plant population, etc.) involved in farming related creation of (e.g. goose butchering, etc.) one or more second biologically based substances (e.g. cow liver, etc.) including at least in part one or more electronic identification codes (e.g. expressed sequence tag, etc.).

In one or more implementations, as shown in FIG. 76, operation o12 includes an operation o1220 for electronically storing symbolic information the recorded as being correlated with said test information and as being correlated with one or more tags, said one or more tags recorded as being at least temporarily in vicinity of one or more second farming related items involved in farming related creation of one or more second biologically based substances via at least in part one or more electronic lookup table. Origination of an illustratively derived symbolic info lookup component group can be accomplished through skilled in the art design choice selection of one or more of the above depicted components from one or more of the above depicted subsystems shown in FIG. 12. Components from the symbolic info lookup component group can be used in implementing execution of the one or more symbolic info lookup instructions i1220 of FIG. 34, can be used in performance of the symbolic info lookup electrical circuitry arrangement e1220 of FIG. 27, and/or can be used in otherwise fulfillment of the operation o1220. An exemplary non-transitory signal bearing medium version of the information storage subsystem s200 is depicted in FIG. 34 as bearing the one or more symbolic info lookup instructions i1220 that when executed will direct performance of the operation o1220. Furthermore, the symbolic info lookup electrical circuitry arrangement (“elec circ arrange”) e1220, when activated, will perform the operation o1220. Also, the symbolic info lookup module m1220, when executed and/or activated, will direct performance of and/or perform the operation o1220. For instance, in one or more exemplary implementations, the one or more symbolic info lookup instructions i1220, when executed, direct performance of the operation o1220 in the illustrative depiction as follows, and/or the symbolic info lookup electrical circuitry arrangement e1220, when activated, performs the operation o1220 in the illustrative depiction as follows, and/or the symbolic info lookup module m1220, when executed and/or activated, directs performance of and/or performs the operation o1220 in the illustrative depiction as follows, and/or the operation o1220 is otherwise carried out in the illustrative depiction as follows: electronically storing (e.g. stored from peer to peer communication, etc.) symbolic information (e.g. color code, etc.) the recorded as being correlated with (e.g. through a query table, etc.) said test information (e.g. testing pecan levels in plant matter, etc.) and as being correlated with (e.g. through search terms, etc.) one or more tags, (e.g. gyroscope, etc.) said one or more tags recorded as being (e.g. recorded as infra-red transmission, etc.) at least temporarily (e.g. shipping time from farm to restaurant, etc.) in vicinity of (e.g. burned into container, etc.) one or more second farming related items (e.g. crop rotation demands, etc.) involved in farming related creation of (e.g. goose egg laying, etc.) one or more second biologically based substances (e.g. cow heart, etc.) via at least in part one or more electronic lookup table (e.g. recording through one or more database lookup tables, etc.).

In one or more implementations, as shown in FIG. 76, operation o12 includes an operation o1221 for electronically storing symbolic information the recorded as being correlated with said test information and as being correlated with one or more tags, said one or more tags recorded as being at least temporarily in vicinity of one or more second farming related items involved in farming related creation of one or more second biologically based substances. Origination of an illustratively derived symbolic info second component group can be accomplished through skilled in the art design choice selection of one or more of the above depicted components from one or more of the above depicted subsystems shown in FIG. 12. Components from the symbolic info second component group can be used in implementing execution of the one or more symbolic info second instructions i1221 of FIG. 34, can be used in performance of the symbolic info second electrical circuitry arrangement e1221 of FIG. 27, and/or can be used in otherwise fulfillment of the operation o1221. An exemplary non-transitory signal bearing medium version of the information storage subsystem s200 is depicted in FIG. 34 as bearing the one or more symbolic info second instructions i1221 that when executed will direct performance of the operation o1221. Furthermore, the symbolic info second electrical circuitry arrangement (“elec circ arrange”) e1221, when activated, will perform the operation o1221. Also, the symbolic info second module m1221, when executed and/or activated, will direct performance of and/or perform the operation o1221. For instance, in one or more exemplary implementations, the one or more symbolic info second instructions i1221, when executed, direct performance of the operation o1221 in the illustrative depiction as follows, and/or the symbolic info second electrical circuitry arrangement e1221, when activated, performs the operation o1221 in the illustrative depiction as follows, and/or the symbolic info second module m1221, when executed and/or activated, directs performance of and/or performs the operation o1221 in the illustrative depiction as follows, and/or the operation o1221 is otherwise carried out in the illustrative depiction as follows: electronically storing (e.g. stored from 10-key entry, etc.) symbolic information (e.g. hologram, etc.) the recorded as being correlated with (e.g. through search terms, etc.) said test information (e.g. testing for banned pesticide presence, etc.) and as being correlated with (e.g. through a query table, etc.) one or more tags, (e.g. compass, etc.) said one or more tags recorded as being (e.g. recorded as video MPEG file, etc.) at least temporarily (e.g. time since introduction of oxygen absorber, etc.) in vicinity of (e.g. riveted to container, etc.) one or more second farming related items (e.g. range area, etc.) involved in farming related creation of (e.g. oat harvesting, etc.) one or more second biologically based substances (e.g. lamb meat, etc.) through at least in part one or more electronically implemented keyword associations (e.g. through one or more keyword databases, etc.).

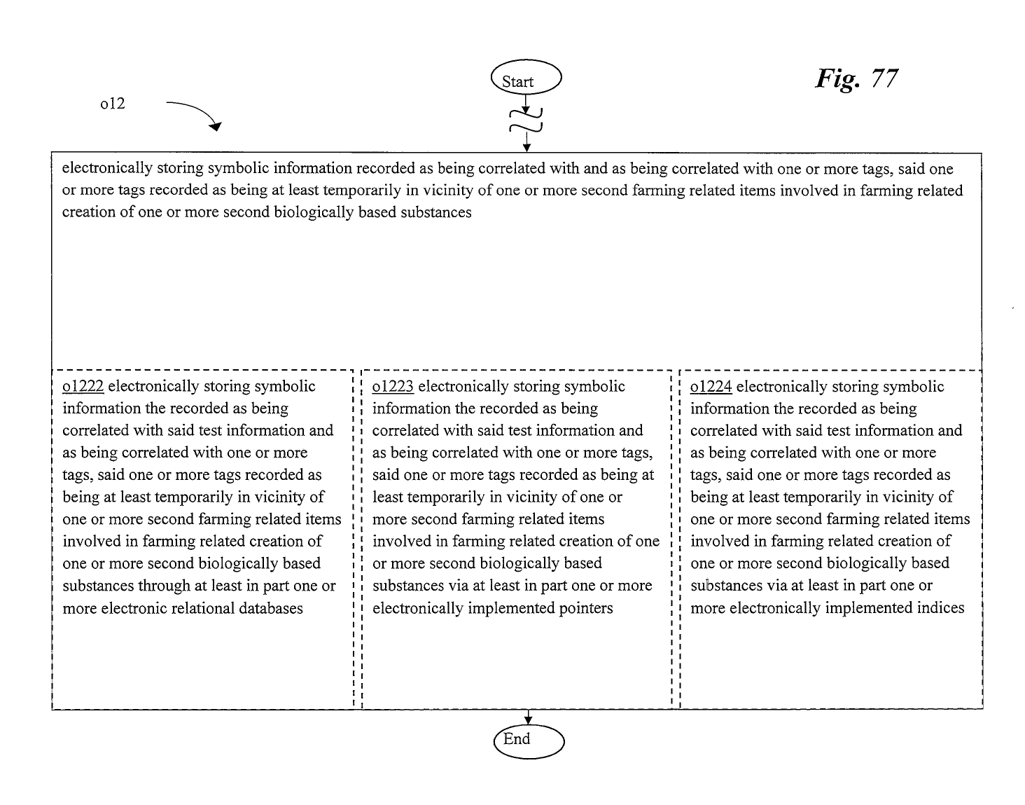

In one or more implementations, as shown in FIG. 77, operation o12 includes an operation o1222 for electronically storing symbolic information the recorded as being correlated with said test information and as being correlated with one or more tags, said one or more tags recorded as being at least temporarily in vicinity of one or more second farming related items involved in farming related creation of one or more second biologically based substances through at least in part one or more electronic relational databases. Origination of an illustratively derived symbolic info relational component group can be accomplished through skilled in the art design choice selection of one or more of the above depicted components from one or more of the above depicted subsystems shown in FIG. 12. Components from the symbolic info relational component group can be used in implementing execution of the one or more symbolic info relational instructions i1222 of FIG. 34, can be used in performance of the symbolic info relational electrical circuitry arrangement e1222 of FIG. 27, and/or can be used in otherwise fulfillment of the operation o1222. An exemplary non-transitory signal bearing medium version of the information storage subsystem s200 is depicted in FIG. 34 as bearing the one or more symbolic info relational instructions i1222 that when executed will direct performance of the operation o1222. Furthermore, the symbolic info relational electrical circuitry arrangement (“elec circ arrange”) e1222, when activated, will perform the operation o1222. Also, the symbolic info relational module m1222, when executed and/or activated, will direct performance of and/or perform the operation o1222. For instance, in one or more exemplary implementations, the one or more symbolic info relational instructions i1222, when executed, direct performance of the operation o1222 in the illustrative depiction as follows, and/or the symbolic info relational electrical circuitry arrangement e1222, when activated, performs the operation o1222 in the illustrative depiction as follows, and/or the symbolic info relational module m1222, when executed and/or activated, directs performance of and/or performs the operation o1222 in the illustrative depiction as follows, and/or the operation o1222 is otherwise carried out in the illustrative depiction as follows: electronically storing (e.g. stored from USB port communication, etc.) symbolic information (e.g. document discriminator, etc.) the recorded as being correlated with (e.g. through common attributes found in data set, etc.) said test information (e.g. testing for natural insect predator population, etc.) and as being correlated with (e.g. through a reverse index, etc.) one or more tags, (e.g. cylindrical, etc.) said one or more tags recorded as being (e.g. recorded as audio WAV file, etc.) at least temporarily (e.g. shipping time on truck from distribution center to market, etc.) in vicinity of (e.g. enveloping material, etc.) one or more second farming related items (e.g. local regulations, etc.) involved in farming related creation of (e.g. carrot growing, etc.) one or more second biologically based substances (e.g. corn, etc.) through at least in part one or more electronic relational databases (e.g. through one or more relational servers, etc.).

In one or more implementations, as shown in FIG. 77, operation o12 includes an operation o1223 for electronically storing symbolic information the recorded as being correlated with said test information and as being correlated with one or more tags, said one or more tags recorded as being at least temporarily in vicinity of one or more second farming related items involved in farming related creation of one or more second biologically based substances via at least in part one or more electronically implemented pointers. Origination of an illustratively derived symbolic info pointers component group can be accomplished through skilled in the art design choice selection of one or more of the above depicted components from one or more of the above depicted subsystems shown in FIG. 12. Components from the symbolic info pointers component group can be used in implementing execution of the one or more symbolic info pointers instructions i1223 of FIG. 34, can be used in performance of the symbolic info pointers electrical circuitry arrangement e1223 of FIG. 27, and/or can be used in otherwise fulfillment of the operation o1223. An exemplary non-transitory signal bearing medium version of the information storage subsystem s200 is depicted in FIG. 34 as bearing the one or more symbolic info pointers instructions i1223 that when executed will direct performance of the operation o1223. Furthermore, the symbolic info pointers electrical circuitry arrangement (“elec circ arrange”) e1223, when activated, will perform the operation o1223. Also, the symbolic info pointers module m1223, when executed and/or activated, will direct performance of and/or perform the operation o1223. For instance, in one or more exemplary implementations, the one or more symbolic info pointers instructions i1223, when executed, direct performance of the operation o1223 in the illustrative depiction as follows, and/or the symbolic info pointers electrical circuitry arrangement e1223, when activated, performs the operation o1223 in the illustrative depiction as follows, and/or the symbolic info pointers module m1223, when executed and/or activated, directs performance of and/or performs the operation o1223 in the illustrative depiction as follows, and/or the operation o1223 is otherwise carried out in the illustrative depiction as follows: electronically storing (e.g. stored from FTP server, etc.) symbolic information (e.g. text, etc.) the recorded as being correlated with (e.g. through database pointers, etc.) said test information (e.g. monitoring crop growth over time span, etc.) and as being correlated with (e.g. through index concurrency control, etc.) one or more tags, (e.g. magnetic field sensor, etc.) said one or more tags recorded as being (e.g. recorded on SD flash memory, etc.) at least temporarily (e.g. time spent unpackaged in home environment, etc.) in vicinity of (e.g. placed inside container, etc.) one or more second farming related items (e.g. duration of pollination, etc.) involved in farming related creation of (e.g. lentil cultivation, etc.) one or more second biologically based substances (e.g. catfish, etc.) via at least in part one or more electronically implemented pointers (e.g. through one or more database pointers, etc.).

In one or more implementations, as shown in FIG. 77, operation o12 includes an operation o1224 for electronically storing symbolic information the recorded as being correlated with said test information and as being correlated with one or more tags, said one or more tags recorded as being at least temporarily in vicinity of one or more second farming related items involved in farming related creation of one or more second biologically based substances via at least in part one or more electronically implemented indices. Origination of an illustratively derived symbolic info indices component group can be accomplished through skilled in the art design choice selection of one or more of the above depicted components from one or more of the above depicted subsystems shown in FIG. 12. Components from the symbolic info indices component group can be used in implementing execution of the one or more symbolic info indices instructions i1224 of FIG. 34, can be used in performance of the symbolic info indices electrical circuitry arrangement e1224 of FIG. 27, and/or can be used in otherwise fulfillment of the operation o1224. An exemplary non-transitory signal bearing medium version of the information storage subsystem s200 is depicted in FIG. 34 as bearing the one or more symbolic info indices instructions i1224 that when executed will direct performance of the operation o1224. Furthermore, the symbolic info indices electrical circuitry arrangement (“elec circ arrange”) e1224, when activated, will perform the operation o1224. Also, the symbolic info indices module m1224, when executed and/or activated, will direct performance of and/or perform the operation o1224. For instance, in one or more exemplary implementations, the one or more symbolic info indices instructions i1224, when executed, direct performance of the operation o1224 in the illustrative depiction as follows, and/or the symbolic info indices electrical circuitry arrangement e1224, when activated, performs the operation o1224 in the illustrative depiction as follows, and/or the symbolic info indices module m1224, when executed and/or activated, directs performance of and/or performs the operation o1224 in the illustrative depiction as follows, and/or the operation o1224 is otherwise carried out in the illustrative depiction as follows: electronically storing (e.g. stored from HTTP communication, etc.) symbolic information (e.g. number, etc.) the recorded as being correlated with (e.g. through database index, etc.) said test information (e.g. monitoring threshing speed of wheat, etc.) and as being correlated with (e.g. through index locking, etc.) one or more tags, (e.g. low frequency RFID, etc.) said one or more tags recorded as being (e.g. recorded on SMTP server, etc.) at least temporarily (e.g. time spent on conveyor belt in factory, etc.) in vicinity of (e.g. affixed to outer layer of carton, etc.) one or more second farming related items (e.g. range schedule, etc.) involved in farming related creation of (e.g. rice threshing, etc.) one or more second biologically based substances (e.g. edible frog, etc.) via at least in part one or more electronically implemented indices (e.g. through one or more database indices, etc.).

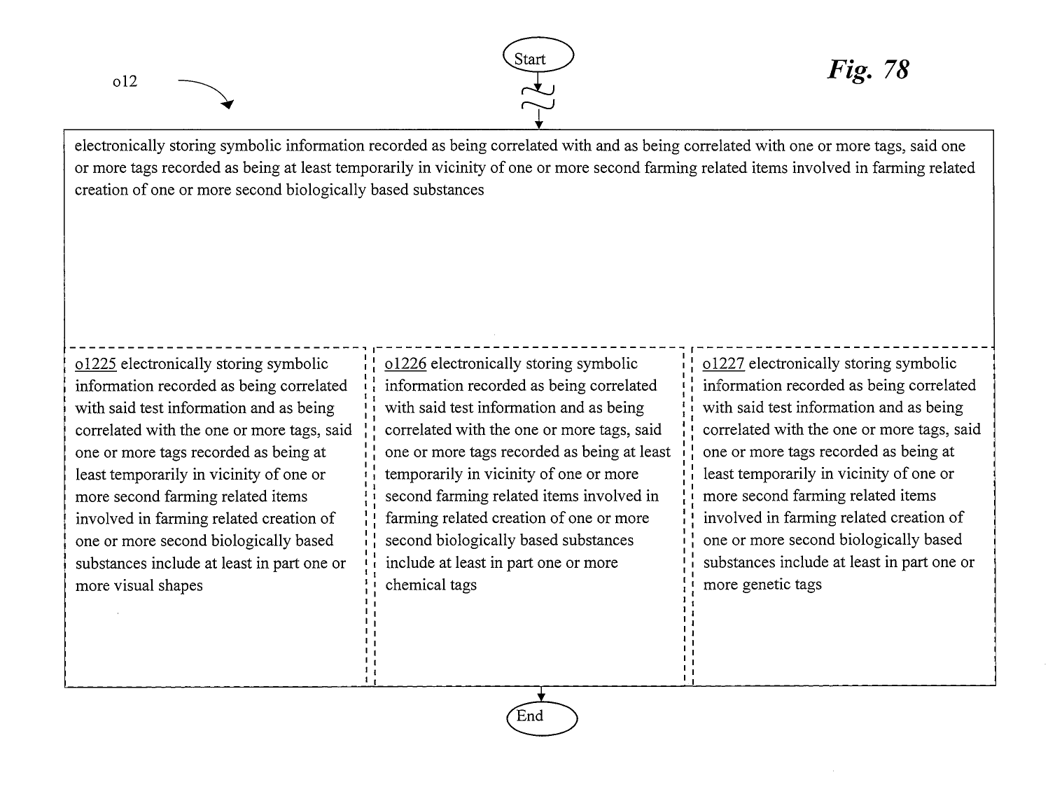

In one or more implementations, as shown in FIG. 78, operation o12 includes an operation o1225 for electronically storing symbolic information recorded as being correlated with said test information and as being correlated with the one or more tags, said one or more tags recorded as being at least temporarily in vicinity of one or more second farming related items involved in farming related creation of one or more second biologically based substances include at least in part one or more visual shapes. Origination of an illustratively derived symbolic info visual component group can be accomplished through skilled in the art design choice selection of one or more of the above depicted components from one or more of the above depicted subsystems shown in FIG. 12. Components from the symbolic info visual component group can be used in implementing execution of the one or more symbolic info visual instructions i1225 of FIG. 34, can be used in performance of the symbolic info visual electrical circuitry arrangement e1225 of FIG. 27, and/or can be used in otherwise fulfillment of the operation o1225. An exemplary non-transitory signal bearing medium version of the information storage subsystem s200 is depicted in FIG. 34 as bearing the one or more symbolic info visual instructions i1225 that when executed will direct performance of the operation o1225. Furthermore, the symbolic info visual electrical circuitry arrangement (“elec circ arrange”) e1225, when activated, will perform the operation o1225. Also, the symbolic info visual module m1225, when executed and/or activated, will direct performance of and/or perform the operation o1225. For instance, in one or more exemplary implementations, the one or more symbolic info visual instructions i1225, when executed, direct performance of the operation o1225 in the illustrative depiction as follows, and/or the symbolic info visual electrical circuitry arrangement e1225, when activated, performs the operation o1225 in the illustrative depiction as follows, and/or the symbolic info visual module m1225, when executed and/or activated, directs performance of and/or performs the operation o1225 in the illustrative depiction as follows, and/or the operation o1225 is otherwise carried out in the illustrative depiction as follows: electronically storing (e.g. stored from wifi transmission, etc.) symbolic information (e.g. bokode, etc.) recorded as being correlated with (e.g. through a sparse index, etc.) said test information (e.g. testing for fungicide levels, etc.) and as being correlated with (e.g. through standardization of index, etc.) the one or more tags, (e.g. spherical, etc.) said one or more tags recorded as being (e.g. recorded on compact flash drive, etc.) at least temporarily (e.g. shipping time from vessel to factory, etc.) in vicinity of (e.g. debossed on container, etc.) one or more second farming related items (e.g. efficiency of tilling, etc.) involved in farming related creation of (e.g. apple harvesting, etc.) one or more second biologically based substances (e.g. domestic goose, etc.) include at least in part one or more visual shapes (e.g. outline profiles for image recognition, etc.).

In one or more implementations, as shown in FIG. 78, operation o12 includes an operation o1226 for electronically storing symbolic information recorded as being correlated with said test information and as being correlated with the one or more tags, said one or more tags recorded as being at least temporarily in vicinity of one or more second farming related items involved in farming related creation of one or more second biologically based substances include at least in part one or more chemical tags. Origination of an illustratively derived symbolic info chemical component group can be accomplished through skilled in the art design choice selection of one or more of the above depicted components from one or more of the above depicted subsystems shown in FIG. 12. Components from the symbolic info chemical component group can be used in implementing execution of the one or more symbolic info chemical instructions i1226 of FIG. 34, can be used in performance of the symbolic info chemical electrical circuitry arrangement e1226 of FIG. 27, and/or can be used in otherwise fulfillment of the operation o1226. An exemplary non-transitory signal bearing medium version of the information storage subsystem s200 is depicted in FIG. 34 as bearing the one or more symbolic info chemical instructions i1226 that when executed will direct performance of the operation o1226. Furthermore, the symbolic info chemical electrical circuitry arrangement (“elec circ arrange”) e1226, when activated, will perform the operation o1226. Also, the symbolic info chemical module m1226, when executed and/or activated, will direct performance of and/or perform the operation o1226. For instance, in one or more exemplary implementations, the one or more symbolic info chemical instructions i1226, when executed, direct performance of the operation o1226 in the illustrative depiction as follows, and/or the symbolic info chemical electrical circuitry arrangement e1226, when activated, performs the operation o1226 in the illustrative depiction as follows, and/or the symbolic info chemical module m1226, when executed and/or activated, directs performance of and/or performs the operation o1226 in the illustrative depiction as follows, and/or the operation o1226 is otherwise carried out in the illustrative depiction as follows: electronically storing (e.g. stored from laptop entry, etc.) symbolic information (e.g. GS1 databar, etc.) recorded as being correlated with (e.g. through a dense index, etc.) said test information (e.g. monitoring worker health trend, etc.) and as being correlated with (e.g. through data structure, etc.) the one or more tags, (e.g. carbon-14 tracker, etc.) said one or more tags recorded as being (e.g. recorded as 256-bti AES encrypted data, etc.) at least temporarily (e.g. portion of time spent packaged with similar material, etc.) in vicinity of (e.g. adhered to material, etc.) one or more second farming related items (e.g. corral dimensions, etc.) involved in farming related creation of (e.g. pear harvesting, etc.) one or more second biologically based substances (e.g. sturgeon eggs, etc.) include at least in part one or more chemical tags (e.g. aromatic chemical tags, etc.).

In one or more implementations, as shown in FIG. 78, operation o12 includes an operation o1227 for electronically storing symbolic information recorded as being correlated with said test information and as being correlated with the one or more tags, said one or more tags recorded as being at least temporarily in vicinity of one or more second farming related items involved in farming related creation of one or more second biologically based substances include at least in part one or more genetic tags. Origination of an illustratively derived symbolic info genetic component group can be accomplished through skilled in the art design choice selection of one or more of the above depicted components from one or more of the above depicted subsystems shown in FIG. 12. Components from the symbolic info genetic component group can be used in implementing execution of the one or more symbolic info genetic instructions i1227 of FIG. 34, can be used in performance of the symbolic info genetic electrical circuitry arrangement e1227 of FIG. 27, and/or can be used in otherwise fulfillment of the operation o1227. An exemplary non-transitory signal bearing medium version of the information storage subsystem s200 is depicted in FIG. 34 as bearing the one or more symbolic info genetic instructions i1227 that when executed will direct performance of the operation o1227. Furthermore, the symbolic info genetic electrical circuitry arrangement (“elec circ arrange”) e1227, when activated, will perform the operation o1227. Also, the symbolic info genetic module m1227, when executed and/or activated, will direct performance of and/or perform the operation o1227. For instance, in one or more exemplary implementations, the one or more symbolic info genetic instructions i1227, when executed, direct performance of the operation o1227 in the illustrative depiction as follows, and/or the symbolic info genetic electrical circuitry arrangement e1227, when activated, performs the operation o1227 in the illustrative depiction as follows, and/or the symbolic info genetic module m1227, when executed and/or activated, directs performance of and/or performs the operation o1227 in the illustrative depiction as follows, and/or the operation o1227 is otherwise carried out in the illustrative depiction as follows: electronically storing (e.g. stored from UPC scan, etc.) symbolic information (e.g. article number, etc.) recorded as being correlated with (e.g. through a bitmap index, etc.) said test information (e.g. monitoring improper hand sanitation of workers, etc.) and as being correlated with (e.g. through common search terms, etc.) the one or more tags, (e.g. expressed DNA sequence tag, etc.) said one or more tags recorded as being (e.g. recorded as UPC scan data, etc.) at least temporarily (e.g. portion of time spent on shipping vessel, etc.) in vicinity of (e.g. embossed on container, etc.) one or more second farming related items (e.g. lease duration of equipment, etc.) involved in farming related creation of (e.g. cod fishing, etc.) one or more second biologically based substances (e.g. goat milk, etc.) include at least in part one or more genetic tags (e.g. embedded genetic markers, etc.).

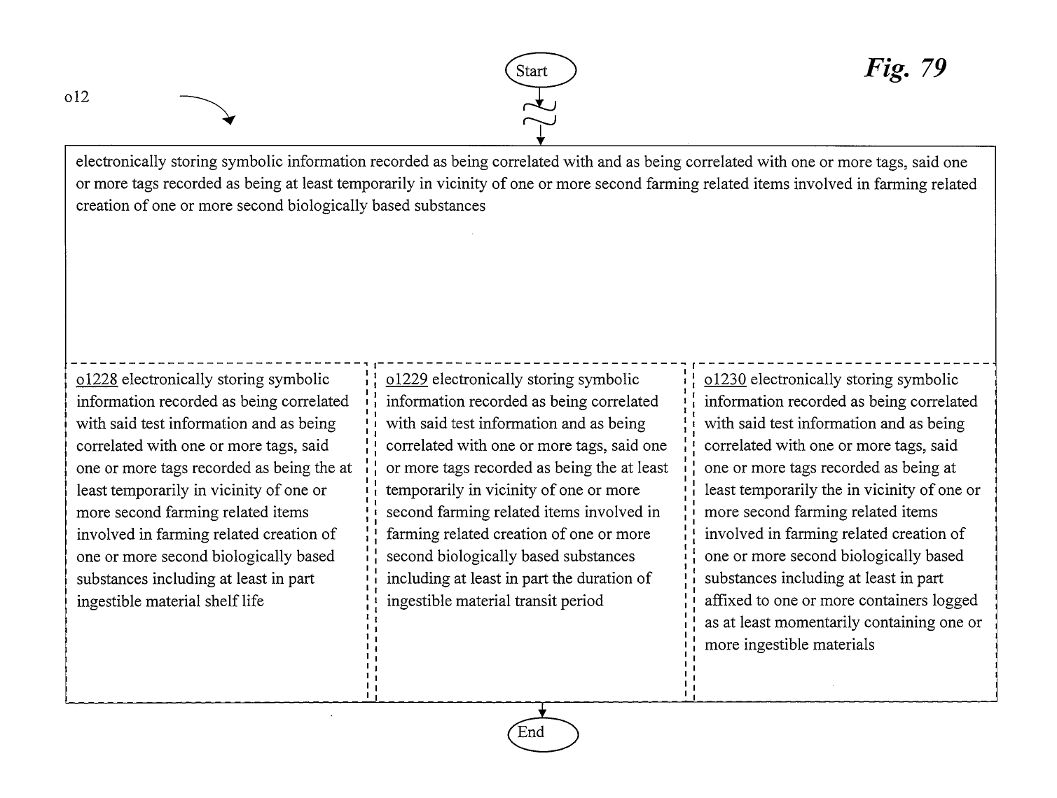

In one or more implementations, as shown in FIG. 79, operation o12 includes an operation o1228 for electronically storing symbolic information recorded as being correlated with said test information and as being correlated with one or more tags, said one or more tags recorded as being the at least temporarily in vicinity of one or more second farming related items involved in farming related creation of one or more second biologically based substances including at least in part ingestible material shelf life. Origination of an illustratively derived symbolic info shelf life component group can be accomplished through skilled in the art design choice selection of one or more of the above depicted components from one or more of the above depicted subsystems shown in FIG. 12. Components from the symbolic info shelf life component group can be used in implementing execution of the one or more symbolic info shelf life instructions i1228 of FIG. 34, can be used in performance of the symbolic info shelf life electrical circuitry arrangement e1228 of FIG. 27, and/or can be used in otherwise fulfillment of the operation o1228. An exemplary non-transitory signal bearing medium version of the information storage subsystem s200 is depicted in FIG. 34 as bearing the one or more symbolic info shelf life instructions i1228 that when executed will direct performance of the operation o1228. Furthermore, the symbolic info shelf life electrical circuitry arrangement (“elec circ arrange”) e1228, when activated, will perform the operation o1228. Also, the symbolic info shelf life module m1228, when executed and/or activated, will direct performance of and/or perform the operation o1228. For instance, in one or more exemplary implementations, the one or more symbolic info shelf life instructions i1228, when executed, direct performance of the operation o1228 in the illustrative depiction as follows, and/or the symbolic info shelf life electrical circuitry arrangement e1228, when activated, performs the operation o1228 in the illustrative depiction as follows, and/or the symbolic info shelf life module m1228, when executed and/or activated, directs performance of and/or performs the operation o1228 in the illustrative depiction as follows, and/or the operation o1228 is otherwise carried out in the illustrative depiction as follows: electronically storing (e.g. stored from UHF reception, etc.) symbolic information (e.g. SPARQCode, etc.) recorded as being correlated with (e.g. through SQL search, etc.) said test information (e.g. monitoring feed consumption of livestock, etc.) and as being correlated with (e.g. through access of ordered records, etc.) one or more tags, (e.g. ultrasonic emitter, etc.) said one or more tags recorded as being (e.g. recorded on FTP server, etc.) the at least temporarily (e.g. time spent in cold storage, etc.) in vicinity of (e.g. stamped onto container, etc.) one or more second farming related items (e.g. quality of feed water, etc.) involved in farming related creation of (e.g. barley harvesting, etc.) one or more second biologically based substances (e.g. feed grain, etc.) including at least in part ingestible material shelf life (e.g. shelf life including that between harvesting and home storage, etc.).

In one or more implementations, as shown in FIG. 79, operation o12 includes an operation o1229 for electronically storing symbolic information recorded as being correlated with said test information and as being correlated with one or more tags, said one or more tags recorded as being the at least temporarily in vicinity of one or more second farming related items involved in farming related creation of one or more second biologically based substances including at least in part the duration of ingestible material transit period. Origination of an illustratively derived symbolic info transit component group can be accomplished through skilled in the art design choice selection of one or more of the above depicted components from one or more of the above depicted subsystems shown in FIG. 12. Components from the symbolic info transit component group can be used in implementing execution of the one or more symbolic info transit instructions i1229 of FIG. 34, can be used in performance of the symbolic info transit electrical circuitry arrangement e1229 of FIG. 27, and/or can be used in otherwise fulfillment of the operation o1229. An exemplary non-transitory signal bearing medium version of the information storage subsystem s200 is depicted in FIG. 34 as bearing the one or more symbolic info transit instructions i1229 that when executed will direct performance of the operation o1229. Furthermore, the symbolic info transit electrical circuitry arrangement (“elec circ arrange”) e1229, when activated, will perform the operation o1229. Also, the symbolic info transit module m1229, when executed and/or activated, will direct performance of and/or perform the operation o1229. For instance, in one or more exemplary implementations, the one or more symbolic info transit instructions i1229, when executed, direct performance of the operation o1229 in the illustrative depiction as follows, and/or the symbolic info transit electrical circuitry arrangement e1229, when activated, performs the operation o1229 in the illustrative depiction as follows, and/or the symbolic info transit module m1229, when executed and/or activated, directs performance of and/or performs the operation o1229 in the illustrative depiction as follows, and/or the operation o1229 is otherwise carried out in the illustrative depiction as follows: electronically storing (e.g. stored from IEEE 802.11 communication, etc.) symbolic information (e.g. matrix code, etc.) recorded as being correlated with (e.g. through a hash table search, etc.) said test information (e.g. testing for proper organ function in animal, etc.) and as being correlated with (e.g. through functions, etc.) one or more tags, (e.g. macromolecule marker, etc.) said one or more tags recorded as being (e.g. recorded as wifi transmission, etc.) the at least temporarily (e.g. time on train between two terminals, etc.) in vicinity of (e.g. bolted to container, etc.) one or more second farming related items (e.g. total cost of harvest, etc.) involved in farming related creation of (e.g. oyster harvesting, etc.) one or more second biologically based substances (e.g. beet pulp, etc.) including at least in part the duration of ingestible material transit period (e.g. including transit period between farm and retail outlet, etc.).

In one or more implementations, as shown in FIG. 79, operation o12 includes an operation o1234 for electronically storing symbolic information recorded as being correlated with said test information and as being correlated with one or more tags, said one or more tags recorded as being at least temporarily in vicinity of the one or more second farming related items involved in farming related creation of one or more second biologically based substances including at least one of other than said one or more first farming related items. Origination of an illustratively derived symbolic info other items component group can be accomplished through skilled in the art design choice selection of one or more of the above depicted components from one or more of the above depicted subsystems shown in FIG. 12. Components from the symbolic info other items component group can be used in implementing execution of the one or more symbolic info other items instructions i1234 of FIG. 34, can be used in performance of the symbolic info other items electrical circuitry arrangement e1234 of FIG. 27, and/or can be used in otherwise fulfillment of the operation o1234. An exemplary non-transitory signal bearing medium version of the information storage subsystem s200 is depicted in FIG. 34 as bearing the one or more symbolic info other items instructions i1234 that when executed will direct performance of the operation o1234. Furthermore, the symbolic info other items electrical circuitry arrangement (“elec circ arrange”) e1234, when activated, will perform the operation o1234. Also, the symbolic info other items module m1234, when executed and/or activated, will direct performance of and/or perform the operation o1234. For instance, in one or more exemplary implementations, the one or more symbolic info other items instructions i1234, when executed, direct performance of the operation o1234 in the illustrative depiction as follows, and/or the symbolic info other items electrical circuitry arrangement e1234, when activated, performs the operation o1234 in the illustrative depiction as follows, and/or the symbolic info other items module m1234, when executed and/or activated, directs performance of and/or performs the operation o1234 in the illustrative depiction as follows, and/or the operation o1234 is otherwise carried out in the illustrative depiction as follows: electronically storing (e.g. stored from acoustic energy reception, etc.) symbolic information (e.g. Morse code, etc.) recorded as being correlated with (e.g. through data structure, etc.) said test information (e.g. testing phosphate levels, etc.) and as being correlated with (e.g. through unique exclusions of data, etc.) one or more tags, (e.g. laser ranging tracker, etc.) said one or more tags recorded as being (e.g. recorded as radio wave communication, etc.) at least temporarily (e.g. time in open air waiting to be packaged, etc.) in vicinity of (e.g. injected into material, etc.) the one or more second farming related items (e.g. livestock slaughter schedule, etc.) involved in farming related creation of (e.g. sheep butchering, etc.) one or more second biologically based substances (e.g. carp, etc.) including at least one of other than said one or more first farming related items (e.g. first farming related items are harvesting machinery and second farming related item is produce to be harvested, etc.).

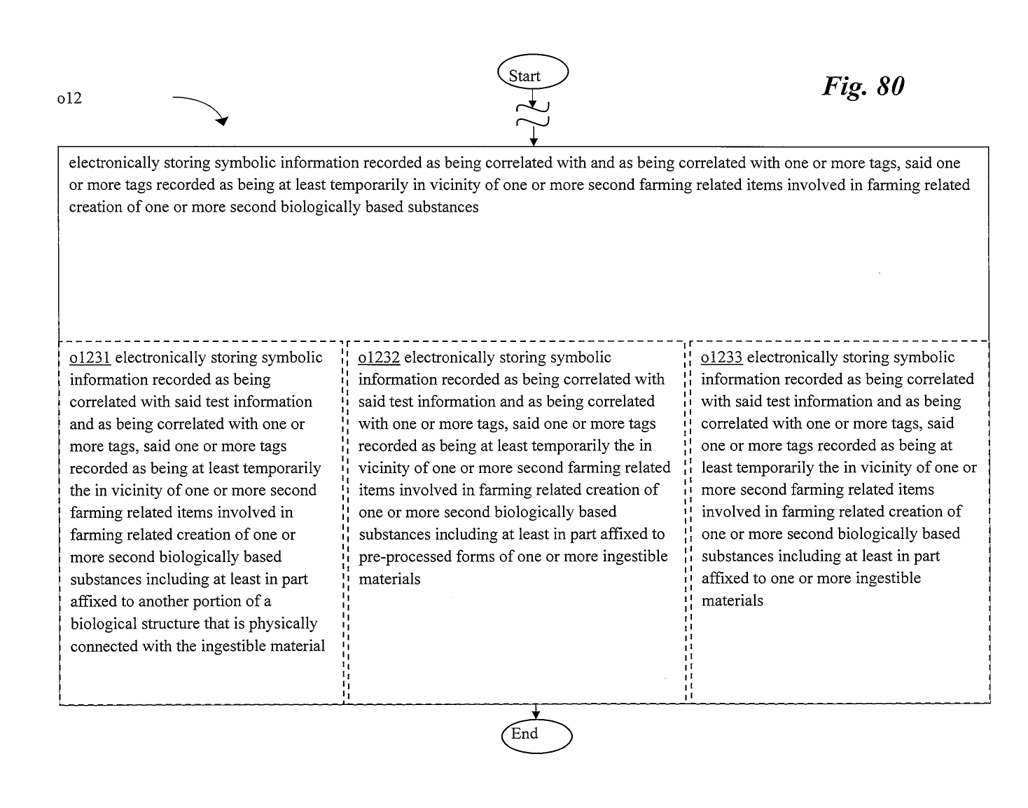

In one or more implementations, as shown in FIG. 80, operation o12 includes an operation o1231 for electronically storing symbolic information recorded as being correlated with said test information and as being correlated with one or more tags, said one or more tags recorded as being at least temporarily the in vicinity of one or more second farming related items involved in farming related creation of one or more second biologically based substances including at least in part affixed to another portion of a biological structure that is physically connected with the ingestible material. Origination of an illustratively derived symbolic info biological component group can be accomplished through skilled in the art design choice selection of one or more of the above depicted components from one or more of the above depicted subsystems shown in FIG. 12. Components from the symbolic info biological component group can be used in implementing execution of the one or more symbolic info biological instructions i1231 of FIG. 34, can be used in performance of the symbolic info biological electrical circuitry arrangement e1231 of FIG. 27, and/or can be used in otherwise fulfillment of the operation o1231. An exemplary non-transitory signal bearing medium version of the information storage subsystem s200 is depicted in FIG. 34 as bearing the one or more symbolic info biological instructions i1231 that when executed will direct performance of the operation o1231. Furthermore, the symbolic info biological electrical circuitry arrangement (“elec circ arrange”) e1231, when activated, will perform the operation o1231. Also, the symbolic info biological module m1231, when executed and/or activated, will direct performance of and/or perform the operation o1231. For instance, in one or more exemplary implementations, the one or more symbolic info biological instructions i1231, when executed, direct performance of the operation o1231 in the illustrative depiction as follows, and/or the symbolic info biological electrical circuitry arrangement e1231, when activated, performs the operation o1231 in the illustrative depiction as follows, and/or the symbolic info biological module m1231, when executed and/or activated, directs performance of and/or performs the operation o1231 in the illustrative depiction as follows, and/or the operation o1231 is otherwise carried out in the illustrative depiction as follows: electronically storing (e.g. stored from bittorent communication, etc.) symbolic information (e.g. security data, etc.) recorded as being correlated with (e.g. through primary key, etc.) said test information (e.g. testing for visual clues in livestock health status, etc.) and as being correlated with (e.g. through sub-linear time lookup, etc.) one or more tags, (e.g. ultrasonic tracker, etc.) said one or more tags recorded as being (e.g. recorded as MP3 file, etc.) at least temporarily (e.g. time spent in cold storage, etc.) the in vicinity of (e.g. subdermally injected into material, etc.) one or more second farming related items (e.g. manure composition, etc.) involved in farming related creation of (e.g. cherry picking, etc.) one or more second biologically based substances (e.g. venison, etc.) including at least in part affixed to another portion of a biological structure that is physically connected with the ingestible material (e.g. including labeling painted on to an eggshell, etc.).

In one or more implementations, as shown in FIG. 80, operation o12 includes an operation o1232 for electronically storing symbolic information recorded as being correlated with said test information and as being correlated with one or more tags, said one or more tags recorded as being at least temporarily the in vicinity of one or more second farming related items involved in farming related creation of one or more second biologically based substances including at least in part affixed to pre-processed forms of one or more ingestible materials. Origination of an illustratively derived symbolic info pre-processed component group can be accomplished through skilled in the art design choice selection of one or more of the above depicted components from one or more of the above depicted subsystems shown in FIG. 12. Components from the symbolic info pre-processed component group can be used in implementing execution of the one or more symbolic info pre-processed instructions i1232 of FIG. 34, can be used in performance of the symbolic info pre-processed electrical circuitry arrangement e1232 of FIG. 27, and/or can be used in otherwise fulfillment of the operation o1232. An exemplary non-transitory signal bearing medium version of the information storage subsystem s200 is depicted in FIG. 34 as bearing the one or more symbolic info pre-processed instructions i1232 that when executed will direct performance of the operation o1232. Furthermore, the symbolic info pre-processed electrical circuitry arrangement (“elec circ arrange”) e1232, when activated, will perform the operation o1232. Also, the symbolic info pre-processed module m1232, when executed and/or activated, will direct performance of and/or perform the operation o1232. For instance, in one or more exemplary implementations, the one or more symbolic info pre-processed instructions i1232, when executed, direct performance of the operation o1232 in the illustrative depiction as follows, and/or the symbolic info pre-processed electrical circuitry arrangement e1232, when activated, performs the operation o1232 in the illustrative depiction as follows, and/or the symbolic info pre-processed module m1232, when executed and/or activated, directs performance of and/or performs the operation o1232 in the illustrative depiction as follows, and/or the operation o1232 is otherwise carried out in the illustrative depiction as follows: electronically storing (e.g. stored from PDA entry, etc.) symbolic information (e.g. phonetic alphabet, etc.) recorded as being correlated with (e.g. through unique exclusions of data, etc.) said test information (e.g. monitoring audible clues in livestock chatter, etc.) and as being correlated with (e.g. through linear search, etc.) one or more tags, (e.g. neuronal tracer, etc.) said one or more tags recorded as being (e.g. recorded as audio on magnetic tape, etc.) at least temporarily (e.g. time spent in processing equipment, etc.) the in vicinity of (e.g. adhered to material, etc.) one or more second farming related items (e.g. animal byproduct inventory, etc.) involved in farming related creation of (e.g. peach picking, etc.) one or more second biologically based substances (e.g. snail, etc.) including at least in part affixed to pre-processed forms of one or more ingestible materials (e.g. including tied to containers of cabbage to be used for sauerkraut, etc.).

In one or more implementations, as shown in FIG. 80, operation o12 includes an operation o1233 for electronically storing symbolic information recorded as being correlated with said test information and as being correlated with one or more tags, said one or more tags recorded as being at least temporarily the in vicinity of one or more second farming related items involved in farming related creation of one or more second biologically based substances including at least in part affixed to one or more ingestible materials. Origination of an illustratively derived symbolic info ingestible component group can be accomplished through skilled in the art design choice selection of one or more of the above depicted components from one or more of the above depicted subsystems shown in FIG. 12. Components from the symbolic info ingestible component group can be used in implementing execution of the one or more symbolic info ingestible instructions i1233 of FIG. 34, can be used in performance of the symbolic info ingestible electrical circuitry arrangement e1233 of FIG. 27, and/or can be used in otherwise fulfillment of the operation o1233. An exemplary non-transitory signal bearing medium version of the information storage subsystem s200 is depicted in FIG. 34 as bearing the one or more symbolic info ingestible instructions i1233 that when executed will direct performance of the operation o1233. Furthermore, the symbolic info ingestible electrical circuitry arrangement (“elec circ arrange”) e1233, when activated, will perform the operation o1233. Also, the symbolic info ingestible module m1233, when executed and/or activated, will direct performance of and/or perform the operation o1233. For instance, in one or more exemplary implementations, the one or more symbolic info ingestible instructions i1233, when executed, direct performance of the operation o1233 in the illustrative depiction as follows, and/or the symbolic info ingestible electrical circuitry arrangement e1233, when activated, performs the operation o1233 in the illustrative depiction as follows, and/or the symbolic info ingestible module m1233, when executed and/or activated, directs performance of and/or performs the operation o1233 in the illustrative depiction as follows, and/or the operation o1233 is otherwise carried out in the illustrative depiction as follows: electronically storing (e.g. stored from desktop computer entry, etc.) symbolic information (e.g. Arabic alphabet, etc.) recorded as being correlated with (e.g. through database constraints, etc.) said test information (e.g. monitoring livestock feeding behavior, etc.) and as being correlated with (e.g. through database constraints, etc.) one or more tags, (e.g. ISM band emitter, etc.) said one or more tags recorded as being (e.g. recorded as video on magnetic tape, etc.) at least temporarily (e.g. time awaiting processing, etc.) the in vicinity of (e.g. ink stamped directly onto material, etc.) one or more second farming related items (e.g. egg storage temperature, etc.) involved in farming related creation of (e.g. duck egg laying, etc.) one or more second biologically based substances (e.g. kangaroo meat, etc.) including at least in part affixed to one or more ingestible materials (e.g. including labeling stuck to an apple, etc.).

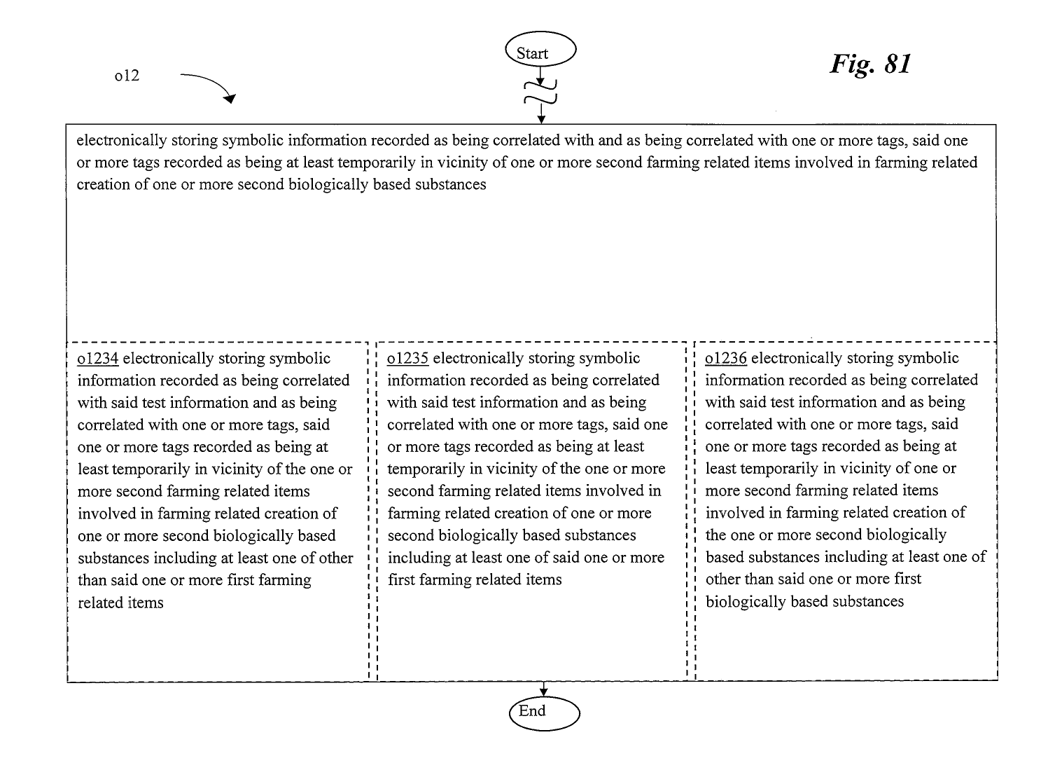

In one or more implementations, as shown in FIG. 81, operation o12 includes an operation o1234 for electronically storing symbolic information recorded as being correlated with said test information and as being correlated with one or more tags, said one or more tags recorded as being at least temporarily in vicinity of the one or more second farming related items involved in farming related creation of one or more second biologically based substances including at least one of other than said one or more first farming related items. Origination of an illustratively derived symbolic info other items component group can be accomplished through skilled in the art design choice selection of one or more of the above depicted components from one or more of the above depicted subsystems shown in FIG. 12. Components from the symbolic info other items component group can be used in implementing execution of the one or more symbolic info other items instructions i1234 of FIG. 34, can be used in performance of the symbolic info other items electrical circuitry arrangement e1234 of FIG. 27, and/or can be used in otherwise fulfillment of the operation o1234. An exemplary non-transitory signal bearing medium version of the information storage subsystem s200 is depicted in FIG. 34 as bearing the one or more symbolic info other items instructions i1234 that when executed will direct performance of the operation o1234. Furthermore, the symbolic info other items electrical circuitry arrangement (“elec circ arrange”) e1234, when activated, will perform the operation o1234. Also, the symbolic info other items module m1234, when executed and/or activated, will direct performance of and/or perform the operation o1234. For instance, in one or more exemplary implementations, the one or more symbolic info other items instructions i1234, when executed, direct performance of the operation o1234 in the illustrative depiction as follows, and/or the symbolic info other items electrical circuitry arrangement e1234, when activated, performs the operation o1234 in the illustrative depiction as follows, and/or the symbolic info other items module m1234, when executed and/or activated, directs performance of and/or performs the operation o1234 in the illustrative depiction as follows, and/or the operation o1234 is otherwise carried out in the illustrative depiction as follows: electronically storing (e.g. stored from acoustic energy reception, etc.) symbolic information (e.g. Morse code, etc.) recorded as being correlated with (e.g. through data structure, etc.) said test information (e.g. testing phosphate levels, etc.) and as being correlated with (e.g. through unique exclusions of data, etc.) one or more tags, (e.g. laser ranging tracker, etc.) said one or more tags recorded as being (e.g. recorded as radio wave communication, etc.) at least temporarily (e.g. time in open air waiting to be packaged, etc.) in vicinity of (e.g. injected into material, etc.) the one or more second farming related items (e.g. livestock slaughter schedule, etc.) involved in farming related creation of (e.g. sheep butchering, etc.) one or more second biologically based substances (e.g. carp, etc.) including at least one of other than said one or more first farming related items (e.g. first farming related items are harvesting machinery and second farming related item is produce to be harvested, etc.).

In one or more implementations, as shown in FIG. 81, operation o12 includes an operation o1235 for electronically storing symbolic information recorded as being correlated with said test information and as being correlated with one or more tags, said one or more tags recorded as being at least temporarily in vicinity of the one or more second farming related items involved in farming related creation of one or more second biologically based substances including at least one of said one or more first farming related items. Origination of an illustratively derived symbolic info said items component group can be accomplished through skilled in the art design choice selection of one or more of the above depicted components from one or more of the above depicted subsystems shown in FIG. 12. Components from the symbolic info said items component group can be used in implementing execution of the one or more symbolic info said items instructions i1235 of FIG. 34, can be used in performance of the symbolic info said items electrical circuitry arrangement e1235 of FIG. 27, and/or can be used in otherwise fulfillment of the operation o1235. An exemplary non-transitory signal bearing medium version of the information storage subsystem s200 is depicted in FIG. 34 as bearing the one or more symbolic info said items instructions i1235 that when executed will direct performance of the operation o1235. Furthermore, the symbolic info said items electrical circuitry arrangement (“elec circ arrange”) e1235, when activated, will perform the operation o1235. Also, the symbolic info said items module m1235, when executed and/or activated, will direct performance of and/or perform the operation o1235. For instance, in one or more exemplary implementations, the one or more symbolic info said items instructions i1235, when executed, direct performance of the operation o1235 in the illustrative depiction as follows, and/or the symbolic info said items electrical circuitry arrangement e1235, when activated, performs the operation o1235 in the illustrative depiction as follows, and/or the symbolic info said items module m1235, when executed and/or activated, directs performance of and/or performs the operation o1235 in the illustrative depiction as follows, and/or the operation o1235 is otherwise carried out in the illustrative depiction as follows: electronically storing (e.g. stored from VHF reception, etc.) symbolic information (e.g. binary sequence, etc.) recorded as being correlated with (e.g. through access of ordered records, etc.) said test information (e.g. testing irrigation water for pathogens, etc.) and as being correlated with (e.g. through primary key, etc.) one or more tags, (e.g. accelerometer, etc.) said one or more tags recorded as being (e.g. recorded as radio wave reception, etc.) at least temporarily (e.g. time spent on conveyor belt in factory, etc.) in vicinity of (e.g. magnetically attached to container, etc.) the one or more second farming related items (e.g. livestock breeding schedule, etc.) involved in farming related creation of (e.g. clam digging, etc.) one or more second biologically based substances (e.g. oyster shell, etc.) including at least one of said one or more first farming related items (e.g. first farming related items include one or more pesticides and insecticides, etc.).

In one or more implementations, as shown in FIG. 81, operation o12 includes an operation o1236 for electronically storing symbolic information recorded as being correlated with said test information and as being correlated with one or more tags, said one or more tags recorded as being at least temporarily in vicinity of one or more second farming related items involved in farming related creation of the one or more second biologically based substances including at least one of other than said one or more first biologically based substances. Origination of an illustratively derived symbolic info other substances component group can be accomplished through skilled in the art design choice selection of one or more of the above depicted components from one or more of the above depicted subsystems shown in FIG. 12. Components from the symbolic info other substances component group can be used in implementing execution of the one or more symbolic info other substances instructions i1236 of FIG. 34, can be used in performance of the symbolic info other substances electrical circuitry arrangement e1236 of FIG. 27, and/or can be used in otherwise fulfillment of the operation o1236. An exemplary non-transitory signal bearing medium version of the information storage subsystem s200 is depicted in FIG. 34 as bearing the one or more symbolic info other substances instructions i1236 that when executed will direct performance of the operation o1236. Furthermore, the symbolic info other substances electrical circuitry arrangement (“elec circ arrange”) e1236, when activated, will perform the operation o1236. Also, the symbolic info other substances module m1236, when executed and/or activated, will direct performance of and/or perform the operation o1236. For instance, in one or more exemplary implementations, the one or more symbolic info other substances instructions i1236, when executed, direct performance of the operation o1236 in the illustrative depiction as follows, and/or the symbolic info other substances electrical circuitry arrangement e1236, when activated, performs the operation o1236 in the illustrative depiction as follows, and/or the symbolic info other substances module m1236, when executed and/or activated, directs performance of and/or performs the operation o1236 in the illustrative depiction as follows, and/or the operation o1236 is otherwise carried out in the illustrative depiction as follows: electronically storing (e.g. stored from GPRS data service, etc.) symbolic information (e.g. hologram, etc.) recorded as being correlated with (e.g. through expressions, etc.) said test information (e.g. monitoring quarantined livestock symptoms, etc.) and as being correlated with (e.g. through foreign key search, etc.) one or more tags, (e.g. cubical, etc.) said one or more tags recorded as being (e.g. recorded as file on compact flash card, etc.) at least temporarily (e.g. time held in port for inspection period, etc.) in vicinity of (e.g. stapled to container, etc.) one or more second farming related items (e.g. livestock fertility, etc.) involved in farming related creation of (e.g. pear picking, etc.) the one or more second biologically based substances (e.g. sheep cheese, etc.) including at least one of other than said one or more first biologically based substances (e.g. including first biologically based substances being citrus based and other substances being grain based, etc.).

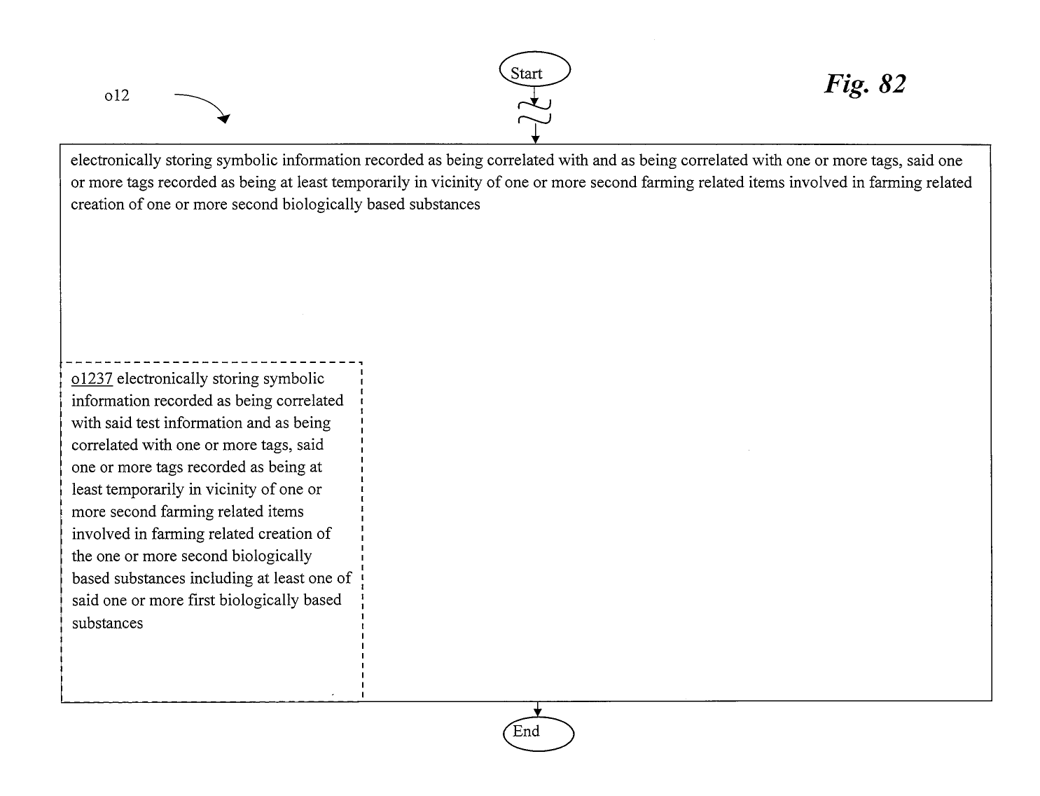

In one or more implementations, as shown in FIG. 82, operation o12 includes an operation o1237 for electronically storing symbolic information recorded as being correlated with said test information and as being correlated with one or more tags, said one or more tags recorded as being at least temporarily in vicinity of one or more second farming related items involved in farming related creation of the one or more second biologically based substances including at least one of said one or more first biologically based substances. Origination of an illustratively derived symbolic info said substances component group can be accomplished through skilled in the art design choice selection of one or more of the above depicted components from one or more of the above depicted subsystems shown in FIG. 12. Components from the symbolic info said substances component group can be used in implementing execution of the one or more symbolic info said substances instructions i1237 of FIG. 34, can be used in performance of the symbolic info said substances electrical circuitry arrangement e1237 of FIG. 27, and/or can be used in otherwise fulfillment of the operation o1237. An exemplary non-transitory signal bearing medium version of the information storage subsystem s200 is depicted in FIG. 34 as bearing the one or more symbolic info said substances instructions i1237 that when executed will direct performance of the operation o1237. Furthermore, the symbolic info said substances electrical circuitry arrangement (“elec circ arrange”) e1237, when activated, will perform the operation o1237. Also, the symbolic info said substances module m1237, when executed and/or activated, will direct performance of and/or perform the operation o1237. For instance, in one or more exemplary implementations, the one or more symbolic info said substances instructions i1237, when executed, direct performance of the operation o1237 in the illustrative depiction as follows, and/or the symbolic info said substances electrical circuitry arrangement e1237, when activated, performs the operation o1237 in the illustrative depiction as follows, and/or the symbolic info said substances module m1237, when executed and/or activated, directs performance of and/or performs the operation o1237 in the illustrative depiction as follows, and/or the operation o1237 is otherwise carried out in the illustrative depiction as follows: electronically storing (e.g. stored from 256-bit AES encrypted data, etc.) symbolic information (e.g. color code, etc.) recorded as being correlated with (e.g. through functions, etc.) said test information (e.g. testing fruit tree fertility, etc.) and as being correlated with (e.g. through a hash table search, etc.) one or more tags, (e.g. high capacity color barcode, etc.) said one or more tags recorded as being (e.g. recorded as file on hard drive, etc.) at least temporarily (e.g. time in holding bay, etc.) in vicinity of (e.g. laser etched onto container, etc.) one or more second farming related items (e.g. banned pesticides, etc.) involved in farming related creation of (e.g. peanut harvesting, etc.) the one or more second biologically based substances (e.g. shrimp, etc.) including at least one of said one or more first biologically based substances (e.g. including one or more livestock, etc.).

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The one or more instructions discussed herein may be, for example, computer executable and/or logic-implemented instructions. In some implementations, signal-bearing medium as articles of manufacture may store the one or more instructions. In some implementations, the signal bearing medium may include a computer-readable medium. In some implementations, the signal-bearing medium may include a recordable medium. In some implementations, the signal-bearing medium may include a communication medium.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, (e.g., transmitter, receiver, transmission logic, reception logic, etc.), etc.).

### Electro-Mechanical System Support

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

### Electrical Circuitry Support

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

### Image Processing System Support

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

### Data Processing System Support

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

### Software as Patentable Subject Matter Support

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

### Mote System Support

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

### Licensing System Support Language

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

### Extraterritorial Use Language

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

### Residual Incorporation Language

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

### Not Limited to Implementations Described Language

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

### Not Limited to Human User Language

Although user XXX is shown/described herein as a single illustrated figure, those skilled in the art will appreciate that user XXX may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

### Plural Terms Language

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

### Operably-Coupled Language

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

### Active/Inactive Component Language

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

### Cloud Computing Standard Language

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scalable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

### Use of Trademarks in Specification Language

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

### Caselaw-Driven Clarification Language

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. A computationally-implemented method comprising:
electronically storing farming related test information generated through testing of one or more test samples of one or more first farming related items involved in farming related creation of one or more first biologically based substances; and
electronically storing symbolic information recorded as being correlated with and as being correlated with one or more tags, said one or more tags recorded as being at least temporarily in vicinity of one or more second farming related items involved in farming related creation of one or more second biologically based substances.

2. The computationally-implemented method of claim 1, wherein the electronically storing farming related test information generated through testing of one or more test samples of one or more first farming related items involved in farming related creation of one or more first biologically based substances comprises:
the electronically storing farming related test information generated through testing of one or more test samples of one or more first farming related items involved in farming related creation of one or more first biologically based substances as at least in part one or more e-mail records.

3. (canceled)

4. The computationally-implemented method of claim 1, wherein the electronically storing farming related test information generated through testing of one or more test samples of one or more first farming related items involved in farming related creation of one or more first biologically based substances comprises:
the electronically storing farming related test information generated through testing of one or more test samples of one or more first farming related items involved in farming related creation of one or more first biologically based substances through at least in part memory card access.

5. (canceled)

6. The computationally-implemented method of claim 1, wherein the electronically storing farming related test information generated through testing of one or more test samples of one or more first farming related items involved in farming related creation of one or more first biologically based substances comprises:
the electronically storing farming related test information generated through testing of one or more test samples of one or more first farming related items involved in farming related creation of one or more first biologically based substances at least in part from cell phone communication.

7. (canceled)

8. The computationally-implemented method of claim 1, wherein the electronically storing farming related test information generated through testing of one or more test samples of one or more first farming related items involved in farming related creation of one or more first biologically based substances comprises:
the electronically storing farming related test information generated through testing of one or more test samples of one or more first farming related items involved in farming related creation of one or more first biologically based substances in least in part as bar code data via one or more scanning actions.

9. (canceled)

10. The computationally-implemented method of claim 1, wherein the electronically storing farming related test information generated through testing of one or more test samples of one or more first farming related items involved in farming related creation of one or more first biologically based substances comprises:
the electronically storing farming related test information generated through testing of one or more test samples of one or more first farming related items involved in farming related creation of one or more first biologically based substances resulting of at least in part one or more radio frequency identification (RFID) response signals.

11. (canceled)

12. The computationally-implemented method of claim 1, wherein the electronically storing farming related test information generated through testing of one or more test samples of one or more first farming related items involved in farming related creation of one or more first biologically based substances comprises:
the electronically storing farming related test information generated through testing of one or more test samples of one or more first farming related items involved in farming related creation of one or more first biologically based substances subsequent to least in part involved with one or more wireless transmissions.

13. (canceled)

14. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part including test information related to climate effects on one or more farming related items.

15. (canceled)

16. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part including test information regarding chemicals involved with one or more farming related items.

17. (canceled)

18. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part including test information regarding misuse of one or more farming related items.

19. (canceled)

20. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part including chemical test information regarding use of one or more farming related items.

21. (canceled)

22. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part including test information regarding forbidden farming related item use involved with farming related creation of biologically based substances.

23. (canceled)

24. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part including information regarding one or more events occurring in one or more portions of one or more agricultural fields.

25. (canceled)

26. The computationally-implemented method of claim 1, wherein the electronically storing farming related test information generated through testing of one or more test samples of one or more first farming related items involved in farming related creation of one or more first biologically based substances comprises:
electronically storing the farming related test information the generated through testing of one or more test samples of one or more first farming related items involved in farming related creation of one or more first biologically based substances at least in part including chemical test information regarding farming related items.

27. (canceled)

28. The computationally-implemented method of claim 1, wherein the electronically storing farming related test information generated through testing of one or more test samples of one or more first farming related items involved in farming related creation of one or more first biologically based substances comprises:
electronically storing the farming related test information the generated through testing of one or more test samples of one or more first farming related items involved in farming related creation of one or more first biologically based substances at least in part including test information regarding health status of one or more biological creatures.

29. (canceled)

30. The computationally-implemented method of claim 1, wherein the electronically storing farming related test information generated through testing of one or more test samples of one or more first farming related items involved in farming related creation of one or more first biologically based substances comprises:
electronically storing the farming related test information the generated through testing of one or more test samples of one or more first farming related items involved in farming related creation of one or more first biologically based substances at least in part including test information with respect to forbidden human behavior as associated with one or more standards as logged.

31. (canceled)

32. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part including test information regarding human observation.

33. (canceled)

34. The computationally-implemented method of claim 1, wherein the electronically storing farming related test information generated through testing of one or more test samples of one or more first farming related items involved in farming related creation of one or more first biologically based substances comprises:
electronically storing the farming related test information generated through testing of one or more test samples of one or more first farming related items involved in farming related creation of one or more first biologically based substances at least in part as video content test information.

35. (canceled)

36. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding genetics factors.

37. (canceled)

38. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding one or more weed aspects.

39. (canceled)

40. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding soil.

41. (canceled)

42. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding weather related items.

43. (canceled)

44. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding production support of farming related items.

45. (canceled)

46. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples of harvesting related items.

47. (canceled)

48. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding one or more animal byproducts.

49. (canceled)

50. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding plant diversity.

51. (canceled)

52. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of the one or more test samples of one or more first farming related items involved in farming related creation of one or more first biologically based substances including at least in part one or more test samples regarding pesticide use.

53. (canceled)

54. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more plant raising related activities.

55. (canceled)

56. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more diary related activities.

57. (canceled)

58. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more slaughtering related activities.

59. (canceled)

60. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more vegetable gardening related activities.

61. (canceled)

62. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more aquaculture related activities.

63. (canceled)

64. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more animal husbandry related activities.

65. (canceled)

66. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more grain cultivation activities.

67. (canceled)

68. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in the farming related creation of one or more first biologically based substances including at least in part one or more fishing related activities.

69. (canceled)

70. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in farming related creation of the one or more first biologically based substances including at least in part one or more processed seafood materials.

71. (canceled)

72. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in farming related creation of the one or more first biologically based substances including at least in part one or more processed plant materials.

73. (canceled)

74. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in farming related creation of the one or more first biologically based substances including at least in part one or more whole animal items.

75. (canceled)

76. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in farming related creation of the one or more first biologically based substances including at least in part one or more seafood based materials.

77. (canceled)

78. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in farming related creation of the one or more first biologically based substances including at least in part one or more plant based materials.

79. (canceled)

80. The computationally-implemented method of claim 1, wherein the electronically storing farming related test information generated through testing of one or more test samples of one or more first farming related items involved in farming related creation of one or more first biologically based substances comprises:
electronically storing farming related test information generated through testing of one or more test samples of one or more first farming related items involved in farming related creation of the one or more first biologically based substances including at least in part one or more materials that will be processed to be ingested by a biological organism.

81. (canceled)

82. The computationally-implemented method of claim 1, wherein the electronically storing farming related test information generated through testing of one or more test samples of one or more first farming related items involved in farming related creation of one or more first biologically based substances comprises:
the electronically storing symbolic information recorded as being correlated with said test information and as being correlated with one or more tags, said one or more tags recorded as being at least temporarily in vicinity of one or more second farming related items involved in farming related creation of one or more second biologically based substances as at least in part one or more e-mail records.

83. (canceled)

84. The computationally-implemented method of claim 1, wherein the electronically storing symbolic information recorded as being correlated with and as being correlated with one or more tags, said one or more tags recorded as being at least temporarily in vicinity of one or more second farming related items involved in farming related creation of one or more second biologically based substances comprises:
the electronically storing symbolic information recorded as being correlated with said test information and as being correlated with one or more tags, said one or more tags recorded as being at least temporarily in vicinity of one or more second farming related items involved in farming related creation of one or more second biologically based substances at least in part as one or more file transfers.

85. (canceled)

86. The computationally-implemented method of claim 1, wherein the electronically storing symbolic information recorded as being correlated with and as being correlated with one or more tags, said one or more tags recorded as being at least temporarily in vicinity of one or more second farming related items involved in farming related creation of one or more second biologically based substances comprises:
the electronically storing symbolic information recorded as being correlated with said test information and as being correlated with one or more tags, said one or more tags recorded as being at least temporarily in vicinity of one or more second farming related items involved in farming related creation of one or more second biologically based substances as at least in part encrypted data.

87. (canceled)

88. The computationally-implemented method of claim 1, wherein the electronically storing symbolic information recorded as being correlated with and as being correlated with one or more tags, said one or more tags recorded as being at least temporarily in vicinity of one or more second farming related items involved in farming related creation of one or more second biologically based substances comprises:
the electronically storing symbolic information recorded as being correlated with said test information and as being correlated with one or more tags, said one or more tags recorded as being at least temporarily in vicinity of one or more second farming related items involved in farming related creation of one or more second biologically based substances as in least in part network data from one or more internet communication protocols.

89.-119. (canceled)

120. A computationally-implemented system comprising:
means for electronically storing farming related test information generated through testing of one or more test samples of one or more first farming related items involved in farming related creation of one or more first biologically based substances; and
means for electronically storing symbolic information recorded as being correlated with and as being correlated with one or more tags, said one or more tags recorded as being at least temporarily in vicinity of one or more second farming related items involved in farming related creation of one or more second biologically based substances.

121. (canceled)

122. A computationally-implemented system comprising:
a storing test info electrical circuitry arrangement operable for electronically storing farming related test information generated through testing of one or more test samples of one or more first farming related items involved in farming related creation of one or more first biologically based substances; and
a storing symbolic info electrical circuitry arrangement operable for electronically storing symbolic information recorded as being correlated with and as being correlated with one or more tags, said one or more tags recorded as being at least temporarily in vicinity of one or more second farming related items involved in farming related creation of one or more second biologically based substances.

123. (canceled)
